(19) United States
(12) Patent Application Publication
(10) Pub. No.: US 2004/0006566 A1
(43) Pub. Date: Jan. 8, 2004

(54) System and method for augmenting knowledge commerce

(76) Inventors: Matt Taylor, Palo Alto, CA (US); Gail Taylor, Palo Alto, CA (US)

Correspondence Address: Matt Taylor, 2741 Middlefield Road, Palo Alto, CA, 94306-2518, US

(21) Appl. No.: 10/014,718

(22) Filed: Nov. 7, 2001

Related U.S. Application Data
(60) Provisional application No. 60/246,118, filed on Nov. 7, 2000.

(51) Int. Cl. G06F 17/00

(52) U.S. Cl. 707/100

(57) ABSTRACT

A system and method for addressing the paradoxes and problems associated with the Knowledge Economy, and the transition to it. The system and method of the present invention create a unified experience of work that scales from individual thought processes to the building and using of a global system of commerce. Described in several levels of recursion, the system and method of the present invention integrate, into a single system and method several discrete Sub-Systems and methods that comprise a myriad of now unintegrated tools and processes that are conducted across contradictory and non-collaborative environments.

This application claims the benefit of U.S. Provisional Patent Application No. 60/246,118, filled Nov. 7, 2001, which is incorporated herein by reference.

### FEDERALLY SPONSORED RESEARCH

Not Applicable

### SEQUENCE LISTING OR PROGRAM

Not Applicable

### BACKGROUND

Field of the Invention

### TERMINOLOGY AND REFERENCES

Throughout the present application, certain terms of art are used. To assist in understanding the intended meaning of these terms in this application, reference should be made to certain published works as detailed hereinafter:

ADAPTION: as described in How Buildings Learn—What Happens After They're Built (1994), Steward Brand.

AGENTS AND AGENCY: as described in Society of Mind (1985), Marvin Minsky.

ARMATURE: as described in Building to Last—Architecture as Ongoing Art (1981), Herb Green.

COMPLEXITY, ORDER, VARIETY: as described in Architecture—Form, Space, and Order, 2nd Edition (1996), Francis D. K. Ching. Also as described in The Quark and the Jaguar (1994), Murray Gell-Mann and in At Home in the Universe (1995), Stuart Kauffman.

CONSCIOUSNESS: as described in The Origin of Consciousness in the Breakdown of the Bicameral Mind (1976), Julian Jaynes.

DEEP STRUCTURE: as it refers to language and cognition, in Language and Mind (1968), Noam Chomsky.

EMERGENCE: as described in At Home in the Universe (1995), Stuart Kauffman and in Emergence, The Connected Lives of Ants, Brains, Cities and Software, (2001) Steven Johnson.

FEEDBACK: (and of a complex kind) as described in The Human Use of Human Beings, Cybernetics and Society, and Cybernetics or Control and Communication in the Animal and the Machine (1948), Norbert Weiner.

HUERISTICS: as described in The Metaphorical Brain (1968, 1989), Michael B. Arbib and Wayne Reeves in Cognition and Complexity (1996).

INFORMATION: as described in Mind and Nature, A Necessary Unity (1972), and Steps to an Ecology of Mind (1979), Gregory Bateson. Also as described in Mathematical Theory of Communication (1948), Claude Shannon.

INTELLECT: as described in The House of Intellect (1978), Jaques Barzun.

INTELLIGENCE: as described in, for example, Frames of Mind: The Theory of Multiple Intelligences (1983), Howard E. Gardner.

ITERATION: as described in The Exemplar (1984), Robert Carkhuff; and as discussed in The Gold Collar Worker—Harnessing the Brainpower of the New Work Force (1995), Robert E. Kelley.

INTERFACE: as described in The Humane Interface (2000), Jef Raskin. “The way that you accomplish tasks with a product—what you do and how it responds—that's the interface” (pg. 2).

LIVING SYSTEMS: as described in Living Systems (1978), James Grier Miller.

MEME: as described in The Selfish Gene (1976), Richard Dawkins and The Meme Machine (1999), Susan Blackmore.

META PROGRAMMING: as described in Programming and Meta-Programming in the Human Bio Computer (1967, 1968), John Lilly.

MORPHIC RESONANCE: as described in A New Science of Life (1981), and The Presense of the Past: Morphic Resonance and the Habits of Nature (1988), Rupert Sheldrake.

NETWORK: as described in Small Worlds, The Dynamics of Networks Between Order and Randomness (1999), Duncan J. Watts.

NODES AND PATCHES: as described in At Home in the Universe, The Search for the Laws of Self-Organization and Complexity (1995), Stuart Kauffman.

PATTERN LANGUAGE: as described by The Timeless Way of Building (1979) and A Pattern Language (1977), Christopher Alexander et al., and as demonstrated by The Wright Space—Pattern & Meaning in Frank Lloyd Wrights Houses (1991), Grant Hildebrand. Both of the above references are described in The Power ofPlace—How Our Surroundings Shape Our Thoughts, Emotions and Actions (1994), Winfred Gallager, and in Frank Lloyd Wright—A Primer in Architectural Principles (1991), Robert McCarter.

PHYSICAL HEALTH, MENTAL WELL BEING, INDIVIDUAL PLACE and PROSPECT AND REFUGE: as described in The Power of Place—How Our Surroundings Shape Our Thoughts, Emotions and Actions (1994), Winfred Gallager, and in Places of the Soul—Architecture and Environmental Design as a Healing Art (1993), Christopher Day.

RECURSION: as described in Diagnosing the System for Organizations, Managerial Cybernetics of Organization (1995), Stafford Beer.

REQUESITE VARIETY: as described in Designing Freedom (1985), and Diagnosing the System for Organizations (1995), Stafford Beer; and Ross Asby in Cybernetics (1952)

SYMBIOSIS: as described in The Symbiotic Man—A New Understanding of the Organization of Life and Vision of the Future (2000), Joel De Rosnay.

SYMBOL: as described in Man and His Symbols (1961), Carl Jung, and in The Hero With a Thousand Faces (1949), The Mythic Image (1974), and The Innner Reaches of Outer Space: Metaphor As Myth and As Religion (1982), Joseph Cambell.

SYNERGY: as described in Synergetics (1975, 1979), R. B. Fuller.

SYNTOPICAL READING: as described in How to Read a Book (1972), Mortimer J. Adler & Charles Van Doren.

TRANSPARENCY AND RECIPROCAL TRANSPARENCY: as described in “The Transparent Society—Will Technology Force Us to Choose Between Privacy and Freedom?” (1998) David Brin.

The definitions and meanings presented in these works provide a foundation and frame of reference only. This Invention develops and adds additional meaning to these terms and employs them as precise Terms of Art as will be noted herein.

The present Invention also employs language on several levels: “Descriptive”—Normal Use NU, “Technical”—Terms of Art ToA, “Pattern language”—Solution Sets SS, “Modeling Language”—Design and Process Terms D/PT, “Algorithm”—Rule Statements RS, “Deep Language”—Machine Language ML. These levels will be noted as appropriate herein.

In addition, the present Invention employs an iconic, visual language ToA as a means of bringing deeper meaning and precise understanding to certain concepts and components of the System and Method. Glyphs are employed as an aspect of this language; as example: [symbol] [symbol] [symbol] [symbol] [symbol] [symbol] [symbol] [symbol] [symbol] [symbol] [symbol] [symbol] [symbol] [symbol] are Glyphs of this language—each with denotative and connotative meaning to one schooled in the art. These Glyphs will be employed as appropriate herein.

One example of Glyphical use, is the “SolutionBox” which is used to document the “voice” of a document or transaction. A document without information about itself can be misleading and/or lack context. The Solution Box is one means of this System and Method to provide “information about (the) information.” In this example, the Solution Box voice is “ENGINEERING” SS on the Creative Process Model, “STRATEGY” SS on the Vantage Points Model and “PRELIMINARY DESIGN” SS on the Design Formation Model.

The SolutionBox system provides a 7×7×7 matrix—or 343 “states”—that frames the information contained in a document or transaction. Each of these “STATES” has language appropriate to it, Terms-of-Art related to it, rules of proof acceptable to it, processes common to it and other associations kindred to a specific culture [symbol] The Models, with which individual Glyphs are associated, add further nuance. Thus, rich context and precise meaning can be created by simple means.

In addition to these terms and Glyphs, the following concepts and objects (below) are defined and are employable on the Descriptive, Technical and Pattern Language levels of language. These definitions pertain to different levels of recursion of this System and Method and relate to different Subsystems of the method (as will be noted). These are employed as terms of art ToA in this System and Method.

To facilitate understanding of what Level of Recursion ToA a given description or definition is applied to, the following convention is employed: rL1=neural nodes, computer code, small parts scale; rL2=machine environment scale; rL3=human scale; rL4=human team and group scale; rL5=human environments and organizations scale; rL6=social and ValueWeb ToA scale; rL7=global network and economy scale. These scales are roughly derived from and related to Miller's system and will be noted herein. This code is part of an Agent Definition Code which is an aspect the “Agent Builder” toolkit—Subsystem 3 Ss3.

To further facilitate navigation, the following convention refers to the different Subsystems of this Invention: Ss1=Subsystem 1 “System and Method for Facilitating Interaction among Agents;” Ss2=“System and Method for Optimizing Agent Pattern Language Values in Collaborative Environments;” Ss3=“System and Method for Integrating/Optimizing Technical Systems to Promote Agent Interaction;” Ss4=“System and Method for Transporting Agents and Agent Environments as an Integrated Experience;” Ss5=“System and Method for Structuring & Facilitating Value Exchange Among Agents Forming Real and Virtual Economies;” Ss6=“System and Method for Facilitating Work and Commerce among Agents in a Knowledge/Network Economy.”

An rL4-Ss1 annotation could refer to a human team scale facilitated interaction framework, as example. Any description or diagram annotated as such should be interpreted in this context.

ACT

[symbol]

rL4-Ss1: The process of doing or performing something. An enactment or decree. To drive to do. To push, propel or push forward.

Part of both the SCAN, FOCUS, ACT model and the 4-Step Recreative Process model. ACT is the opportunity to see whether the models will pan out as they become viable systems in their own right. If discipline and imagination have been brought to the two preceding stages, this stage should be successful.

Agency

Minsky defines Agency as “any assembly of parts considered in terms of what it can accomplish as a unit, without regard to what each of the parts does my itself.”

Agent (Simple, Complex, Smart and Intelligent)

Minsky defines Agent as “any part or process of the mind that by itself is simple enough to understand—event though the interactions among groups of such agents may produce phenomena that are much harder to understand.”

ANDMap Project Management Tool

rL4-Ss3: The term ANDMap stands for Annotated Network Diagram Map and refers to an invention that synthesizes Gannt charts, network diagrams like PERT, CPM or GERT, and process flow charts. The items on the map are plotted to scale over time and may be collected across a series of horizontal tracks, like Gannt charts. A standard set of symbols are employed to represent a range of activities from the strategic (Landmark, Benchmark) to the tactical (Event, Task), to the conditional decision point (Cusp) to the task level (Milestone). Landmarks and Benchmarks can be employed to express large scale ideas like missions, visions and goals. Events are rounded rectangles used to identify activities in points of time. They can be annotated with resource and duration data and used in network diagram fashion. Tasks have symbols representing the start and end of an activity, much the way activities are represented on Gannt charts. The Cusp represents a decision gate that may be found in process charts. Since the ANDMap is laid out with time as one of its axes, loops are usually avoided—currently it's still impossible to go backwards in time—instead a NO decision out of a Cusp will either end in a cessation of the project, an alternative contingency, or an indication that previous work must be redone, and showing this rework extending out along the timeline so the project team can get a visual sense of the impact of the decision. Milestones are used to highlight significant subdivisions of Events or Tasks. All of the symbols are connected by lines that may be coded to represent dependency, parallel processing, or critical information exchange. The symbols and lines may be color coded to provide additional information to the user, and extensive annotations may be written around the symbols on the map to provide explanations.

Anticipatory

[symbol]

rL4-Ss1: To feel or realize before hand; foresee. To act in advance so as to prevent; prejudice; forestall. To foresee and fulfill in advance. To cause to happen in advance; accelerate. To take before.

As one of the six elements of the Appropriate Response model, anticipatory represents the notion that designs or solutions to problems are living systems. As such, they must include the apparatus and processes necessary to use models based on past experience, along with current data gathering to make predictions concerning the future behavior of other systems in the environment. At the lowest level, this serves survival; at higher levels, anticipatory hardware and software enable systems to effectively collaborate with one another to support both the homeostasis and evolution of their collective ecosystem.

Anticipatory Design

[symbol]

[symbol]

A concept of Buck Fuller that describes the process of designing solutions to emerging problem prior to their general awareness in an organization or society. The solutions are, thus, in the prototype stage and ready for swift adaptation when the problem can be see and, thus, when the motive exists to resolve it.

Architecture

Refers to the field of architecture. In this system and method, the formal definition of architecture is: “the objectification of the values humans hold essential to living—making these values concrete by building and using the structures that form the environment.”

Architecture is also employed herein as references to the basic structure/process of an idea system or artifact.

Artifact (Test—Prototype) [symbol] (Known as Mechical Cat)

In order to test our concept, we create physical models and compare them to the reality. The artist paints; the engineer builds scale models; the business person turns to planning software and spreadsheets; the writer composes stories. See the Three Cat model.

Author-To-Author (also known as Be-The-Author) (See Syntopical Reading)

rL4-Ss1: A type of Design Shop event or Work Shop module in which each participant has been given a different book to read in advance. At the time of the module, the participants engage in a discussion of the issues facing the enterprise, however, they discuss from the vantage point of the authors they have read. Each participant assumes the personae, knowledge base, vantage point and opinions of the author whose book they were assigned to read. The exercise forces a change of vantage point and introduces new information into the pot. Its a day one or day two exercise.

Body of Knowledge

[symbol]

rL4-Ss1: One domain in the 7-Domains model, the Body of Knowledge represents the sum total of the historical and contemporary artifacts produced by all members of an organization. It is the living memory of an enterprise. Its purpose is to embody what is critical to successful planning, coordination and steerage, and implies the continuous interaction of members to sustain meaning and purpose. Group Genius does not occur systematically without a living Body of Knowledge that is documented, organized and synthesized. However, simply amassing volumes of archival data should not be confused with the function of the Body of Knowledge. The Body of Knowledge is more of a living property of an organization that arises in the process of creation. Capturing it in the form of artifacts augments learning and enables useful patterns to be recognized. This results in the cultivation of insights gleaned from experience that sustains organizational self-awareness and a sense of the future.

Boundary Conditions

The framework in which an exercise is conducted or a problem defined. See: Zone of Emergence Engine FIG. SS1-8. This framework is defined by a number of elements depending on subject, context and the operation in play. These can include: time, scale and scope, rules-of-engagement ToA and so on.

Breakout

rL4-Ss1: A general activity during a DesignShop event or Work Shop when a large group is divided into smaller teams to work on either different issues, or different aspects of the same issue. The space in which this activity takes place is a Breakout Area. The group undertaking this activity is called a Breakout Team. Breakout activities are variously referred to as Breakout Rounds or Design Rounds.

Build

[symbol]

rL4-Ss1: To form by combining materials or parts; to erect; construct. To give form to according to a definite plan or process; to fashion; mold; create. To establish and strengthen. To establish a basis for.

One stage in the DESIGN, BUILD, USE model. There must be a process for rapid execution of the design that allows frequent adjustments to the realities of a build-out and the changing perceptions of the user as the design unfolds. The process and the product (space) must provide for this speed throughout the occupancy so that the enterprise of users does not have to waste time and talent in reconfiguring itself to meet changing conditions.

Capture Team

rL4-Ss1: A subset of the KreW of Knowledge Workers in a DesignShop event who are assigned to work in a Breakout Area to document, or capture, the discussion in one or more forms: keywords, synthesis (by individual attribution or journalistic summary), graphics from the WorkWalls. The work of this team is published to the DesignShop Journal.

Change

[symbol]

rL4-Ss1: An element in the Rate of Change model. In this System and Method, change is treated as continuous but measurable in discrete steps see: Memory Aspect 12.

Channel

Referes to a means by which ideas, energy, goods or Agents are transported. See Memory Aspect: 11 and Mind Engine SS6-1.

Circle-Up

rL4-Ss1: A ritual for the disciplined sorting of signals to help a Patch (Team) through the process of association and decision-making in support of the next major phase of work. Circle-Up also brings the Patch into unity at a point in time; although unity does not imply consensus in this case. Its also a formal time to acknowledge progress, failures and successes along the Lifecycle of the Web (Enterprise). Its a time to engage the multiple intelligences of the teams members in a process of collaborative design. Commonly a Circle-Up is use to shape the opening and closing of an event. It can put the Patch back in touch with its Vision and the iteration of the work to be done.

Circuit

A complete loop usually involving a series of way-points.

Coevolution

The process by which one evolving complex system, A, changes in concert and with feedback ToA—thus, causing change—with another complex system, B, which forms A's environment.

Complex—Complexity

[symbol]

rL4-Ss1: An element in the Rate of Change model. From the Principia Cyberneticus Web site: “the original Latin word complexus, which signifies “entwined”, “twisted together”. This may be interpreted in the following way: in order to have a complex you need two or more components, which are joined in such a way that it is difficult to separate them. Similarly, the Oxford Dictionary defines something as “complex” if it is “made of (usually several) closely connected parts”. Here we find the basic duality between parts which are at the same time distinct and connected. Intuitively then, a system would be more complex if more parts could be distinguished, and if more connections between them existed.

A description of the complex phenomena demonstrated in systems characterized by nonlinear interactive components, emergent phenomena, continuous and discontinuous change, and unpredictable outcomes. Although there is at present no one accepted definitions of complexity, the term can be applied across a range of different yet related system behaviors such as chaos, self-organized criticality, complex, adaptive systems, neural nets, nonlinear dynamics, far-from-equilibrium conditions, and so on. Complexity characterizes complex systems as opposed to simple, linear, and equilibrium-based systems. Measures of complexity include algorithmic complexity; fractal dimensionality; Lyapunov exponents; Gell-mann's “effective complexity” and Bennett's “logical depth” (definition from the EdgeWare Glossary, The Plexus Institute).

Concept (of Object/Thing) [symbol] (Known as: Concept Cat)

rL4-Ss1: The mental model that we build of an object or thing, based upon our observations of the real thing, that aids our decision making process. We learn to associate current phenomenon with past occurrences of similar phenomenon. We make decisions based on projections of past behavior onto the current situation. Lacking any such direct associations, we are forced to invent. See the Three Cat model.

Conception

[symbol]

rL4-Ss1: As the first component of the Stages of an Enterprise model, Conception is where ventures and enterprises originate. Scribbles on napkins, nagging dreams, a persistent or alarming push by the external or internal rate of change.

Conception is the ability to form mental concepts; invention. The formation of a zygote capable of survival and maturation in normal conditions. Concept, plan, design, idea. To take to oneself.

Condition

[symbol]

rL4-Ss1: The particular mode or state of being of a person or thing. The existing circumstances. Latin, conditio, agreement, stipulation, from condicere, to talk together, agree.

As the first stage in the Creating the Problem model, these are the existing conditions before you begin the creative process. Notice that these conditions, in and of themselves, are merely conditions. They are not the problem. These conditions are in constant flux and will change as the creative process advances.

Creative Tension [symbol] (See: Tension—Creative)

rL4-Ss1: Creative: the power to cause to exist, bring into being, originate. Tension: a force tending to produce elongation or extension. Voltage or potential; electromotive force.

As a component of the Creating the Problem model, the creative tension that comes into being when you decide to resolve the problem is the interplay between vision and reality. As the two tug and pull at each other, they will each change and modify in an effort to reach a synthesis.

Crew (Also spelled KreW)

rL4-Ss1: A team of Knowledge Workers charged with supporting a process such as a DesignShop event.

Culture

[symbol]

rL4-Ss1: Cultivation, tilling. The totality of socially transmitted behavior, patterns, arts, beliefs, institutions, and other products of human work and thought. As a component of the Vantage Points model, Culture defines the various components of the Enterprise and their relationship to one another in action. Also encompasses standard behaviors of these components—behaviors which are manifestations of the Philosophy.

Customer

[symbol]

rL6-Ss1: A person who buys goods and services on a regular basis. To become, to accustom.

According to the ValueWeb model, the customer still purchases and uses the product. But customers are also interested in how well and ethically the companies are run—they vote with their investments. And customers are included in production.

Cybernetics

The science of organization. “The theoretical study of communication and control processes in biological, mechanical, and electronic systems, especially the comparison of these processes in biological and artificial systems” (The American Heritage Dictionary of the English Language, Fourth Edition).

Death

[symbol]

rL4-Ss1: Termination, extinction, loss or absence of spiritual life.

As a component of the Stages of an Enterprise model, Death represents the fact that eventually all organizations reach their demise. Usually this is good. Sometimes it's the easiest way for the enterprise to allow new ideas to escape and try for viability. And even if the name of the corporation does not change, sometimes, its old self dies and a new one is born in its place.

Design

[symbol]

rL4-Ss2: To conceive, invent, contrive. To form a plan for. To draw a sketch of. To have as a goal or purpose; intend. A visual composition; pattern. To mark out; sign out.

As part of the Design, Build, Use model, Design represents the creation of sketches, models, plans, schedules, and budgets to convey a sense of the scope of the project in many different dimensions. This is not done merely at the beginning of the project, but as a sort of continuous process throughout the life of the building. The design takes into account past and present work process requirements, and the uncertainty associated with the future as well.

Design Assumption

A major aspect that underlies a design approach. Remove the assumption and the design is massively altered.

Design Development

A discreet step following PRELIMINARY and proceeding CONTRACT DOCUMENTS in the Design Formation Model.

Design Issue

An issue in a circumstance that is directly resolvable by exercising the design process.

Design Strategy

[symbol]

[symbol]

The core aspects and feature of a design that directly address the significant aspects of a problem. See: Creating the Problem Model.

Designshop Event

[symbol]

[symbol]

rL4-Ss1: An event whose purpose is to release Group Genius in the client, condense the time in which a team moves from Scan to Act by an order of magnitude, capture and organize all of the information generated, and do all of this in a facilitated way by managing not the people involved, but the 7-Domains that regulate collaboration and evolve ingenuity.

Designshop Sponsor

[symbol]

[symbol]

rL4-Ss1: Representatives from the client who usually have a considerable stake in the successful outcome of the DesignShop. They may be project managers, department heads, or CEOs. Sponsors are also participants in the event, although in some cases they may work on the KreW. Some clients have only one sponsor, and others have an entire sponsor team.

Distribution

[symbol]

rL4-Ss1: To allot, grant apart. Dispersion, diffusion. Divide and dispense in portion.

As a stage in the 10 Step Knowledge Work Process model, distribution is the process of repackaging, encoding, transducing, and transmitting across the Web (Enterprise) to all parties that need the information as potential compelling input.

Document

[symbol]

rL4-Ss1: To note down, to mark. Lesson, example, warning, to teach. Anything serving as evidence or proof. To support with citations, annotate.

As a stage in the 10 Step Knowledge Work Process model, the information is captured, encoded in the form of a message, tagged for shipping, transduced across the Event membrane, and transferred via some signal, medium, and channel to the K-Base. Also referred to as Documentation.

Documentation Team

rL4-Ss1: A subset of the KreW whose work comprises capturing reports and conversations that occur when all of the participants are assembled into one group. (The Capture Teams document reports and conversations that happen in Breakout Teams.)

Education and Training

[symbol]

rL4-Ss1: Education and Training, representing one domain in the 7-Domains model, are critical factors for thriving in an environment of rapid and discontinuous change. Often confused as one, education and training are actually very different in both intent and method. Education means “to lead out” and is primarily an open-ended process. Training means “drawn or dragged behind;” it is a closed process that ensures the continuance of purposeful habits. Training instills heritage. It transfers what is known. An organization should never lose its basic, root knowledge and skill; its memory. Education leads forward to discover the new. It is a form of leadership. Practicing the craft of leading through educating is how meaning and purpose are translated into a resilient capacity to create the future.

Efficacious

[symbol]

rL4-Ss1: One of 6 components of the Appropriate Response model, Efficacious is the power or capacity to produce the desired effect. Ability to achieve results. To execute, make; perform, work out. To effect. By contrast, the word effective means “having the intended or expected effect.” The difference lies in the use of the word “power.” An efficacious design exudes power and this power is efficiently directed to yield predictable results.

Emergence—Emergent Behavior

Emergence is a new kind of cause and effect. It is the cause and effect of living entities and the phenomena related to them. It is that kind of cause and effect where “the interaction of the elements or entities gives rise to higher-level properties that are not apparent in the lower levels nor predictable from those levels.

“Such a system would define the most elemental form of complex behavior; a system with multiple agents dynamically interacting in multiple ways, following local rules and oblivious to any higher-level instructions. But it wouldn't truly be considered emergent until those local interactions resulted in some kind of discernible macro behavior.” Steven Johnson, Emergence, page 9.

Encounter

[symbol]

rL4-Ss1: To meet or come upon, especially casually or unexpectedly. To meet, especially in conflict.

In the context of the S'poze Model, during the Encounter stage, the system's current Paradigm meets up with a high information messaging event. This means, simply, that the system is experiencing the effect of New Information that does not fit into its current model of how things work—its Paradigm. And it means that the potential effect of this information is of such a magnitude as to compel a conscious decision for handling it. Either it represents a threat and the system must learn new strategies for thwarting it, or it contains a potential benefit and the system must learn how to take advantage of it.

Engagement Team

rL4-Ss1: A group of people who are assigned to work with a specific client over the duration of the relationship. They may also include DesignShop facilitators and Knowledge Workers, but this is not necessary.

Entrepreneurial Button

[symbol]

rL4-Ss1: Organizing, operating and assuming the risk for business ventures to undertake—to take between; to strike against, thrust, pierce.

Within the Stages of an Enterprise model, newly conceived ideas within an existing Enterprise, even if tested through the looping stage, cannot become viable unless the Entrepreneurial Button is pushed. There must be an overt recognition of the need for and value of the new idea or it will not be allowed to grow.

Environment

[symbol]

An environment is that which surrounds and creates the circumstances of an organism. In this System and Method, environments can be physical and/or virtual and make up one of the three core capacities of the system of the present Invention: (processes [symbol] environment [symbol] tools [symbol] ).

In this System and Method, environments can include machine rL2 and network systems/structures rL7. Environments can include humans rL4 and other life forms and subsystems of these rL1. An environment can be a social system rL6. It can include transportation environments Ss4.

rL5-Ss2: Environments to house this System and Method are presently referred to, generically, as Management Centers, NavCenters and KnOwhere Stores especially in the context of DesignShop events, PatchWorks exercises and other formal processes. This Invention is not limited to these expressions. More generally, any space that has been consciously designed and configured to support a process in a flexible and evolutionary manner. Most of us work in “spaces” (office space, work space, etc.) that are devoid of enlightened, conscious design, and therefore very poorly support our lives and the processes that comprise them. In this System and Method, environments for human teams rL5, while being architecture and accomplishing Pattern Language values, affording knowledge-workers ToA more individual accommodation, self-adjustment and adaptability—in less overall footprint—this System's environments are conceived [symbol] , designed [symbol] , built [symbol] and used as a tool [symbol] of knowledge creation: to display, store, retrieve, recreate [symbol] and display, in iterations, information/knowledge objects/Agents. This is accomplished in extremely short design-build time periods, from manufactured components, at affordable prices, as a major Subsystem process and capability of the present Invention.

Evaluation

A key step in any systematic process of work. See: Design Formation Model. Evaluation is also a key aspest of feedback and use. See Stages of the Creative Process and 4-Step Recreative Process Models. See also, criticism process.

Event

[symbol]

The first act [symbol] in the 10 Step Knowledge Work Process model. As a Term-of-Art of this System and Method, every event has to be seen and treated in this context. An event can be formal or informal. It can be of short duration or of many days. It is, however, treated as discrete. And, it is an EVENT, in terms of this method, only if the other steps in the 10 Step Model are taken.

There is a strong relationship between MEMORY, as a term-of-art of this System and Method, and the “Mechanical Cat” [symbol] of the 10 Step Model. The 10 Step is a process engine designed to emply many of the natural characteristics of memory as observed in a complex system. The CyberCon Tool-Kit (Subsystem 3) is designed to augment this process.

On the highest level, an event is a discrete act, as part of an extended process, augmented with cybernetic tools. Therefore, previously not-integrated, loose, non-intentional networks can be made to function like natural living systems.

An event is bounded by a beginning and an end—by dimension and location. An event must be observed and documented to be an event.

Event Sponsor

[symbol]

[symbol]

[symbol]

rL4-Ss1: In the context of a DesignShop event, these are representatives from the client who usually have a considerable stake in the successful outcome of the DesignShop event. They may be project managers, department heads, or CEO's. Sponsors are also participants in the event, although in some cases they may work on the KreW. Some clients have only one sponsor, and others have an entire sponsor team.

Exemply

[symbol]

rL4-Ss1: One of the 5-E's in the 5 E's of Education model. To explain by example. Someone or something worthy of imitation or duplication. Serving as an illustration, a model, or an instance. To take out.

Expect

[symbol]

rL4-Ss1: One of the 5-E's in the 5 E's of Education model. To look forward to the probable occurrence or appearance of. To look out at.

Experience

[symbol]

rL4-Ss1: One of the 5-E's in the 5 E's of Education model. The apprehension of an object, thought, or emotion through the senses or the mind. Active participation in events or activities leading to the accumulation of knowledge and skills. To try, test.

Expert

[symbol]

[symbol]

rL4-Ss1: Person with a high degree of skill or knowledge in a certain subject. Latin: to try; (i.e., risk, lead over, press forward, to learn by experience). In the context of the Learning Path: Five Points of Mastery model, the Expert develops specialized knowledge to a high degree in a given body of knowledge and is a resource to others. Everyone has expertise to share; everyone applies their expertise to create value for themselves and others, as participants in this learning environment.

Explain

[symbol]

rL4-Ss1: One of the 5-E's in the 5 E's of Education model. To make plain; remove obscurity from. To define, explicate. To offer reasons for, or a cause of. To spread out; completely flat plain.

Explore

[symbol]

rL4-Ss1: One of the 5-E's in the 5 E's of Education model. To investigate systematically; examine, study. To search into or range over for the purpose of discovery. To search out. Cry out aloud.

Facilitation

[symbol]

Facilitation means to “make easy.” It is the second Domain of the 7 Domains Model: “Work Process Design and Facilitation.”

Facilitator [symbol] (Sometimes Called the Key Facilitator)

rL4-Ss1: The Facilitator works with the DesignShop, PatchWorks, (or other event [symbol] Sponsors (which may include members of the Engagement Team ToA and the Process Facilitator ToA (representing the KreW) to design the event before it begins, manage the continuing design and execution of the event while it is happening, to bring closure to ideas and processes immediately following the event, and to open paths for progress to the next stages of work. To facilitate means “to make easy.” The art of facilitation is the art of bringing clarity and effectiveness to the work process [symbol] of individuals rL3 and groups rL4. The facilitator's mandate is to ensure that the process [symbol] is designed [symbol] and implemented in a way that brings out the best thinking of each participant and the best resolution of issues from each group.

In a further manifestation of this System and Method, facilitation and work can be performed by Agents of all kinds for Agents of all kinds (humans, machines, systems, and so on).

Facilitation involves a wide range of actions [symbol] taken to affect the interaction of Agents. It involves bringing order to the universe of thoughts and possibilities [symbol] about a topic, and giving back to people (or other Agents) what they already know, in a way that brings clarity and a foundation for effective action [symbol] . It involves setting appropriate Boundary Conditions ToA (time, physical space, and agreements—Terms-of-Engagement ToA) within which an individual or group can work efficaciously [symbol] . It involves clarifying conditions and goals, through a process Ss1 we describe as “creating the problem”

[symbol]

[symbol]

[symbol]

[symbol]

[symbol]

Facilitation involves introducing the right “new” information [symbol] (Objects/Agents) that challenge R existing ways of thinking [symbol] and leads individuals to explore/discover [symbol] their own unexamined Design Assumptions (ToA) about a given condition [symbol] It involves providing feedback [symbol] so that what has been learned [symbol] [symbol] is incorporated [symbol] into the design [symbol] work that follows avoiding unnecessary looping

[symbol]

It involves observation and assessment, and taking actions to ensure that a group's natural biases do not prevent some vantage points from being heard, or certain phases of the creative cycle to skipped. When necessary, the facilitator will interject new challenges to prevent a group from coming to closure on an idea prematurely; and at other times to push a group to closure when the exploration is sufficient and no gain is to be made by working an issue further.

The present inventors reject the notion that the facilitator should be an “objective third party” who does not get involved in content and focuses only on process, performing only some kind of umpire or gatekeeper role. The present inventors do not apply the “facilitator as umpire” (only) model for many reasons, including philosophical considerations: no one can ever be completely unbiased, and as modern physics has shown, even the act of observing a process will affect that process. Objectivity, in this System and Method, is accomplished by deliberately allowing all possible “voices” (Agents) to be heard and making clear all possible positions or biases (including those of the facilitator [symbol] , tool-set [symbol] and environment [symbol] ).

Moreover, it's our experience that the agreements put in place by this model nearly always function more to protect the facilitator than to produce effective results. However, the Commissioner of Baseball metaphor has meaning in the act of governance and facilitation on the scale of ValueWebs rL6.

Feedback

[symbol]

Feedback is the message, to the controller of a system, from a sensor of a system, of the difference between performance and expectation. No message, no feedback. No message to a controller (an agent that can act to modify what the system is doing), no feedback. No message from a sensor (designated as such as an agent of the system), no feedback. This definition holds on all levels of recursion embodied by this System and Method from neural nets to a global economy.

The frequency of feedback is a critical issue in the design of dynamic and complex systems. Messages have to be requisite with the rate of change in the environment taking into account the time “lag” inherent in the total response cycle (Jet Planes Model).

POSITIVE feedback reinforces an action creating increasing returns. Too much positive feedback in a system will lead to instability. In this context, positive does not mean “good.”

NEGATIVE feedback attenuates a system's behavior. In this context, negative does not mean “bad.” (See Weiner)

rL4-Ss1: In the context of the 4-Step Recreative Process model, discover how well the creation performs in the world. Does it fulfill your vision? How do others like it? Does it inspire new visions in you or in others?

Focus

[symbol]

rL4-Ss1: One component of the SCAN, FOCUS, ACT model. FOCUS is often seen as the middle stage of a three stage model, but the model is in fact nonlinear and highly recursive. FOCUS implies choice. The majority of the opportunities presented by the SCAN are discarded in favor of only one or several, which are scrutinized and evaluated more rigorously. The models we build in FOCUS are more tangible expressions of the conceptual models we built in SCAN. At length a decision is made and it's time to ACT.

Graceful Failure

An engineering principle attributed to Amory Lovins that advocates building the failure path into a system. Systems will fail. The important thing is to minimize the downside consequences by the way that the system is engineered, built and used. Graceful failure connotes an easy, non-catastrophic, recoverable failure path.

Complex systems that survive exhibit this characteristic. Nature designs systems this way. Too often, human-made systems are more brittle than this. The scale and scope of present and future human complex systems requires the graceful failure approach. Failure is minimized by appropriately designed-in feedback, memory of alternatives and “graceful” exit strategies. The definition of “graceful” is dependent on the nature of the system users and the consequences inherent in the potential failures of that system. Several hundred humans dropping several miles in a metal tube, with no alternative recovery process, is not graceful.

Group Genius

rL4-Ss1: The ability of a group working iteratively and collaboratively to seek, model and put into place higher-order solutions. Time compression, systemic work-flow, dynamic feedback, individual creativity and collective creativity are core features of Group Genius.

The Group Genius process is the heart of MG Taylor's methodology. Designing, building, and using environments, processes, and tools that systematically and repeatedly release this ability critically distinguishes the MG Taylor” Process from other ways of working.

Gail Taylor first encountered the concept of group genius while living in Kansas City in the early 1970's in the work of Lawrence Halprin, community developer and co-author of Taking Part: A Workshop Approach to Creativity. The idea resonated with Gail's core beliefs about the nature of creativity and the collaborative potential of a group. Several years later, when Gail and Matt Taylor formed MG Taylor (then Taylor Associates), releasing “group genius” became a core principle in the organization's philosophy.

Hypertile

rL4-Ss2: The WorkWalls manufactured by Athenaeum international as part of this System and Method, are made of steel and, therefore, accept magnets. Hypertiles are large rectangles of flexible magnetic material, matching various paper sizes. They are covered on one side with a sticky surface manufactured by 3M. Sheets of paper can be adhered to this surface and peeled off without leaving any residue on the back of the paper. The paper can then be photocopied or scanned for entry into the Knowledge Base.

Many of these can be “tiled” togehter on the WorkWalls to create composite graphics made of many pieces that can be easily scanned—“Hyper” reffers to Hyper Text (Ted Nelson)—thus, the term HyperTile.

Identity

[symbol]

rL4-Ss1: The collective aspect of the set of characteristics y which a thing is definitely recognizable or known. The quality or condition of being or remaining the same. Latin; the same.

The first stage in the Seven Stages of the Creative Process model. Explore, discover and understand how the system produces the conditions. Even if you think you know how it's done, think again. Use techniques of collaborative, creative design to see the system from different vantage points. Break out of common assumptions and past practices (you can always go back to them if you need to). Build a working model of the current system that replicates the conditions you see. It probably won't be right but it will lend some needed insight. Creativity is the elimination of options. So generate some optional ways of seeing the system and its components. Work until you can see the truth in everyone's viewpoint. This means building models of these viewpoints. Then, maybe you can assemble components of the viewpoints together to get a more robust map of the system and conditions than you could by clinging only to your own opinions.

Incorporate

[symbol]

rL4-Ss1: To cause to merge or combine together into a united whole. To unite with or blend indistinguishably into something already in existence. To form into a body.

In the context of the S'poze model, if the results of the simulation seem favorable, the system may incorporate the New Information into its Paradigm and begin making decisions based upon this new mixture. Also incorporation.

Increasing Returns

A natural ToA and frequently recurring phenomena that “locks” a system into a positive feedback ToA loop. This becomes a growth engine until the system limit ToA is reached or some other agency ToA intervenes. If the system limit is reached, catastrophic failure usually occurs. See: Stages of An Enterprise Model. Many human designed systems are exhibiting this phenomena. This indicates a structural flaw in their architecture ToA. Within limits—maintained by properly placed negative feedback loops—increasing returns can be maintained in sustained growth. This requires structural recreation ToA of the system ToA as it proceeds through iterations ToA of activities and “jumps” recursion ToA levels at moments of transformation ToA.

The Dutch Tulip craze and the Spanish gold inflation are notable examples from history of increasing returns unbounded by appropriate feedback.

Information

[symbol]

As defined by Gregory Bateson, information is “the difference that makes a difference.” See: Data, Information, Knowledge Model.

Information—New [symbol] (See: New Information)

rL4-Ss1: A numerical measuer of the uncertainty of an experimental outcome. Knowledge derived from study, experience, or instruction. A non-accidental signal used as input to a computer or communication system.

In the context of the 'Spoze model, systems are receiving all kinds of messages from other systems and the environment in general. Messages are neutral. They do not contain information. Rather, information is the result of a system's interpretation of a message, including whatever meaning it assigns to the message based on past experience. This meaning—or message in context of associated experiences—is what we call information. The measure of information is proportional to its uncertainty, or surprise. The more surprising the message, the more information it contains. Most messaging events are devoid of information, either because they are filtered out, or because they bear messages whose content is expected by the receiving system.

Insight

[symbol]

rL4-Ss1: The capacity to discern the true nature of a situation. An elucidating glimpse. Old English: thing seen within.

At this stage of the Seven Stages of the Creative Process model, there's only one stumbling block: your vision is full of holes. You will have figured this out by now. Sometimes when working on simple problems, the vision really will contain a clear definition of the problem, and the answer, but usually there are lots of unknowns and gaps in understanding. The problem—the PROBLEM—is how to conceive of, invent, allow for the emergence of, or create the subsystems and ecosystems that will fill the gaps in the vision—that will rework the vision to make it more powerful. The problem is not how to fix the conditions. The problem is how to imagine, design and allow for the evolution of new components of the system (or new systems) that will help the system create different (and hopefully more healthy) conditions. There's no other problem you can solve. You can't fix the conditions.

Intellectual Capital

A business concept that measures the true value of an enterprise. Three elements ToA have to be present for intellectual capital to be created and sustained: First, intellectual property ToA. Second, a market ToA that can employ the idea, service, product, artifact that represents the virtual/physical manifestation of the IP. Third, the operational capability to manufacture and deliver value to said market and to sustain the variability imposed by a changing marketplace.

This System and Method facilitates the creation of ValueWeb ToA architectures as a means of accomplishing these three conditions in high variety, complex environments.

Intent

[symbol]

rL4-Ss1: Aim, purpose, meaning, purport. Firmly fixed, concentrated. Having the mind fastened upon some purpose. Latin: to stretch toward.

In the context of the Seven Stages of the Creative Process model, Intent asks Are you excited yet? Do you have the juice to live in the vision and do the work to bring as much of it it back to the present each day as you can? How long can you live with the ambiguity and paradox of working in two different worlds? Can you assume the mantle and the risks of the prophet and advocate? Intent is the well of energy that you'll return to over and over while you're working to bring your vision to the present. The greater the distance on the fitness landscape between the old and new system, the greater the challenge and the more energy you'll need to succeed

Interface

Interface is commonly understood in terms of the interaction between a computer and a person. Jef Raskin takes it further and relates it to the design of products of all kinds. In this System and Method, it includes these perceptions and extends them to transitions in architectural space and transactions in processes.

There is an issue of Interface every time space, state, time, context, mode, style, purpose, use, environment (and so on) transitions. There is an issue of Interface every time energy and/or matter is transported (Subsystem 5). The management of Interface is the management of the “white space,” “negative space,” “time-out” and “shift” that happens between things.

Different Agents require different facilitation between these states as appropriate to their nature and status in the system/process.

Investor

[symbol]

rL6-Ss1: One who spends or utilizes time, money or effort for future advantage or benefit. To besiege. To clothe in, surround.

According to the ValueWeb model, the investor provides capital to the enterprise with the hope of receiving a return on the investment, and a return of the original investment as well at some point in time.

Iteration

Progressive, feedback driven, full cycles of work that are closely coupled in time and context.

Knowledge (See: Body of Knowledge)

Data points are the bits of experience [symbol] . Data, integrated by some principle or schema (Model ToA) is information [symbol] . Information, in context ToA of prior experience [symbol] (memory ToA), with the focus [symbol] of intent [symbol] in act [symbol] is KNOWLEDGE.

In this definition, which is intrinsic to this System and Method, KNOWLEDGE cannot exist outside of action [symbol] There is no such thing (in this method) as abstract, passive knowledge. Remove action and you have memory of (high level information about); remove intent and you have (structured) information; remove an integrating Model and you have data—raw experience.

KNOWLEDGE, in this method, is an intelligent construct that can exist on many levels of recursion of a complex ToA, learning system ToA. KNOWLEDGE, in this definition, is the result of the interaction of Agents. Knowledge emerges ToA as the result of this interaction.

The interaction that results in KNOWLEDGE always takes place in an environment [symbol] and is always augmented by tools. It always results in memory ToA and Agent alteration.

Knowledge Economy (See; Network Economy)

It is generally recognized today that the principle valued-added element in the production and use of products and services is knowledge—hence the term Knowledge Economy.

This, however, can be misleading if the concept [symbol] is confused with the “mixed” condition [symbol] that now exists. This System and Method employs these terms in a much stricter sense than this general philosophical [symbol] perception. The Industrial Economy and the Knowledge/Network Economy are intrinsically different (and competing) systems. The Industrial Economy will not evolve (with existing methods and tools) into a sustainable, self-correcting [symbol] knowledge-based economy.

rL7-Ss6: Further, the entire method and means by which value is understood and assessed has to be recreated [symbol] operationally.

rL7-Ss4:This will require more sophisticated means of exchange and structuring custom economies.

Knowledge is a “no-thing”—an intangible. Our present economy measures and rewards things. Still. Even e-commerce, as its present confusion (June, 2000) discloses. There are two significant Design Strategies [symbol] [symbol] that have to be applied to “create the problem” [symbol] worth solving: first, a comprehensive Model ToA of the process [symbol] of how idea becomes value (Ss6); and, second, an order of magnitude (or more) fine graininess and “smarts” in the medium of exchange (Ss4). Neither the present Model nor the medium can match the variety ToA of a global knowledge-worker, hunter-gatherer, affinity-based, tool-augmented society.

The Knowledge/Network Economy will be global. It will reward knowledge. It will employ networks and systems immeasurably more complex ToA than exist today. It will employ smart/intelligent cybernetic systems and tools. It will destroy the old economy. Timing and transition are important. It is not here yet.

Knowledge Objects or Agents

Artifacts ToA of information, inserted, interactively, into a process (an environment of Agents) by a rule or algorithm for the purpose of knowledge ToA creation.

rL4-Ss1: On the human level of recursion in a facilitated [symbol] event [symbol] these artifact/objects are usually from outside of the body of knowledge [symbol] resident in the participant Agents and brought to the attention of the group at the right time to facilitate [symbol] ideas into focus [symbol] or expand (explore [symbol] ) a perception. These artifact/objects may take the form of articles from magazines or journals, books, quotes, research papers, models, graphics, multimedia or databases—or any combination of these. They will often be displayed on WorkWalls ToA. This act [symbol] is part of building [symbol] environment [symbol] for the participant/Agent.

rL2-Ss3: In a robust expression of this System and Method, the CyberConn Tool Kit augments the 10 Step process and tracks [symbol] each Agent interaction with each artifact/Agent.

Knowledge Base

[symbol]

rL5-Ss2: The Body of Knowledge that supports an individual, a group, an Enterprise, or a ValueWeb.

In the 10 Step Knowledge Work Process model, the K-Base serves as repository, or data warehouse, and router for messages in the enterprise. The sum or range of what has been perceived, discovered or inferred. Skill, understanding, experience. Familiarity, awareness.

Knowledge Wall

rL5-Ss2: Management Center and NavCenter environments have at least one (usually more) large wall sometimes up to 50 feet in length, usually the back side of the Radiant Wall that is covered with a mildly adhesive surface manufactured by 3M. This wall serves as an oversized European-style kiosk. All sorts of information may be posted to the wall. Sometimes portions of the documentation are placed on it. Photographs, color art work, and diagrams are also posted here. Articles from magazines or the Internet are also displayed for participants to browse through. Information is not displayed haphazardly, rather, a layout is thoughtfully designed, making the wall a structured information event. In a further embodyment of this System and Method the KnowledgeWalls will be electronic.

Knowledge Workers

[symbol]

[symbol]

rL4-Ss1: The individuals who comprise the KreW that supports activities such as a DesignShop, Workshop, PatchWorks event or other embodiment of this System and Method. They are responsible for managing the flow of information temporally through the duration of the event and spatially within the Environment—or environments of the event.

Knowledge Worker Sponsor

[symbol]

[symbol]

[symbol]

rL3-Ss1: A Knowledge Worker of at least Journeyman level who is also a Process Facilitator or Facilitator, and whose purpose is to provide an official, facilitative and welcoming link to the work and philosophy of the organization for one or several other Knowledge Workers in the network.

KreW

rL4-Ss1: Another term for the Crew of a DesignShop or other event. The “K” and “W” in the title refer to the abbreviation “KW”, or Knowledge Worker. The “re” can take on most any meaning that seems appropriate to the situation. KWIB Knowledge Work Information Broker. Each Management Center or KnOwhere store has a KWIB, usually assigned on a rotating basis, to collect, maintain and disburse information concerning events in the center.

Learner

[symbol]

[symbol]

rL4-Ss1: Someone who gains knowledge, comprehension or mastery of through experience or study. Acquire through experience.

In the Learning Path: Five Points to Mastery model, a Learner is an explorer, innovator, self-developer, model-builder and action-taker who is receptive to ideas and guidance, able to reflect and act creatively, learns how to access information and create value from it for self and others. A unique set of contacts—family, peers, facilitators, sponsors, experts, and community members—comprise the Learner's constantly evolving learning network.

Limit

The boundary of a system. When this is exceeded the system ceases to be the system that it was. This is catastrophic failure of the system's architecture.

Logistics

[symbol]

rL4-Ss1: The KreW facilitates the flow of matter, energy and information through the DesignShop or the Management Center. Logistics focuses on the flow of matter and energy. This includes providing the physical environment, tools, equipment, materials, food. It also calls for the continual refreshing and maintenance of these elements.

Looping

[symbol]

rL4-Ss1: A length of line folded over and joined at the ends to form into a loop. Loupe. Imperfect gem. A small magnifying glass used by jewelers.

Most ideas go through a roller coaster ride of peaks of success followed by valleys of near collapse before they become viable—capable of separate existence. The Stages of an Enterprise model identifies this process as Looping.

Management Center

[symbol]

[symbol]

rL5-Ss2: Special environment for managing the design and innovation process in the context of expected social-economic change, and for building action plans to accomplish the goals established. By careful facilitation of the elements of environment, information, design and group process, Management Centers decrease the “accident” factor of discovery and synergistic events. Management Centers are “safe” environments in which designers and decision makers can risk exploring and creating new models. Also called “DesignCenters.”

Manager/Management [symbol] (See: Systems Integrator)

rL6-Ss1: The act, manner or practice of directing or controlling the use of. To direct or administer. Hand, handle. To mete out, dispense. To be an aid, minister to, servant.

Management provides the information and communication hub between the other players in the Business of Enterprise model. At different times in history, managers have focused alternately on fulfilling the desires of one player or another. According to the ValueWeb model, Management still balances the business of the whole web, but the management function is more distributed. There is more management going on, but fewer managers doing it.

Management—Project [symbol] (See: Project Management)

rL4-Ss1: Within the 7-Domains model, Project Management is the Domain of execution. It is the application of methods and procedures to planning and strategy. Goals cannot be managed—they must be translated into “doable” tasks and daily activities with resources allocated for specific reasons. At the same time, the mission cannot become too distant or projects lose focus and momentum. Project Management unfolds through cycles of measurement and feedback, in the true cybernetic sense that adaptation and evolution occur through self-correction and adjustment. Thus, when a project component is not achieved “as planned,” it is both and opportunity of discovery and learning, as well as an opportunity to refine the plan, based on “real world” information.

Management—Venture [symbol] (See: Venture Management)

rL4-Ss1: Venture Management is the sum of the preceding six domains in the 7-Domains model. Venture Management is also a function in itself and a driver which, in further cycles of work, recreates the first six Domains. It is both an attitude and a methodology. Venture Management is the practice of managing the organization, as a living system, that is dynamic rather than a collection of parts, and possessing integrity as a complete system. This is a different approach than seeing an organization only in terms of resources and results.

Maturity

[symbol]

rL4-Ss1: Fully developed. Worked out fully by the mind. The state of a note, bill or bond being due.

According to the Stages of an Enterprise model, Maturity is probably the longest and most stable stage of the Enterprise. It is also the most favorable time for spawning new enterprises although many ventures fail to do so until it's almost too late.

MEDIA

The material in which an idea or thing ToA is rendered. All things exist in a media. No-things ToA do not. The media is not neutral. It imposes limits ToA on the expression and functionality of any manifstation (thing), When an idea or thing is transported ToA—to another media, it has to be recreated ToA or it will progressively decay by copying which will always bleed information ToA. See 4 Step Recreative Model.

Meme

An element of culture that is passed on by non-genetic means, such as by imitation. Ideas that catch on by passing from brain to brain.

Memory

Memory is a key concept of this System and Method and is described on all levels of Language and applied in each Subsystem of the System and Method. Memory, in this system, has to be understood as a series of state changes ToA that take place iteratively ToA (State 1, State 2, State 3, State . . . n) and existing on different levels of recursion ToA of a complex system.

In a dynamic ToA complex ToA system, the memory STATES ToA will be different. Information ToA, provided by feedback ToA, is contained in these different states and can be used—this is a fundamental aspect of how the System and Method, of the present Invention, operates.

Agents ToA and Agency ToA are objects ToA or units of this memory.

In this Model ToA, the entire system is memory. Memory can be in the system (at a lower level of recursion) but is composed of the system and is regenerated when “recalled.” This recalling alters the state, and as an event/Agent (object) is part of the STATE of the (altered) system. Each iteration ToA is a discrete ToA step and involves a complete process ToA. See: FIG. SS1-1 from U.S. Pat. No. 6,292,830, included in the Appendix.

Metaphors Exercise

rL4-Ss1: A Breakout Round in which the various teams will compare some “unrelated” system to the situation at hand in a metaphorical way. If the situation concerns a distribution system, a team might be asked to examine how an ant colony manages its distribution system, or how a distribution system might be described in quantum mechanical terms. The purpose is two-fold: (1) to actually learn how other, alien or obscure systems actually manage similar processes, and (2) to see the situation from a radically different vantage point since we know that this is a powerful technique for generating creativity.

On a general level, all words—other than denotative—are metaphors of some “real” things or “no-thing.” Even a denotative concept is not the thing, itself, being referenced. The ability to manipulate and “bend” words (concepts), is intrinsic to the human creative process and may well relate to machine “intelligence.” Making a pun is shifting the level of recursion ToA of a concept. It is an example of active [symbol] memory.

Words are Models ToA and follow the rules associated with appropriate modeling.

Method

A systematic, documented way of doing work. In human Agents, it involves both Consciousness ToA and unconsciousness ToA (See: Mind Engine SS6-1), however, it can be taught and transferred to other Agents of many kinds.

MODEL

rL4-Ss1: A “slice of reality,” a vantage point of perception. The Latin derivation, modulus is the diminutive of modus, which means measure, rhythm, harmony. So a model is a little measure, a little rhythm, a little harmony—a slice. Of these three terms, we're perhaps the most familiar with “measure”, but the other two are more important to contemplate. We're used to building models to measure things—the effect of air pressure on the surface of a wing, or the profitability of a corporation. We may not be so comfortable with ferreting out models that divine the rhythm and harmony of the world around and in us. Or if we are, we confine those models to the realms of art, philosophy, essay, poetry. But the complexity of the world—even the corporate world—is too deep to be fathomed by measurements alone. Business is art and the Enterprise should call upon the qualities of rhythm and harmony inherent in art for assistance to lead it into the future.

Nature-Trueto

[symbol]

rL4-Ss1: In the Appropriate Response Model, a design that is true to nature is composed of elements that support one another, that do not conflict, and whose capabilities are mutually requisite. In a growing seedling, the roots, stem and leaves all remain requisite with one another: the leaves don't photosynthesize too much or too little, the stem is sized just right to provide structural support and the transport of materials up and down. A design should be elegant, all of its parts fitting together in a pleasing fashion that makes people want to employ it.

The forces or processes of the physical world, generally personified as a female being. The order, disposition and essence of all entities composing the physical universe. The aggregate of a person's instincts, penchants and preferences. To be born, birth.

Net

A term referring to a specific network.

Network

An architecture ToA of nodes, channels, thresholds ToA and other elements that is loosely connected in various ways. Networks of critical mass act organically ToA and exhibit self-organization ToA.

Network Economy (See: Knowledge Economy)

An economy characterized by a distributed ToA, nodal ToA, mind-like architecture that works through channels ToA and web-like configurations of Agents. See: ValueWeb Architecture SS6-2. Tightly related to the Knowledge Economy concept because knowledge-intensive environments ToA demand flexibility ToA, adaptability ToA, high variety ToA and the ability to reconfigure on demand. Traditional organizational structure/processes cannot respond well in these conditions ToA. Network and Knowledge Economies tend towards increasing returns ToA due to the nature of their core resources. Traditional governance ToA mechanisms do not function appropriately in these economies. See: Appropriate Response Model.

New Informationt (See: Information—New)

rL4-Ss1: A numerical measure of the uncertainty of an experimental outcome. Knowledge derived from study, experience, or instruction. A non-accidental signal used as input to a computer or communication system.

In the context of the S'poze model, systems are receiving all kinds of messages from other systems and the environment in general. Messages are neutral. They do not contain information. Rather, information is the result of a system's interpretation of a message, including whatever meaning it assigns to the message based on past experience. This meaning—or message in context of associated experiences—is what we call information. The measure of information is proportional to its uncertainty, or surprise. The more surprising the message, the more information it contains. Most messaging events are devoid of information, either because they are filtered out, or because they bear messages whose content is expected by the receiving system

Node

A place of connectivity in a network architecture where resources cluster.

Object

A discreet physical thing or virtual ToA no-thing ToA that can be treated as bounded ToA, defined and possessing certain characteristics, attributes ToA, functions ToA, relationships and rule-sets ToA.

Related in this System and method to OOP (Object Oriented Programming) in terms of certain software methods.

Overshoot and Collapse

[symbol]

rL4-Ss1: To go beyond, to miss by or as if propelling something too far. To fall down or inward suddenly. To cease to function, to break down suddenly in health or strength. Slide together; fall in ruin.

In the Stages of an Enterprise Model, if the enterprise does not learn how to maintain homeostasis, it may overshoot its envelope of healthy growth and then rapidly collapse upon itself. This stage is sometimes called the “Hollywood Star” syndrome.

Paradigm

[symbol]

rL4-Ss1: Any example or model. [In our case, a world model used by the controller of a system to make decisions based upon input to the system and past experience.]

For a living system to make decisions, it must be able to compare the nature of sensory input that it receives to some model that predicts probable future outcomes based on stored previous experiences involving that input. This memory may be inherited genetic storage, or learned mental storage. In either case, it represents a guide to success given a variety of situations. The sum total of these situations and the guidelines stored in the system comprise its Paradigm.

Patch

A collection of nodes ToA that are bounded ToA and follow certain swarming rules ToA.

Patchworks Design

A specific architecture of Patches ToA and Nodes ToA that deals with organizational issues related to information ToA overload, lock-in ToA, decision paralyses and over-voting. High variety, complex and massive scale networks employ this architecture to remain both effective and adaptive.

Philosophy

[symbol]

rL4-Ss1: Loving wisdom. The investigation of causes and laws underlying reality. Inquiry into the nature of things by logic instead of empirically. Any system of motivating concepts or principles of a culture.

In the context of the Vantage Points model, Philosophy is the fundamental—usually hidden—beliefs that unite the components of an Enterprise, enabling them to act as a cohesive whole. Properly applied, philosophy enables both innovation and stability.

Preliminary Design

rL4-Ss2: Latin: before the threshold ToA. Prior to or preparing for the main matter, action or business. Latin: to mark out. A drawing or sketch. The invention and disposition of the form, parts, or details of something according to a plan—a visual composition.

In the Design Formation Model, the proof of the program showing the scaled relationships between elements of the program. A dimensioned, hard line drawing.

Problem

[symbol]

rL4-Ss1: A question or situation that presents uncertainty. A question put forward for discussion or solution. Greek, problema, “thing thrown forward”, projection, obstacle.

In the Creating the Problem Model, the problem is created when you discover a gap between reality and your vision for a new reality. The problem is neither current conditions nor the vision. Rather, it is the discrepancy between them.

Process Design and Facilitation

[symbol]

rL4-Ss1: Process Facilitation is the systematic removal of blocks to individual and organizational creativity. To facilitate means to “make easy” or “smooth the way.” It is the method and practice for removing obstacles and clearing paths so that organizational activity flows naturally and efficiently. Blocks are of many types, for example: Physical, a work setting that hinders one's ability to organize and produce; Conceptual, locked into past solutions or lacking models of new or different approaches; Temporal, not having the right people together long enough to break through to new solutions. Process Facilitation is knowledge work's equivalent of engineering. Its use not only removes waste, downtime, confusion and friction, it also enables the systematic creation of new knowledge and innovation.

Process Facilitator

rL4-Ss1: An individual who facilitates the work of the KreW and the Facilitator during the DesignShop event.

Producer

[symbol]

rL4-Ss1: One who brings forth, creates by mental or physical effort. One who causes to occur; one who leads forward.

The producer actually makes the product. Producers are employees, vendors and suppliers that make up the entire chain required to create and deliver a product or service. According to the ValueWeb model, the producer still makes the product or creates the service. But producers are more involved in understanding how the company works through programs like open book management. See: SS6-2 Value Web Architecture.

Production

rL4-Ss1: The subset of the KreW of a DesignShop charged with keeping track of all of the documentation generated by the DesignShop and assembling it into paper and electronic Journals for distribution to the participants, usually within a few days of the end of the event. Journals may be 500 or more pages in length. The new documentation process allows the Journal to be captured in a database for ease of use in an electronic format.

Production Management

A specific set of protocols and procedures related to the making of a specific product or artifact.

Program

rL4-Ss2: Greek: to write before. A procedure for solving a problem. Any organized list of procedures. In the Design Formation Model, a set of specifications concerning the intended use of a space including who may use it, and what they want to use it for. The program is typically a list.

Project Management [symbol] (See: Management—Project)

rL4-Ss1: Within the 7-Domains Model, Project Management is the Domain of execution. It is the application of methods and procedures to planning and strategy. Goals cannot be managed—they must be translated into “doable” tasks and daily activities with resources allocated for specific reasons. At the same time, the mission cannot become too distant or projects lose focus and momentum. Project Management unfolds through cycles of measurement and feedback, in the true cybernetic sense that adaptation and evolution occur through self-correction and adjustment. Thus, when a project component is not achieved “as planned,” it is both and opportunity of discovery and learning, as well as an opportunity to refine the plan, based on “real world” information.

Project Status Map

rL4-Ss3: A project management tool that employs a matrix of projects listed down one side and days or weeks listed across the top. There are two ways to use a project status map: (1) for each sub task within a project, place a tag along the projects line under the date when the sub task is due. Then track the progress of work on each sub task through a system of visual indicators (green for go, red for holding, blue for completed, etc.); (2) if youre tracking a number of identical projects, advance a single tag along each projects line to indicate the status of the project. Project status maps are most appropriate for projects whose scale and complexity tend to make them linear progressions of tasks. If there are many parallel tasks or the duration of the project runs for many quarters or years, an ANDMap or similar project management tool is more appropriate.

Prospect

A concept in architecture ToA that defines landscapes and spaces of high variety ToA, ambiguity ToA and mystery that stimulates interest and the desire to Scan ToA in intelligent Agents ToA. These architectural spaces can be physical (thing) or virtual (No-thing) or combination thereof.

Radiant Room

rL5-Ss2: A large space in a Management Center where the participants gather together as one body to hear reports or have synthesis discussions of some sort. The focus of the Radiant Room is a long WorkWall called the Radiant Wall that may be straight, folding or curving depending on the design of the individual center. Some Radiant Walls stretch to over 40 feet in length. The back side of the Radiant Wall is frequently covered with an adhesive material made by 3M to which paper can be adhered and removed many times over. This is called the Knowledge Wall, although you may hear it called the Sticky Wall by old timers in the network. The term Radiant Wall comes from Isaac Asimovs idea of a Radiant Cube that he introduces in the third volume of his Foundation Trilogy. The cube is a device that holds the plans for the rebirth of an entire galactic civilization, yet sits unobtrusively on a table top. When a Speaker from the Second Foundation focuses his mind on the cube, it projects the plan on the walls of the room. With further mental effort the Speaker can navigate the plan from start to finish, zoom in to more detail or pull out to a more general landscape, and see the record of all the changes that have been made to the plan and all of the contingencies built into it as well.

This System and Method includes the creation and operation of virtual radiant “rooms” and the combination of these with physical places.

RDS (Rapid Deployment System)

rL5-Ss2: Also called the Transportable Management Center. An entire kit of WorkWalls, Work Stations, Break-out Tables, lighting, computers, network, video cameras, video technical direction equipment, video editing equipment, supplies, library, games and toys sufficient to support a multiple day DesignShop for a group varying from five to one hundred participants and up to thirty or so KreW. The RDS is shipped in trucks and takes a day or two to assemble and tear down depending on the size of the event.

Read Ahead

[symbol]

rL3-Ss1: A collection of materials delivered to participants up to a week or so in advance of a DesignShop. The articles and books chosen for a Read Ahead will serve one of two purposes: provide more information concerning the problem to be created and solved during the DesignShop, and to stretch thinking and introduce new ideas that challenge preconceptions. The Facilitator, Process Facilitator, Sponsor and perhaps one or two KreW members handle the selection, assembly and distribution. Books are ordered through the KnOwhere store.

Real (Thing—Object) [symbol] (Known as: Real Cat)

rL4-Ss1: Being or occurring in fact or actuality; having verifiable existence. Existing actually and objectively.

In the Three Cat Model, the real cat stands for “objective” reality. Actually, we don't really ever see the real cat. Our senses gather signals from the visible part of the electromagnetic spectrum, fluctuations in air pressure that register on our ears as sound, and the electrochemical signals that result from physically touching an object. Because our information concerning real cat is most incomplete, there's always more to learn.

Recursion (and Levels of)

In organizational structures and processes of all types—of any complexity—elements of that organization will operate at different scales (time, space, levels, and so on). Recursion is a design strategy that deals with excessive linearity, critical mass (too much, too little) at any place and misplaced complexity (as a partial example). Recursion is a way of dividing an organization/process functionally without loss of feedback. Recursion levels act as environments to one another, as well as, support systems to one another. See: Zone of Emergence Engine SS1-8 and Table 2. Each recursion level must have all the attributes of a viable system (Beer) to function appropriately. See Appropriate Response Model.

Recreate

[symbol]

rL4-Ss1: To impart fresh life to. RE:again. CREATE: to cause to exist; to bring into being; to cause to grow. Latin: to cause to grow anew.

Within the 4-Step Recreative Process model, between each of the steps, you must recreate what it is you are trying to do given the different and unique parameters of each of these different steps.

Refuge

A concept in architecture that relates to the creation of places of rest, safety, peace and contemplation. This is the counterpoint to prospect. Both kinds of place are necessary to the functioning of human Agents.

Report Out

rL4-Ss1: After participants have spent some time in Breakout Teams they are often invited to reassemble as a large group to hear each team report their work. To prepare for this report, the teams are asked to recreate (not copy) their work onto paper covered magnetic Hypertiles (11×17 inches) which will adhere to the porcelain steel WorkWalls. The group reassembles in a large room that usually has a very large, curving WorkWall called the Radiant Wall (some are over 40 feet long). The teams group their Hypertiles on this wall either by team or by some other sorting category, or they place them on the wall as they are being discussed. The tiles can be moved about and drawn around to sort, connect and emphasize ideas.

Rules of Engagement

rL4-Ss1: A list of boundaries that must be set on a DesignShop, session, Management Center or NavCenter in order to secure success. The requirement of having no observers or visitors during a DesignShop is an example (everyone either participates or they are on KreW). Another example is the limitation on the conduct of other business by the participants during the DesignShop (it destroys breakout team integrity and compromises the product to have individuals constantly conducting other business away from the team on the phone).

Rules of Engagement are critical to all Agent relationships. These operating interactivity rules are part of what defines an Agent.

Scale

In architecture, the relationship between elements of a design or built environment and the humans that occupy it. Scale is critical if continuity of experience is to be accomplished.

Scale is a critical design element in the architecture of organizations (enterprises, cities, social systems, and so on). When a system, or parts of a system get “out of scale” the functionality of the system is compromised because the Agents within it can not “read” their environment and therefore lose context and sense of place.

Scan

[symbol]

rL4-Ss1: One component of the SCAN, FOCUS, ACT model. SCAN is often seen as the first stage of a three stage model, but the model is in fact nonlinear and highly recursive. SCAN means just what youÕd imagine; looking about for different options, or to gather information in a broad sort of way. SCAN also implies a vantage point of some sort from which to view. The original meaning of the word means to climb or mount. In the SCAN phase we build conceptual, mental models.

Schematic Concept

rL4-Ss1: Latin: form, figure. A structural or procedural diagram, esp. of an electrical or mechanical system. Latin: a thing taken to oneself. A general idea or understanding, especially one derived from specific instances or occurrences.

Within the Design Formation Model, the first proof of the program. Freehand blocking of the ideas at the smallest scale represented by the program, showing prominent elements that drive the design. “Bubble diagrams” and loose sketches.

Scenario Exercise

rL4-Ss1: A module of a DesignShop that is frequently employed to uncover assumptions among the participants regarding how they think about trends, the past and the future. Its usually done in large group on the Radiant Wall. The Radiant Wall is divided horizontally into time frames. Sometimes the Scenario considers the distant pastup to 30,000 years ago, passes through the present (usually the current year plus or minus 5-10 years) and ends sometime in the future. Participants stand before the wall one at a time and state an event they wish to place on the timeline (sometimes further defined by the facilitators instructions) and perhaps its significance. Then they write that event on the wall under the year it occurred. Then the next participant places their event on the wall. This may continue through all of the participants and through several rounds. The exercise is very flexible in terms of how the wall is laid out, what types of events the participants are asked to place on the wall, and how Sketch Hogs are employed to augment and synthesize the visual display. A good synthesist on the KreW can predict much of the outcome of the DesignShop and the solution to the problem simply by studying a well-executed scenario.

Scope—Proper

[symbol]

rL4-Ss1: Breadth or opportunity to function. The area covered by a given activity or subject. Watcher, goal, aim.

According to the Appropriate Response model, an excellent design should properly fill its niche and not strive for too much, nor suffer from a timid presence. The boundaries of the design must be clearly defined. This does not mean they must form a contiguous presence, only that by some combination of matter, energy and information the solution is able to distinguish itself clearly from other elements in its environment.

Self-Correcting

[symbol]

rL4-Ss1: To provide with knowledge or training. To discipline, train or develop. To bring up. Within the Appropriate Response Model, once a system can make predictions about the future, it must compare these predictions with its current behavior and implement changes to adjust its behavior to bring it into harmony with its future models. In this sense it's bringing its vision of the future back to the present.

Share-A-Panel

rL4-Ss1: A module of a DesignShop usually preceded by a Take-A-Panel exercise wherein participants assemble into teams and visit each team members panel or WorkWall in succession to hear a report of the work scribed on that panel. After each team member has reported their individual work, the team usually assembles in a Breakout Area to either synthesize what they have heard, or begin work on another exercise. If the total number of participants in a DesignShop is small, they may all participate in the exercise, which is then called a “Walk-About”. After each participant has had an opportunity to share their panel, the entire group may assemble for a synthesis discussion or may be divided into Breakout Teams to begin another round of work.

Simulation

An environment, A, in which some aspects of another environment, B, are played and tested to determine the efficacy of some aspects of their likely performance in the real, B, environment.

Systems of great complexity cannot be understood and controlled. This means they cannot be successfully tested—predictability is impossible. Unintended consequences result. Simulation is a method for approaching requisite variety ToA by “testing” in as close to a real-world condition as is possible. See: 3 in SS6-3 ValueWeb Builder and SS3-4 in SS3-3 for reference to two ways (of many) that the present invention employs simulation.

Sketch Hog

rL4-Ss1: Also called a scribe. A KreW member skilled in listening to a conversation or presentation and capturing its essence and significance in illustrated and annotated diagrams on WorkWalls, paper, computer, or in a 3D physical model. Sketch Hogs are called upon to support participants in Breakout Teams to illustrate their ideas, work before the large group during synthesis discussions, create finished art and icons to support the production of the Journal, and to create finished art and diagrams to support any follow-on WorkProducts.

Sponsor [symbol] [symbol] Client (See: Event Sponsor)

rL4-Ss1: An individual or small group who hold primary responsibility or a principal stake in the outcome of a DesignShop, NavCenter, Management Center, or session. Often the sponsor is the champion of the idea which the shop or center is designed to address. The sponsor may also be a manager or executive. Often a sponsor team is assembled made up of representatives from various constituents who comprise the participants in the DesignShop. See: SS6-2 Value Web Architecture.

Sponsor [symbol] [symbol] [symbol] Knowledge Worker

rL4-Ss1: An experienced individual (usually of Journeyman level) who assists and supports another Knowledge Worker through the transition into, through, and out of the ValueWeb system rL6. The sponsor is not necessarily a mentor, and is chosen my mutual agreement—never assigned. Assigning sponsors would violate the pattern of “Stepping Up” or self-selecting tasks and projects from the work to be done. Sponsors are literally individual Transition Managers ToA.

Sponsor [symbol] [symbol] Navcenter

rL4-Ss1: An individual, or most commonly a team who champions the purpose, mission and existence of a NavCenter. Since NavCenters are established to support a particular project or purpose, the Sponsor may also be the project manager. Because a NavCenter represents a way of work which radically departs from the behavior of the rest of the organization, the Sponsor should have a position of authority within the organization as well.

Sponsor Session

[symbol]

[symbol]

rL4-Ss1: Usually a three or four hour session attended by the client sponsor (individual or team), the key facilitator, the process facilitator, and supported by one or more KreW. The purpose of this session is to develop clear objectives for the DesignShop, work on assembling the right participant list, decide on general logistics arrangements, take a first cut at the design of the DesignShop process, and get a general idea of what sort of products should be generated during and after the DesignShop.

S'poze

[symbol]

rL4-Ss1: Shorthand for suppose. To assume to be true for the sake of explanation or argument. To conjecture. To substitute, put under, forge. In the context of the S'poze model, It is not advisable for a system to accept any and all New Information to add to its Paradigm. The process of modeling enables the system to play “what if” without actually engaging in a potentially threatening experience.

State Change (or Phase Transition)

When a group of people let go of one reality or model and shift simultaneously to a higher order solution. This state change usually happen about half way through a dynamic DesignShop process. Closely tied to the notions of Emergence and Tipping Points.

Steward

[symbol]

rL4-Ss1: Within the Learning Path: Five Points of Mastery Model, the Steward applies talents and knowledge in service to others—in stewardship of the community and ultimately of the world. Stewardship means holding a vision for yourself, your community, and your world, and being committed to actualizing that vision. The only way to steward anything is to engage with what we are stewarding in a cybernetic, whole systems manner. By learning anticipatory design, we steward our future as well as our present. Stewardship encompasses stewarding what we value, what we invent, our personal growth, the growth of others, the health of our communities and the natural environment. Stewardship arises from the philosophy that “all life is sacred” rather than “everything is a commodity.”

Strawdog

rL4-Ss1: Before each DesignShop, PatchWorks Design phase or other event, the Event Facilitator (Key Facilitator) and/or the Process Facilitator generates a first cut at the design of the event. Sometimes this process is completed formally in a Sponsor Session with the DesignShop Sponsor, the Facilitator and Process Facilitator. These sessions are documented [symbol] The Strawdog summarizes the planners thinking in terms of the purpose of the event, the desired outcomes and the individual modules that comprise the design. Usually the first half of the event is outlined in detail; the rest cannot be designed until the work is underway.

rL4-Ss3: In a further manifestation of this System and Method, the KnowledgeBase ToA can be queried, by an Agent of the system, and a number of alternative Strawdogs can be generated based on specific (inputted) information. The memory of all Strawdogs and their results are part of the system and can be shared, as Agents, according to the created profile of those Agents.

On an even more general level of this System and Method, any expert [symbol] [symbol] process [symbol] can be captured in a template [symbol] in the KnowledgeBase [symbol] of the system to be thus queried and and employed as an Agent to facilitate [symbol] design [symbol] This can occur on multiple levels of recursion ToA. Again, results can be shared as memory of the system according to specific Agent profiles and embedded rules. These Agents can make up an economy and be traded within it.

Success

[symbol]

rL4-Ss1: The achievement of something desired, planned or attempted. To follow closely, go after, to go toward.

Within the Stages of an Enterprise model, at this stage, the enterprise is viable. This means it understands as an organism how to maintain its metabolism from month to month, and how to grow.

Sustainable

[symbol]

rL4-Ss1: To provide with knowledge or training. To discipline, train or develop. To bring up.

Within the Appropriate Response Model, a system must be able to survive birth, grow to maturity, and reproduce itself. It must do this without depleting the systems that support its growth, otherwise it will cause its own demise.

SYNERGY In Synergetics, R. B. (Bucky) Fuller notes the following with regard to Synergy: “Synergy means behavior of whole systems unpredicted by the behavior of their parts taken separately. Synergy means behavior of integral, aggregate, whole systems unpredicted by behaviors of any of their components or subassemblies of their components taken separately from the whole. A stone by itself does not predict its mass interattraction for and by another stone. There is nothing in the separate behavior or in the dimensional or chemical characteristics of any one single metallic or nonmetallic massive entity which by itself suggests that it will not only attract but also be attracted by another neighboring massive entity. The behavior of these two together is unpredicted by either one by itself. There is nothing that a single massive sphere will or can ever do by itself that says it will both exert and yield attractively with a neighboring massive sphere and that it yields progressively; every time the distance between the two is halved, the attraction will be fourfold. This unpredicted, only mutual behavior is synergy.

“Synergy is the only word in any language having this meaning. The phenomenon synergy is one of the family of generalized principles that only co-operates amongst the myriad of special-case experiences. Mind alone discerns the complex behavioral relationships to be cooperative between, and not consisting in any one of the myriad of brain-identified special-case experiences. The words synergy (syn-ergy) and energy (en-ergy) are companions. Energy studies are familiar. Energy relates to differentiating out sub-functions of nature, studying objects isolated out of the whole complex of Universe—for instance, studying soil minerals without consideration of hydraulics or of plant genetics. But synergy represents the integrated behaviors instead of all the differentiated behaviors of natures galaxy systems and galaxy of galaxies. Chemists discovered that they had to recognize synergy because they found that every time they tried to isolate one element out of a complex or to separate atoms out, or molecules out, of compounds, the isolated parts and their separate behaviors never explained the associated behaviors at all. It always failed to do so. They had to deal with the wholes in order to be able to discover the group proclivities as well as integral characteristics of parts.

“The chemists found the Universe already in complex association and working very well. Every time they tried to take it apart or separate it out, the separate parts were physically divested of their associative potentials, so the chemists had to recognize that there were associated behaviors of wholes unpredicted by parts; they found there was an old word for it—synergy. Because synergy alone explains the eternally regenerative integrity of Universe, because synergy is the only word having its unique meaning, and because decades of querying university audiences around the world have disclosed only a small percentage familiar with the word synergy, we may conclude that society does not understand nature.

“In addition, there is a corollary of synergy known as the Principle of the Whole System, which states that the known behaviors of the whole plus the known behaviors of some of the parts may make possible discovery of the presence of other parts and their behaviors, kinetics, structures, and relative dimensionalities. The known sum of the angles of a triangle plus the known characteristics of three of its six parts (two sides and an included angle or two angles and an included side) make possible evaluating the others.

“Eulers topology provides for the synergetic evaluation of any visual system of experiences, metaphysical or physical, and Willard Gibbs phase rule provides synergetic evaluation of any tactile system. The systematic accounting of the behavior of whole aggregates may disclose discretely predictable angle-and-frequency magnitudes required of some unknown components in respect to certain known component behaviors of the total and known synergetic aggregate. Thus the definitive identifications permitted by the Principle of the Whole System may implement conscious synergetic definition strategies with incisive prediction effectiveness.”

Syntopical Reading

A technique employed in DesignShops and other collaborative events that involves readers studying different books (or other materials) then sharing them interactively in a real-time dialog.

This process (on the human scale) mimics their own internal mental processes of memory. An example of the scale-ability of this System and Method through many levels of recursion and the employment of different kinds of Agents.

System

Any collection of parts that can be seen as such, that can function with continuity, and can be described. Once a “system” is declared the logic of the interrelationships between these parts takes hold. The making of a system is “arbitrary” (not bound by nature) but once made the rules of the system must be followed.

Complex systems are always “partially overlapping” (Fuller).

Systemic

Where the core of everything is connected—tied together at the root and must be considered as a unified body of parts.

Systems Integrator [symbol] (see: Manager/management)

rL6-Ss1: The act, manner or practice of directing or controlling the use of. To direct or administer. Hand, handle. To mete out, dispense. To be an aid, minister to, servant.

Management provides the information and communication hub between the other players in the Business of Enterprise model. At different times in history, managers have focused alternately on fulfilling the desires of one player or another. According to the ValueWeb model, Management still balances the business of the whole web, but the management function is more distributed. There is more management going on, but fewer managers doing it.

Take-A-Panel

rL4-Ss1: A module of a DesignShop wherein the participants take one panel of a WorkWall (about 6 tall by 4 wide) each and compose on it answers to an assignment. The exercise allows all of the participants to be heard, to express their ideas in whatever visual fashion they wish, and have their ideas available to be viewed by other participants and captured by the DesignShop KreW. This exercise is usually succeeded by a Share-A-Panel exercise.

Technical Systems [symbol] (See: Tools)

rL4-Ss1: Technical Systems, Domain five in the 7-Domains model, augment and amplify human creativity. They are the set of tools and protocols that enable an organization to work effectively as a whole system. They help define and preserve the boundaries of an organization and enable it to sense and respond to the external environment. An organization's technical system is akin to the human nervous system: it continually organizes a vast amount of information about the health of all its component parts and their internal and external interactions. It provides the means by which knowledge that is fragmented or local can become organized and available where needed.

Template

[symbol]

rL4-Ss1: A pattern or gauge used as a guide in making something accurately or in replicating a standard object. Often a piece of wood or a thin metal plate. Old French “temple”: a wooden device in a loom that keeps the cloth aligned during weaving. “Temple”: sanctuary.

As part of the 4-Step Recreative Process Model, create a template for your creation, in words, symbols, pictures, 3D, or some other physical medium. This template should represent your vision and be able to communicate its essence to others.

Tension—Creative [symbol] (See: Creative Tension)

rL4-Ss1: Creative: the power to cause to exist, bring into being, originate. Tension: a force tending to produce elongation or extension. Voltage or potential; electromotive force.

As a component of the Creating the Problem model, the creative tension that comes into being when you decide to resolve the problem is the interplay between vision and reality. As the two tug and pull at each other, they will each change and modify in an effort to reach a synthesis.

Threshold

The band between the optimum operating environment of a system and it's limit ToA. Approaching the threshold will increase the frequency and magnitude of (negative) feedback ToA in a viable system.

Tipping Point

Comes from the field of epidemiology and indicates the point at which a disease has infected enough hosts that it must be considered a raging epidemic and the spread of the disease grows exponentially. We use tipping points to mean that point which changes the game. The future is no longer a linear extrapolation of the past. Our system and method tracks tipping points through multiple iterations of weak signal research.

Tools [symbol] (See: Technical Systems)

rL4-Ss1: Technical Systems, Domain five in the 7-Domains model, augment and amplify human creativity. They are the set of tools and protocols that enable an organization to work effectively as a whole system. They help define and preserve the boundaries of an organization and enable it to sense and respond to the external environment. An organization's technical system is akin to the human nervous system: it continually organizes a vast amount of information about the health of all its component parts and their internal and external interactions. It provides the means by which knowledge that is fragmented or local can become organized and available where needed.

Tracking

[symbol]

rL4-Ss1: To draw, pull. Trace, trail. To follow the footprints or traces of.

Within the 10 Step Knowledge Work Process model, tracking records the condition, origin and destination of each message that crosses the Knowledge Base membrane (transduction). It creates a history of the use of the K-Base.

Transition Manager/Transition Management

[symbol]

[symbol]

Transition Management is a specific kind of management.

It is required at specific historical moments in the life of an organization, corporation, city, country or planet.

That moment is the transformation from one state of being to another.

The Transition Manager facilitates the process of the transformation by combining the vantage points of strategic planning and project management, and forging an environment in which the creative energies of a group of people can function for mutual and planetary advancement.

The role and duties of the Transition Manager are specific; and the ethical framework of the Transition Manager is of the highest order.

The Transition Manager may or may not be in an apparent position of authority or power; s/he may or may not be recognized for the work performed—these issues are circumstantial and a matter of practical consideration.

The Transition Manager works for no agency alone, s/he pledges allegiance to life, planet Earth, humankind, and the community within which s/he works.

The Transition Manager is responsible to life's quest to reach a higher order of being, manifested in specific accomplishments.

No matter what wok role or position the Transition Manager assumes, s/he functions from sapient authority in performance of the duties.

Organizations in transformation are in the mature phase or exist in an environment that is in a mature phase of its life cycle. In those circumstances, human credibility, certification and authority are based on the assumptions of the old paradigm that is undergoing severe stresses.

The Transition Manager maintains the ability to operate in two different, and often hostile, environments; this ability is essential to creating the bridge necessary for successful transformations.

The Transition Manager must remain free from entrapment by either the old or the new; the correct vantage point is from both and from a healthy transition with no commitment to a predetermined outcome in the specific.

The Transition Manager's fiduciary responsibility requires that s/he gain not undue advantage from the experience.

The Transition Manager's Creed, Matt and Gail Taylor, 1982.

Turn Around

[symbol]

rL4-Ss1: To cause to move around in order to achieve a desired result. To reverse the course of. Unsettle, upset. A chance or opportunity to do something. Lathe, tool for drawing a circle.

In the context of the Stages of an Enterprise model, ventures lose their ability to maintain homeostasis and begin to collapse. Usually this is due to a lag time in the organization's ability to respond to or anticipate external or internal rates of change: it falls behind or leaps too far ahead and is exposed. Careful crafting allows the organization to return to the Maturity stage.

Use

[symbol]

rL4-Ss1: To bring or put into service; employ for some purpose. To consume or expend the whole of. The permission, privilege or benefit of using something. The power or ability to use something. The quality of being suitable or adaptable to an end. The goal, object or purpose for which something is used.

According to the Design, Build, Use Model, as the environment is used, it will change the processes that take place within it. These changes, in addition to events in the external environment will drive a demand for the work space to adjust its function, and to do so rapidly. The design and build capacities must always be readily at hand.

Valueweb

[symbol]

[symbol]

[symbol]

[symbol]

rL6-Ss1: The Value Web Model is made up of four components—each themselves a network (a ValueWeb architecture on anther level of recursion). No matter the size of the ValueWeb, these four components have to be in relative balance with one another. They are: the user (customer) network; the producer network; the investor network—and, the system integrator (management). The purpose of a ValueWeb is to create and distribute wealth. Wealth in the broadest definition not just in narrow (UpSideDown) economic terms. And, the idea of distribution is to do this in terms of the individual members. This is something a generic economy does not do. See: SS6-2 Value Web Architecture.

Variety

The number of possible states of a system (Beer). See Requisite Variety ToA.

Vision

[symbol]

rL4-Ss1: That which is or has been seen. Unusual competence in discernment or perception. A mental image produced by the imagination. The mystical experience of seeing as if with the eyes the supernatural or a supernatural being. Latin: to see.

In the context of the 4-Step Recreative Process model, create a Vision for what you want to create.

Venture Management [symbol] (See: Management—Venture)

rL4-Ss1: Venture Management is the sum of the preceding six domains in the 7-Domains model. Venture Management is also a function in itself and a driver which, in further cycles of work, recreates the first six Domains. It is both an attitude and a methodology. Venture Management is the practice of managing the organization, as a living system, that is dynamic rather than a collection of parts, and possessing integrity as a complete system. This is a different approach than seeing an organization only in terms of resources and results.

Walkthru

rL4-Ss1: A session during which the DesignShop is designed, including all of the modules, assignments, and team configurations. Day one is rigorously designed, day two a little less so, and day three may be rather sketchy at this point. The Client Sponsors, Facilitators, Process Facilitators and KreW participate in the WalkThru.

WAWD Team

rL5-Ss6: A consortium of knowledge workers, or enterprises of one, who are linked together in a vast value web, and whose expertise, skills, and passions can be focused on helping clients imagine visions and then implement them anywhere on the globe.

Weak Signal Research

Weak Signal research refers to processes that enable the enterprise to detect weak signals as a matter of course, build models and stories that illustrate the possible effects of whole sets of signals over time, and redesign itself efficiently to take advantage of these possibilities. A Weak Signal is a half-hidden idea or trend that will affect how business is done, what business is done, and the environment in which this business is done. Weak Signals often consist of new and surprising information from the receiver's vantage point, they are sometimes difficult to track down amid noise and other signals, and they are often seen as a threat to an organization. Weak Signal Research operates in the realm where uncovering a weak signal before anyone else does, gives us an edge in development and may allow us to witness the emergence of an entire ecosystem of interlocked, collaborating ideas, inventions, and enterprises. In a narrow sense, we're talking about tracking trends, but more generally, we're interested in spotting non-linear, hard to predict ideas long before they reach mainstream recognition.

WRITING TEAM

rL4-Ss1: A subset of the KreW and Sponsors of a DesignShop charged with crafting the assignments that participants will work on in their Breakout Teams. The term “craft” is key here. Assignments are not composed without considerable thought. When you consider that a single assignment will consume perhaps 1/6 of the duration of a DesignShop and that the reports from such an assignment will steer the entire content and tone of the DesignShop, it's easy to understand their importance.

Work Product

rL3-Ss3: A synthesis or evolutionary product of the DesignShop whose purpose is to either crystallize some concept, detail and illustrate some plan, or take the participants beyond the information of the DesignShop into new realms they may not have considered yet. Its purpose is not to simplify, but to present the complicated and obtuse in a way that is merely very complex so that it may be understood, but not watered down.

Workwalls

rL5-Ss2: Panels of light colored porcelain steel which accept a variety of marking materials such as chalks, dry erase markers, water colors, India ink, pastels, and water based markers. They are used by participants and KreW as a tool to support collaboration. A typical Management Center may have more than 3,000 square feet of this surface available. Large or small groups can illustrate complex issues and detailed plans all within plain view of the entire group, and all easily editable. The amount of information that can be manipulated on these wall systems and the flexibility of erasing or adding to it, dwarfs the capabilities of butcher paper, flip charts, or projection systems. The walls are typically six or more feet high and may be any length. Rolling walls come in lengths from four to 28 feet in length (although greater length is possible), some of which are folding. WorkWalls may also be permanently installed within the environment. The walls are manufactured by Athenaeum International under MG Taylor License and distributed by Athenaeum International or through MG Taylor Corporations chain of KnOwhere stores.

The WorkWalls make up a significant component of the environment-setting aspect of this System and Method. They also are a strong element of the Taylor environments Trade Dress. This is further described in Subsystem 2 of this Invention.

The full manifestation of the WorkWall concept, in this System and Method, will incorporate electronic input and display (read/write) as shown in the diagram, as well as, smart technology as described in Sub System 3 of this Invention.

The essential [symbol] process contribution of the WorkWalls is several fold: they facilitate the display of Knowledge Objects and Agents (ToA). They allow Human Agents (ToA) to “work big” simultaneously seeing the scope and interconnectedness of their work while sharing in its creation. They are a strong symbol of collaboration.

The essential [symbol] environment contribution of the WorkWalls is they create space, bring Armature down to human scale and adjust quickly as the work requires it.

The essential [symbol] tool contribution of the WorkWalls is that they provide “plug and play” capability for a wide variety of interactive computer and multimedia technology and integrate these devises into a seamless work process.

The scale, scope and level of integration of [symbol] [symbol] [symbol] is not accomplished by existing pieces and components in place nor the systems architecture in which they are employed.

### BACKGROUND OF THE INVENTION

[symbol] It is now widely understood that we are in the midst of a global transformation from a manufacturing society to an information based society, i.e. Knowledge Economy ToA or Net Work economy ToA. As our society makes the transition to this new economy, we must have set in place new ways of working that will be fundamentally different from those we have experienced in the last 100 years. These new ways of working will demand that we view Agents ToA, whether individual humans, machines, groups or organizations, as the economy's most important resource and resource creator, the resource that moves and creates information and designs artifacts ToA and solutions ToA.

Unlike most natural resources ToA, intelligent ToA Agents and the knowledge they produce have unlimited potential. Unlike most natural resources, these resource are not “lost” when spent and tend to increase in value through use. We, as a society, have only begun to find ways to effectively, measure, account, tap and nurture this potential for new knowledge ToA. This knowledge will affect everything we do, from tilling the land, to manufacturing vehicles for transportation, to the delivery of education, health and other services. It will redefine our understanding of work itself, as well as, the very nature of our economy. Our investment in Intellectual Capital ToA and how we organize and manage it will be the key to our society's productivity and growth. Indeed, it may be the key issue in determining if our society can continue to exist at anything near its current level of wealth which, in its present form, is created and used by means that are not sustainable over any significant period of time. If we accept and successfully meet the challenge of this window of opportunity ToA, we can experience unprecedented growth and development in the quality of life supported by this society. If we refuse to see the need for this transition, or fail to meet its challenge, we are doomed to decline, not just in power, but in our quality of life.

[symbol] The nature of the problems that Humankind faces are different than those of prior generations. Problems that are socially significant, offer great opportunity or danger and relate directly to the emerging Knowledge/Net Work Economy are systemic in nature. These problems do not yield to the kinds of approaches characteristic of simple problems. An example of a systemic problem ToA is a river running through three states, 8 counties and 14 cities. Who owns it, controls it, pollutes it and stewards it? Equally, a systemic problem can be described as a weapon system used by multiple services and countries, deployed globally and employing 40,000 people world-wide in its creation use and support. Systemic problems cannot be solved (without harmful unintended consequences) in a linear fashion from a “parts” perspective using simple tools. Systemic (complex) problems cannot be solved (dissolved) based on definitions formed in a language ToA not able to describe them. Complex solutions cannot be implemented by inadequately adaptive organizations transacting business with financial tools that are cumbersome, based on the structure of a prior economy, ambiguous and lacking sufficient complexity (Requisite Variety Problem).

Systemic problems are by definition complex. Complexity drives variety. High variety, complex systems, by definition, cannot be understood nor are they amenable to traditional “command and control” kinds of governance Complex systems EMERGE and co-evolve with their environments. They represent a fundamentally different kind of phenomena than simple systems.

The economic shift from an Industrial Economy to a Knowledge Economy has been the subject of a tremendous amount of discussion and commentary in business and political literature. Among other things, it is widely recognized that this Economic Shift creates both opportunities, challenges, problems and paradoxes.

What is lacking is a framework ToA for systematically and methodically addressing the paradoxes and problems associated with the Knowledge/Network Economy and the transition to it. While there is no known system ToA and method for augmenting ToA knowledge commerce, there have been attempts to address discrete parts that relate to the augmentation and facilitation ToA of knowledge commerce ToA.

In this context, the background relating to the principal Sub-Systems of the present invention will now be discussed. For ease of understanding, the system of the present invention will be described as including six discrete subsystems that are linked, connected and integrated in myriad ways at many levels of recursion. The six Subsystems of the present invention may be summarized as follows: Subsystem 1—Facilitating Interaction Among Agents

The present inventors have recognized that there are three broad elements that affect the interaction of agents. These may be broadly classified as environment [symbol] process [symbol] and tools [symbol] (themselves which may considered to be agents). The expression “Agent” ToA as used herein refers to individuals, machines, groups of individuals and/or machines, organizations of individuals and/or machines, and other things, such as documents, computer software, and firmware. In addition, agent as used herein is intended to have its broadest meaning. For example, Marvin Minsky in “Society of Mind” defines “Agency” as any assembly of parts considered in terms of what it can accomplish as a unit, without regard to what each of its parts does by itself and “Agent” as any part or process of the mind that by itself is simple enough to understand—even though the interactions among groups of such agents may produce phenomena that are much harder and even impossible to understand. Roughly, “Agent” in this context can be correlated with “Object” in object oriented programming.

In the latter part of the twentieth century, there have been numerous efforts to facilitate interaction among Agents as defined herein, especially in the areas of organizational interaction and, more recently interaction between humans and machines and interaction between machines (e.g., artificial intelligence). In connection with human agents, these efforts have focused on group dynamics and learning. Past approaches tend to focus on a specific element such as environmental factors, process factors or tools. Thus, there are numerous “tools” available to enhance personal or group productivity and a plethora of training and consulting services available. Recent examples include tools such as ergonomic office furniture, personal organizers and new office designs. There are various systems based on management theories such as those set out in “The Seven Habits of Highly Effective People” by Stephen R. Covey. For example, numerous training sessions have been conducted based on the “habits” discussed in Coveys book, namely Be Proactive; Begin with the End in Mind; Put First Things First; Think Win/Win; Seek First to Understand, Then to be Understood; Synergize; and Balanced Self-Renewal. There have been some attempts to offer both tools and services. One example of such a system is The Franklin Covey Company, a joint-venture of Franklin Quest and the Covey Leadership Center. The Franklin Covey Company offers tools, training and consulting services.

In addition, facilitation methods such as “Open Space” and “Future Search Conferences” have been developed to assist human Agents in dialog, planning and consensus building. While these individual tools and programs vary significantly, they share a common trait—they are narrowly focused on certain aspects that affect interaction among Agents or are focused on specific environments or groups of Agents.

There has not, to date, been an effort to simultaneously address each of the factors that affect the interaction of agents (e.g., environment process [symbol] and tools [symbol] ) in a coordinated and widely applicable way to create an optimal environment for the interaction of agents. Moreover, to the extent that others have considered “Environment” issues, there has been a focus on the physical environment and in a very narrow loosely connected way. There is only limited understanding of the fact that other environments, such as those occurring within a computer, are fundamentally no different from the physical environment. This has become increasingly evident with the advent of object-oriented ToA technologies. Moreover, it is now known that computer environments can exhibit characteristics of the physical environment. For example, there are known computer environments [symbol] that exhibit evolution, i.e., evolutionary computer models or machines. Nonetheless, there has been no coordinated effort by others to develop a system and process that is adaptable to a broad variety of environments and explore the impact of “environment” [symbol] in this broad sense. The narrow focus of others in attempting to address these issues (environment [symbol] process [symbol] and tools [symbol] ) suggests that these elements are independent and affect one another in a linear way.

The present Inventors have suspected for some time, however, that the interrelationship between each of these elements is non-linear (ToA) and that it is possible to obtain synergistic (ToA) effects by simultaneously addressing these elements to create an environment [symbol] that fosters group genius (i.e., a synergistic outcome that is greater than the sum of the parts—and not predicted by its parts (ToA). The present inventors also suspect that synergies ToA can result from a wide variety of multi-agent environments, e.g., environment, process or tools, or other multiple agent synergies such as human-machine interaction. In short, when multiple agents are interacting with one another, there is the possibility of feedback (ToA), self adjustment ToA and pattern emergence ToA. Testing and implementing this insight presented a significant challenge. Demonstrating behavior of complex systems and interactions of agents, or groups or organizations of agents is very difficult—if not impossible—without real life experience [symbol] and testing (3 Cat Model) in an environment similar to the what the real-world application will be.

Recognizing this, the present inventors have conducted numerous experiments and demonstrations over a period of about twenty years to demonstrate, prove and refine some selected elements of the present Invention. These efforts have been concentrated in limited environments. More specifically, the present inventors have conducted experiments to develop certain tools [symbol] and processes [symbol] for improving certain aspects of the integrated environment [symbol] . As a result of these experiments and the present inventors experience, certain concepts and system elements have emerged, including tools, elements of environments, environments, agents, and work or tasks.

To describe some of the concepts underlying the system and method of the present invention, the inventors have coined certain phrases and have developed a language and grammar system. To assist in the description of the present invention, therefore, the definitions set forth above should be referred to. As noted above, further information [symbol] concerning these definitions and details of the environments [symbol] discussed herein can be found in the Appendix hereto, which is incorporated herein by reference and demonstration. In addition, over the past 20 years, the present inventors have developed a visual language consisting of diagrams annotated with labels and glyphs and supported by accompanying text—in short, a visual grammar and symbology to assist Transition Managers ToA in the collaborative design [symbol] , building [symbol] and use [symbol] of Knowledge-based enterprises [symbol] This is the “Modeling Language”—Design and Process Terms (D/PT) level of this System and Method.

The models collectively form a systematic grammar and lexicon for people to use when talking about and engineering [symbol] the qualitative dynamics of enterprises [symbol] undergoing the transition from mechanistic bureaucracies to organic (ToA), collaborative networks (ToA). The models have been used in a diagnostic fashion to assist in the practice of limited aspects of applications of the system and process [symbol] of the present invention by, for example, helping enterprises [symbol] determine where they are, what is happening and why, and what possible paths may be taken. The models may also be used as templates ToA and design [symbol] tools [symbol] for creating collaborative processes. Although the models can be studied and applied individually, their full power is only unleashed when considered in an interconnected and collective manner.

The present inventors have borrowed the subtitle of Hermann Hesse's masterwork Magister Ludi: The Glass Bead Game ToA as a metaphor for describing how to use the models together. Thus, Facilitators, Knowledge Workers Sponsors (and, ultimately, participants) play Glass Bead Games by translating current conditions into design solutions by using the models as catalysts and filters.

Even in the experimental application on a limited basis of certain elements of the present invention, modeling language speakers must develop an easy familiarity with the language for it to be of most value. Just like learning a foreign language, at some point they lay aside the dictionaries, grammar books and begin to think in the new language and use the language itself as a vehicle for learning more of it. The terms that describe the models and their components are purposefully general. Many people begin working through the modeling language with a study of the etymology, or linguistic roots, of the terms. Then, when the terms are linked together within and across models, powerful insights [symbol] become available and exact meanings can be held in common by a community-of-work (ToA). The models comprise part of an evolving art form that seeks the measure, rhythm and harmony/synthesis of the features of the complex world of the evolving enterprise.

Each model has several features: a number of components expressed as terms and symbols (glyphs); a spatial arrangement of these components relative to each other and perhaps to some axis such as time; and additional connections between the components that indicate flow or dependency. These language elements, to date, have not been employed on the level of a full Language that is capable of describing, comprehensively, the full range of concerns required by this invention. Practice has been one of diagrams and isolated words used mostly on a notional level. As languages have to evolve, these “words” have evolved as an organic experience [symbol] of the experiments that have been conducted. Lacking has been a sufficient critical mass of words, as well as, knowledge of the minimal scope [symbol] of the System and Method necessary for the desired effects to be sufficiently accomplished by one schooled in the art. In addition, words related to logical operations, transactions and some specific terms of art have been missing. These missing elements are being added to the current iteration (ToA) of the System and Method.

The Language, itself, has not been utilized sufficiently for minimal realization of its intended purpose: a Language artifact competent for describing the interaction of (agent) processes, tools and environments to augment and facilitate synergy among agents of all kinds in a Knowledge/Network Economy. Experiments have shown, however, that such a Language is possible and necessary for the accomplishment of the present invention and its intended purpose and use.

Further information concerning these glyphs and models and details of the systems and environments discussed herein can be found in the Appendix hereto, which is incorporated herein by reference.

With this background in mind, the experiments and demonstrations that the present inventors have conducted over a period of about twenty years to demonstrate, prove and refine certain elements and limited applications of the present invention may be grouped into several categories. These categories include a Business of Enterprise model that contains all of the clients, the knowledge worker network (past and present), KnOwhere Stores, client centers and a larger environment of vendors that make up a working ValueWeb. Specific “products” include DesignShops, Management Centers and NavCenters, and on the level of recursion (ToA) of the ValueWeb (ToA) can be considered part of the tool kit of that system.

In the field of management consulting, for example, the present inventors have recognized that the world is going through the largest and most rapid transition in known history. It is the shift from the industrial to the post-industrial or information age. As this shift occurs, high performance executives and KnowledgeWorkers of all kinds (i.e., Transition Managers—To A) are grasping the implication of these changes and are taking responsibility for steering them with craft and excellence. Thus, to test the applicability of the present invention to a single environment, the present inventors have developed management centers to research, design, prototype, and market new management systems to empower Transition Managers. The information age (Knowledge/Network Economy) will require new capabilities for the creation and application of information and knowledge. These capabilities will result from dramatic expansion in the performance of the intellectual resource—both human and computer-based—available within an organization. Accordingly, the present inventors have designed, developed and delivered tools, processes and environments that facilitate individuals and organizations in their transition to a knowledge-based world.

Moreover, to develop, augment and refine the process of the present invention, the present inventors have conducted a series of DesignShop events. Specifically (and with reference to the definitions set forth herein) the DesignShop practices, which have been conducted and evolved hundreds of times over the last twenty years, are events whose purpose is to release group genius (positive synergy—ToA) in the client, condense the time in which a team moves from Scan [symbol] to Act [symbol] by an order of magnitude, completely capture [symbol] and organize all of the information [symbol] generated, and do all of this in a facilitated [symbol] way by managing not the people involved, but the Seven Domains [symbol] [symbol] [symbol] [symbol] [symbol] [symbol] [symbol] that regulate collaboration and evolve ingenuity by making up the total environment of those doing the work. This environment may be physical and co-located, virtual and remote or a combination of both See Subsystems 2, 3 and 4).

The success of these DesignShop activities is evidenced by both consumer feedback and by the fact that sophisticated public companies are willing and eager to pay large amounts of money to participate in these DesignShop events [symbol] During the months of July and August, 1998, over 15 DesignShops were conducted for major organizations in the US and Europe for a market value of over $4,500,000. By 2000, one to 10 DesignShop events are taking place a week all over the globe for a market value of up to two to three million a month. Although current practices are only a partial and fragmented expression of the complete envisioned System and Method, this action-research indicates the full potential of the system.

For the last twenty years, the present inventors have tested the DesignShop concept hundreds of times with hundreds of organizations and thousands of people. In addition, the DesignShop process has been documented extensively by the production of WorkProducts and by participant-observers. What the DesignShop event has allowed these organizations to do has been to solve their most pressing problems. Groups have used DesignShop events to complete mergers, develop marketing plans, instill new cultures, redesign entire organizations, create shared visions of what is and what can be, resolve seemingly deadlocked union struggles, and design solutions that would have taken months or years of “business as usual” to create, if indeed “business as usual” could have designed a solution at all.

An experience of a very different way of working, the DesignShop event proves its value in the results that it produces. For a DesignShop event, all of the key stakeholders, decision makers and interested parties [symbol] [symbol] [symbol] [symbol] are brought together so that the decisions that need to be made can be made—in real time. During the event, participants rigorously explore their current conditions and their visions [symbol] of the future, co-design [symbol] multiple problems associated with the issue being explored, assess the merits of their different problem examples, and decide which problem best represents the issue at hand. Using the power of parallel processing (ToA) looking at various issues from different vantage points and synthesizing the results of that examination participants can deal with the tremendous complexity involved in planning for the future. A large group brings diversity of opinion, knowledge, experience and vantage point, enabling the DesignShop process to release their dynamic group genius. The design [symbol] of the event follows the SCAN [symbol] FOCUS [symbol] ACT [symbol] process [symbol] During the SCAN [symbol] phase, the participants confront and process a vast body of information and knowledge. Participants build models of emerging social and economic trends. They establish a common language for the group, identifying terms of art, uncovering assumptions, and discovering the unexpected. A context emerges for the area of focus. Judgment and argument are withheld during this time so that ideas can flow freely. The scan phase is based on the DesignShop axiom, “Creativity is the process of eliminating options” (Taylor Axiom). Wise elimination assumes that rich, dynamic, timely options have been explored. The variety of ideas created by thirty, sixty or ninety people multi-tasking allows the participants to design from many different vantage points [symbol] [symbol] [symbol] [symbol] [symbol] [symbol] [symbol] simultaneously. In the FOCUS [symbol] phase, participants use parallel processing to systematically examine the ideas generated during the SCAN phase. The market, financial, cultural, organizational, and social dynamics of the potential paths are explored by modeling and S'poze. Through these exercises, participants set aside prejudices, work through “stretch” models and scenarios as if they were true, then step back and to examine the viability of the different options they have created. Scenarios using convergence possibilities are examined. Participants have said that the FOCUS phase is hundreds of percentage points more productive than a typical meeting day. Each successive round of the iterative process provides more discrimination and clarity to the designs and ideas that the group creates. By the end of FOCUS, participants have “created the problem” (ToA) and developed a clearer vision of the route they will be taking. During the ACT [symbol] phase, the ideas and design from the first two phases converge.

Throughout the process, ideas have either gained strength and developed or fallen away naturally. The strong components remain, and design ideas turn into programs and projects which are laid out over time. The group reaches a common vision and engineers a comprehensive plan of implementation through group genius (ToA). From the rich body of knowledge [symbol] developed over the previous two days, the group chooses those elements most critical to their organizations particular needs. In addition, the experience of the past several days becomes the model for a new way of working. As a stand-alone event, the DesignShop can be used to design solutions to tremendous problems. Its greatest value, however, can be found in the pattern of work that the DesignShop process represents. By taking the Ten Step Knowledge Management process [symbol] [symbol] [symbol] [symbol] [symbol] [symbol] [symbol] [symbol] [symbol] with them when they return to their organizations, participants discover that productivity levels of a DesignShop event can be replicated at home.

Whereas the DesignShop has demonstrated certain aspects of the present invention, its full expression has been hampered by the lack of certain components of the invention, as well as, the non existence of certain Sub-Systems of the present invention.

Most notably these have been in the realm of Sub-Systems according to the present invention including the appropriate development of Computer and Tool Augmentation (Sub-System 3), the virtual and physical Transportation of Agents (Sub-System 4), Knowledge Economy components of trade, measure and instruments of execution (Sub-System 5) and the full expression of the Modeling Language and related Terms of Art, Pattern language and algorithms as has been noted.

The present expression of the invention brings these elements into harmony allowing the full expression of the DesignShop and related processes in the form of PatchWorks Designs (ToA) and other practices.

While related, these aspects of the full expression of the present invention, in fact, create a quantum leap in performance in relation to prior experiments. Further information concerning the DesignShop process and details of the environments used can be found in the Appendix hereto, which is incorporated herein by reference.

A Different Definition of Process

In another example of an application of some of the elements of the present invention to a specific discrete use, the present inventors have also developed and sold Management Centers that integrate work process design, innovative architecture, technical systems and information management tools, process and environment. Over the past 20 years, about 20 environment experiments have been conducted. Management Centers represent a systematic reinvention of the way people think, decide and work together to accomplish organizational goals. Management Centers provide organizations with an enhanced capacity to anticipate, plan, and act. In short, Management Centers provide Transition Managers ToA with the proper tools to manage what the present inventors have identified as all of the Seven Domains as a total system: growing and adapting the body of knowledge required to model the internal and external environment and then create appropriate organizational responses; [symbol] facilitating the processes of decision making, design, the way work gets done individually or with others in order to release Group Genius the genius that provides the enterprise with a competitive and cooperative edge; [symbol] creating just-in-time ToA education systems to help organizations explore beyond their current boundaries of performance and invention, and training systems to set the memes of new performance standards quickly throughout the complexities of the value web; [symbol] employing environments (including their tool kits) that allow individuals and groups to see the whole picture and the details, to collaborate effectively, work individually, and change configuration within a matter of minutes to accommodate the expansion or contraction of ideas, groups, plans and designs; [symbol] using technical systems to leverage education systems and more rapidly adapt the body of knowledge 1 to the external business, social, technological and political environment so much so that truly effective organizations have a greater hand in creating the external environment, and doing so in a responsible, healthy way; [symbol] managing projects6 collaboratively with less waste, more innovation, and an ability to see into the “white space” ToA between activities the place where unanticipated opportunities are mined and unforeseen disasters averted; [symbol] and managing the entire ValueWeb ToA as a venture [symbol] including dozens or thousands of individuals and other organizations into a synergistic whole, each part maintaining its identity [symbol] and ability to lead sapientially ToA, while contributing to the work of the whole and the other parts. This includes connecting the Management Centers (and NavCenters as described below) into an extended ValueWeb (Business of Enterprise Model) of other centers and resources.

Management Centers were invented to address the specific technological, social and economic conditions and opportunities facing organizations now and in the future. In their broadest terms, these conditions are characterized by a rapid and accelerating rate of change and complexity, and the inability of most organizations to effectively respond to that rate of change through traditional (typically incremental and linear) approaches (Rate of Change Model). To this end, the management centers provide:

1. The ability to anticipate and track internal and External changes (Weak Signal Research);

2. The ability to respond quickly and appropriately to new conditions and, thus, “turn turbulence into opportunity;”

3. The ability to reconfigure internal operations to meet changing demands;

4. The ability to move beyond dissent and need for alignment, among members of an organization, in order to address new challenges and focu action;

5. The ability to design new processes and develop the conditions to support high performance (ToA);

6. The ability to master complexity (ToA) and continually be able to discern the critical events and trends in an era of information overload; and

7. The ability for each individual to see the whole as well as the parts, and to apply a systems (ToA) perspective to their work.

In addition, the present inventors have developed used and sold a specialized form of Management Center known as a NavCenter. NavCenters use combinations of Environments, Processes and Tools (see the Seven Domains model) similar to those found in Management Centers. The difference between Management Centers and NavCenters is the very specific purpose of the NavCenter. While a Management Center is designed to support numerous, large groups doing a variety of work, a NavCenter is designed, more typically, with a specific purpose in mind. Nested inside a specific company, the NavCenter is the focal point for the entire fulfillment of the companys purpose. Management and NavCenters, like DesignShops have proven effective tools for Human Agents, but like DesignShops have been hampered by lack of the full expression of the System and Method as described herein. The emerging requirements of the Knowledge Economy demand orders of magnitude increases in human performance—even above that of DesignShop, Management Center and NavCenters which are demonstrated to be at the very top of the present practices of group creativity, group genius, project management6 and organizational collaboration.

It is expected that these processes environments and tools will take a quantum leap in effectiveness and economy with the full expression of the System and Method as described herein. Further information concerning the environments, systems and processes and tools used in Management Centers and NavCenters can be found in the Appendix hereto, which is incorporated herein by reference. The four key elements of the NavCenter that serve to realize its purpose are Dialogue, Grok, Align and Act. “Grok,” which comes from Robert Heinleins novel, Stranger in a Strange Land, means literally, “to drink.” The metaphorical meaning is “to understand, usually in a global sense.”

In a NavCenter environment, knowledge is available in ANDMap, Project Status Map, Time & Task Map, Infolog, WorkWall, and Knowledge Wall systems, and available on the Internet. This information allows any viewer to Grok the whole project and the ways in which the components progress and interact. Each project must be aligned with the purpose of the company and of the NavCenter. As the hub, the NavCenter is the ideal vantage point from which to examine the relationships of the parts to the whole. Alignment does not imply that there will always be agreement in fact, differences in opinion and vantage points provide the creative tension by which solutions are generated.

In these experiments, the participants were not taught the underlying aspects of the invention, but were, rather, exposed to discreet embodiments of the process at a high level. This was sufficient to test and prove the process without revealing the underlying concepts or the scalability and applicability of the system and process to other areas. Thus, notwithstanding the public use and testing of these components, the underlying concepts are have not been understood within those experiments outside of the inventors.

Starting in 2000, discrete licensed practitioners have started education into the deeper aspects of the System and Method. This is a requirement of reaching Level One and verifying the advanced aspects of the concept.

Subsystem 2—Optimizing Pattern Language Values

[symbol] The traditional collaborative work space, or office space arrangement used today is a remnant of the 19th Century. It is widely recognized that there are of variety of deficiencies with traditional collaborative work space systems. In part, these problems result from the variety of needs and/or objectives that a collaborative work space must satisfy today. For example, it is desirable to provide knowledge workers (toA) with as much work space and as great a variety of work space as possible. On the other hand, there is a desire, for economic reasons, to maximize density (the number of knowledge workers per square foot of office space). As office space has become more important the desire for density and efficiency has become paramount. It is also recognized that plug and play or modularity of office furniture systems can enhance efficiency. Likewise mobility and user mobility are desirable objectives. These objectives can broadly be termed as addressing human values, that is values related to pragmatic and economic concerns. As used herein the expression “human values” is intended to encompass the range of aesthetic, physological, health, economic and pragmatic values that are affected by work space design. From the vantage point of the User [symbol] human values include but are not necessarily limited to:

ABILITY TO CONTROL—light, temperature, sound, view providing a variable, scaleable and user controllable “sense” of isolation or involvement.

ADAPTABILITY—at minute, hour, day, week month year scales by the user(s) in order to make the specific arrangement necessary to support the work being performed. This has to be accomplished across the entire spectrum of modern KnowledgeWork (ToA).

CONFIGURATION ADJUSTABILITY TO WORK & USER STYLE SPACE FOR MULTIPLE TASKS—“open” @ once different tools

PROVIDE PROSPECT REFUGE at individual, Team and large group scales

From a manager's vantage point, human values include (but are not necessarily limited to):

USE OF SPACE PER INDIVIDUAL—often assumed to require a compromise between economic pressures (less space) and knowledge work requirements (more space).

WIRE MANAGEMENT—MANY WIRES—Changing all the time AVOID PLACEMENT OF WIRES IN BUILT WALLS BUILD INTO WORK WALLS, FURNITURE, ARMATURE ELEMENTS. PLUG & PLAY—Code Differences A particularly important concern is ADJUSTABILITY: which involves a variety of objectives, including (but not limited to)

MINIMIZING “PRIEST HOOD.” ONLY USER CONFIGURABLE “OFFICE SCALE” FURNITURE SYSTEMS TRUE ADJUSTABILITY IS NOT “EVERYONE THE SAME SO ANYONE CAN GO ANYWHERE” SCALES OF ADJUSTABILITY—Time, Physical, color, texture, movement within personal space within team setups, Building to building Another important concern that is frequently not addressed by standard open space systems is the desire for PLACE OWNERSHIP. To address this concern, one must provide the ability to Customize Individual Spaces to allow work process access and a public/private feel and to Customize Team Spaces. In short, users should be able to “own”, customize, keep and evolve their components, including the ability to take components with them (easily) when they move.

COMPLEXITY/VARIETY: Existing Systems inherently lack sufficient complexity to make arrangements that: Achieve density; Achieve individual user require space (and kinds of spaces); Allow full use of foot print (no wasted, single-use spaces); and address: Pattern Languages (Demonstrated values); Armature (Alexander, Ching, Greene, Flun and Brand); Prospect & Refuge (Gallager, Day); Order & Complexity; and Evolution & Adaptation

DURABILITY—Modern systems best when new, the materials not repairable, the styles (limited by the system) do not have not intrinsic design—they get old, dated. The present invention is intended to mellow (age gracefully), last for years and be easily fixed & adapted. For example, a standard straight work wall panel can: hang on wall; fold on track or wheels; slide or double hang. Similarly, an individual pod can be one-piece work station, two, three, etc., to complete room (or “s” curve).

Within this universe of concerns, it is widely believed that there are inherent conflicts. For example, the need for greater density, for more knowledge worker space and a greater variety of knowledge worker work space typically believed to directly conflict with the need for greater density. Likewise, the need for greater variety of work space has been viewed as conflicting with the need for greater modularity.

Recently efforts have been focused on the human values concerns. In particular, it has been recognized in the prior art (see U.S. Pat. No. 5,684,469 assigned to Steelcase Inc.) that as modern offices become increasingly complicated and sophisticated the needs of the users for improved utilities support and collaborative work space are increasing. “Utilities,” as the term is used, encompass all types of resources that may be used to support or service a worker, such as communications and data used with computers and other types of data processors, electronic displays, etc., electrical power, conditioned water, and physical accommodations, such as lighting, HVAC, security, sound masking, and the like . . . Thus, modern offices for highly skilled “knowledge workers” such as engineers, accountants, stock brokers, computer programmers, etc., are typically provided with multiple pieces of very specialized computer and communications equipment that are capable of processing information from numerous local and remote data resources to assist in solving complex problems.

Such equipment has very stringent power and signal requirements, and must quickly and efficiently interface with related equipment at both adjacent and remote locations. Work areas with readily controllable lighting, HVAC, sound masking, and other physical support systems, are also highly desirable to maximize worker creativity and productivity. Many other types of high technology equipment and facilities are also presently being developed which will find their place in the workplaces of the future.

One important consequence of the advent of sophisticated electronic offices is the increased need and desirability for distributing utilities throughout the various offices in a manner which can be readily controlled. For example, both personal security and information security are ever-growing concerns in today's office environment, particularly as more and more sensitive business data is being transmitted electronically.

Complex video and computer systems have been developed which have a central location from which all workstations in any given grouping and/or building can be continuously monitored, and the security of each associated piece of electronic equipment connected with a communications network can be checked. Related alarms and electronic locking mechanisms are typically integrated into such security systems to provide improved effectiveness.

These types of security systems must presently be hard-wired in place in the building and the associated workstations. This serves to increase the cost of the office space, and severely limit its ability to be readily reconfigured. The efficient use of building floor space is also of great concern, particularly as building costs continue to escalate. Open office plans have been developed to reduce overall office costs, and generally incorporate large, open floor spaces in buildings that are equipped with modular furniture systems which are readily reconfigurable to accommodate the ever-changing needs of a specific user, as well as the divergent requirements of different tenants. One arrangement commonly used for furnishing open plans includes movable partition panels that are detachably interconnected to partition off the open spaces into individual workstations and/or offices. Such partition panels are configured to receive hang-on furniture units, such as worksurfaces, overhead cabinets, shelves, etc., and are generally known in the office furniture industry as “systems furniture.” Another arrangement for dividing and/or partitioning open plans involves the use of modular furniture, in which a plurality of differently shaped, complementary freestanding furniture units are positioned in a side-by-side relationship, with upstanding privacy screens available to attach to selected furniture units to create individual, distinct workstations and/or offices. All of these types of modular furniture systems have been widely received due largely to their ability to be readily reconfigured and/or moved to a new site, since they are not part of a permanent leasehold improvement.

To gain increased efficiency in the use of expensive office real estate, attempts are now being made to try to support highly paid knowledge workers with these types of modular furniture systems in open office settings, instead of conventional private offices. However, in order to insure peak efficiency of such knowledge workers, the workstations must be equipped with the various state-of-the-art utilities and facilities discussed above. Since such workstations must be readily reconfigurable to effectively meet the ever-changing needs of the user, the distribution and control of utilities throughout a comprehensive open office plan has emerged as a major challenge to the office furniture industry. Some types of modular furniture systems, such as selected portable partition panels and freestanding furniture units, can be equipped with an optional electrical powerway, which extends along the entire width of the unit, and has quick-disconnect connectors adjacent opposite ends thereof to connect with adjacent, like powerways, and thereby provide electrical power to an associated furniture group or cluster. Outlet receptacles are provided along each powerway into which electrical appliances can be plugged. Cable troughs or channels are also provided in most such furniture units, so as to form a system of interconnected raceways into which signal and communications wires can be routed. Such cabling is normally routed through the furniture system after the furniture units are installed, and is then hard-wired at each of the desired outlets. While this type of distribution system has proven somewhat effective, the types of utilities provided are rather limited, their distribution is not wholly modular, thereby resulting in higher installation and reconfiguration costs, and there is little or no control for those utilities available, at least on an overall systems level. The inherent nature of modular furniture systems, which permits them to be readily reconfigured into different arrangements, makes it very difficult to achieve adequate utility distribution and control. To be effective, not only must the furniture units have built-in utility capabilities, but the distribution system should also be able to determine the location of each particular furniture unit within a system of multiple workstations, monitor its utility usage, and then control the same, all at a relatively low cost and readily adaptable fashion, which will function effectively, regardless of where the individual furniture unit is positioned or how it is configured.

So-called “open office plans” typically comprise large, open floor spaces in buildings that are furnished in a manner that is reconfigurable to accommodate the needs of a specific user. Many such open plans includes movable partition panels that are detachably interconnected to partition off the open spaces into individual workstations and/or offices. Such partition panels are configured to receive hang-on furniture units, such as worksurfaces, overhead cabinets, shelves and the like. An alternative arrangement for dividing and/or partitioning open plans includes modular furniture arrangements, in which differently shaped, freestanding furniture units are interconnected in a side-by-side relationship, with upstanding privacy screens attached to at least some of the furniture units to create individual, distinct workstations and/or offices.

As recognized in U.S. Pat. No. 5,651,219, these types of conventional workstation arrangements do not optimize human (i.e., economic and pragmatic) design values. For example, conventional designs of these types are not particularly adapted to support workers engaged in group work, such as self-managing teams, or others involved in team problem solving techniques, wherein a relatively large number of workers from different disciplines, such as engineering, design, manufacturing, sales, marketing, purchasing, finance, etc., meet together as a group to define and review issues, and set general policy, and then break out into either smaller sub-groups, or into individual assignments or projects to resolve those specific problems relating to their particular discipline.

Group work is steadily gaining importance as a way of improving productivity and time-to-market, thereby emphasizing the need to support such activities more efficiently and effectively. In addition, built-in offices and conference rooms are typically expensive to construct and maintain, and are not usually considered an efficient use of space in open plan environments. When such conventional rooms are constructed in rented office space, they become permanent leasehold improvements, which must be depreciated over a lengthy time period, and can not be readily moved upon the expiration of the lease. The reconfiguration of such spaces is quite messy, and very disruptive to conducting day-to-day business.

Furthermore, with conventional conference room arrangements, breakout meetings among the various sub-groups of workers often prove inconvenient, since the offices of the participant workers are seldom located in close proximity to the conference room. It is recognized that group problem-solving techniques necessarily involve some degree of interaction between coworkers, thereby creating the need in furnishings for modem office environments to promote the establishment of an optimum balance between worker privacy and worker interaction. Throughout a given workday, an office worker normally oscillates between interaction with others and time spent alone. Each such worker actively seeks out or avoids others based upon their ever changing tasks, objectives, and goals. Furnishings can serve to help these workers better regulate involvement with or isolation from coworkers. For example, full height offices are known for privacy. Their surrounding walls and door provide privacy by consistently controlling unwanted distractions, but often limit opportunities for spontaneous interaction. On the other hand, open offices precipitate an awareness of coworkers. Furniture and partition based workstations encourage participation by convenient access, but often lack sufficient controls for individual quiet work. Private workspace, and convenient access to coworkers for the completion of work involving group or team efforts are both quite important to the overall success of such collaborative projects. There have been various attempts to address these pragmatic and economic human concerns.

For example U.S. Pat. No. 5,684,469 assigned to Steelcase Inc. proposes a utility distribution system for modular furniture of the type comprising individual furniture units that are juxtaposed to form one or more workstations. A signal conductor is positioned in each furniture unit, and extends generally between opposite sides thereof. Quick-disconnect connectors are provided at the opposite ends of each of the signal conductors, and mate with like quick-disconnect connectors in adjacent furniture units to create a communications network through the workstations. Each furniture unit has a signaler physically associated therewith, which is connected with an associated signal conductor at a coupler. A network controller is operably connected to the network to evaluate the network and/or the associated furniture units. The furniture units may be equipped with one or more utility ports, which are connected with the coupler, and service utility appliances, such as personal computers, telephones, facsimile machines, switches, power outlets, data receptacles, and the like. The utility appliances preferably have memory capability to internally store operating instructions for the same, which are transmitted to the network controller when the utility appliance is initialized. U.S. Pat. No. 5,675,949 assigned to Steelcase Inc. discloses a utility distribution system is open office plans and other similar settings, that includes a prefabricated floor construction designed to be supported directly on a building floor. The floor construction has a hollow interior which defines at least one raceway to route utility conduits therethrough, and a floor surface on which workstations can be positioned. The utility distribution system also includes at least two utility posts, each of which has a foot which mounts to the floor construction to support the utility posts in a generally upstanding orientation. A utility beam extends generally horizontally between the two utility posts, and is supported thereby.

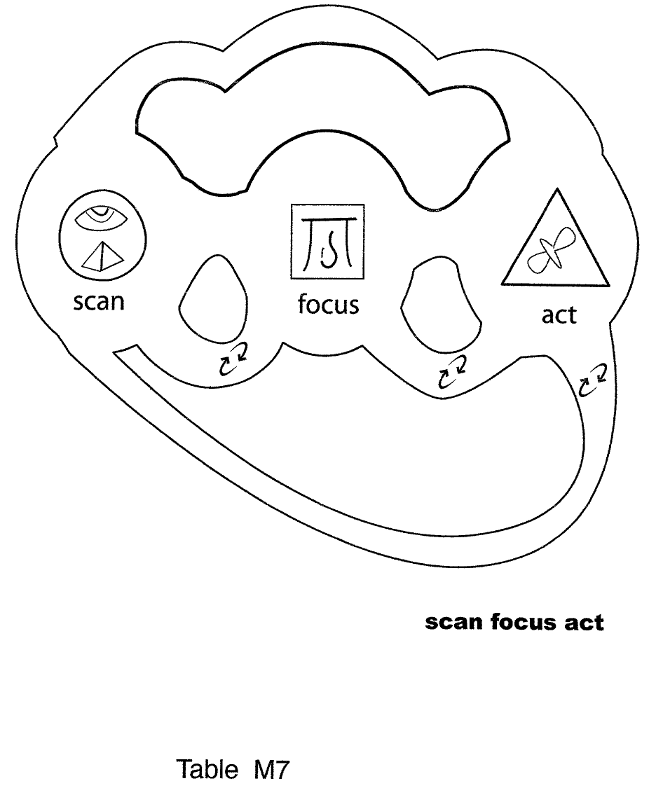

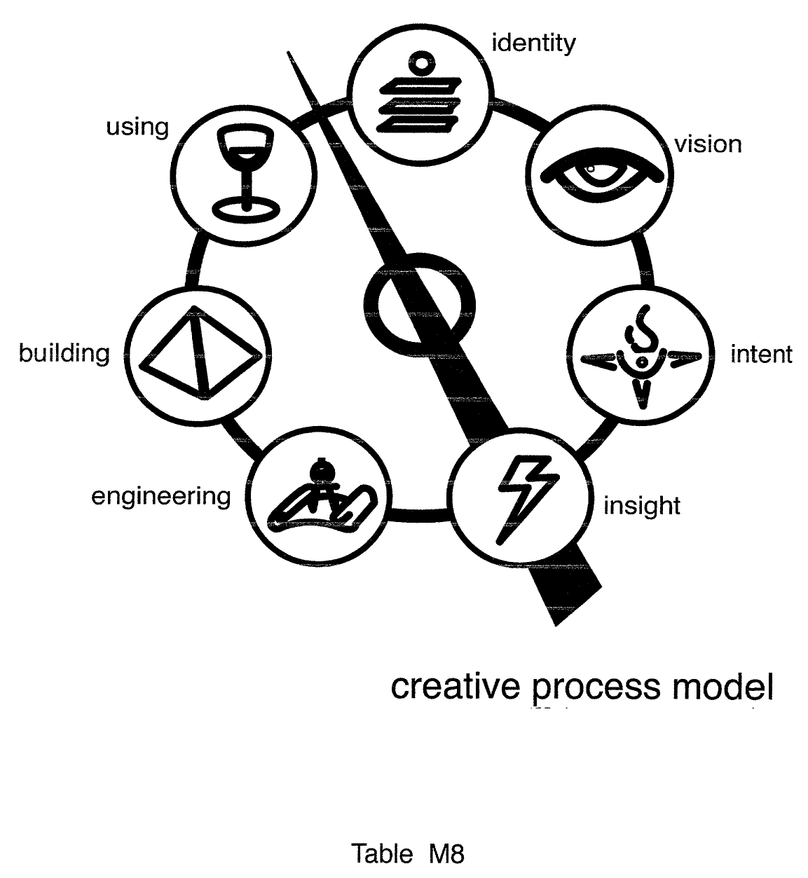

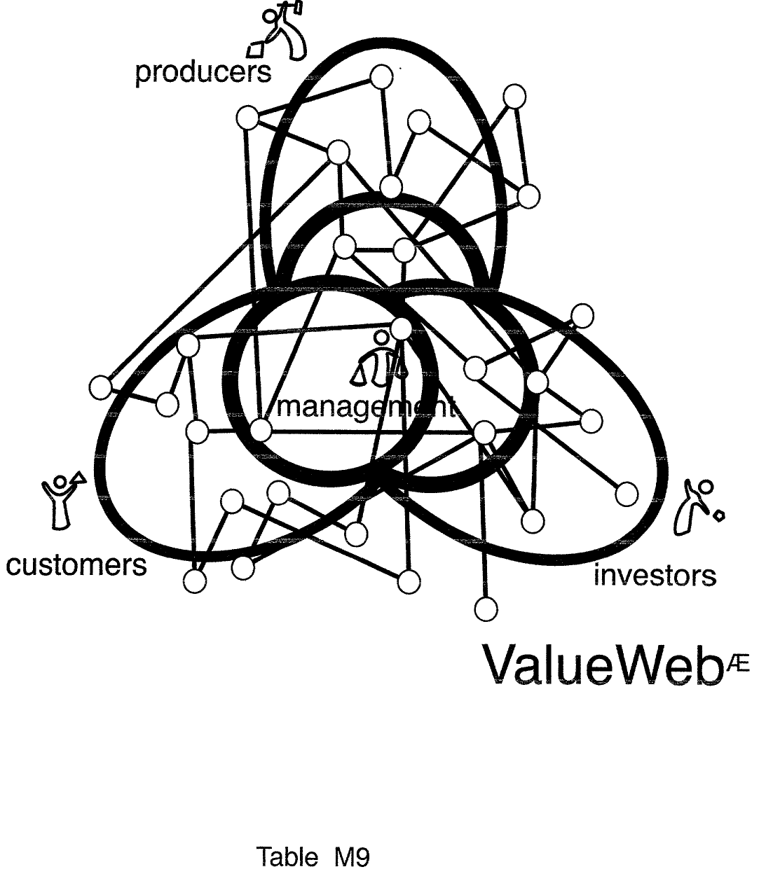

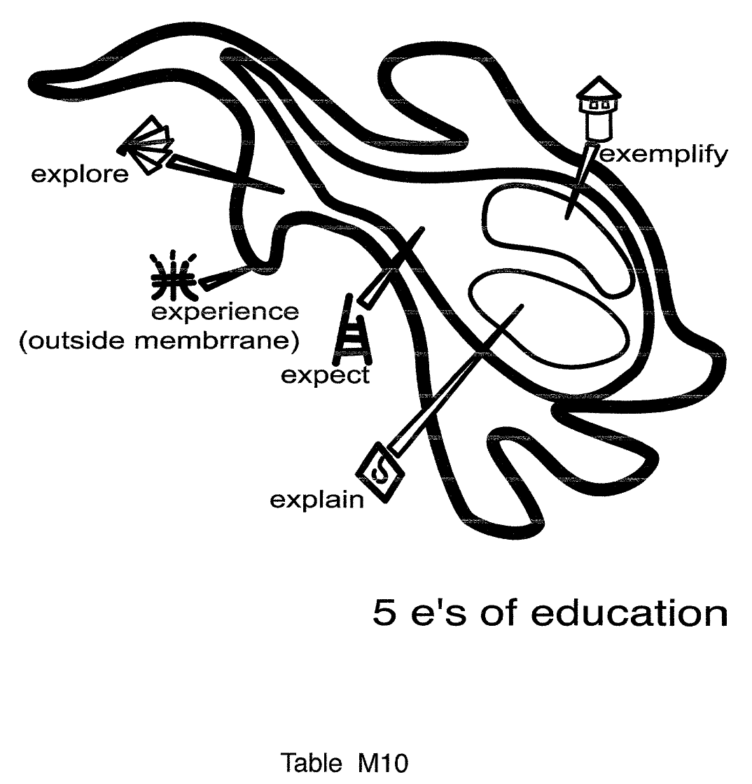

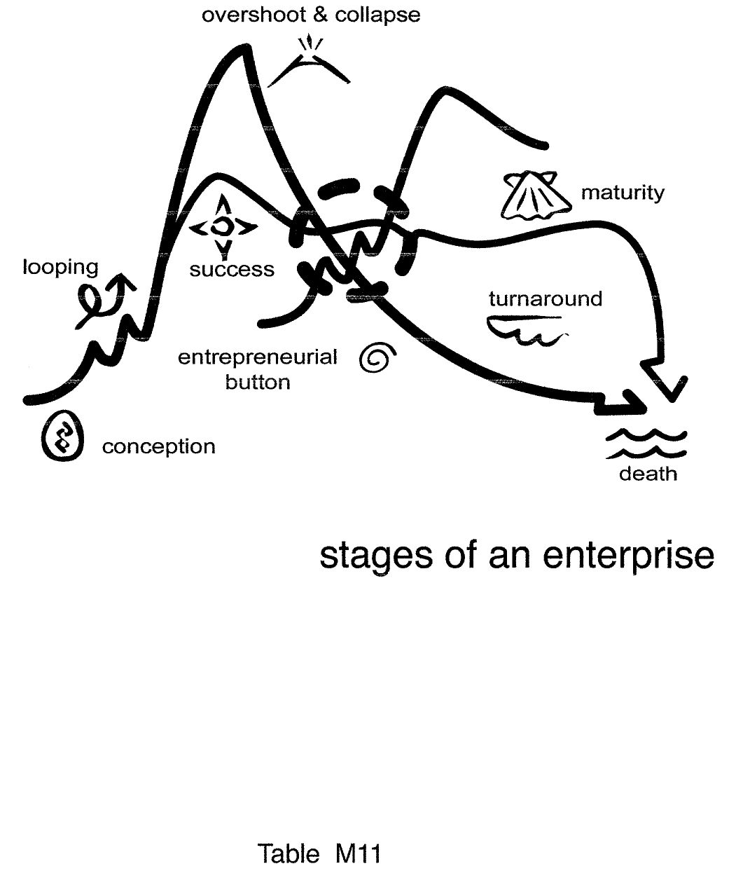

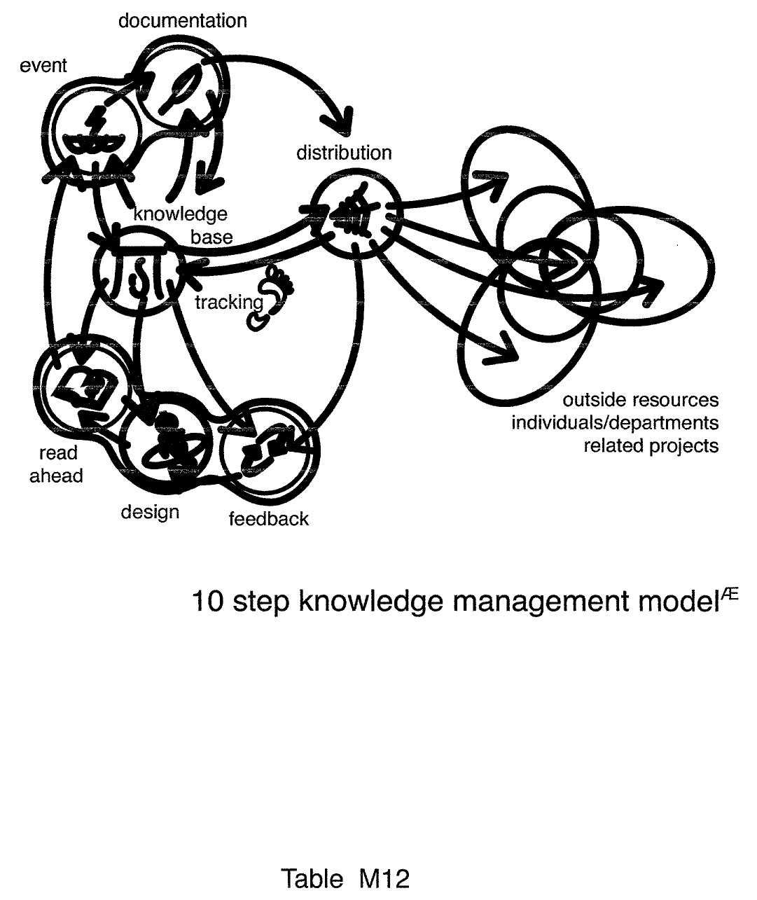

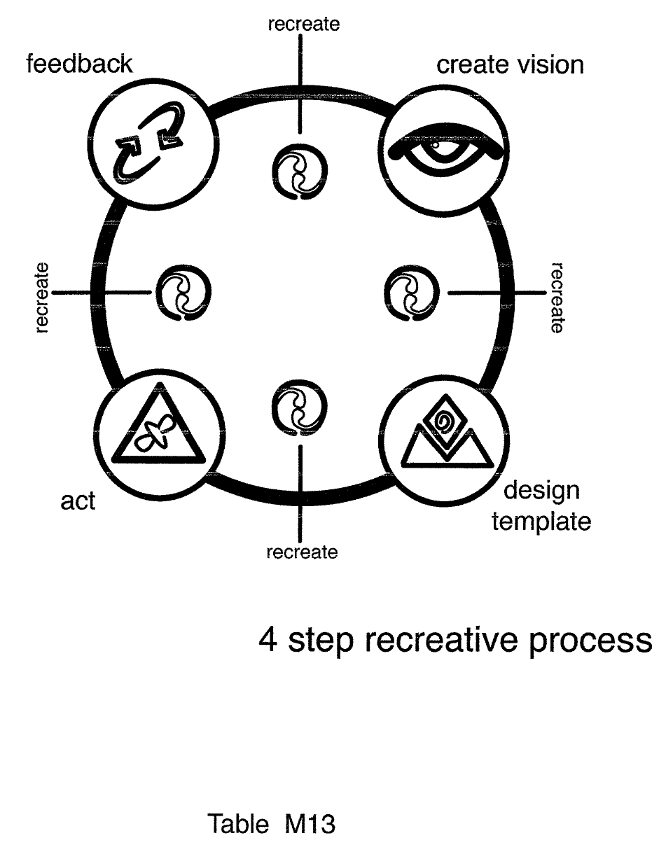

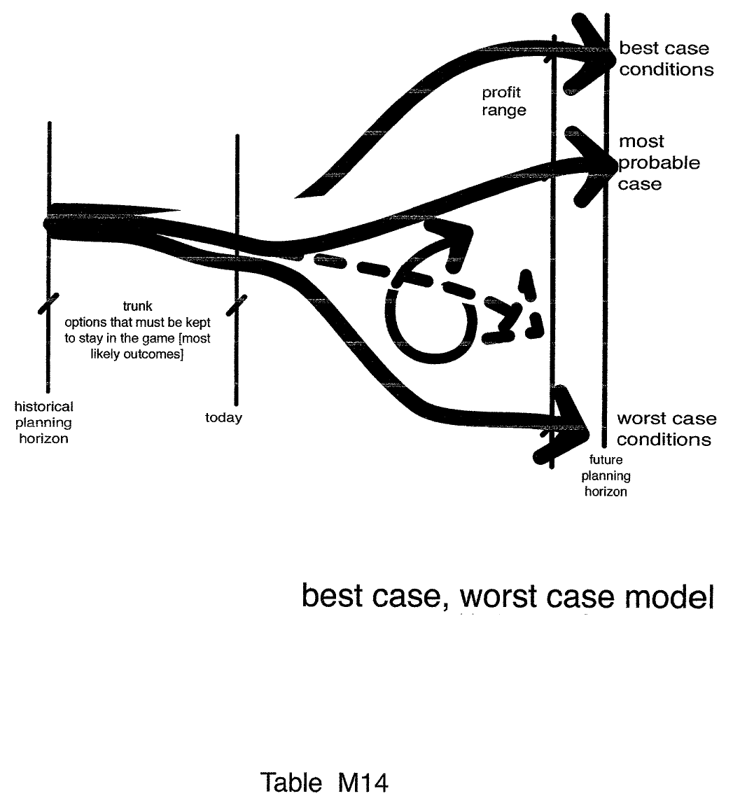

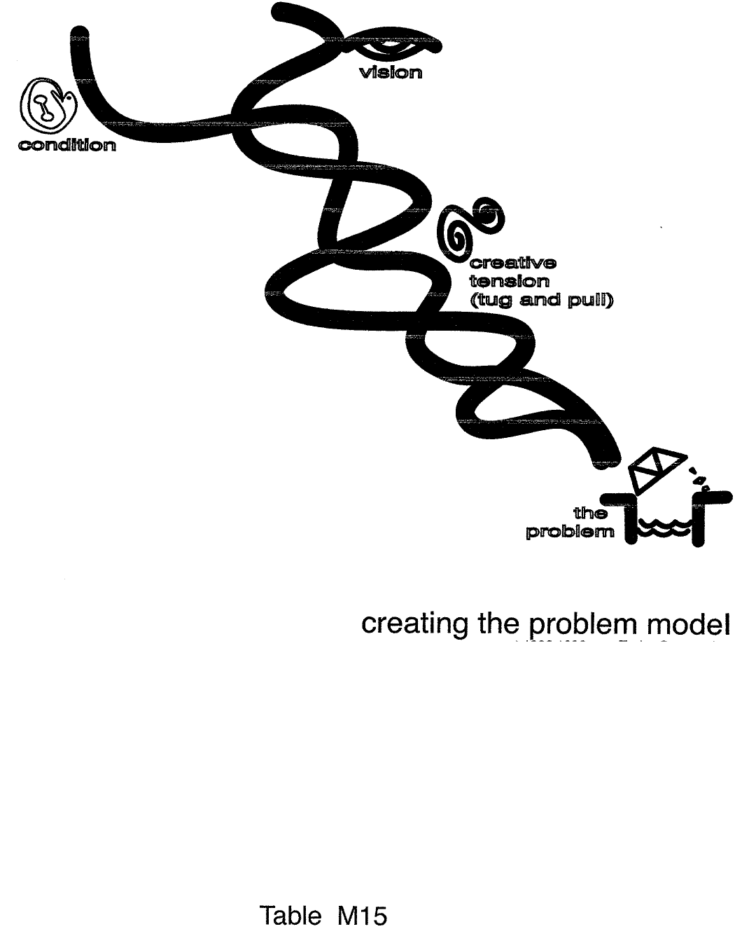

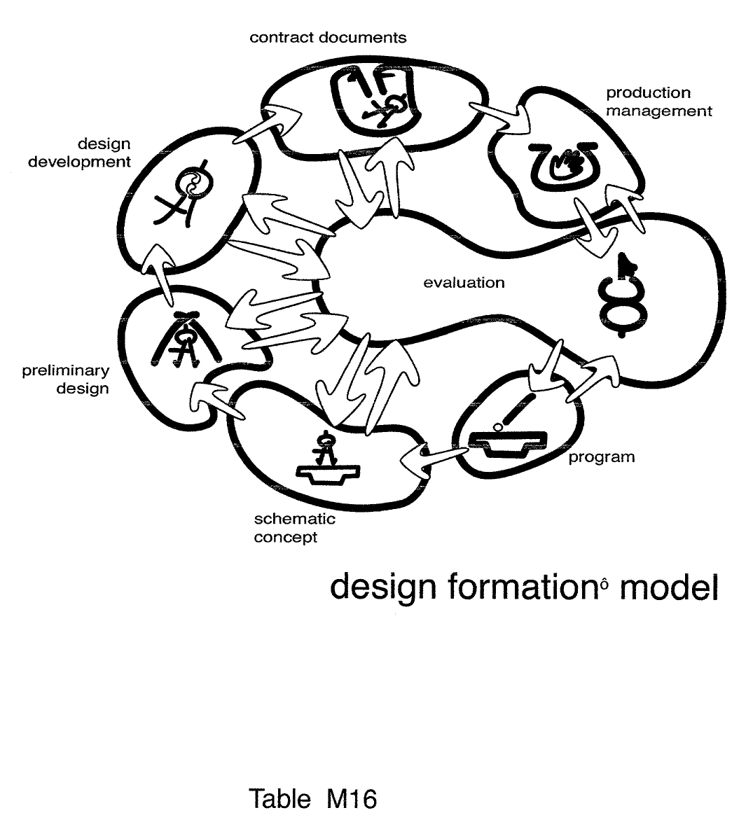

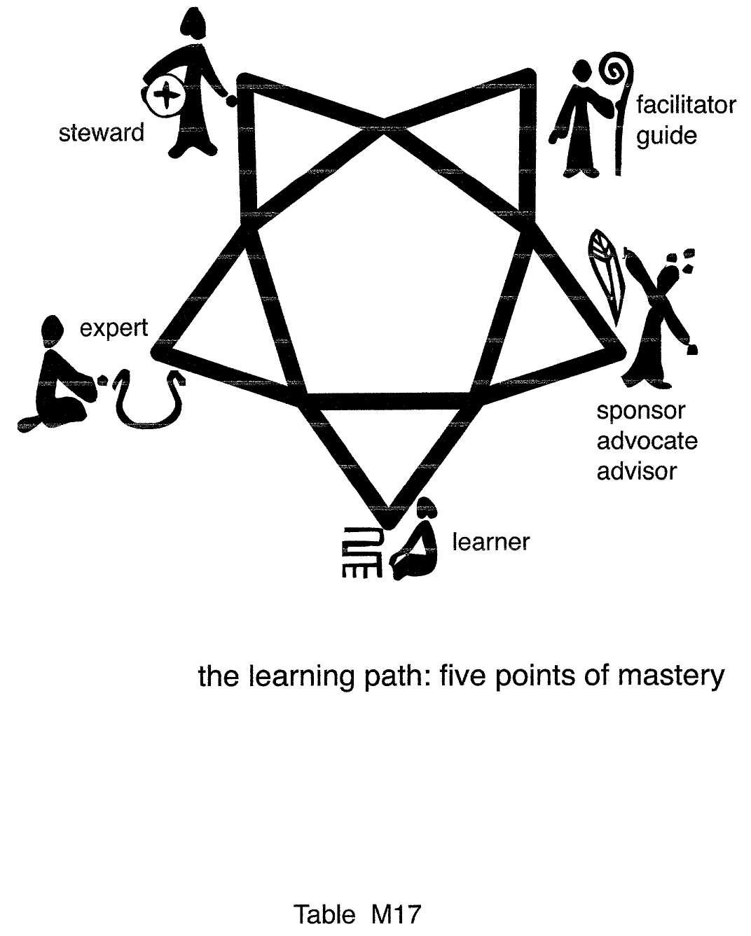

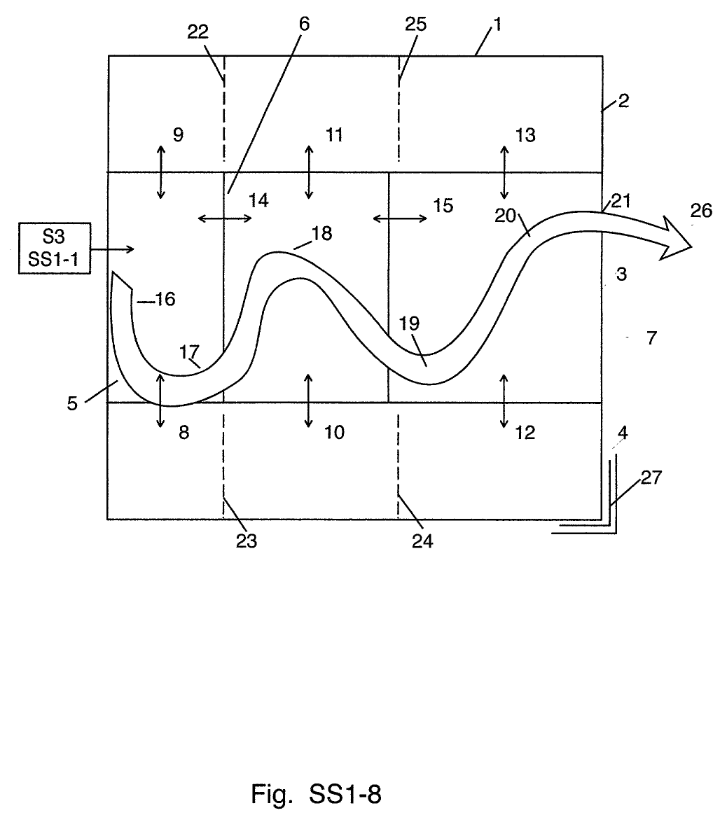

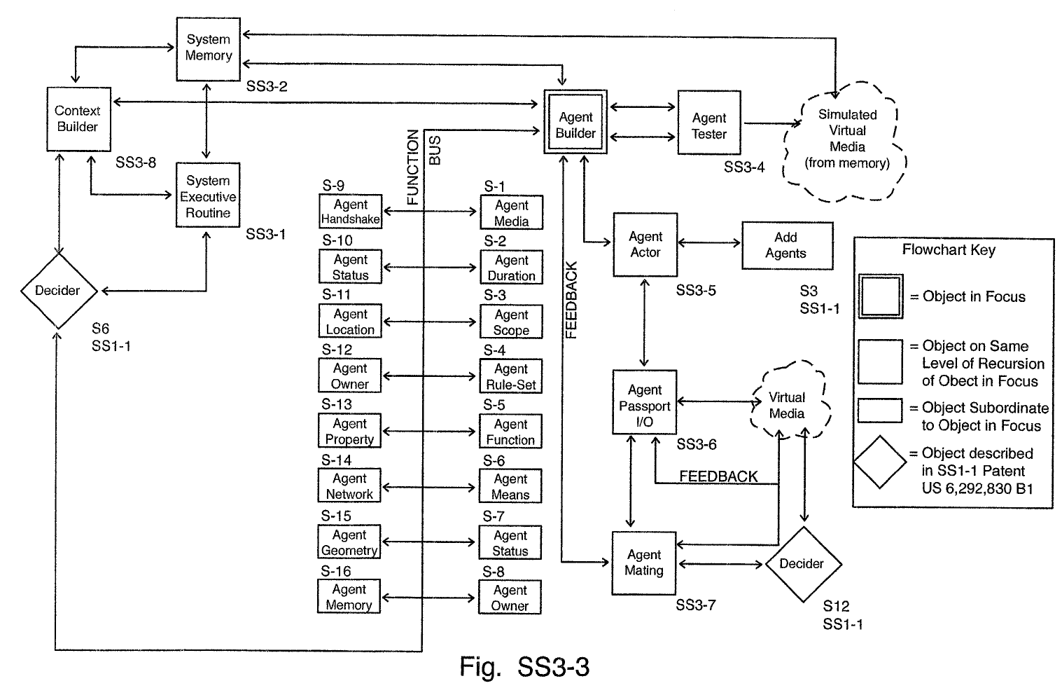

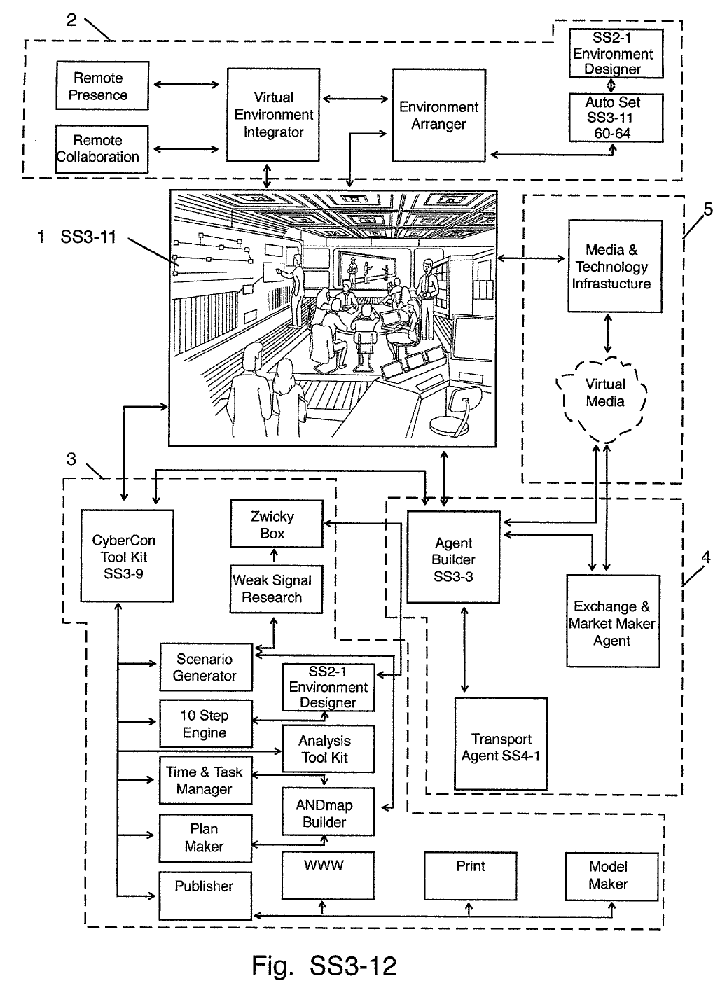

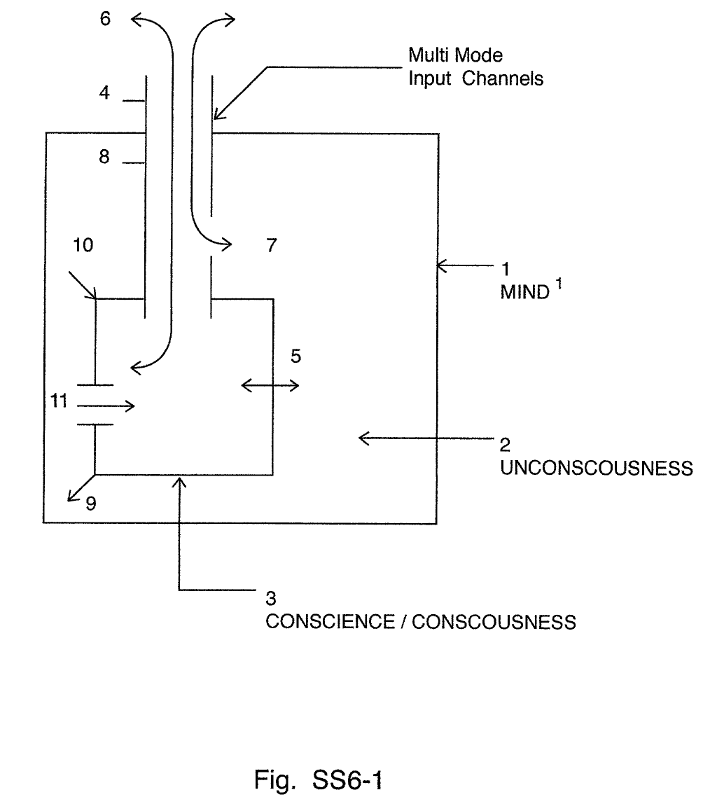

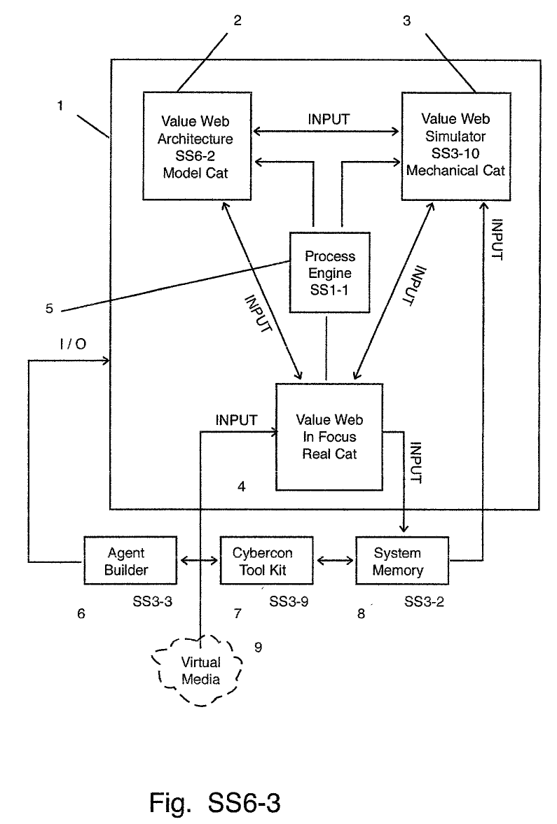

The utility beam has at least one raceway extending longitudinally therealong, with opposite end portions communicating with the utility channels in the utility posts to route utilities therebetween. U.S. Pat. No. 5,651,219 assigned to Steelcase Inc. describes a workspace module for open plan spaces, and the like, that includes a compact footprint, comprising a freestanding framework supporting a three-sided partition to form an interior workspace and a portal opening for user ingress and egress. A door partition shaped to selectively close the portal opening is movably mounted on the framework. The door partition preferably has an accurate plan shape, and is positioned adjacent one side of the portal opening, such that shifting the door partition from the fully open position to the fully closed position both increases the amount of the interior space in the workspace module, and alters the plan shape thereof for improved freedom of user movement, while alleviating any sense of user claustrophobia. FIG. 45 of the patent shows a perspective view of an office arrangement that includes a plurality of workspace modules arranged in two clusters, and furniture positioned in a common area framed by the clusters of workspace modules. FIG. 46 shows a perspective view of an office arrangement including a plurality of workspace modules arranged in two clusters, and a furniture system positioned in a common area framed by the clusters of workspace modules, wherein the furniture system is configured to define two, smaller subgroup workspaces for breakout-type activities. The arrangement of workspace modules 1 shown in FIG. 45, includes tables 142, chairs 143, and mobile displays 144. FIG. 46 shows, a cluster of workspace modules 1 is shown configured in a predetermined arrangement on building floor surface 8, with a unique furniture system 145 positioned in the common workspace 141 to assist in further supporting group work activities. The furniture system 145 includes a plurality of posts or columns 146 which support an overhead framework 147 on the floor surface 8 of the open office space in a freestanding fashion at a predetermined elevation, generally above average user height. A plurality of individual panels 148 are provided, wherein each panel 148 is constructed to permit easy, manual bodily translation of the same by an adult user. A hanger arrangement 149 is associated with overhead framework 147, and cooperates with connectors 150 on panels 148 to detachably suspend panels 148 at various locations along overhead framework 147. Panels 148 are manually reconfigurable between many different arrangements, such as the configurations shown in FIGS. 45 and 46, to support different group work activities. Panels 148 are capable of providing a partitioning function to visually divide at least a portion of the workspace, and/or a display function to facilitate group communications. U.S. Pat. No. 5,651,219 seeks to provide a compact and dynamic workspace module that is particularly adapted to effectively and efficiently support knowledge workers engaged in group work activities in open plans, and the like. The workspace module is preferably configured such that when the door partition is moved to its fully closed position, the interior workspace expands, the shape changes, and interior walls and appliances are automatically exposed, thereby improving freedom of user movement and user effectiveness, and evoking a sense of roominess and comfort. The workspace module is preferably freestanding, such that it can be easily transported and reconfigured within a given workspace, and may have a knock-down construction which permits the same to be readily disassembled and reassembled at new project locations. The overhead framework may include raceways to equip the workspace module with power, signal, lighting, and other utilities. Communication devices, and other similar office appliances may be built into the interior of the workspace module in a vertically stacked array adjacent one side of the seated user to effectively support the user. A mobile personal storage unit adapts the workspace module to be used by multiple workers, and a mobile worksurface equips the workspace module for both private and conference activities. The workspace module is extremely flexible and dynamic to meet the ever changing needs of various users, is economical to manufacture, capable of a long operating life, and particularly well adapted for the proposed use.

U.S. Pat. No. 5,511,348 assigned to Steelcase Inc. discloses a furniture system particularly adapted to support group activities in open plans. The system includes a plurality of columns supporting an overhead framework on the floor of a building in a freestanding fashion at a predetermined elevation, generally above average user height. A plurality of individual panels are provided, wherein each panel is constructed to permit easy, manual, bodily translation of the same by an adult user. A hanger arrangement is associated with the overhead framework, and cooperates with connectors on the panels to detachably suspend the panels at various locations along the overhead framework. The panels are manually reconfigurable between many different arrangements to efficiently and effectively support different group activities. Preferably, the panels are capable of providing a partitioning function to visually divide at least a portion of the workspace, and/or a display function to facilitate group communications. While the designs described in these recent patents address some of the human value concerns by providing more efficient systems, they fail to appreciate, much less address, the need to address architectural pattern language values. As a result, the components described are not sufficient to optimize both human and pattern language values. In addition, the emphasis on pragmatic and economic values has led to an emphasis on standardized systems that attempt to achieve maximum efficiency without consideration of other important values such as, high variety, the use of natural materials to achieve true durability, true reconfigurability, architectural armature, prospect and refuge and perhaps most importantly, pattern language values.

Given the emphasis on efficiency and pragmatic and economic concerns, it is not surprising that well known systems that address one or more the previously mentioned objectives do so by sacrificing other objectives. In particular, conventional furniture systems do not allow optimization of human and pattern language values. With regard to Human Values, the variety of furniture and work space arrangements and configurations does not match the variety needed to solve the problems, i.e., to meet and optimize and (all the pragmatic, human and economic) values. In this way, furniture design limits the range of possible solutions sets and limits the ability to create environments that facilitate collaborative interaction. Moreover, while pattern language values are well documented (see Alexander), most cannot be achieved using conventional “off the shelf” furniture components. Custom design is required. This is very expensive and non-standard and requires a case-by-case approach.

In addition, there is a continuing need to integrate, preferably in a seamless way, new technologies into the collaborative workspace. Before the advent of the Internet, distributing information to all the interested decision makers was prohibitively expensive. Today, the world wide web is an unparalleled distribution channel, where the cost to provide information to an extra user is essentially zero. This makes massive distribution of corporate data economically feasible for the first time in history, turning every Internet user into a potential customer for data. With a non-zero demand price, a zero supply marginal cost, and an Internet user base that is growing exponentially, the commercialization of corporate data represents a tremendous business opportunity to the corporations who have the data, and a high value added to the decision makers who need the data. This completely new paradigm is described by some as query tone. This is an analogy to an information revolution of similar proportions which is known today as dial tone.

Under query tone, the data warehouse shifts from money sink to profit center, and the average consumer is suddenly able to obtain information previously accessible only to the top management of Global 2000 companies. Leading companies have proposed a “query tone” enabled world where information flows freely in a frictionless market; a win/win situation where decision makers can obtain all the information they need and corporations can profit from their data warehouses; a society where a person can turn on a computer, and ask any question from any database anywhere, just like today a person can pick up a telephone, and talk to anybody anywhere. Thus the economics and technology are now in place and being continuously improved to allow users to query a wide range of databases to obtain desired information “just in time (toA).” The technology preferably allows people to use web browsers to sift through large stores of data.

While this technology has wide applicability, there remains a need for an overall process and environment that takes full advantage of “just in time information” and integrates this information into the collaborative work space. Moreover, there remains a need for a system and method for facilitating interaction and transportation of software and other “agents” used to sift through data. In addition, there exists, today, little if any integration between working environments and the transition of agents from on state to another in the transportation process.

These transitions ToA are not designed and facilitated. They happen as the accident of the sum of the processes parts of a discontinuous series of events. As is outlined in Subsystem Four of this invention, transportation units are environments, and in the Knowledge Economy, these environments cannot be dissociated from the production (value-added) process. Agent movement in the Knowledge Economy is a necessity to it, is information ToA and memory in itself (that the economy requires to run), and can be a value-added event [symbol] in the creation of Agency ToA. All Knowledge-based environments are nodes ToA in a system of environments that, when organized and facilitated as a function ToA of the present invention, create a network-environment ToA that facilitates Agent work and Agency across what are now critical gaps in the process.

The “plug and play” of Agents is a necessary feature of a knowledge-economy environment. This feature must occur on all levels of recursion from knowledge-objects ToA software agents and tools, components of the human Agent environment, the system of transporting environments. Environments (“fixed” or mobile) are made of Agents and are themselves Agents. Thus, there remains a need for a comprehensive system and method that provides an optimal solution by addressing each of these objectives without sacrificing other objectives. Thus, there are paradoxes and problems associated with the Knowledge Economy, and the transition to it, that are not addressed by existing systems and methods of work and the tools utilized for conducting commerce.

Subsystem 3—Integrating/Optimizing Technical Systems to Promote Agent Interaction

[symbol] A Part of the challenge of developing intellectual capital is the need to develop information, communication and thought augmentation systems that can help us (as Agents) extend the power of our minds: not only the ability to reason analytically, but the ability to use intuitive processes as well.

Ultimately, we need an intelligent partnership ToA among Agents (humans, machines, groups, organizations and combinations thereof) that support their work, play, and growth. This is a radically different concept of “information processing” than the one we find in place today. Existing systems are extremely limited in concept and tend to “automate the 19th Century”—that is, focus on refining processes that were invented in earlier periods and shaped by the limited technology of those times.

These deep structures limit the utility of the tools even as they become faster and more economical. It is an insight of this Invention that tools are not cognitively “neutral” but have embedded in them (intrinsically) processes of great value or harm. It is also an insight of this Invention that a close-coupling can be achieved between processes, tools (augmentation means), the Agents that employ them and the environments they work in. This can result in systems of far greater power and subtly than presently exist. These systems can exhibit life-like behavior.

In the final analysis, this concept demands a synergy between the special capabilities of Agents, whether humans, machines, groups, organizations and combinations thereof. In addition to being structurally based on an old paradigm, existing technical systems are highly fragmented and fail to support Agents in a seamless and powerful way. Computer Agents are limited to narrow and specialized environments. Human Agents have to navigate a plethora of tools and tooling systems and environments in order to perform typical and mundane knowledge-based tasks. High level integration of work and the environments of work is not possible with existing models and tools.

Effective economic Agents do not exist on any significant scale. Recent developments in object-oriented programming (and programs like “Java” and “Jini” by Sun Micro Systems), as well as, the development of multimedia and the Internet provide a platform upon which a radically different approach is (becoming) possible. However, the specific conceptual framework, exact configuration of software and the embedded processes mentioned before make this nearly impossible—the critical mass of the industry is moving in another direction.

“You Cant get THERE from HERE” (Taylor axiom). While there exists, today, rudimentary learning in some elements of the total tool kit that supports knowledge-work, learning by all Agents of the system, on all levels of recursion—and by the system itself—is not a built-in and accomplished systematically—it is incremental and accidental.

Learning ToA, as happens in a human agent, is partially understood as a shared and common experience among some humans. However, the approach to accomplishing it is crude and mostly colloquial. Learning by computer agents has just recently been explored on any significant scale (Media Lab at MIT and others). Learning by other systems, such as buildings, has been described by Steward Brand in “How Buildings Learn.” Brand applies a cybernetic perspective to how “innate” objects change and record experiences. Learning, in this context is closely allied with memory.

While provocative, these tools, experiments and insights fall far short of the kind, scale and type of knowledge-augmentation ToA required to effectively support knowledge-work in a Knowledge/Network economy.

Further, it is an insight of the present invention that the built-in processes [symbol] endemic to existing tools and common approaches to their design, manufacture and use are (mostly) intrinsically inimical to the practice of knowledge-augmentation required by present and future conditions.

The key is that all Agents must learn. That complex Agents made up of Agents, must learn. That the system of Agents (which is an Agent) must learn. It is only this way that complexity ToA, emergence ToA and Requisite Variety ToA can be addressed.

Thus, the human Agent, rather than defining, dominating and controlling other Agents in the system-in-focus ToA participates in a collaborative process with Agents of all kinds. Learning is a function ToA of complex feedback, iteration, recursion, critical mass, the specific process used and the intrinsic process-bias of the tools employed.

The focus of the present Invention is not only how each Agent component of the system learns but how the system, itself, learns. The present Invention is a System and Method for consistently accomplishing this. In this System and Method, learning and what is called creativity ToA is considered the same thing.

Creativity is learning aimed outward at accomplishing some goal; learning is creativity aimed inward to accomplish a state-change ToA in a specific Agent or environment of Agents. In both cases, the memory ToA of the system is altered.

To be effective in to days and future environments, hardware and software Agents have to be adaptive—as well as ubiquitous. They have to co-evolve with their user Agent (or Agents) and other environments on multiple levels of recursion beyond the computer system environment itself. The computer system architecture, thus, becomes an analog of the process that is being created. Easy movement between modalities: analysis, synthesis, simulation—to name a few—is essential.

Subsystem 4—Transporting Agents and Agent Environments

[symbol] As indicated above, an important aspect of the present invention is the interaction among the various Sub-Systems. The underlying similarities among these systems make the overall system and process of the present invention widely applicable. There are, naturally, differences among the various agents. One important difference is that, among the different agents discussed herein (including humans, machines, organizations and groups), human agents are the only agent that “times out.” To the extent that the human agents are the center of the overall system and process is currently contemplated, this becomes a significant issue.

The human agent or knowledge worker “times out” when he sleeps, engages in recreation or when moving from one location to another. Until very recently, most workers, including knowledge workers, worked in only one location, thus the human agent has been disconnected from the system while engaged in other lifestyle activities (sleeping, recreation) or moving from place to place. With increased use of transportation, the amount of time spent moving from place to place has increased dramatically. Thus, there have been attempts to allow human agents to connect to the system from remote locations. Portable phones, portable pagers and portable computers are examples of such efforts to keep human agents connected. Nonetheless, these systems are, without question, less than perfect in keeping human agents connected with the system.

The system and method for transporting agents and agent environments as an integrated experience is not limited the transport of human agents. To the contrary, the transportation Sub-System of the present invention is scaleable both upward and downward in size to address analogous transportation problems in connection with other forms of agents. Specifically, the system of providing an agent builder, feedback and transportation can be used in the development of “learning systems” and other forms of intelligent agents. An example of a known automated agent system is described in U.S. Pat. No. 5,748,954 issued to Mauldin on May 5, 1998 for a “Method for searching a queued and ranked constructed catalog of files stored on a network.” The Mauldin patent relates to known Internet search engines that use a method of constructing a catalog of files stored on a network comprised of a plurality of interconnected computers each having a plurality of files stored thereon. The method is accomplished by establishing a queue containing at least one address representative of a file stored on one of the interconnected computers, ranking each address in the queue according to the popularity of the file presented by the address, downloading the file corresponding to the address in the queue having the highest ranking, processing the downloaded file to generate certain information about the downloaded file for the catalog, adding to the queue any addresses found in the downloaded file, and determining the popularity of file represented by the addresses in the queue according to how often a file is referenced by a computer other than the computer on that the file is stored.

Because of the vast size of the Internet, specialized types of software agents, referred to as robots, wanderers, or spiders, have been crawling through the Internet and collecting information about what they find. Such robots, however, quickly caused problems. Whenever a robot gained access to a server, the server could be rendered ineffective for its normal purpose while it processed all of the requests for information generated by the robot software. As a result of numerous complaints, guidelines have been developed in that robots perform a search in a manner that avoids a particular server from being seized by the robot. However, such searches often result in particularly relevant files being passed over in favor of much less relevant files.

A second problem is encountered in dealing with the massive amount of information that is uncovered by the robot. Some form of data selection and/or compression is needed to reduce the amount of data retained in the catalog while at the same time maintaining sufficient data to enable the user to make an intelligent choice about the files to be visited. Thus, the need exists for a software robot that can intelligently search through the files of the Internet and for a mechanism for processing the located files for presentation to an end user in a meaningful manner.

Subsystem 5—Exchanging a Value and Objects that Serve as a Medium of Exchange or a Measure of Value

It has long been recognized that direct exchange of items of economic value (e.g., barter) is not always efficient. Thus, there have historically been objects that serve as a measure of value and a system and method for exchanging such objects on a macro economic scale. The essential ingredients of any economic system or model include the medium of exchange and measure of value as well as the system and method of exchange as well as some system for verifying ownership, enforcing ownership rights and monitoring current value.

All known systems have drawbacks. For example, current systems tend to value those objects that are tangible and easily transferable. But, objects that are tangible and easily transferable are not the only things that have value, nor are they necessarily the most valuable objects. Thus, there remains a need for an improved system and method for exchanging a value and objects that serve as a medium of exchange or a measure of value. In addition, present forms of money can be easily manipulated causing, among other things, critical information in the system to be lost or obscured. If the change in the cost of a good is the result of an increase of decrease of its value that is one thing. If it is the result of a change in value of the medium of exchange itself by arbitrary means (printing more money for example)—and this medium is the sole method of exchange—then feedback to the seller and buyer is compromised and a dynamic is introduced into the exchange that is not connected to the intrinsic value of the exchange itself.

This is why governments spend so much time attempting to regulated their currency. What is not operational in the present economy is a system of exchange that is inherently complex enough, and self regulating, to match the true variety of the market place.

In other words, the facilitator of exchange is becoming the limiter of possible exchanges while more and more of potential economy is “lost” due to the inadequacy of the medium. This is no different than trying to describe a complex object without the cognitive and language tools to do it. The object cannot be “seen” or manipulated to its full potential. Potential transactions are lost.

Existing forms of currency cannot learn, they are not “smart” they do not adapt. Existing forms of currency cannot transact based on context sensitive and case-specific conditions. This gives rise to a plethora of financial instruments and agents that add complexity in the wrong place while arbitrarily attenuating the variety of the system (of exchange). Existing forms of currency do no “know” ownership and location—they cannot report their condition nor be related to specific objects or processes of value in the system. They cannot function as complex Agents but—as noted before—create unnecessary non-value-added ToA complexity and overhead to the present system of exchange among Agents.

Subsystem 6—Facilitating Work and Commerce Among Agents in a Knowledge Economy

[symbol] The true economic value of modern corporations does not lie in the direct assets that appear on their balance sheets, but instead in a wide range of “intangible” assets such as corporate brainpower, organizational knowledge, customer relations, ability to innovate, and employee morale knowledge worker/knowledge base, intellectual property assets, technology base/infrastructure and market position that contribute to an organizations success.

As a whole these assets have come to be referred to as “Intellectual Capital.” To provide a common understanding of the components of intellectual capital, we will group the wide range of “intangible” assets into the following broad categories: Knowledge Worker/Knowledge Base, Intellectual Property Assets, Technology Base/Infrastructure and Market Position.

Knowledge Worker Knowledge Base

Knowledge Worker/Knowledge Base refers to the collective know-how, knowledge, expertise, creative capability, leadership, entrepreneurial and managerial skills embodied by the employees of the organization. It may also include the organizational ability to respond to high stress situations. This category also encompasses corporate brainpower, organizational knowledge and ability to innovate.

Intellectual Property

Intellectual Property typically refers to the right to exclude others from things that they would otherwise be free to do. Patents, Trademark rights, Copyright, Semiconductor Topography Rights, and various Design Rights are all examples of intellectual property rights. Intellectual property rights, i.e., the right to exclude, are granted to those who discover new and useful products and processes (patents), to those who create original works involving artistic expression (copyright) and to those who are the first to use a particular name or mark as an indicator of the source or origin of a particular type of goods (trademark). In addition, it is possible to exclude ones employees (and certain persons that have had contact with ones organization) from using know-how and other valuable business information in competition, if one takes steps to protect such assets including know how (by, for example, entering into non-compete agreements with employees). The value of these assets obviously are directly tied to the value of the asset protected.

Technology Base/Infrastructure Assets

Technology Base/Infrastructure assets are those technologies, methodologies and processes that enable the organization to function. Examples include methodologies for assessing risk, methods of managing a sales force, databases of information on the market or customers, communication systems such as e-mail and teleconferencing systems. Basically, the elements that make up the way the organization works.

Market Position (Increasing Returns)

Being a market leader either by having a product that is the industry standard or by offering exceptional customer service has a demonstrable value. Market position may affect the potential an organization. Various proposals have been put forth for measuring ones market position (not just market share). Examples include repeat business percentage, value associated with goodwill such as branding, market dominance due to the market strategy, including positioning strategies that have commercial value. Customer relations, employee morale and market position are all closely related within this category.

Together the assets grouped in these broad categories make up what has come to be referred to as the Intellectual Capital ToA of an organization. Yet another consequence of the shift to an information based society is the recognition that Intellectual Capital, however one defines it, will be critically important to all types of organizations. Though Intellectual Capital has only recently received attention, some forms of Intellectual Capital, such as “know-how,” have always been critically important to organizations. Even a traditional resource and equipment dependent organization like a coal mine relies to a considerable extent on the “know-how” of its workers. Similarly, throughout industry the value of a production line, chemical plant or other means of production is how it works, not the metal and fasteners. Thus, even in a manufacturing society intellectual capital is hidden within virtually all organizations. But, in the past, intellectual capital has been overshadowed by more tangible and scarce assets such as plant, equipment and access to limited resources: the essential requirements for manufacturing society businesses. Nonetheless, to produce a product organizations have traditionally had to have “hard assets”—land, factories resources that were all limited in availability i.e., scarce. Thus, wealth depended on scarcity.

The difference in today's economy is that Intellectual Capital is playing a bigger, perhaps paramount role, in the economy. The creation of wealth no longer depends on scarcity. The economic shift that we are currently witnessing may, therefore, be even more fundamental than currently understood: a shift from a resource based (scarce) economy to a knowledge based (abundant) economy. This, however, requires a definition of knowledge that can be made operational and a set of augmentation tools that can integrate people, events, databases, into mind-like organisms that have memory ToA.

For whatever reason, it is increasingly apparent that Intellectual Capital can no longer be ignored. To date, most energy has been devoted to a search for ways to identify and quantify hidden intellectual capital assets which occur or are found to exist in “successful” organizations, because it is recognized that the global economy is becoming increasingly distorted for want of an effective way to identify and measure these assets. Little attention is given to the creation, nurturing and management of intellectual capital in a systematic way. Lost in the obsession with quantifying what already exists is the fundamental question of how Intellectual Capital is created?

The conventional view is that intellectual capital is something found to exist or something that evolves or occurs spontaneously in successful organizations. Thus, the current discussion focuses on issues such as how to protect intellectual capital, how to show it on balance sheets etc. There is currently little if any attention given to how to create intellectual capital. Is intellectual capital really something that just happens or is there a systematic approach to creating intellectual capital in a way that enhances its value and protectability and therefore brings greater wealth to the organization.

### SUMMARY OF THE INVENTION

[symbol] The present Invention broadly relates to a System and Method for addressing the opportunities, paradoxes and problems associated with the Knowledge/Network Economy, and the transition to it. The System and Method of the present Invention create a unified experience of work that scales from individual thought processes to the building and using of a global system of commerce.

The System and Method of the present Invention integrate, into a single method, a myriad of now un-integrated tools and processes that are conducted across contradictory and non-collaborative environments. The System and Method of the present Invention provides a way-of-working that unifies and facilitates the value of AGENTS of all kinds: Human, machine, environmental and a wide array of tools, infrastructure elements and methods of information storage and commerce.

The scope of this Invention relates to the facilitation and augmentation ToA of physical, mental and virtual Agents, on multiple levels of recursion, ranging from neural nets, bits of computer code, to human thoughts, humans, tools, tool kits, environments, organizations, networks and organizations of networks of a global scale.

It is a basis of this Invention that all things (and “no”-things) can be described and treated in the language of Object-Oriented “code” that establishes a family of relationships and rules that govern their interactions as Agents ToA. Further, that complex, emergent ToA “life-like” systems involve the interaction of multiple Agents through multiple iterations and on multiple levels of recursion; that complex behavior emerges as the consequence of iteration, recursion, feedback, critical mass and the specific “genetic code” (rules, algorithms and physical constraints) that govern the interactions.

Complex behavior of complex systems is not predictable nor controllable in the common sense of these words. This gives rise to many problems in the realm of Human action in large-scale creative relationships and economies. Prior to the present Invention, there has been no method and system for describing, creating and acting upon Agents in such a way that desired results can be accomplished in a reliable manner without destroying the phenomena of “group genius” (Synergy) and emergence thus degrading the result to a simple-solution that lacks adequate requisite variety ToA with the situation in focus.

In other words, the limits of the available methods themselves, set the scope of the resulting “solution-sets” which, as a consequence, are increasingly becoming categorically and systemically nonviable. If all you have is a hammer, every attachment solution becomes a nail.

As Humans struggle with the emerging ToA complexity ToA, time compression ToA, the global nature and virtual ToA character of the so called “Knowledge/Network Economy,” the intrinsic limits of applying essentially linear, sequential, “simple” methods to ever more complex situations creates conditions [symbol] that are increasingly unstable and dangerous.

The pattern of this situation is ubiquitous. For example, often the extreme movements of financial markets are related more to technical adjustments in the monetary system and to public opinion (based on a single public statement) rather than being an accurate reflection of the true status and health of the economy or any component of it. To have a single “Agent” type—such as the dollar—serving as a single feedback loop of such a complex system is poor systems engineering.

Alternative Agent-scripts will be necessary to satisfy the Requisite Variety Rule RS and to provide vitality and stability in a truly global economy. There are myriad conditions that have to be understood, organized and acted upon to succeed in the realms covered by this invention; however—prior to this invention—there existed no unifying language, system and method of work to do so.

On the scale of human work processes, environments and tooling rL5 which facilitate creativity, as one example, many different languages are employed to “describe” phenomena and direct action. This “Tower of Babel” exists among the fields related to these realms—on the level of recursion related to humans—and, almost totally fails to describe, recognize and provide necessary structure “below” (neural nets, computer codes, tool kits) and “above” (environments, systems, organizations, networks, ecologies) thus making unified, systemic action impossible.

This web of phenomena is seen and treated as made up of different, unrelated and often contradictory elements (the perceived conflict between human economies and natural ecology, as example). This causes immense confusion, leads to poor utilization of resources and drives emergent behavior of increasing instability in complex systems such as human collaboration, large organizations, global networks and economies.

It is a significant insight of the present invention that a System and Method is required to “see” and treat (act upon) a broad bandwidth of this phenomena in an unified way that:

1. Provides a language (Descriptive, Technical, Pattern Language, Modeling Language, Algorithm, Deep Language) that describes the necessary phenomena, from the levels of neural nets to global economies, as essentially similar and reoccurring, rule based processes that can be treated in consistent, concurrent engineering terms (in other words, the similarities between the complex phenomena can be described and employed);

2. Provides the ability to create environments (made up of processes, environments and tools)—which can be also treated as Agents—so that Agents (on the levels of recursion from computer code to networks) can be housed, augmented, facilitated and “acted upon” in such a way as to systematically promote interaction, collaboration, synergy, leading to desired emergent behavior;

3. Provides the processes and rules of interaction so that the proper facilitation of interaction among Agents (of many kinds) is accomplished; so that collaborative environments for these Agents are created; so that tools and a system of tools necessary for Agent interaction and synergy is provided; so that the transportation of Agents (without “down time”) and allowing sophisticated interactions (in transit and “parking” and upon “arrival”) is made possible; so that Agents can create and trade value (and form custom economies), and so that, a system and method of work and commerce is made consistent with the realities and conditions of an emergent, global Knowledge/Network Economy;

4. Provides the net result of Human collaboration and “group genius” (with orders of magnitude greater productivity and reduction of time and effort—therefore cost) able to remain requisite with the complexity—that humans themselves are creating—while being able to better integrate human actions with other natural phenomena.

An insight of the present Invention is that “structure wins” and that the factors limiting the present economy are intrinsic, structural and technical. It is not simply a matter of human imagination, level of effort or good will—working harder will not improve things, it may make them worse.

To appropriately effect a complex system one must act upon the system as a system. To do this the Law of Requisite Variety (Asby, Beer) must be met. Existing processes, tools and environments do not allow this. Many aspects of the present system-in-place are contrary to the precepts and necessary conditions for the emergence of a true Knowledge/Network Economy. At the simplest level, there is not an adequate working definition of what a Knowledge Economy is.

The complexity of presently forming and future Human social systems, technologies and economies is such that they cannot, in principle, be analyzed, understood and directed. A whole new strategy of human work has to be devised. A whole new tool-kit has to be developed to implement the strategy. A new language has to be created to identify, “see,” and act with efficacy.

This is a “technical” problem and the languages, methods and tools of the present economy, as expressed in business, economics, politics and social theory cannot address the necessary levels of “action” that are required. The technical system of communication, banking and legal structures further impede growth and transition. The Industrial Economy cannot evolve into a Knowledge Economy—there are too many systems-in-place that cannot be removed without causing premature failure of the existing order. This would have disastrous results.

However, the emerging elements of the new economy are driving unprecedented growth and complexity that can “blow up” the present systems ability to respond.

Many (would be) “solutions” actually increase complexity further, thus, increasing the rate of decline of the system that was (to be) “fixed.” This is the result of too many, misplaced positive feedback loops ToA built into many key elements of the system. A new system has to be put in place that can exist in parallel with the old, augmenting the Industrial Economy, and replacing it over time.

Prior to this Invention, there is no known method (or known attempt to make a method) that explicitly addresses these issues.

The existing “economy” exists on multiple levels of recursion. It is no just “out there” in a contextual, abstract sense. As one simple example, it is an embedded language and set of constraints in the memory of a group designing a new product.

Any robust process has to allow “Graceful Failure” ToA. The present invention, therefore, composes a whole system that can emerge, incrementally, augment the existing order but, ultimately, create a system with orders of magnitude more flexibility and capability of processing complexity. The interaction and integration of the Subsystems described herein is a particularly significant aspect of the present invention. For example, a process on one level of a Subsystem can turn out to be a specialized process of what is another Subsystem. Moreover, a step in a process of one Subsystem can turn out to be the same step in the process of another Subsystem. This, of course, demonstrates the principles of Recursion and Iteration. In a broader sense, the interaction and integration of the Subsystems and the recursive and iterative aspects of the System and Subsystems relate to the issue of intelligence (ToA) itself.

The system and its Subsystems are a kit of “tools” or “components” required to making networks and “non-living” systems “intelligent.” In this sense, the present invention is a system that contains processes that are related to the construction of any “thinking” system and that are likely to emerge on the level of a PC or in the network itself. An example of this is that an Agent on the level of an JAVA Applet is seen to be no different (other than capacity and rule-set) than a human Agent in a DesignShop or a KnOwhere Store (as an) Agent in a Network (itself an Agent).

All of these Agents act by rules and can be facilitated, for example, as described in Subsystem 1 of the present Invention pertaining to facilitation of Agents. The present inventors have found that it is the similarities among these Agents that are critically important. All these exhibit many of the same behaviors as a mind/brain neural Agent as described by Minsky. In contrast, differences are species specific and, thus, less relevant to the overall system and process of the present Invention. This vantage point, of similarities among vastly “different” Agents, then offers a new perspective for considering the question of what makes a complex system work including what is “intelligence” or “life.”

Iteration, Recursion and “Critical Mass” and “Entrainment” ToA and Feedback may well form the principal Agency (architecture) of what we commonly refer to as intelligence and self awareness. (See: Lilly and Janes).

Naturally, it takes the materials of a real species to make a living thing and, naturally, these materials will interact according to their own rules—but this is immaterial to what makes life. “Life” can be breathed into anything if certain aspects and patterns exist. Thus, in addition to iteration and recursion, critical mass and entrainment, the processes, tools and environments—as a systemic approach—establish foundations for truly intelligent systems that are, at least life-like—it not capable of evolving into real living systems (Gaia Hypothesis—Lovelock).

In particular, the System of the present Invention includes a plurality of real Agents—each real Agent having a plurality of characteristics. Agents are used in the sense previously defined. The System further includes means for creating virtual Agents to represent real Agents in the system, each of the Agents containing data corresponding to some characteristic of the real Agent represented. This means can be a computer capable of copying computer code to replicate another Agent or biochemical replicators or humans creating copies of Agents. Humans, teams, groups and organizations can create models (Agents).

The System further includes means for allowing at least some of the Agents to control the degree to which data corresponding to characteristics is revealed to other Agents. Humans and agents at higher levels of recursion (teams, groups organizations etc.) plainly have this capability and computers can be programmed to create software Agents (e.g., objects or applets) that reveal more or less data to other Agents. This feature can also be achieved through known biochemical techniques.

The system further includes means for allowing Agents to control other Agents, including themselves. Humans and other Agents operating at higher levels of recursion typically can control themselves and Agents at lower levels of recursion, including tools. Control in this context is used in its cybernetic definition. Human agents and agents operating at higher levels of recursion can, but do not necessarily have control, over Agents at their own level of recursion. Computers can be used to create software Agents (e.g., objects or applets) that control other software objects. The system further includes means for at least some of the virtual Agents having an access/use characteristic that allows access or use only to agents having access privilege corresponding to the Agent. Computers can be used to create software Agents (e.g., objects or applets) that have an access/use characteristic. There are also known biochemical techniques for controlling access.

At the human level and higher levels of recursion, there are numerous ways of controlling access, including, without limitation, password protection, locks and biometrics tools. The system further includes means for allowing the Agents to posses access or use privileges with respect to access or use of other Agents. Computers can assign or grant privileges to software Agents (e.g., objects or applets). There are also known biochemical techniques for granting access to certain Agents, but not others. At the human level and higher levels of recursion, there are numerous ways of gaining access, including, without limitation, keys passwords, locks and biometrics characteristics.

The system also includes means for allowing Agents to control what is revealed by those Agents that they control or interact with. Computers can limit the degree to which software agents (e.g., objects or applets) communicate with one another. There are also known biochemical techniques for determining certain characteristics of other Agents, but not others. At the human level and higher levels of recursion, there are numerous ways of limiting disclosure.

The system also includes means for allowing Agents to modify the Agents that they control. This means can be a computer capable of altering computer code to modify another agent or biochemical replicators or humans creating copies of Agents. Humans, teams, groups and organizations can modify models and lower level Agents and some Agents at or above their own level of recursion. The system also includes means for allowing Agents to replicate other Agents to the extent the characteristics of the other Agents are revealed. Again, this means can be a computer capable of copying computer code to replicate another Agent or biochemical replicators or humans creating copies of Agents.

Humans, teams, groups and organizations can create models and other Agents through copying what they observe. The system also includes means for measuring actual performance of Agents. Any known measurement means can be used. The measurement may be objective, e.g., a quantity or measured value or the measurement may be subjective, e.g., “good” or “bad.”

The system also includes means for inputting expected performance of Agents. The means for inputting may be a human to computer data interface, communication between software objects, biochemical communication, a statement of goals and objectives. The system also includes means for comparing actual performance of Agents to expected performance of Agents The comparison may be objective, e.g., a difference between a desired and actual quantity or measured value or the comparison may be subjective, e.g., “goals met” or “objectives achieved.”

The system also includes means for modifying Agents based on the difference between actual performance of Agents and expected performance of Agents. Again, this means can be a computer capable of copying computer code to modify another agent or biochemical agents or humans altering of Agents. Humans, teams, groups and organizations can modify models and other Agents through altering the composition of the Agent components, e.g., the members of a steam or the objects used in an “electronic” environment. The system also includes means for allowing communication between Agents limited to what the Agents reveal about themselves. There are myriad forms of Agent communication from direct human-to-human communication to biochemical reaction to electronic communication to communication through networked computers. Any known means of communication may be used.

The system also includes means for determining the location of Agents within the system. Again, any known means may be used. Computers can track and keep records of the location of objects in the system or software objects can be programmed to report their own location. With human agents and tools, GPS is an effective way of communicating an agents location to an electronic Agent. Any of the senses smell, sound, visual touch can be used to determine location, however.

The system also includes means for determining the health, status or condition of Agents within the system. Any known means may be used for this purpose. At lower levels of recursion direct measurement is possible with tools or systems. At higher levels of recursion health, status or condition can be sensed or monitored electronically or determined through inspection by other Agents. The system also includes means for determining the value that other Agents places on access, control, use or communication of another Agent and report. The means employed can be any form of market (live or virtual), an auction, an electronic or textual reference table, e.g., “the Blue Book,” a physical characteristic, e.g., “attraction” or actuarial tables and statistical analyses.

The present Invention also contemplates a variety of methods for optimizing interaction among Agents that include various combinations of the following steps:

1. Creating virtual Agents to represent real Agents in the system, each of the Agents containing data corresponding to some physical characteristic of the real Agent represented; at least some of the Agents can control the degree to which data corresponding to physical characteristics is revealed to other Agents;

2. Allowing Agents to control other Agents, including themselves; at least some of the virtual Agents having an access/use characteristic that allows access or use only to Agents having access privilege corresponding to the Agent; allowing the Agents to posses access or use privileges with respect to access or use of other Agents; allowing Agents to control what is revealed by those Agents that they control; allowing Agents to modify the Agents that they control;

3. Allowing Agents to replicate other Agents to the extent the characteristics of the other Agents are revealed; measuring actual performance of Agents; inputting expected performance of Agents; comparing actual performance of Agents to expected performance of Agents; modifying Agents based on the difference between Actual performance of Agents and expected performance of Agents;

4. Allowing communication between Agents limited to what the Agents reveal about themselves; determining the location of Agents within the system; determining the health, status or condition of Agents within the system; determining the value that other Agents places on access, control, use or communication of another Agent and report.

For ease of understanding, the system of the present invention will be described as including six discrete Sub-Systems. The six Sub-Systems of the present invention are linked, connected and integrated in myriad ways at many levels of recursion. The six Sub-Systems of the present invention may be summarized as follows:

Subsystem 1—System and Method for Facilitating Interaction Among Agents—Promoting Feedback, Learning and Emergent Group Genius in a Radically Compressed Time Period

The system and method for facilitating communication and other interaction among Agents (humans, machines, groups, organizations and combinations thereof) provides feedback, learning and self-adjustment among the individual agents thereby creating an environment for interaction (consisting of environment, tools and processes) that facilitates emergent group genius in a radically compressed time period.

The experiments and demonstrations that the present inventors have undertaken have demonstrated that the interrelationship between environment, process and tools is, as suspected, nonlinear and that it is possible to obtain synergistic effects by simultaneously addressing these elements to create an environment [symbol] that fosters Group Genius (i.e., a synergistic outcome that is not predictable by the behavior of the parts).

In particular, the inventors past experience has confirmed the usefulness and demonstrated the possibility of the system and process for facilitating communication and other interaction among Agents (humans, machines, groups, organizations and combinations thereof, documents, software, hardware, and computers) so as to provide feedback, learning and self-adjustment among the individual agents thereby creating an environment for interaction (consisting of environment, tools and processes) that facilitates emergent group genius in a radically compressed time period.

Thus, where the experiments and demonstrations conducted to date (which are also described in the Appendix hereto, which is incorporated herein by reference) have empirically shown that certain elements of the invention can be applied by highly trained individuals to discrete environments, there remains a need for an automated, widely applicable and easily scaleable system and method for applying the inventors insights.

The present invention has been developed through the process, demonstrations and refinement described previously. Specifically, the present inventors have developed an integrated process that is self-adjusting, provides feedback, and is emergent. Moreover, by demonstrating the scalability and applicability of this process in a variety of situations, the inventors have demonstrated that this process can be applied to a wide variety of applications involving the interaction of Agents (e.g., people, computers, groups, organizations).

It is an objective of the present invention to use the inventors insights and the empirical evidence and experience gained through the experiments and demonstrations described above to develop a system and method which, among other things, facilitates and automates application of the invention to specific environments and widely applicable embodiments.

In general, the system and process of the present invention address environments [symbol] , processes [symbol] and tools [symbol] in a way that creates an improved environment for group interaction. At the highest level, these areas are each addressed through description, explanation and specific physical examples. At a deeper level, the elements are addressed through high-level manuals written in a language that can be understood by the Agents. At a still deeper level, the essential concepts involved can be described in models and/or glyphs. The glyphs are original artistic expressions of concepts relating to group dynamics, learning, feedback and control in complex systems. Collectively, the glyphs, when used in connection with a grammar system, constitute a separate language somewhat analogous to a fourth-generation language. At a still deeper level, the present invention makes use of a series of rules or algorithms that effect an environment, process and tools.

As mentioned, the inventors have developed a language and grammar system to describe some of the concepts underlying the System and Method of the present Invention. This language and grammar are reflective of elements of tools and other aspects of the invention and are thus critical to a full understanding of the System and Method. To this end, the following brief definitions are set forth (further elaboration and explanation can be found in the detailed description)

Ten Step Knowledge Work Process Model (Table M-12): The engine for processing information from events ToA through a knowledge base ToA, into distribution, into design ToA, and on to subsequent events.

Scan-Focus-Act Model (Table M-7): A basic representation of the creative process in three stages (plus a feedback element). Each of these stages are not “steps” In the linear and sequential sense, but are “modes of operation” from which Agents (of all kinds) are viewed and acted upon.

Business of Enterprise Model (Table M-9): The network-based architecture for linking the functions of production, investment, consumption and management in the Knowledge-based enterprise. This is referred to as a ValueWeb ToA.

Stages of an Enterprise Model (Table M-11): The Lifecycle of any enterprise including special situations such as overshoot and collapse, turn-around, the entrepreneurial button. An “enterprise” can be an idea, an Agent of any kind, a nation, a meme, an economy, and so on.

5 Es of Education Model (Table M-10): The necessary and sufficient components of a integrated educational experience. These components have to exist in real-time and at appropriate scale and mass.

Vantage Points Model (Table M-2): Seven shells of context from philosophy to task that must be in place for enterprises to maintain homeostasis.

7—Domains Model (Table M-3): The seven areas that are managed in every enterprise and every activity of the enterprise. When managed properly they ensure corporate health and allow Knowledge-based organizations to grow and profit.

Seven Stages of the Creative Process Model (Table M-8): The most complex of the creativity models developed by the present inventors, this model explains how problems are created and then solved in a process that is recursive, fractal, cyclic and nonlinear in character.

S'poze Model (Table M-4): The S'poze model holds the secret for allowing systems to evolve in rapidly changing environments and yet maintain their own homeostasis and identity. Enterprises use S'poze to innovate without having to grab on to every new idea that passes by.

Appropriate Response Model (Table M-5): Every stage of the Creative Process involves producing a result. Superior results can be obtained by filtering or testing competing designs through the six elements of this model.

Three Cat Model (Table M-1): We all build mental concepts of how things work by observing reality. But to cement the learning, we must build models that exemplify our concept and test these models against what we observe to confirm our understanding.

Design Build Use Model (Table M-6): The unfolding of a project or creation over time is an interactive, iterative game between the designer, builder and user. However, when we make the process linear, discrete and focused on being “finished”, the outcome is a nonliving one.

Creating the Problem Model (Table M-15): This model explores the relationship between vision and condition that creates the “problem.” It continues with a description of the tug and pull of creative tension that brings the vision and conditions together to create a new condition.

The Learning Path Model (Table M-17): Five Points of Mastery: Instead of the three traditional roles of education (student, teacher, administrator), we present five: the learner, the sponsor, the expert, the facilitator, and the steward. In high performance environments each individual moves from role to role sometimes in rapid succession and sometimes in cycles that span years.

The Four Step Recreative Process Model (Table M-13): The creative process has many facets and can be understood and practiced from many different vantage points. The Four Step model emphasizes the activity of recreation [symbol] between each stage of the creative process and shows this recreation as a wave and a particle phenomenon linear and non-linear approaches.

Each of these essential concepts can be described in models and/or glyphs. The glyphs are original artistic expressions of concepts relating to group dynamics and the behaviors of complex systems. Collectively, the glyphs, when used in connection with a grammar system, constitute a separate language somewhat analogous to a fourth-generation language. The use of glyphs in the modeling language has the intent [symbol] to convey some additional, deeper, more connected in memory sense of each component of a model and its application to a broad number of situations. This is done by researching the etymology of the word and searching for symbols that support certain meanings that we wish to emphasize (Jung and Campbell).

For example, the 5th E of Education is EXPLORE. The root of the word means “to search out; cry out aloud.” The symbol chosen to represent EXPLORE is an open fan. The fan represents imagination, air and wind. You can envision the fan as a sail of the mind with the human spirit filling it with wind, and the imagination crying aloud for new vistas.

These aspects add a measure of play, fun and interest to the modeling language, therefore adding to its utility. In sum, the present invention provides a system and method that is self-addressing and self-correcting and results in an emergent system, that can be applied to a large variety of situations involving interaction between Agents.

In this way, the present invention facilitates interaction between Agents to promote feedback and self-adjustment to obtain synergy. The individual experiments and simulations that applicants have conducted over the past two decades have demonstrated that the concept works in a wide variety of contexts and is not restricted or limited to only a single environment. Based on these experiments, therefore, it is reasonable to assume that the present invention can be applied to a wide variety of enterprises to promote group genius and synergy.

To achieve the stated and other objects of the present invention, as embodied and described below, the invention includes a method for fostering creativity comprising the steps of identifying a number of Agents and selecting a subset of these agents based on certain determined criteria and other methods. An environment for creative interaction is prepared, and the Agents selected are placed within this environment. Work is then performed on these agents in order to develop a result. The result is then evaluated, which produces a first new Agent. This first new Agent produced is then tested. Further, the first new Agent may be added as an Agent to the existing environment, added as an element of the environment, or added as additional work to be performed in the environment by the Agents, and the process of the present invention is then repeated with this new element to produce a second new agent. In addition, the first new Agent may be added to an external environment, wherein the first new Agent is altered and may return or produce a third new Agent for return, in which case, the altered first new Agent or the third new Agent is added as an Agent to the existing environment, added as an element of the environment, or added as additional work to be performed in the environment by the Agents, and the process of the present invention is then repeated with this new element to produce another new Agent. The method is consistently repeated until a pattern appears. This pattern can be readily identified and discussed using the specific language developed by the present inventors.

Subsystem 2—System and Method for Optimizing Agent Pattern Language Values in Collaborative Environments

The system and method for optimizing a collaborative work space both in terms of human, (i.e., pragmatic and economic) values and architectural pattern language values provides optimum collaborative work spaces that offer high density, total media integration, greater individual control, larger work spaces, adjustability, reconfigurability and improved pattern language values. The system also includes to a system for design and facility management of such collaborative work spaces and for furniture components for use therein.

The system and method for optimizing a collaborative work space is used in connection with the system and method for facilitating communication and other interaction among agents (humans, machines, groups, organizations and combinations thereof) so as to provide feedback, learning and self-adjustment among the individual agents thereby creating an environment for interaction (consisting of environment, tools and processes) that facilitates emergent group genius in a radically compressed time period.

The present invention provides a system and components for the system to make it possible to optimize the design of a collaborative work space both in terms of human, pragmatic and economic values as well as pattern language values. In part, the present invention results from the present inventors' recognition that systems constructed using linear arrangements of rectangularly-based components are a source of the problem. The variety of objectives that one would ideally like to achieve in a collaborative work space cannot be achieved through the use of known components. An array of new components is required. Thus, the present invention provides a series of components and a system for using these components in combination to achieve results that have not heretofore been obtainable.

In contrast to conventional collaborative environments that do not address the entire range of basic human requirements (they require compromise and tradeoff), there is no need to compromise with the system of the present invention. The present invention provides collaborative work spaces, high density, greater individual control, larger work spaces, adjustability and reconfigurability, addresses pattern language values and provides computer-augmented design and facility management.

The present invention also provides a system for facilitating design and management of collaborative work spaces. The system is based on the recognition that a collaborative work environment is a collection of objects and that the system has rules. Thus, the system of the present invention knows the cost of certain objects, knows the architectural rules, knows the architectural values and knows the rules of pattern language. This is achieved through the use of values stored in memory tables or the like. Moreover, the system can adjust the relative values of things such as architectural values based on a customer's or client's objectives. The system includes means, preferably electronic display monitors, for displaying environmental layout and means, such as icons, for graphically representing objects within the environment. The user can “pick up” and place the objects in desired locations within the environment. The system knows the cost of the objects selected, the architectural rules concerning its placement, the architectural values associated with particular objects in the rules of pattern language. In addition, the system can provide the total cost as well as architectural values score or in the pattern language score, on a real time basis.

In accordance with a further embodiment of the invention, the system of the present invention can be used to manage the environment. In particular, the system can be designed so that the individual system knows what objects are in the environment and where those objects are (how the environment is configured). This can be achieved in a variety of ways such as by placing chips in each of the objects or placing sensors within the environment. In this way, the system can monitor an environment once in place and send a warning, if, for example, an object is moved into a place that is architecturally unacceptable (e.g., an object is moved to place where it blocks the door). Thus, in summary, the system facilitates both design and placement of furniture in office, home and other environments and also monitors the environment once in place. This is done through a system, which can be a central computer and/or plurality of individual objects networked, so long as the system knows what the objects are and what they can do, the rules applicable to the environment and the objects and where the objects are and how they are configured. Thus, the system knows its environment, knows what objects are in its environment and what the rules applicable to that environment are.

The present invention also relates to various furniture components that make it possible to optimize human and architectural pattern language values in a collaborative work environment. In general, a collaborative work environment may be thought of as including various levels of components. In connection with the component described in this application, the components may be grouped in the following levels (from lowest to highest):

| | | |
|---|---|---|
| I. | SUB-COMPONENTS: | including, for example, secretaries, file |
| | | cabinets, pigeon holes and shelves |
| II. | PIECES: | including, for example, dogs (work units), |
| | | wings, tables, kiosks |
| III. | SYSTEMS | including, for example, CubeOffice ™, |
| | | WorkPod ™, Octopus ™ (inside air |
| | | moving units/lighting) |
| IV. | WORK WALLS ™ | including, for example, fixed walls, rolling |
| | | walls, sliding walls, folding walls, and dbl. |
| | | hung walls. |
| V. | ARMATURE | including, for example, beams, trellises, |
| | | chases, path edges and bases. |

At the highest levels (aside from cities and regions themselves), the environment also includes buildings and the rooms within the buildings. The present invention, however, relates primarily to components below these as listed above. These components are described in the figures attached hereto and in the appendices hereto.

One of the principal advantages of the system of the present invention is that the components are provided (as shown in the drawings and appendices) that allow optimization of Pattern Language values. Although certain pattern language values have been used extensively in custom designs by architects such as Wright, there has to date been no way to address most of the pattern language values catalogued by Alexander in practical way with conventional off the shelf furniture, much less furniture that also addresses human values such as economic efficiency, mobility adjustability and the like. Thus, a remarkable aspect of the system of the present invention is that components allow one to address at least 100 of the 253 pattern language values catalogued by Alexander. Further information concerning these pattern language values may be gleaned from A Pattern Language by Christopher Alexander, 1977.

Another important aspect of a collaborative environment is access to information. At one level this need can be addressed by providing various printed materials throughout the work space. The furniture components of the present invention are well-suited for this purpose in that they include a variety of shelf space, work surfaces and display surfaces. The work space should, however, also include access to electronic databases including the Internet and data warehouses. To facilitate such access, the environments of the present invention preferably include display monitors throughout the space and furniture components are designed to movably support such monitors. In addition, the furniture components and armature elements are designed to conceal or guide cables and wires connected to electronic components. This collection of components and their arrangement within the environments (as shown in the drawings and appendices) are able to provide total seamless media integration within the environment. In addition, the system is highly scaleable and adaptable to new technologies that are now widely available or likely to become widely available in the next few years, including large scale electronic work walls, electronic assistants, electronic displays, real time video conferencing, intelligent agents and data warehouses. Collectively, these components provide an environment in which information can be made available as needed, i.e., “just in time information,” and remote collaboration is seamless.

Thus, the system and method of the present invention provide an ideal environment for the integration of “query tone” technology in which information flows freely as needed in a frictionless market so that decision makers can obtain all the information they need when needed from data warehouses. Specifically, the environment includes a complete range of fully integrated media sources and displays so that, for example, a knowledge worker can turn on a computer (workstation, network computer, lap top, PDA or intelligent assistant), and ask any question from any database anywhere, in the same way that a knowledge worker today can pick up a telephone, and talk to anybody anywhere. The present invention provides the overall process and environment to take full advantage of “just in time information” and integrate this information into the collaborative work space. Of course, the present invention also contemplates a software agent transportation system that would improve the ability to extract relevant data from databases.

Thus, the present invention provides several functional advantages over known systems. To begin with, the present invention makes it possible to design practical layouts of components that cannot be provided using a known systems based on rectangular components. The system of the present invention is useful in facilitating the interaction among agents, i.e., creating an environment for facilitating the interaction among agents including humans and machines. Moreover, the present invention makes it possible, for the first time to address pattern language values using standard components. In the past, known standardized systems have not been particularly useful in addressing pattern language values.

Subsystem 3—System and Method for Integrating/Optimizing Technical Systems to Promote Agent Interaction

This system is, at a high level, a knowledge worker tool kit module of the full system. The overall system not only includes the tool kit, but agent functions, process filters, simulators and data or knowledge warehouses.

According to the present invention, a user builds the agents and then, in accordance with the overall process of the present invention tests the agent, uses the agent, sets a term for the agent and stores the experience. Using principles of iteration and recursion, together with feedback and critical mass, the system becomes self-adapting and self-improving.

Of course, testing the agent requires simulation. The process filters described are required to replicate a scan build process. In particular, when working with human agents, it is possible to engage in a very different level of consciousness that is often referred to as “brainstorming.” Although brainstorming is often referred to as just another kind of thought process, it is in fact an entirely different level of consciousness in which the mind is forming new connections without the constraint of logic. To replicate this process in a machine, it is necessary to use a randomizer that is iterative and self-adapting. At the basic level, the randomizer is able to make random connections of relevant or related pieces of data and then test those random connections to see what type of results they provide. Machines capable of this type of randomizer activity include a so-called “Zwicky box,” and other devices that can generate morphological forced connections. The Zwicky Box is named after Fritz Zwicky, a designer who invented the morphological forced connection process as a way of searching for connections that no “logical” mind would make.

Another significant module of the system and method for integrating/optimizing technical systems for promoting agent interaction is the pattern recognizer. The pattern recognizer is a system that analyzes data and looks for patterns in the data. It provides information concerning these patterns as a possible route for gaining feedback. For example, the pattern recognizer may analyze the user's input into the system (textual, audio or visual) and compare these various inputs to see if a pattern can be recognized. If a pattern is recognized, the system can suggest additional inputs that have a similar pattern. The user/system interface may be in the form of the system posing a simple question to the user, “Is this what you are looking for?” or the interface may be automatic or transparent to the user. In this way, the user's acceptance, acquiescence or rejection of the suggestion derived from pattern recognition will allow the system to learn from feedback. The pattern recognizer thus facilitates feedback into the system so that even a generic simple agent can quickly “teach itself” to be a customized agent for the particular user. The agents thus teach themselves through application of the system and method of the present invention. The pattern recognition strategies employed may be kinesthetic, visual, verbal and combinations thereof. Further, “contextual” information may be used such as kind, location, size, scope or other attributes.

In this sense, the present invention provides a unified process and system for approaching the wide variety of problems associated with the transformation to a knowledge economy. The system applies a consistent logical sequence to the variety of problems and relies to a large extent on recursion, iteration, critical mass and feedback to allow solutions to emerge even when the underlying rationale for why the solution works may not be fully understood. The basic process follows the three cat model approach of designing, building and testing through simulation and feeding back the results of the simulation to the design.

A central element of the success of this system is that the simulator gets smarter as it goes along. Thus, the simulator has a learning mode. The simulator generates results that are stored in the form of a data or knowledge warehouse, which provides input for future simulations.

It is important to note that the same process applies to all Sub-Systems of the present invention. In this sense, the present invention provides a formal system of a concurrent engineering that is applicable to a wide variety of systems.

Central to the present invention is the iterative building of agents as solutions to complex problems. According to the present invention, the agent (solution) is designed with minimum information and then built. The agent is allowed to act within its environment, and able to provide information concerning its results so that this information can be used in refining the design. Thus, agents evolve or emerge through recursion and iteration.

This is fundamentally different from the approach taken today in trying to design complex solutions using more information from data warehouses in the initial design. If too much information is introduced in the design of the initial agent, then the agent is so constrained that it cannot evolve or emerge through actual experience. It is in this sense that the present invention provides an IC factory, in iterative recursive engine of creation. Thus, the present invention is based on the fundamental recognition that knowledge is created only in interaction with reality and the experience gained therefrom. To create a “engine of creation”, therefore, it is necessary to create a system that allows both interaction with an environment (either actual or simulated) and learning from the experience of the interaction. With these two fundamental characteristics, the ability to improve the agent or the design is limited only by the ability to iterate successive generations of the design through the simulation and learning process. Thus, recursion, interaction and feedback are the key elements to this interactive process.

The present invention provides a new framework, processes and algorithms for the performance of knowledge-based work. Future, this invention is based on 20 years of experimentation with Human Agents in the production of real work producing economic value. In these experiments (supported by DesignShop, management center and NavCenter processes tools and environments) a disciplined, scaleable approach has been developed for the augmentation and facilitation of agents of all kinds. Further, the basic rules for the “manufacturing” of non-human agents have been determined by demonstration and test.

A Human Agent, in a Knowledge Economy, will have an augmentation system that consists of the following components:

A basic, integrated tool kit for drawing, writing, calculating, analyzing, accessing the Internet and other networks, scenario building, planning, project managing, scheduling, full (real time) multimedia augmentation and various custom applications.

An “Agent Builder” for the manufacture and management of a variety of virtual “intelligent” agents to perform tasks, represent existing articles of value and trade, search data bases and other virtual environments, “represent”—as an agent—the Human Agent in conducting negotiations and trades; and, build and employ other active agents as indicated in the present invention.

A simulator for testing agents and communities of agents to understand their behavior and the behavior of complex environments.

A library and system of processes and process filters for analyzing, testing. designing, engineering and the performance of the majority of (codified) professional services.

A Pattern Recognizer for recognizing patterns in textual, audio or visual inputs or data together with a means for presenting similar data as a suggestion to the user and receiving input (feedback) from the user as to the desirability of the suggestion.

Data Warehouse and Knowledge Base functions. These Data Warehouse and Knowledge Base functions will be characterized by “information about the information.” This requires employment of Processes and tools such as InfoLog™ (which assigns a unique number and keywords to information-events), SolutionBox™ (which annotates “documents” indexing their “location” on the Creative Process, Vantage Points and Design Formation Models; and, forms active links to archived “solutions”), and Confidence™ (which indicates measures of data “hardness,” completeness, comprehensiveness, etc.). It is an insight of the present invention that information about information is essential if a community-of-work (ToA) is to accomplish high performance. This functionality is necessary for “communities” of agents of all kind on all levels of recursion. Thus as an agent, or a community of agents, “experiences” these experiences become part of the agent and it's environment. Depending on protocols (agent processes) these experiences are shared with other agents. This provides memory (ToA) in the system; state¹, state², state³, state . . . ⁿ as described elsewhere.

A “Decider” (Sub-System 1).

A seamless (agent-based) interface that is context sensitive and “learns” the Human Agent's habits and desires.

The above is representational of the elements of the present invention but not exhaustive.

The system for integrating and optimizing technical systems according to the present invention is a powerful tool for supporting the transition to the knowledge economy. It can provide agents with new ways of working. It can aid in the redesign effectively and re-equipment of the workplace to operate effectively in the information age. The system for integrating and optimizing technical systems according to the present invention is a synthesis of elements of the present invention. The components are: 1—Body of Knowledge, 2—Process Facilitation, 3—Educational Programs, 4—Technical Systems, 5—Environments, 6—Project Management, and 7—Venture Management. The functioning of the system for integrating and optimizing technical systems according to the present invention depends on all the components working together. None can exist alone and have a full expression of the system. This is not to say that each component must function at the same level of sophistication. The components will, in fact, co-exist while each is at a different level of completion and sophistication. The system itself is subject to the same “rules” of creativity and evolution, as are the projects and processes it manages.

The system for integrating and optimizing technical systems according to the present invention is, in broader terms, an idea manager as well as a planning and project manager. The hub of the system is a knowledgebase designed to provide information to the user, information that is relevant to the task at hand, but that also provides gateways to further exploration of the implications of that task. The knowledgebase is designed to support the user's creative process in dealing with any topic. Further, it is designed to act as a “knowledge capture” mechanism through its interaction with the person using it.

Linked to the knowledgebase are a series of modules. The main function of these modules is to allow the user to explore the relationships between ideas about how the future might unfold and the creation of practical plans to guide actions into that future. These modules bring together three of the principal Taylor knowledge technologies: the Scenario; the Strategic Plan and its graphic manifestation, the AND MAP; and the Time and Task management system. The system for integrating and optimizing technical systems according to the present invention also provides a pathway to the corporate knowledgebase and to other application packages that support the creative process, such as word-processing, spreadsheet, graphics and computer aided design (and manufacturing).

The system will function as an expert system providing the user with artificial intelligence, as well as tools with which to pursue creative endeavors. This expert system is composed of sets of Terms of Art (ToA), Pattern Language (SS), Modeling Language (D/PT) and Algorithms (RS) found and demonstrated by the present inventors as necessary for the consistent performance of synergy between agents. It is a feature of the present invention that these “rules” can be expressed to agents of many kinds. For example, a Human agent may be given the Pattern Language (SS) of how other human agents approach the creative process and related life/work style—this may be expressed in a series of 18 to 25 “habits” of human creativity. The same rules may be applied to the building (programming) of a machine agent in the form of Algorithms (RS) or formal rules. Scalability and “cross-platform” integration is a consistent feature of the present invention. The large-scale synthesis of agent intelligence will usher in an era of creative exploration far surpassing any in humanity's experience.

The tool-kit sub-component system for integrating and optimizing technical systems according to the present invention is composed of eight major modules. At the hub of the system is the knowledgebase, the main data base of information resources. The Knowledgebase Interface is the shell that protects the data base and provides the tools to access the data directly or through applications. Outside the shell are the six “principle applications” modules of the system. They are Data Management, General Applications, Tools, Scenario, Strategic Plan and Time and Task Management Modules. Together they form an integrated environment for the creative exploration of ideas about the future. They also provide the means of programming and managing courses of action to provide the transition, for the corporation or organizations between the present and the future. Finally, the system also provides an intelligent link with the corporate past, which it builds upon by documenting corporate actions as they unfold. The system is, therefore, an historian of actions, providing the chronicle as events occur.

The knowledgebase and its interface contain the information upon which the six “applications” draw. The knowledgebase also provides the means of entering and retrieving general information to and from the system. Finally, it provides a means of exploring and creating new ideas, using the creative process, black box and other processes and models that form the basis of the System and Method of the present invention. The knowledgebase interface will link the specific work modules, called the principle applications, with the knowledgebase and application programs that reside “outside” the system for integrating and optimizing technical systems according to the present invention. It will provide the means of manipulating data so that it is compatible with the needs of the work modules and the outside applications programs.

The knowledgebase interface will link with other sub-component systems such as agentBuilder™, agentSimulator™, memoryKeeper™ and other sub-components of sub-system 3 as described herein.

Ultimately, the knowledgebase interface will manage the expert system aspects of the system for integrating and optimizing technical systems according to the present invention. For example, in a full expert system implementation, when a particular user signs on to work with a module, the system will call up specific parts of the tool kit that the user profile indicates the user prefers to use. The system might also make suggestions on investigative strategies the user might like to pursue, basing the suggestions on the user's level of expertise.

The Scenario Module will facilitate the formulation of ideas about the future. A structured investigation into the past could also be accomplished using this module. Key features will include: 1) the support of several formal methodologies such as morphological and cross-impact analysis, with which the structure of postulated events may be developed and/or analyzed, 2) the ability to access information in the knowledgebase that pertains to an event through a keyword query 3) the ability to compare different scenarios and to analyze the implications of variations between the types of events projected, and variations in the timing of those events.

The Strategic Plan Module facilitates the formulation, testing, and maintenance of broad plans of action. The AND MAP technology will be supported in PERT/CPM or decision network form. Formulation of goals and objectives as well as specific activities within the plan will be linked to scenario events that affect them. Likewise, events within a plan are linked to specific actions within the time and task management system associated with the plan. Through this linkage, the effects of a change in any one of the modules on the other modules will be recorded. Documents that support or explain the plan, or specific actions within the plan, can be retrieved from the knowledgebase. The module will support “what if” computations on a plan or group of alternative plans. The development and alteration of AND maps will be graphically and analytically supported.

The Time and Task Management Module will translate the intent of the strategic plan into a day to day scheduling of actions implementing the plan. Specific work packages will be broken out showing team membership, the responsible manager, time lines, etc. The rate of completion of various work packages and specific actions will be fed back to the strategic plan to monitor plan progress. Possession of a variety of reporting capabilities will be a key feature of both the Strategic Plan and the Time and Task Management modules.

The Tool Kit Module will contain routines that are used in common by the other work modules. For example, statistical analysis of data will be needed in each of the main work modules. When needed, it will be called from the tool kit, 90 that it will not be necessary to have a complete set of code to do statistical work resident within all three of the planning modules. Possibly some simple procedures, such as calculation of the mean and standard deviation of a set of data, will be more efficiently placed within the planning modules themselves. This is an issue to be determined in the future, however.

The planning modules, that is, the Scenario, Strategic Plan, and the Time and Task Management modules, are designed to support a complete planning process. This process can be described in simplified fashion in the following model:

1. define problems and opportunities

2. describe the problems and opportunities in systems terms

3. define goals and objectives to deal with the problems and opportunities

4. define performance specifications to implement the goals and objectives

5. define resources and constraints to accomplish the goals and objectives

6. define the plan of action

7. create work packages to implement the plan

8. create a task management system to control and track work

9. feed back changes in organizational goals and objectives and in resource or constraints to the plan and the task management system

10. feed back changes in the plan's schedule to organizational goals and objectives

Each of the above steps in the planning process is related to one of the system for integrating and optimizing technical systems according to the present invention planning modules.

The system of the present invention provides a method of user interaction with the system that allows the user to learn the system's next level of operation while using a lower level. The system of the present invention also creates various scenarios about the future. Be able to test the assumptions within the scenarios to see how reliable they are based on present knowledge and opinion. Be able to compare the probability and the impacts of various scenarios. Be able to monitor the reliability of a given scenario as events unfold.

The system of the present invention also provides a method of exploration of the knowledgebase in a way that gives the user the information s/he is looking for and makes reference to other related information not initially requested.

The system of the present invention, in all modules, provides the ability to work with text and graphic images within the same viewing plane and provides multiple window display.

The system of the present invention also provides the user with the ability to create an outline plan for each working session with the system. It should facilitate the discovery of new information by the user.

The system of the present invention also provides a record of each working session for the user to review and learn from to increase his/her efficiency.

The system of the present invention also provides extensive on-screen help and tutorials to assist the user in operating the system in an efficient and effective manner.

The system of the present invention also provides the user with a “tool kit” of methods for the exploration of the structure of knowledge in selected subject areas aimed toward generating new insights and knowledge. That is, an expert system on the exploration of knowledge.

The system of the present invention also provides the system with the ability to acquire new information from interaction with the user, and to learn the user's methods of operation, in order to assist the user in performing those methods with maximum effectiveness and efficiency.

The system of the present invention also provides the ability for agents within the system to carry on multiple conferences with each other.

The system of the present invention also an analysis of scenario events to show how events are logically connected. Develop strings of events to be inserted into a scenario.

The system of the present invention also shows the variability in the estimates of when an event will happen within a scenario

The system of the present invention also shows the combined probability of a particular chain of events happening, that is, a risk analysis of the chain of events.

The system of the present invention also correlates the scenario events to specific articles, working papers, etc. that collaborate or dispute the probability of the event occurring.

The system of the present invention also facilitates the formulation of alternative plans of action based on key events in the scenario. Creates network diagrams of these plans. Link activities within the plans to a database of the characteristics of the activities.

The system of the present invention also links key events in the scenario to elements in the strategic plan. Links the work packages in the strategic plan to elements in the time and task management system. When one related element in any module changes, the system will inform the user and/or automatically update related elements in the other modules.

The system of the present invention also creates plans in a decision network format, utilizing the unique symbols and identifying structures of the AND map.

The system of the present invention is also able to analyze a network based on time minimization, cost minimization, and optimization (trade-off between time and cost) criteria. The system of the present invention is also able to compare various plans based on any one or all of the above criteria, i.e. a goals achievement analysis across multiple plans. The system of the present invention is also able to perform “what if” analysis on a plan or plans based on:

a. minimum time with unlimited resources for a given topology.

b. minimum cost criteria

c. specific resource limitations.

d. maximum parallel tracks for network activities

The system of the present invention is also able to perform “what if” calculations on a given plan based on:

a. changes in the network topology.

b. changes in the resource allocations on the network.

The system of the present invention can provide the ability to do resource leveling.

The system of the present invention can create descriptions of the network in AND map form, Gantt Chart form, and in activity precedence tables; show the critical path activities for deterministic networks and critical path options for probabilistic networks; report slack times for each non-critical activity. Also show the reduction in slack for non-critical activities as the project progresses, so that these activities do not go critical.

The system of the present invention can create “work packages” that are given to people responsible for given major tasks and that identify the specifications of the work to be done, the time lines to be met, and the resources available to the project team. The reporting schemes for all three major modules will be hierarchical in nature. The first level will give only basic information and each succeeding level will increase the density of information about the queried activity or event.

The system of the present invention can monitor the actual time and resources required by various activities for completion, and feedback those results to an on-going activity type model. Incorporate an analysis of variance to see if the variation in performance is due to the nature of the activity or the nature of the resources: primarily people and their level of training and expertise. Create an activity by activity comparison of the time scheduled versus the actual completion time, and report any slippages in time lines.

Monitoring will be tied to the cost outlay accounting for each activity in the Plan. The time and task system will be tied to an overall project time and cost accounting system. (2) The strategic plan module parameters are very flexible in order to respond to the variety of types of plans that will be developed using it.

The system learn the user's planning style and provide appropriate information and tools to support that style. The style should also be compared with “ideal” approaches and the user be made aware of the differences in approach, and possible performance differences, between his/her style and the “ideal”.

The time and task management system provides a break out on a sub-track basis of who will do what and when. All activities within the time and task management system will be tied to a specific activity within the strategic plan.

The system of the present invention includes time and task reporting systems that are able to call up the “work package” in which are contained the associated project activities, the name of the person responsible for the project's completion, the time frame in the total project, whether the activities in the work package are on the critical path and if not what their slack is.

The system of the present invention also can: record comments and suggestions about the plan from those using the plan; analyze their comments and use the results to bring refinement to the plan.

The system of the present invention also can: create ways of allowing the “line” managers and personnel to design the ways that the time and task management categories are developed, in order to implement the project; create ways of allowing the “line” personnel to have input into the creation as well as the modification of the plan; create a flexible report generator so that information output concerning any of the modules can be customized or called from a standard template.

The system of the present invention also can: provide a project documentation module that records who gets what information, so that updates and changes to the plan can be distributed efficiently to the appropriate people.

The system of the present invention also can: create a user interface that is graphically-oriented and has a menu-command string-icon structure.

The system of the present invention also can employ a “learn as you do” user operation strategy.

The system of the present invention also can: create “fly it” expert systems for each of the main modules.

Subsystem 4—System and Method for Transporting Agents and Agent Environments as an Integrated Experience

The system and method for transporting agents and agent environments as an integrated experience of the present invention can be used to transport agents, including human agents, within separate environments that are unique to that agent in a remarkable efficient way while optimizing utilization of transportation resources. The system includes transportation modules or “eggs,” that can take many different forms. In the case of human transport, the environment can be tailored to an individual's wants, needs and desires. However, all of the “eggs” within the system should minimally be able to know where they are (in the case of human transport this can be accomplished through, for example, a GPS system or the like) and be able to report their location and status to a system for coordinating transportation. The eggs should also be able to verify the identity of their occupant. In the case of human transport, this can this could be done, for example, through biometric techniques discussed herein or passwords and keys.

Use of a system that knows the identity and location of all agents within the system affords tremendous opportunities to facilitate transportation of agents. Moreover, in accordance the system and process underlying this invention, the system is capable of receiving feedback and is thus capable of improving itself through recursion and iteration.

To fully facilitate transportation, the agents within the system must able to communicate to the overall system to indicate a desired location, i.e., where they want to go. The system has predictive capabilities that are improved over time through recursion, iteration and feedback to increasingly improve its ability to facilitate transportation. The transportation system improves the overall system in two ways. First, the transportation Sub-System provides tremendous opportunities to reduce waste in transportation. In the case of human transport, for example, consider, for example, a person going to the airport. Under current systems, the airline has no way of definitively forecasting which passengers holding reservations will actually arrive at the airport. Moreover, the current system for identifying passengers, ticketing passengers and loading passengers onto the plane only begins when the passenger arrives at the airport. Thus, passengers are told to arrive an “hour or two” before scheduled departure time. Although people have generally grown accustomed to this delay, almost all of it is a waste of time. A system that knows the identity and location of agents within the system can accurately forecast, based on their real behavior, which agents will actually arrive in time for a particular flight. In addition, processing the agents is greatly exemplified using the system. By reducing these unnecessary delays, the utilization rate or percentage use of expensive assets such as jet aircraft, could be dramatically increased, thus increasing airline profit.

The transportation system offers similar advantages in connection with other modes of transportation. One can appreciate the lack of utilization of modes of transportation by considering the number of cars that are not in use at any one time. The same applies to trucks, boats and trains. A system that is aware of the location and desired destinations of all agents within the system, allows further optimization through multi-modal transportation. In particular, based on past experience, an agent is transported in the most efficient way possible using whatever particular modes of transportation will yield fastest transport. Again, the only systems necessary are the individual environment (agent module) or egg having the ability to know its location, its occupancy, the desired destination of its occupancy and the ability to report all of these to a central system. To make the system a learning system, however, the system should have a predictive capability to predict the best routing of the agent as well as storage means for keeping track of predictive routing as well as actual results so that the system receives feedback (ToA) and can then improve itself using processes of recursion (ToA) and iteration (ToA).

Although the greatest inefficiencies in today's economy seem to be in connection with the transportation of human agents, the system described herein is readily applicable to the transportation of all forms of agents.

Thus, at one level, the system of transportation serves to generate a vastly improved efficiency and utilization of existing transportation resources. It is expected that this improved efficiency will likely result in changes in the allocation of investment in transportational resources. For example, if one is ensured of having transportation available when and where needed, ownership of transportation assets (and the burdens associated with such ownership) becomes much less desirable to individuals.

As indicated above, the specific form of the transportation module, or egg, can vary. However, it should be appreciated that certain additional efficiencies are offered, especially in the ability to use a multi-modal form of transportation, when the individual transportation module is readily adaptable to different forms of transportation.

The system and method for transporting agents and agent environments as an integrated experience of the present invention is expressly not limited to the transport of human agents. To the contrary, the transportation Sub-System of the present invention is scaleable both upward and downward in size to address analogous problems in connection with other forms of agents. Specifically, the system of providing an agent builder, feedback and transportation can be used in the development of “learning systems” and other forms of intelligent agents.

For example, as noted above, there is still a need for a software robot “agent” that can intelligently search through the files of the Internet and for a mechanism for processing the located files for presentation to an end user in a meaningful manner. Known approaches, including that disclosed in the Mauldin patent attempt to gain information through brute force sifting through files. The fundamental problems with such solutions are that they are not sufficiently scaleable to accommodate exponential growth in use and data to be searched and that the “agents” used are static and do not improve through feedback. The system and method of the present invention can be applied to develop improved “agents” for searching databases. This can be understood as an application of the transportation Sub-System of the present invention (where the “agents” are software objects transported through of a plurality of interconnected computers each having a plurality of files stored thereon) and/or an application of the facilitation Sub-System of the present invention (where the software “agents” interact with one another and the user to develop better agents). This again demonstrates the tight interaction and integration of the Sub-Systems of the present invention.

In addition, the method and system of transporting agents and agent environments as an integrated experience according to the present invention demonstrates the interaction of the entire system. In particular, the system and method are developed by developing a PatchWorks Design (tm) Diagram. In this case, the exercise is aimed at the development process of the Transportation Sub-System of the Invention itself.

The system and method for transporting agents and agent environments as an integrated experience includes various transportation modes for transporting an occupant environment. The environment may be in the form of a contained environment or “egg.” The egg itself is a complete user environment that is adaptable to a variety of modes of transportation, for example, the environment may include navigation, GPS and communication systems.

The specific mode of transportation shown can include, among other things, smart adjustable shrouds, impact protection, storage areas, an adaptive tracking system that allows the vehicle or transportation component to be used in the road, rail, air, etc., a propulsion unit and an agent environment package.

In accordance with the method of the present invention, the occupant egg is adaptable to various modes of transportation, and the transportation vehicle itself is adaptable to traditional modes of transportation.

Another aspect of this sub-system is a code protocol and language that describes the agents that make use of the system. This protocol defines the key attributes of the agent and the rules (RS) by which it interacts with other agents and agent environments. This protocol is useful in accomplishing the goal of “ship information, not mass” (SS) allowing the transportation of knowledge (ToA) and local, point-of-use manufacturing. As example, the entire materials list for a dwelling, including the configuration, mass, composition, location (in space and time), connectivity, etc., of each piece and component can be encoded into a “document” (agent) of a few “pages.” This can include the rules (agents) governing the behavior and use of each piece, component and sub-assembly of the agent dwelling, as well as, it's maintenance and operation.

This document, therefore, is an agent and each of it's sub-components is, each, an agent. After transporting, this (document) dwelling agent (and it's composition of agents) can interact with agents of various kinds (computer, human, machine, etc.) to manufacture, erect and use the dwelling in accordance to local conditions and rules (which are themselves agents of the system in focus). The learning feature of the present invention, and the rule-based nature of it, allows emergence in this process. The dwelling agent does not have to execute it's instructions in a merely “mechanistic” manner, but can interact, learn and adapt with the agents that form the environment of execution. Thus, “Mass Customization” (SS) can be accomplished with “standard” components. Of course, agents such as this dwelling agent are a commodity and can be owned and traded by other agents and, themselves, make up a part of the Knowledge Economy (ToA). Libraries of these agents will be available (the Solution Box™ system) making sophisticated solutions available to large numbers of agents for small fees.

Because these agents can be built by their creators (AgentBuilder sub-system 3) the “Rules of Engagement” (ToA) can be built into the agent so that improper, non authorized and non compensated use is not possible. It is contemplated by this invention that special manufacturing and assembly facilities will be an integral part of the shipping system and will be general purpose assemblers (ToA) at the end of a given shipping “pipeline.” Given the nature of this agent-based approach and the integration made possible by it, at each step of the transportation/assembly process, the “owners” of each component agent can be compensated, economically, based on exact use including the real benefit delivered and risks taken and the consideration of other factors. This constitutes a level of economy and utilization orders of magnitude greater than possible within the limits systematically imposed by the structure/process of the Industrial Economy (ToA) today. In addition, this System and Method will have profound effect on currant practices of “supply chain management” and shipping systems.

In addition, utilization of the System and Method makes it possible to “embed” codes and other constraints into objects (agents) of all kinds. By employment of embedded chips and other devices, as heretofore mentioned (in sub-system 2), the “real” object can communicate with it's virtual agent equivalent—and visa versa. Therefore, illegal, dangerous or not-agreed-to use can be reported and/or prevented. This means that Building Codes, in the example of “agent dwelling,” can be built into the manufacturing and use processes (agents). Too many people in a room, for example, can be reported to the appropriate agents with some response built in the room itself—like the “refusal” to perform certain functions. Likewise, insurance risks and compliance can be more precisely matched to costs and allow actual performance-based billing. Economic factors related to utilization and damage can be automatically “billed” in Real Time (ToA) with feedback (ToA) made available to the user of the devise, tool or environment. The users, in this example, of the dwelling can directly effect their costs, as well as, the total performance of the dwelling by their own actions. This feature of the present invention replaces a plethora of inaccurate, statistically based (not actual performance based) instruments such as invoices, contracts and other such methods. The behavior of a user can directly effect the performance levels and cost of the system the user is employing. Owners of systems can, therefore, mitigate undesirable costs while better serving their customers. “Here are the keys to the car but don't drive over 60 or beyond the city limits” can now have real operational meaning. The application of this Method extends to processes and objects of all kinds allowing “mass customization” of both user and provider experiences and costs. There are many such aspects of the present invention that are enumerated further in the description of sub-system 5.

The utility of this method of transportation ranges from employment with existing methods of manufacturing and building (utilizing computers, Cad Cam and other automated equipment, as well as, humans and other agents) to future technologies such as Nano Technology approaches where this system and method will be particularly significant in the automated creation of objects of all kinds.

The example given is that of an agent-dwelling. Any object or process can be treated this way requiring only the “building” of the appropriate agents. Thus, this Method can be used to design, transport, assemble and use tools and devices of all kinds, process instructions, information, economic instruments of execution and so on. Given the took-kit, Method and System of the present invention, humans (agents) and agents of all kinds can participate in the emergence of an economy limited only by imagination and synergy. This economy is no longer limited by the tools of transaction (money, stocks, contracts, etc.) as these tools grow as an integral aspect of the creation and interaction of the agents themselves.

There exists, today, primitive methods of coding attributes of an object or process. The insight and unique feature of the present invention is a system and method that integrates these many separate aspects, that today require system-imposed high-overhead cost, into a self-correcting leaning, adaptive, economical process from the insight and design function through shipping, manufacture and use. This process (sub-system 1) is made up of a myriad of agents (all “owned” by different agents) that are brought into an environment and “acted upon” in a specific way so as to create synergy (Group Genius—ToA). Each of these agent transactions and transformations “execute” economic activity (sub-system 5) employing agents, in the case of the agent dwelling example, of sub-system 4. The sum of all this is the IC Factory™, i.e. the first systematic process of creating Intellectual Capital (ToA—sub-system 6).

Subsystem 5—System and Method for Structuring and Facilitating Value Exchange Among Agents Forming Real and Virtual Economies

The present invention further includes objected oriented system and method for exchanging a value and objects that serve as a medium of exchange or a measure of value and/or a means of transacting value. In this system, objects, preferably computer software and/or firmware objects, are created to represent the value of various items within the system. Thus, for example, an object could be created to represent the value of a tangible object such as a boat, an object can be created to represent the value of one person's service and so on. Objects can also be created to represent the value of one's future earnings. Each object within the system has certain characteristics. Foremost among the characteristics of each object is an ownership characteristic, which is establishes who, within the system, has ownership with control of the value represented by the object. It is, naturally, critically important that the integrity of the ownership characteristic be maintained. In other words, it is important that one person within the system cannot misappropriate the ownership characteristic from others within the system. Thus, it is contemplated that the ownership characteristic be linked to unique characteristics of the individuals within the system. Examples of appropriate and unique characteristics can include fingerprint patterns, iris patterns, DNA patters and, encrypted code values. Thus, an object “knows” that it is linked to the person having a certain, unique, DNA pattern or fingerprint.

Like the transportation Sub-System, the system for determining the value of objects makes it possible to achieve increased utilization of objects that have value. These can include objects that are physical objects (a boat) or metaphysical objects (the future value of services that can be rendered). At its most basic level, the system includes objects that have value. The system is connected with data resources capable of evaluating or ascertaining the “value” of an object at any particular time. In addition, the object's location is always known and its status (health or condition) is always known. Reporting on location can be done with GPS technology or other similar devices that can ascertain a location precisely. Circuits and chips that measure conditions that are believed to be significant factors in the value of the object can be used to ascertain “status” or “health.” In the simple case of a boat, for example, a chips would report whether the boat is afloat or sunk and the status of it's major sub-systems. Initially, the object within the system should be very simple, but should operate through recursion and iteration to refine the predictiveness of the system. Thus, through experience, for example, it will be learned that certain factors affect the value of the objects. The system must be adjusted accordingly. The key it that feedback is used to refine as experience is gained.

Thus, using the system of the present invention, anything that has value to some people can be a commodity. Any commodity in this sense can be a tradable instrument. This allows much greater utilization of assets (for example, future value of services rendered that might otherwise not be used at all).

This system preferably includes a third party agent or enforcement agent, which under current systems could be courts, a legal process generally to enforce rules of exchange and ownership, for example.

This system is useful on an extremely large macroscale and for discrete, definable groups of persons that have a common interest. Thus, it is possible with this system to have multiple, distinct economies. It is contemplated that it will be necessary to include within the system some form of interface with other economies. This Sub-System of the present invention plainly opens doors to even greater utilization of assets to field the economy. Thus, the present invention offers the opportunity to create tremendous wealth since most assets of the economy are, at any given time, inactive because of the inherent limitations of the second wave economy.

It is further contemplated that the system includes means for modeling, sampling, and verifying the current value, preferably in a real time basis, of the objects within the system. Thus, for example, the physical objects that are represented by the software objects within the system could, for example, report signals indicative of their current state to a monitoring system. In the case of a boat, for example, the boat would continuously report its location and that all systems were in order. As long as these signals were received the system would recognize the value of the object representing the boat. However, once the system failed to receive an indication that the boat reported the boat's location and function, it would no longer recognize the value of the object value associated with the object representing the boat. There are, of course, other ways of verifying the values of the objects represented within the system. For example, in the case of tangible objects such as boats and automobiles, there is the conventional techniques for establishing a “blue book value” could be used. It should be appreciated, however, that because of the digital nature of the system and method of the present invention, it is possible, with sufficient input to much more accurately model real world values and their fluctuation due to specific variable conditions. The fact or/of ownership and control of the physical object could be continuously verified, but this seems to be unduly complicated using current technology and on the granular level necessary for significant gain, impossible with the methods and means available. Thus, it is preferred that the system operate, to some extent, on an “honor system” that is enforced through periodic verification or spot checking as well as by a credit report type system whereby participants within the system can lose the ability to participate within the system if they fail to report or file misleading or fraudulent reports.

In accordance with a preferred embodiment, Biometric verification, in which an individual's identity is checked by examining unique physical characteristics such as fingerprints, eye retinas, palm prints and voice signatures is used to establish and verify ownership. In addition, it is contemplated that the virtual agents themselves can be configurated is such a way that they behave as “genes.” With this method, certain agents will naturally “hook” together while others will fail to “see” the existence of those agents outside of their umbaldt.

Economies built on tools of this kind behave more like living systems and natural ecologies than simple, even complex, machines. This is one reason why as these new tools are introduced into the existing structure of the Industrial (Second Wave—ToA) economy that it becomes increasingly unstable. Therefore, these tools have to be constructed and employed in such a way so as to build, incrementally, a Knowledge Economy (ToA) as they are used. The System ad Method of the present invention facilitate this whereas existing methods do not (sub-system 6).

Subsystem 6—System and Method for Facilitating Work and Commerce Among Agents in a Knowledge Economy

In accordance with another aspect of the present invention, it is possible to develop a model for a total service network that takes insights and ideas from the creation stage to the organizational stage—an Intellectual Capital Factory.™ In direct contrast to the conventional approach of trying to quantify that which occurs or is found to exist in “successful” organizations, makes it possible to manage and grow intellectual capital from the seed of a good idea. The contrast between these two approaches is as sharp as the contrast between foraging for food in a fertile valley and hydroponic agriculture. Thus, where a conventional view of intellectual capital management might focus on retaining employees that demonstrate creativity, the present invention provides and maintains a work environment that unleashes the creativity that most people have so that “ordinary” individuals achieve the “extraordinary” results that they are capable of.

This Sub-System is really a high level system that combines two things while tying all the rest together. The two things are the PatchWorks Design (tm) Process and the Intellectual Capital Process The key to bringing structure to the process of creating intellectual capital may be summarized in the model of an intellectual capital factory or “IC factory.” The IC factory is a model for bringing structure to creation, nurturing and protection of intellectual capital.

A central premise of this model is the notion that the creative process cannot be controlled, but it can be managed. The creative process is managed by managing the conditions that create or block creativity. Thus it is necessary to manage the process of information development within a group and manage the process of information development within a group and to manage the energy field around the group. All of this is accomplished through structure that can be managed and modeled as an IC Factory.

The IC factory model provides a system and method for creating and nurturing intellectual capital.

Again, information age products are not capital intensive. Information age products are difficult to create, but easy to recreate or replicate. This is because knowledge-based products result from an insight or idea. Once the insight or idea is recognized a path to creation of the knowledge-based product may be inevitable at least once that path is made clear in the introduction of a product. Thus, for example, knowledge-based products such as computer software are often based on important insight, but once a product becomes available, the product itself can be easily replicated or the insight can be appropriated by others. There are also examples in the life sciences field. For example, the discovery of a new composition, pharmaceutical or gene sequence requires a great deal of research and in some instances an insight. However, once the existence of the composition, pharmaceutical or gene sequence is understood it is easily, in a relative sense, replicated

The IC factory model represents a structured non-linear non-incremental approach to creating, nurturing and protecting intellectual capital. In this sense, the IC factory structured approach is analogous to hydroponic growth of ideas.

The IC factory requires a knowledge-based (body of knowledge) and systems (educational and technical) for keeping the knowledge-based fresh and current. In addition, there must be systems for facilitating access to the knowledge-based within work groups. Thus, one critical function that must occur within the IC factory is growing and adapting the body of knowledge required to model the internal and external environment. This is done, as mentioned before, by creating education systems to receive inputs from external services—find out what's going on and use technical systems to leverage education systems and adapt a body of knowledge. When these systems are appropriately structured to achieve these functions, ideas are introduced into the system (the IC factory) and rapidly iterated and grown.

The IC factory also includes a structured environment that allows release of group genius. This requires careful attention to the effect of one's environment on one's creativity and productivity. The environments of the present invention are a good example of this type of structured environment, but most current work environments include numerous obstacles to creativity and Group Genius.

One of the critical elements of any collaborative work environment is to create an environment that allows individuals and groups to see the whole picture and, simultaneously, see details to allow effective collaboration.

In addition, to release group genius, there must be a way to facilitate the process of decision making. We have found that an interdisciplinary approach is particularly helpful. Thus, it is very important to have all stakeholders involved. In the case of a IC factory, the stakeholders would certainly include an expert in intellectual property, an expert in capital financing, and an expert in the particular industry that our idea relates to.

The IC factory also includes a ValueWeb™ that is managed as a venture. The web members provide inputs into the system or venture, but also have separate identities. In this sense, the members of the value web are like software objects (agents) and that they bring value to the web and draw value from the web. Examples of web members within an IC factory would include the intellectual property expert member and the capital financing expert member or object. The members or objects can be individuals or groups of individuals or firms.

Obviously, a critical aspect of managing a web of independent agents is the integration and system facilitation function—the Systems Integrator (ToA).

The value of members provide feedback loops into areas of interest so as to keep the knowledge base fresh and current.

The IC factory may be industry focused or generalist depending on the available expert objects.

As mentioned above, the IC factory requires a system integrator who bring these various elements together. This is best done using a system and method for facilitating interaction of intelligent agents. In this regard, it should be understood that the agents could be human agents, organizational agents, machine agents and electronic agents.

The present invention achieves hydroponic growth of ideas by removing environmental and structural barriers and expanding an organization's knowledge base. The IC factory approach provides a clear path to directly (not indirectly) proving every element of intellectual capital in a systematic way. Thus, all the traditional components of intellectual capital are proved in a systematic way. Consider, for example, the improvements to corporate brain power, organizational knowledge, customer relations, the ability to innovate, employee morale, the knowledge base, the technology base and the market position. Successful high technology companies empirically know that environment profoundly effects morale. Thus, the emergence of “open work places and casual dress” has been a characteristic feature of emerging growth companies. However, these approaches are working on the edges, but not addressing the environment in a comprehensive way.

In summary, therefore, the IC factory is an open system that incorporate new technologies or individuals for performing the critical functions. Ultimately, the quality of results achieved by the IC factory model will depend on the quality of performing the requisite functions.

The critical functions may be summarized as follows:

(1) Establishing a knowledge base 1 that is continuously refreshed with inputs from outside the organization (IC factory). In the case of an IC factory, the knowledge base must include information concerning intellectual property, a venture capital financing and the particular industry involved.

(2) The information and the knowledge base must be made available to all people that need the information in the collaborative process by systematic application of the 10 Step Process.

(3) Environmental barriers to collaboration and communication must be removed.

(4) The output of the IC factory must be protectable so as to establish “ownership” of the value created.

The basic team members of an IC factory are selected to achieve the following functions:

1. Intellectual Property: This cannot be addressed after the fact. It must be part o the process of creating product.

2. Incubation: Providing the tangible resources to develop a product and create a product or service.

3. Organizational Building Capacity

4. Financing

5. Operational Capabilities

6. Marketing and Distribution Systems and, perhaps the most important, a system integrative for integrating each of these six other functions.

Finally, and most importantly, there must be a system integrator or facilitator. Intellectual capital involves the interaction among agents. This includes human-human interaction; human to environment interaction; human to machine interaction; and machine to machine interaction. To date, there has been no system and method for facilitating interaction among these various agents. As a result, there is no reliable direct process for moving an idea to a sustainable organization. Communication within the organization is critical to establish dynamic, adaptable self-adjusting organic organization that operates with feedback loops to insure rapid iteration and growth to achieve the desired hydroponic growth of ideas. The IC factory model provides such a process for turning ideas into protectable intellectual capital.

Each of the Sub-Systems of the present invention provide distinct and independently valuable results that contribute to addressing the paradoxes and problems associated with the Knowledge Economy, and the transition to it, as described below.

Subsystem 1—Agent Interaction

Dissolves many problems of numerous Agents (Humans, computers, books, data bases, environmental and infrastructure elements, multimedia objects, etc.) speaking in non-compatible voices while interacting to solve complex problems associated with the necessity to stay requisite with a quickly changing and transforming environment and economy. Dissolves numerous blocks to the systematic emergence of synergy among Agents.

Subsystem 2—Agent Environments

Dissolves many problems of Human (and other Agents) Architectural Pattern Language Values while accomplishing flexibility of arrangement (from workstation component level to building scale), the variety of individual and work spaces necessary for the full range of knowledge-intensive work (including collaboration of different size groups), the integration of multimedia and communication tools, yet, accomplishing and greater utilization of space and utilities than existing systems. Dissolves numerous block to the timely and economic management of these environments.

Subsystem 3—Agent Systems

Dissolves many problems of knowledge-augmentation by technical systems and tools for single Agent work and the collaborative interaction of Agents, both real time and asynchronously, through multi-channel and multimedia networks and tool sets. Dissolves numerous blocks to the systematic creation, testing and employment of Agents of many kinds.

Subsystem 4—Agent Transportation

Dissolves many problems of seamless and integrated Agent (and agent environments) transportation providing a continuity of work and experience required by the demands of a global economy. Dissolves numerous blocks related to supply chain integration, RemotePresence, RemoteCollaboration and RemoteManufacturing.

Subsystem 5—Agent Economy

Dissolves many issues of facilitating knowledge-economy Transactions and Agent value accounting while radically reducing the multiplicity of financial instruments (in a myriad of legal environments) now systemic to the industrial-based economy. Dissolves many problems associated with the evaluation of intangible assets. Dissolves many problems associated with the failure of existing “instruments and processes of execution” to accomplish the cycle-time (ToA), fine-graininess, ubiquity and scale-of-use required by the emerging Knowledge/Network Economy (ToA)—today, “v does not equal V” (RS).

Subsystem 6—Agent Work and Commerce

Dissolves many problems of Agent participation in a Complex Global Economy and the TRANSITION to it. Dissolves many problems related to the incremental use of new capacities that, lacking appropriate built-in feedback, can actually damage the economic system that “hosts” them.

The System and Method AS a System

In accordance with the present invention, however, all of these Subsystems INTEGRATE into a single system and method-of-work that facilitates a seamless, continuity of effort and high-performance results across what are now partially connected systems, (at different and, often, non-communicating levels of recursion), now delivering a fragmented, expensive and lengthy experience that is not requisite with the existing (let alone future) complexity and rate-of-change in the global economic environment. Further, these existing levels of recursion embody few means for systematic governance, the creation of memory nor conversant languages.

### BRIEF DESCRIPTION OF THE TABLES

Tables 1-3 further explain, summarize and demonstrate the invention. Briefly, Table No. 1 deals with scope, Table No. 2 describes the “engines” of Iteration, Feedback and Recursion, and, Table No. 3 provides an example of the present invention applied and also describes Sub-System 4 of the present invention relating to Transportation. More specifically:

Table No. 1 “Relationship Among Invention Elements” 1 of 3—Provides an overall systems view.

Table No. 2. “Principles of Iteration and Feedback, and, the Rule of Recursion” 2 of 3—This states the key operational uses of iteration, feedback and recursion as process rules of the system. The proper application of these is what makes the system reliable.

Table No. 3. “Basic Description of the Invention Utilizing the Modeling Language and Algorithms of the Present Invention” 3 of 3—A description of the system described in terms of itself.

Tables 1-3 taken together demonstrate the synergy that occurs when the discrete Sub-Systems described herein are used in combination—the present invention is thus a single process that deals with specific knowledge economy problems.

Tables M-1 through M-12 show the visual representation of the models of the present invention. More specifically:

Table M-1 illustrates the Three Cat Model, including: [symbol] Real Cat; [symbol] Conceptual Cat and [symbol] Mechanical Cat.

Table M-2 illustrates the Vantage Points Model, including [symbol] Philosophy; [symbol] Culture; [symbol] Policy; [symbol] Strategy; _Tactics; [symbol] Logistics; [symbol] Tasks.

Table M-3 illustrates the Seven Domains Model including [symbol] Body of Knowledge; [symbol] Process Facilitation; [symbol] Education; [symbol] Environment; [symbol] Technical Systems; [symbol] Project Management; [symbol] Venture Management.

Table M-4 illustrates the S'Poze Model including [symbol] Encounter; [symbol] New information; [symbol] Paradigm; [symbol] S'poze; [symbol] Incorporation.

Table M-5 illustrates the Appropriate Response Model including [symbol] Efficacious; [symbol] Proper Scope; [symbol] True to Nature; [symbol] Anticipatory; [symbol] Self-correcting; [symbol] Sustainable

Table M-6 illustrates the Design—Build—Use Model including [symbol] Design; [symbol] Build; [symbol] Use.

Table M-7 illustrates the Scan-Focus-Act Model including [symbol] Scan; [symbol] Focus; [symbol] Act; and—Feedback.

Table M-8 illustrates the Model of the Creative Process including [symbol] Identity; [symbol] Vision; [symbol] Intent; [symbol] Insight; [symbol] Engineering; [symbol] Building; [symbol] Using.

Table M-9 illustrates the Business of Enterprise, or ValueWeb Model including [symbol] The Investor; [symbol] The Producer; [symbol] The Customer; [symbol] The Management (or System Integrator (ToA).

Table M-10 illustrates the 5 E's of Education Model including [symbol] Explain; [symbol] Experience; [symbol] Expectation; [symbol] Example; [symbol] Explore.

Table M-11 illustrates the Stages of an Enterprise Model including [symbol] Conception; [symbol] Looping; [symbol] Success; [symbol] Overshoot and Collapse; [symbol] Entrepreneurial Button; [symbol] Maturity; [symbol] Turnaround; [symbol] Demise;

Table M-12 illustrates the Ten Step Knowledge Work Process Model including [symbol] Event; [symbol] Documentation; [symbol] K-base; [symbol] Distribution; [symbol] Tracking; [symbol] Feedback; [symbol] Knowledge Base; [symbol] Design; [symbol] Read-Ahead; [symbol] Event.

Table M-13 illustrates the 4-Step Recreative Process Model, including [symbol] Create Vision; [symbol] Design Template; [symbol] Act; [symbol] Feedback; and [symbol] Recreate.

Table M-14 illustrates the Best Case, Worst Case Model, including The Best Case; The Worst Case; and The Most Probably Case.

Table M-15 illustrates the Creating the Problem Model, including [symbol] Condition; [symbol] Vision; [symbol] Problem; and [symbol] Creative Tension.

Table M-16 illustrates the Design Formation Model, including Program; Schematic Concept; Preliminary Design; Design Development; Contract Documents; Production Management; and Evaluation.

Table M-17 illustrates the Learning Path: Five Points of Mastery Model, including [symbol] Facilitator Guide; [symbol] Sponsor, Advocate or Advisor; [symbol] Learner; [symbol] Expert; and [symbol] Steward.

Table M-18 illustrates the Rate of Change Model, including [symbol] Complexity; [symbol] Change; and [symbol] The Ability of Organizations to Respond.

### BRIEF DESCRIPTION OF THE DRAWINGS

The present invention will now be described in detail with reference to the attached drawings in which:

Subsystem 1—

FIGS. SS1-1 through SS1-7 from U.S. Pat. No. 6,292,830, included in the appendix.

FIG. SS1-1 is a block diagram of a single iteration of an embodiment of the present invention.

FIG. SS1-2 shows a block diagram of the process of a decision point element contained in the block diagram of a single iteration of an embodiment of the present invention.

FIG. SS1-3 is a block diagram illustrating the plurality of agents and their functions.

FIG. SS1-4 is a block diagram showing elements of the environment.

FIG. SS1-5 is a block diagram illustrating important components of the performing work element of an embodiment of the present invention.

FIG. SS1-6 presents examples or elements of the altered or output agent produced by iterations of an embodiment of the present invention.

FIG. SS1-7 contains examples or elements of the output agent and new environment interaction.

FIG. SS1-8 illustrates the Zone of Emergence Engine which describes the conditions necessary for emergence in complex systems.

Subsystem 2—

FIGS. SS2-1 through SS2-93 from U.S. Pat. No. 6,292,830, included in the appendix.

FIGS. SS2-1 and 1A show a high level system flow diagram of the system of the present invention;

FIG. SS2-1B shows a sketch of a collaborative work environment according to the present invention. The environment includes tools according to Sub-System 3 of the present invention as well.

FIG. SS2-2 shows a high level view of a system configuration according to the present invention

FIG. SS2-3A is a front perspective view of a medium height rolling bookcase;

FIG. SS2-3B is a front perspective view of a full height rolling bookcase;

FIG. SS2-3C is a perspective view of a stack of chairs;

FIG. SS2-4 is a front perspective view of a kiosk;

FIG. SS2-5 is a front perspective view of another kiosk;

FIG. SS2-6 is a front perspective view of a work unit;

FIG. SS2-7 is a perspective view of a plurality of shelf cubes arranged to provide a portion of a cube-office system;

FIG. SS2-8 is another view of stacked shelf cubes that can be used in a cube office system;

FIG. SS2-9 is a perspective view of a portion of an environment that includes work walls, an enclosed space, worktable, and chairs;

FIG. SS2-10 is a front perspective view of a plurality of bookshelves grouped together with working walls to divide a room;

FIG. SS2-11 is a perspective view of a kiosk and a wing component docked together;

FIG. SS2-12 is a perspective view of a work unit;

FIG. SS2-13 is another view of the work unit of FIG. SS2-12 and also shows rolling work walls in the background;

FIG. SS2-14 is another view of a kiosk component according to the present invention;

FIG. SS2-15 shows the kiosk of FIG. SS2-14 at a reduced height and docked with a wing component;

FIG. SS2-16 is a perspective view of a kiosk of the type described previously in connection with FIG. SS2-4 in which an oval work surface is inserted into one of the slots of the kiosk;

FIG. SS2-17 is a perspective view of a kiosk in use;

FIGS. SS2-18-20 show portions of an environment according to the present invention;

FIGS. SS2-21-30 are various perspective views showing one embodiment of the work pod component of the present invention;

FIGS. SS2-30A-50 are various perspective views showing alternative pod constructions and configurations according to the present invention;

FIGS. SS2-51 and 52 are perspective views showing a single section from which the work pod can be constructed;

FIGS. SS2-54 and 55 are perspective views of a cube office system according to the present invention.

FIG. SS2-56 is a schematic view of a polycentric work area layout;

FIGS. SS2-57-62 are perspective views showing a Rapid Deployment System (RDS) type environment in use;

FIG. SS2-63 is a perspective view of an adjustable wing, a kiosk and a smaller wing and a movable storage file;

FIG. SS2-64 is a perspective view of a work surface according to the present invention;

FIGS. SS2-65 and 66 are perspective views of a portion of an environment in which cube systems are used to divide an environment into different sections;

FIG. SS2-67 is a perspective view showing several aspects of an environment according to the present invention;

FIG. SS2-68 is a perspective view of curved cube systems according to the present invention;

FIGS. SS2-69-71 are perspective views of architectural armature and pattern language features according to the present invention;

FIGS. SS2-72 and 73 are perspective views of a cube office system according to the present invention;

FIGS. SS2-74-82 are perspective views of cube office system components and assemblies according to the present invention;

FIG. SS2-83 is a perspective view of a wall-mounted folding workwall;

FIG. SS2-84 is a perspective view of cube components of the present invention;

FIG. SS2-85 is a perspective view of a pod assemblies according to the present invention;

FIG. SS2-86 is a perspective view showing side-by-side work stations;

FIG. SS2-87 is a perspective view of a work environment that includes cubes and a work surface with a wing component;

FIG. SS2-88 is a perspective view of a cube office system that includes curved cube components and a wing component;

FIG. SS2-89 is another perspective view of an environment that includes pullout work surfaces an drawers;

FIG. SS2-90 is a perspective view of a five section pod.

FIG. SS2-91 is a perspective view of an environment that shows a modular seating niche;

FIG. SS2-92 is a perspective view of a work area constructed using reconfigurable walls that include utility panels;

FIG. SS2-93 is a perspective view of a component according to the present invention that includes a foldup work station.

Subsystem 3—

FIG. SS3-3 illustrates the Agent Builder and related sub systems and components.

FIG. SS3-11 illustrates augmentation processes, tools and environments for facilitating human and other agents.

FIG. SS3-12 illustrates sub systems, processes and components in support of SS3-11.

Subsystem 4—

FIG. SS-4, from U.S. Pat. No. 6,292,830 and included in the appendix, schematically illustrates an embodiment of the occupant module (virtual agent) of the present invention.

Subsystem 6—

FIG. SS6-1 illustrates Mind Engine and related components.

FIG. SS6-2 illustrates ValueWeb Architecture and related components.

FIG. SS6-3 illustrates the ValueWeb Builder—3 Cat Engine and various components.

### DETAILED DESCRIPTION OF THE INVENTION

Principles of Iteration and Feedback and the Rule of Recursion, as Used in the Present Invention

One important aspect of the present Invention is the use of iteration ToA, feedback ToA and recursion ToA in the System and Method to consistently provoke emergent ToA behavior. In particular, iteration, feedback and recursion assembled properly (architecture) along with critical mass and proper scope will generate sufficient complexity to deal with the “Requisite Variety” rule and facilitate emergent behavior in systems. This is significant since the Requisite Variety issue has remained “unanswered” since the foundations of Cybernetics were established in the 1940s and 1950s (Weiner, Asby, Beer). There is no known system and method in which emergent behavior can be consistently provoked (as a directed, documented, transferable practice, engaging Agents of many kinds and on many levels) outside of the present invention. Rule of Recursion: All elements that define viability, on one level of recursion, of a system must occur on all levels of recursion of the system (Beer). For a complex Agent to be viable or for a simple Agent to be effective in a complex environment, (of Agents) the Agent must be “acted upon” (and/or be acting) at a minimum of three Levels of Recursion (“above,” at the level of the Agent and a level “below” the Agent).

It is an insight of this invention that a complex Agent cannot be predicted or controlled at the level of its own emergence. Levels of recursion above the Agent constitute context. Levels below the Agent constitute disciplines. The level of the Agent must be free if emergence is to occur systematically.

Actions that on a single Level of Recursion that are additive, on multiple Levels of Recursion will usually be multipliers, leverage is accomplished by employing more than one Level of Recursion (thus, dealing with the Requisite Variety Rule: Variety must equal Variety). Generally, greater complexity can be dealt with or accomplished by employing Recursion than by action on one level of a system (given the same number of actions and level of resources). Emergence happens “between” (out of) Levels of Recursion.

Rule of Iteration: All things being equal, a single iteration of work, in isolation, is additive between steps while multiple iterations of work (in a continuous process) multiplies results. Work iterations must happen in rapid succession and within time compression for maximum effect. There must exist a continuity of experience (Agent environments, processes and tools) in such a way that establishes a Real Time ToA environment in order for the Rule of Iteration SS to be employed.

Rule of Feedback: Feedback is the message from a sensor of the system to the controller of the system of the difference between performance and expectation. Positive feedback amplifies; negative feedback attenuates. Feedback on feedback and/or feedback between Levels of Recursion is feedback of a complex kind ToA and is required for the governance (self correction) of complex and emergent systems.

Rule of Iterative, Feedback Driven Systems acting on Multiple Levels of Recursion: These systems exhibit increasing returns ToA and learning. They co-evolve ToA—(with their environment)—emergent behavior ToA. They are open-ended and cannot be predicted or controlled. These systems can be operated [symbol] [symbol] [symbol] in a way so that the desired kinds or results are consistently accomplished. This is possible when the Rules of Iteration, Feedback and Recursion are employed in a system of specific architecture [symbol] [symbol] [symbol] [symbol] [symbol] [symbol] [symbol] —as described—that employs sufficient critical mass ToA.

Emergence ToA is the result of complexity. Complexity ToA is a factor of iteration, feedback, recursion, critical mass ToA and the number of Agent (nodes) interactions in a specific time period and place (and the architecture of how they are connected).

Levels of Language

There is language inherent in each us. Social beings organize, co-evolve and adapt through the use of language. This language is both verbal and not, and grows and expands as our psychological and knowledge-based foundation develops from intense experience, physical and mental travel, and study. Languages are both species-specific and individual-specific—each individual develops an unique memory and co-evolved language. A simple concept to remember when thinking about language, and its importance in society, is that “everything speaks.” Each action, word, behavior, organization or product does not tell; it speaks. Dialog, within a system is transactional—that is, it transmits instructions. To better understand the breadth of emergent solutions made possible by the present Invention, and to facilitate Agents with this experience, the following Levels of Language are provided by the System and Method of the present invention.

Descriptive Language: Normal Use NU; Explains the organic and inorganic Agent ENVIRONMENTS in which we live and work. Agent-individuals explain the “sky” as “blue,” the “light” as “amber,” the “climate” as “comfortable.” We explain the “office” as “creative,” or “flexible,” or “rigid.” We explain the “organization” as “innovative,” or “mundane,” or “mainstream.” Descriptive language describes the design of Agent environments in relation to the five senses of the human body; sight (“light” and “dark”), smell (“good” and “bad”), sound (“loud” and “quiet”), touch (“rough” and “smooth”), and taste (“delicious” and “awful”). Descriptive language provides context for the concept of primary and secondary color, explaining how red, yellow, and blue can flower purple, green, and brown. Descriptive language distinguishes our natural resources . . . . water, wood, coal, oil, iron ore. Descriptive language is an essential ingredient in creating an {gent environment experience as a tool for facilitating Agent interaction (on the level of Human Agents) to breakthrough results.

Technical Language: Terms of Art ToA; Explains the TOOLS of the mind in the form of buildings, infrastructures, computers, electronic devices, modes of transportation, and more. Earth is an organization in itself, formed of many cultures of living systems; animals, people, groups, organizations, communities, businesses. Each applies unique technical language to its agents. The Term of Art for the agent who created Windows Operating System is “Microsoft”. The Term of Art for the appliance that bakes slices of bread is “toaster”. The Term of Art for a team of individuals working together within a company may be “Strategic Business Unit”, or “Marketing Department”. We use Technical Language (Terms of Art) in all disciplines including manufacturing, law, medicine, technology, education, etc. With each new discipline you begin to acquire mastery in, a new set of Technical Language (Terms of Art) you will have to learn. In organizations we create brands, symbols, icons, and slogans that work as modem technical languages. Developing a vast technical language prepares Agents for success in a knowledge economy. The most obvious representation of Technical Language (Terms of Art) are glossaries, indexes, dictionaries, manuals, brochures, etc.

Pattern Language: Solution Sets SS; Explains solutions to what we understand to some degree, and we find difficult to change. These are rigid patterns of behavior, language, architecture, organization, that once observed become obvious, but seldom we take time to understand them. Within major disciplines of work (architecture, education, systems thinking, biology, technology, mathematics, social sciences, physics, anthropology, etc.), agents connect Technical Language and Descriptive Language creating solutions to society's most common problems. Understanding this knowledge allows Agents to understand the world. English, Spanish, French and Japanese are embed, often hidden, pattern languages for their respective cultures, solutions that solve “the problem” of communication. The language may change, or not, to benefit society and to increase understanding. Understanding English allows agents to understand other agents who also understand the solution sets SS society calls English. When the same agent understands the solution-French, it increases its knowledge, and ability to communicate, by an order of magnitude, and so on. The same could be said about a computer, as you add software programs making it multi-functional and cross-platform.

Consider the young woman, agent-Mary, who at an early age travels long distances, across culture and gathers technical language along the way. She enters a multi-national organization and spends time in several different strategic business units (SBUs). She brings a great deal more solutions to her work, because of the patterns she has learned from her experience. Consider a student of medicine, who becomes an expert in a bone of the knee, in the mechanics of it, how it moves, etc. Compare this person to an architect, biologist, technocrat, mathematician. What if all this knowledge were combined, through practice and study? What if we viewed the world through a broad based lens, covering many disciplines, not just one? Agents collect these solutions from a variety of sources, most common of which are formal education and experience.

The present inventors have found that an element of emergence of solutions is the ability to augment ones experience with the appropriate Knowledge Objects in the form of articles, books, research materials, scientific explanations, mechanical objects, and much, much more. The experience that agents bring to their work can currently be augmented with knowledge objects (books, Internet research, stories, mechanical objects, etc.) including texts covering several disciplines, familiar and not.

These knowledge objects/Agentss each provide unique solution sets that can be applied to the complex problems of a group, AND solutions that facilitators can use to accelerate Emergence of solutions. The knowledge base available to all Agents is currently increasing exponentially with improvements to communication and data mining technologies.

Modeling Language: Design and Process Terms D/PT; Explains the PROCESS we use to work, interact, live, transport, build, etc. The models have formal and informal “rules of engagement” which are flexible, sometimes broken, boundaries for agent interaction. Some of us choose to explore these models, drill deep into them, break old models, and create new ones. In accordance with an important aspect of the present invention, the present inventors have created modeling language for organizations to use to develop common understanding—a means to view existing conditions in alternative ways. This modeling language provides a vehicle for Agents to communicate on all levels, in any environment, at all times. Creating common language among Agents improves efficiency and profitability when solving complex problems.

The Modeling Language of the Present Invention Includes the Following Models:

Three Cat Model (Table M-1):

The Three Cat Model is a metaphor for info management in the act of creation. The model summarizes the acts of observing reality, forming a concept, and testing that concept by building a model to reveal our understanding. The model is then compared to reality for verification, the concept is adjusted, the model rebuilt, and so on.

[symbol] Real Cat: Actually, we don't really ever see the real cat. Our senses gather signals from the visible part of the electromagnetic spectrum, fluctuations in air pressure that register on our ears as sound, and the electrochemical signals that result from physically touching an object. Because our information concerning real cat is most incomplete, there's always more to learn.

[symbol] Conceptual Cat: As we observe real cat, we create mental models to use as aids in decision making. We learn to associate current phenomenon with past occurrences of similar phenomenon. We make decisions based on projections of past behavior onto the current situation. Lacking any such direct associations, we are forced to invent.

[symbol] Mechanical Cat: In order to test our concept, we create physical models and compare them to the reality. The artist paints; the engineer builds scale models; the business person turns to planning software and spreadsheets; the writer composes stories.

Now, what about the connections between the three cats? There are two lines that connect any two cats. The squiggle line is the symbol for a resistor in electronics and refers to the attenuation of information in that direction. So, for instance, the communication of information from Real Cat to Concept Cat is severely attenuated. The triangle line is another symbol borrowed from electronics—an amplifier. The information running from Concept Cat back up to Real Cat is amplified.

Using the model: 3 Cat Analysis describes a methodology for testing ideas through modeling and taking action. When an idea is only a concept, people can argue endlessly whether it will work or not work. It is usually far more effective to take the concept into action, by creating a physical world, or better yet, a demonstration, prototype, or other real world test. This is particularly true when accompanied by a feedback-driven process that encourages ongoing learning and discovery. Many concepts are hard to explain, yet are readily understood when demonstrated.

The 3 Cat Model may be applied to planning as well. A trap with planning is to believe that the plan is what you will go out and do. When results (the real cat) deviate from the plan (your mechanical cat), use this information to modify your actions, strategies and tactics accordingly, steering toward your vision (your concept cat). Can the model by “two-catted:? Yes, but very carefully. Using only two cats in the model has great uses, but also great abuses. Refrain from “two-catting” until you fully understand the relationships between each cat in the model.

Vantage Points Model (Table M-2):

[symbol] Philosophy: The fundamental—usually hidden—beliefs that unite the components of an Enterprise, enabling them to act as a cohesive whole. Properly applied, philosophy enables both innovation and stability.

[symbol] Culture: Defines the various components of the Enterprise and their relationship to one another in action. Also encompasses standard behaviors of these components—behaviors which are manifestations of the Philosophy.

[symbol] Policy: At the broadest level, statements of purpose, intent and goals. At a narrower level, Policy can specify boundaries on the design and prosecution of Strategy, Tactics, Logistics and Tasks. Policy states the rules of the game.

[symbol] Strategy: The organization, disposition and direction of large scale forces over space and time to achieve the objectives of Policy, maintain homeostasis in a competitive and cooperative environment, and manage growth. Also the set of recognized “patterns of play” known or suspected to produce favorable results when implemented.

[symbol] Tactics: The art of matching the resources of Logistics with Strategy and deploying these effectively and efficiently in the game.

[symbol] Logistics: All of the issues concerning resources, energy knowledge, and the mechanics of their distribution and storage throughout the Enterprise.

[symbol] Tasks: The work to be done and how its actually done. The way a tool is untreated, of course speaks plainly of the philosophy and culture of the user.

In a way, you can never understand the philosophy of a system or enterprise until you are immersed in the tasks that comprise its daily functions. The task provides a mental elevation from which the whole essence of the system can be contemplated. The philosophy and culture of an organization will be expressed in the way an associate is taught or allowed to perform its tasks. By observing people performing various tasks, by sensing the atmosphere, energy and ethics of the environment, most anyone can determine the true expressed philosophy of any organization.

On the other hand, sometimes immersion in daily tasks can blind people to culture and philosophy, or cause them to accept it too casually. Many of our actions are based on essentially hidden stimuli and barely understood themes. Most of us cant spend all of our time evaluating various philosophies; its easier to accept one and act out from it. Philosophies accepted as truth are very hard to shake or adapt to changing circumstances.

The Vantage Points are meant to be managed and designed-used as templates and auditing tools. The Vantage Points break down into three overlapping zones from special types of management emphasis.

Design and mange Philosophy, Culture and Policy to steer the evolution of the enterprise.

Design and manage Policy, Strategy and Tactics to steer the operational and structural support of the enterprise.

Design and mange Tactics, Logistics and Tasks to steer the work to be done by the enterprise.

7—Domains Model (Table M-3):

The seven areas that are managed in every enterprise and every activity of the enterprise. When managed properly they ensure corporate health and allow Knowledge-based organizations to grow and profit.

[symbol] Body of Knowledge: The sum total of information and information about how to get information that the system requires to remain viable, to improve and innovate.

[symbol] Process Facilitation: The philosophy and methods for removing obstacles and clearing paths so that processes within the system flow naturally and efficiently.

[symbol] Education: The processes and methods by which the system learns: how it explores, experiences, gathers explanations and examples, and how it sets cybernetic expectations. 4 Environment: The physical, emotional and metaphysical field within which the system plays its role. But the system is not merely subject to the environment—it creates and is created by it.

[symbol] Technical Systems: Artifacts created and employed to amplify, modulate or attenuate the other domains so that the system can be internally and externally requisite and cybernetically responsive.

[symbol] Project Management: The philosophy, culture and methods employed by the system to efficiently allocate resources and monitor energy flow in the pursuit of finite, temporal objectives.

[symbol] Venture Management: The philosophy, culture and methods employed by the system to determine (not just manage to) its cybernetic homeostasis and engage in complex activities designed to explore unknown opportunities for growth and transformation.

Most of us tend to examine the domains serially. We talk about them one at a time and one after the other. There's nothing wrong with this approach; it is, however, a woefully incomplete approach.

The domains are connected to one another in weblike fashion. Its much more interesting and valuable, therefore to think about things like the Environment of Process Facilitation, or the Environment of Technical System, or the Technical Systems of the Body of Knowledge, or the Venture Management of Education.

A frequently asked question about the domains concerns why human resources or team spirit or some other people-oriented domain seems to be missing. People are not resources to be managed. Instead, people collaboratively manage the Seven Domains to achieve together what they cannot achieve separately.

A venture is composed of projects and processes. These two overlap—there is no clear definition that divides projects from processes. Both must be managed and facilitated to maintain balance and growth. The Venture lives within and creates its environment or environments—the field on which the game is played. It calls upon a body of knowledge to execute its projects and processes. It employs technical systems that enable its metabolism to remain requisite with its surroundings—managing lags, avoiding collisions, employing hunting strategies as guidance mechanisms for staying on specification, compensating for unwanted changes in energy thruput or system velocity.

Finally, it engages an education system to manage learning—a discovery and feedback system whose purpose is to add to, analyze, and winnow the body of knowledge.

S'Poze Model (Table M-4):

New pieces of information are constantly trying to penetrate the boundaries of ones paradigm. In order to survive, a paradigm must have strong boundaries, which consequently means that few new ideas can get in. Playing “Spoze” allows us to set up a neutral space to see what would happen IF a new idea were to enter a paradigm.

[symbol] Encounter: At this stage, the systems current Paradigm meets up with a high information messaging event. Either the new information represents a threat and the system must learn new strategies for thwarting it, or it contains a potential benefit and the system must learn how to take advantage or it.

[symbol] New information: Systems are receiving all kinds of messages from other system and the environment in general. Information is the result of a systems interpretation of a message, including whatever meaning it assigns to the message based on past experience. The measure of information is proportional to its uncertainty, or surprise. The more surprising the message, the more information it contains (Baetson).

[symbol] Paradigm: For a living system to make decisions, it must be able to compare the nature of sensory input that it receives to some model that predicts probable future outcomes based on stored previous experiences involving that input. It represents a guide to success given a variety of situations. The sum total of these situations and the guideline stored in the system comprise its paradigm.

[symbol] S'poze: It is not advisable for a system to accept any and all New Information to add to its Paradigm. The process of modeling enables the system to play “what if” without actually engaging in a potentially threatening experience. I Incorporation: If the results of the simulation seem favorable, the system may incorporate the New Information into its Paradigm and begin making decisions based upon this new mixture.

### EXAMPLE

Like Scan Focus Act, this is a naturally occurring model. A common example used in describing Scan Focus Act will also serve here—the story of the lioness hunting wildebeest on the plains of the Serengeti. The lioness Scans the herd for a potential meal. Focuses on likely candidates and then Acts explosively to chase one down. That is a simple description of the process from the vantage point of creativity. But what is going on from a signal processing standpoint? New information about the herd and perhaps other animals lurking about, is constantly streaming into the lioness senses.

This new information, according to James Millers Living Systems model is processed by a function called the Associator. The Associator compares the input to patterns and models in Memory, searching for overlaps that trigger the Decider function to initiate some physiological activity in response. New information that enters the system as a result of this response is fed back into Memory to update the pattern. This trio of functions—Associator, Memory and Decider—represents the learning process. Thus, the lioness learns how to spot potential meals among the animals in the herd.

It also learns different strategies for approaching and chasing its meal. The activity of the Associator is one representation of playing S'poze. The Associator is trying to build little vignettes (or scenarios) of future predictions based on a comparison of new information and old memories.

Strategies for playing Spoze: It may seem from looking at the model that the activity of S'poze is played outside of the host system, in some safe, confined area. This is not the case. S'poze is played in real life with an element of risk. Playing S'poze is required for the organization to continue to learn, and also to spawn offspring that can successfully adapt to changing conditions in the wider ecosystem. The risk is unavoidable. The most complete way for an enterprise to play Spoze is to create offspring, preferably through “recombination of DNA.” In enterprises, recombination occurs when two or more organizations share ideas and strengths to form a separate project or enterprise for the purpose of testing the quality of the ideas in action. You can simulate all you want, but at some point you really just have to do it to know whether it will succeed.

Appropriate Response Model (Table M-5):

[symbol] Efficacious: It is defined as “the power or capacity to produce the desired effect.” By contrast, the word effective means “having the intended or expected effect.” The difference lies in the use of the work “power.” An efficacious design exudes power and this power is efficiently directed to yield predictable results.

[symbol] Proper Scope: This element contains the power inherent in the first element. An excellent design should properly fill its niche and not strive for too much, nor suffer from a timid presence. The boundaries of the design must be clearly defined. This does not mean they must form a contiguous presence, only that by some combination of matter, energy and information the solution is able to distinguish itself clearly from other elements in its environment.

[symbol] True to Nature: A design that is true to nature is composed of elements that support one another, that do not conflict, and whose capabilities are mutually requisite. In a growing seedling, the roots, stem and leaves all remain requisite with one another: the leaves dont photosynthesize too much or too little, the stem is sized just right to provide structural support and the transport of materials up and down. A design should be elegant, all of its parts fitting together in a pleasing fashion that makes people want to employ it.

[symbol] Anticipatory: Designs, or solutions to problems are living systems. As such, they must include the apparatus and processes necessary to use models based on past experience, along with current data gathering to make predictions concerning the future behavior of other systems in the environment. At the lowest level, this serves survival; at higher levels, anticipatory hardware and software enable systems to effectively collaborate with one another to support both the homeostasis and evolution of their collective ecosystem.

[symbol] Self-correcting: Once a system can make predictions about the future, it must compare these predictions with its current behavior and implement changes to adjust its behavior to bring it into harmony with its future models. In this sense its bringing its vision of the future back to the present.

[symbol] Sustainable: Finally, a system must be able to survive birth, grow to maturity, and reproduce itself. It must do this without depleting the systems that support its growth, otherwise it will cause its own demise.

Every stage of the Creative Process involves producing a result. Superior results can be obtained by filtering or testing competing designs through the six elements of this model The model has six elements grouped into two sets of three.

The first set includes functional qualities: Efficacy, Scope, Nature. The second set embraces living system capabilities: Sustainability, Self-Correction, Anticipatory. These divisions seem somewhat arbitrary. The ability of a system to anticipate future events can be seen as either a functional quality or a living system capability. However, the ability to extrapolate events into the future, the ability to use this extrapolation to correct behavior in real time, and the ability to grow and reproduce oneself are characteristics that clearly set living systems apart from mechanical or nonliving systems. A hammer produces a desired effect (efficacy), is built with a particular scope of work in mind (scope), and has qualities that keep its parts requisite with each other (nature). However, it is not sustainable; rather it degrades and is incapable of reproduction. It embodies no ability to correct itself or learn. And it certainly cannot anticipate future results.

Design—Build—Use Model (Table M-6):

The most common approach to designing, building or using most anything is linear. In its extreme incarnations, not only is there no feedback between stages, but the individuals involved in each stage are different as well as do not communicate across the boundaries between stages. The traditional, linear approach of the model generates static, non-living artifacts which can be torn down in response to a wide range of demands upon their flexibility. Life becomes an unending compromise. The model should grow from a linear process to cycles of feedback.

[symbol] Design: Create sketches, models, plans, schedules, and bud gets convey a sense of the scope of the project in many different dimensions. This is not done merely at the beginning of the project, but as a sort of continuous process throughout the life of the building. The design takes into account past and present work process requirements, and the uncertainty associated with the future as well.

[symbol] Build: There must be a process for rapid execution of the design that allows frequent adjustments to the realities of a build-out and the changing perceptions of the user as the design unfolds. The process and the product (space) must provide for this speed throughout the occupancy so that the enterprise of users does not have to waste time and talent in reconfiguring itself to meet changing conditions.

[symbol] Use: As the environment is used, it will change the processes that take place within it. These changes, in addition to events in the external environment will drive a demand for the work space to adjust its function, and to do so rapidly.

The design and build capacities must always be readily at hand. The cyclic model illustrates the requisite relationship between design, build and use. The designer and the design process is connected to both the user and the builder. The builder and the building process is connected to the user and designer.

The user and the processes employed by the user in the conduct of the business of the enterprise is connected to the designer and builder. These interconnecting feedback loops imply that the designer, builder and user remain connected throughout the lifespan of the enterprise. It also requires that the products of this collaboration be stable enough to provide day-to-day integrity and flexible enough to allow radical, rapid redesign to fit the changing needs of the user over time. It means that the environment is never “finished” and that it is constantly able to provide a “just enough, just in time” solution. Things that are “finished” in our emerging world are dead.

Requisite Variety V=0; V≠0

Degrees of Freedom (to act)

Transition Management (acting in tacit [ ] degrees of Freedom)

“No our there” (Recursion Issue) Increasing Returns Model

180° Principle

Levels of Recursion of the system

It is important to reemphasize that not only must the three different entities communicate and collaborate, but their processes must dovetail as well. That means that the design, build and using processes should not inhibit each other or create confusion. For the user it indicates a mental shift in understanding that a design and build capability occupy a permanent part of the larger web of the enterprise. It also changes the way that equity, debt and cash flow are treated within the value web between the builder, designer and user.

Scan-Focus-Act Model (Table M-7):

Scan-Focus-Act is a basic model for the process of planning, decision-making and creative problem-solving. To get a picture of how the model works, imagine a hungry lioness on the plains of the Serengeti. She Scans her domain for luncheon possibilities (note that scanning frequently takes a long time), Focuses on particularly attractive selections and positions herself appropriately, then Acts to bring the meal down.

[symbol] Scan: To Scan is to seek ideas and perspectives that are new and challenging to your existing world view. You survey conditions and possibilities relative to your plan, and seek insights that may come from outside you organization and industry. You are also seeking to expose hidden assumptions that may limit the options you can see or consider. In the Scan phase we build conceptual, mental models.

[symbol] Focus: To Focus is to take the ideas generated in the Scan phase that are best suited for your plan and begin iterating them. In this phase, ideas are treated as models to be tested and explored, not judged or condemned. In the Focus phase you should choose a frame of reference, and narrow your options to only a handful. At length, a decision is made and its time to . . .

[symbol] Act: To Act is to take your ideas and designs and put them into action. The process begins by selecting the strongest ideas, and formulating them into plans and actionable steps.

[symbol] Feedback: The result of an experience is fed back as learning to the next iteration of the process. Feedback is termed positive if the desire is to grow the system, and can be negative if homeostatic control, or goal-seeking is the object.

Movement through the model: One of the dangers of the Scan-Focus-Act model is to assume that the model is designed in a linear of cyclic fashion. There are six different combinations of the scan-focus-act model. These should not be thought of as different models, but as strategies to be used in different situations. For instance, it is not always necessary or viable to start with a scan phase. If you're driving on the highway and see a car in front of you swerve out of control, you may describe you reaction as Acting first to avoid collision, then Focusing on next alternatives, choosing to bring the car to a controlled stop along the roadside, and then taking a longer Scan around to see what is going on. This might be the most useful way to explain how the model felt in this particular situation. However, it is also true that a lightning quick Scan occurred the instant you noticed the other car swerve out of control. It was followed by an equally lightning quick Focus, perhaps a reflex decision-making and choice of an option to take—avoiding collision. Within the Act, you have scanned and focused.

The pace of the model varies greatly. Sometimes the stages unfold rapidly one after the other. Other times they creep along at a glacial pace. Scan may take a second or two but the Focus and Act stages might drag on for weeks. Or it might work the other way around. Sometimes teams struggle for a long time trying to bring a coherent sense of vision to a project and once it clicks in place, the Focus and Act phases follow swiftly.

It is important to note that although each phase does not adhere to a set time frame, one should refrain from becoming “bogged-down” in a single phase. For example, some people or enterprises have great ideas and can never bring them to fruition (stuck in Scan). Or they may entertain in a slavish, myopic view of annual plans and budgets, thereby missing opportunities and hampering implementation (stuck in Focus). Perhaps their days are spent “putting out fires” and they never seem to have time to innovate or make systematic efforts to improve (stuck in Act). Or, a lingering introspection promotes timidity (stuck in Feedback).

Model of the Creative Process Model (Table M-8):

[symbol] Identity: In this phase, you study the world around you and observe data, facts, and feelings. Your task is to identify your conditions and your relationship to these conditions.

[symbol] Vision: In this phase you seek what can be created. Often this is an image of the “end state” you want to achieve, with hardly a clue as to how to get there.

[symbol] Intent: Here you size up the situation and decide to “do something” about it. Primarily, this is the phase of personal ownership and commitment, where you make solving the problem part of your personal quest.

[symbol] Insight: This is the “Aha!” stage in which a synthesis occurs between all that has gone before; the confusion starts to make sense.

[symbol] Engineering: Its time to put ideas into practice. Once insight is achieved, one has the information, plan, or design that allows for detailed-level questions to be asked.

[symbol] Building: In this phase, you take the numbers and the schedules and do it. This is the phase of production, marketing, and entrepreneurship.

[symbol] Using: Often forgotten, this phase is when the consumer uses the end product, of the entire process that we can truly evaluate our success. Inevitably, when this phase is not ignored, the process brings new insight.

This model explains how problems are created and then solved in a process that is recursive, fractal, cyclic and nonlinear in character.

The most striking feature is the bipartite division that separates the Using stage from the Identity stage and cuts the insight stage in half. The model “starts” with the Identity stage and the purpose of the first half is creating the problem. The second half has the job of solving the problem which the first half created, thereby producing a new Condition in the Using stage, out of which the first half will again have to create a new problem.

The first half of the process is individual and the last half collective. This is so because until an idea has a physical manifestation, it cannot be perceived in a useful collective manner. Ideas have no value merely as ideas; they must be expressed in specific form. Likewise, manifestations have no value unless they can be translated into ideas to be transported, improved and evolved.

The whole purpose of the first half of the creative process is to investigate, discover and discern the operating mechanics, cybernetic connections, and principles of self-organization of the existing system. Then—maybe—we can act upon the system with intelligence. Or at least envision a new system that produces different condition more in line with our vision.

Business of Enterprise Model, Also Known as the ValueWeb Model (Table M-9 and FIG. SS6-2):

The players and their roles in the model:

[symbol] The Investor: The investor provides capital to the enterprise and gets a return of and on the investment. However, more and more investors are also providers and customers.

[symbol] The Producer: The producer still makes the product or creates the service. But producers are more involved in understanding how the company works through programs like open book management.

[symbol] The Customer: The customer purchases and uses the product. But customers are also interested in how well and ethically the companies are run—they vote with their investments. And customers are included in production.

[symbol] The Management: Management balances the business of the whole web, but the management function is more distributed. There is more management going on, but fewer managers.

Some companies are learning how to transform a zero-sum game into an infinite game. In a zero sum game, there is a finite amount of resource and the game is to decide how it gets distributed. In an infinite game, the purpose of the game is to continue the game—to grow and expand the resource base and the distribution model. The best models to use when playing infinite games are living systems models.

But just growing an organization does not eliminate the conflict inherent in the old model of business. After all, many organizations experience tremendous growth rates yet only exacerbate the conflicts between their constituents. There are two more factors that must be added for the new model to be truly transformative.

Take another look at the picture of the model. You're looking for the connections between constituents. Management is the largest hub connecting the constituents, but there is a whole web of lines that connect customers, producers and investors. Its these many subnetworks that tie the players more tightly together and make them interested in their shared fortunes. These links represent true knowledge—or experientially applied information about how the different portions of the enterprise work, and about how the enterprise works together as a whole. With this knowledge in hand, each constituent can act responsibly with respect to the enterprise and serves in a small cybernetic-style management role.

There is one more necessary factor that doesn't jump out at you from the model. Not only are subgroups of constituents linked together into mini nets but an individual constituent may play more than one role. An individual could be an investor, a customer and a producer all at once, and therefore have a true stake in every facet of the enterprise. To leverage that stake, the individual must also play a role in the management function—in understanding the body of knowledge that helps him or her make good decisions as a customer, investor and producer.

The 5 Es of Education Model (Table M-10):

The role of education is to serve as a catalyst for innovation, problem reformulation, and organizational renewal. The 5 Es are principles of education—and of leadership—for effective organizations. These components are:

[symbol] Explain: The learner needs a “background” composed of information and theory in order to intellectually understand. This “body of knowledge creates a context for action.

[symbol] Experience: The learner and teacher must have experience which embodies what is to be learned. Explanations and experience work together to personalize and bring meaning to the learner.

[symbol] Expectation: Expectations must be high in order for growth.

[symbol] Example: People will learn from what you do, not from what you say you are. To some extent, you are the subject you are teaching.

[symbol] Explore: The most powerful learning occurs when the learner is challenged and encouraged to take their understanding further, into “uncharted waters.” True exploration means leaving certainty behind.

These principles can be applied to any learning/teaching situation. The model implies that explanations and examples form the foundation of education, but this doesn't mean that they necessarily come first in the process of education. Perhaps exploration and some experience come first—then out of the experience the learner can extract explanations and develop a systematic approach to hunt for further examples to confirm, deny, or expand their conclusions. In practice, the process tends to jumble all of the 5 Es together, calling upon whichever one is required by the learner to take the next step or receive the next insight. If an event lacks one or several of the Es chances are its benefits will be marginalized.

Structure of the model: In this fluid model, explanation and example form the core. They are surrounded by a sac and membrane of expectation. Beyond that lies another, larger area of exploration. The membrane surrounding the entire model is experience.

It's clear that expectations exceed simple explanation and example. But they also, clearly must fall short of exploration, with its hidden element of the unknown and undiscovered. One of the keys to understanding this model is to realize that experience enfolds it all. Even the act of hearing or reading an explanation is an experience. If you imagine experience to be a separate exercise from explanation, then the setting and force of the explanations will likely suffer.

Experience should be managed using the Seven Domains as a template, for all experiences are facilitated one way or another. Frequently the facilitative aspects are left to chance, or hidden or poorly designed, but they are present. And experience should be crafted.

Thus, we can couch experience in terms of the other four Es, with the following result:

the experience of explanation is in the ability to listen, focus and absorb (not necessarily referring to only an auditory process).

the experience of expectation is acknowledging mastery and the path to be taken

the experience of exploration is a sense of wonder and a willingness to risk.

the experience of experience . . .

Stages of an Enterprise Model (Table M-11):

[symbol] Conception: This is where ventures and enterprises originate.

[symbol] Looping: Most ideas go through a roller coaster ride of peaks of success followed by valleys of near collapse before they become viable—capable of separate existence.

[symbol] Success: At this stage, the enterprise is viable. This means it understands as an organism how to maintain its metabolism from month to month, and how to grow. a Overshoot and Collapse: If the enterprise does not learn how to maintain homeostasis, it may overshoot its envelope of healthy growth and then rapidly collapse upon itself.

[symbol] Entrepreneurial Button: Newly conceived ideas within an existing Enterprise, even if tested through the looping stage, cannot become viable unless the Entrepreneurial Button is pushed. There must be an overt recognition of the need for and value of the new idea or it will not be allowed to grow.

[symbol] Mature: The Enterprise passes through probably its longest and most stable stage. This is also the most favorable time for spawning new enterprises although many ventures fail to do so until its almost too late . . .

[symbol] Turnaround: Ventures lose their ability to maintain homeostasis and begin to collapse. Usually this is due to a lag time in the organizations ability to respond to or anticipate external or internal rates of change; it falls behind or leaps too far ahead and is exposed.

[symbol] Demise: Eventually all organizations reach their demise. Sometimes its the easiest way for the enterprise to allow new ideas to escape and try for viability.

### The Entrepreneurial Button

To make a big leap of innovation the Entrepreneurial Button must be pushed. This means one of several things: An entirely new entity is born, unencumbered by the structures and culture of its parent. Perhaps the company spawns a subsidiary, or a venture with a partner. Or enterprising employees go off on their own with better ideas that were not being heard. The result is the zone of innovation for the new entity. The parent may go on to struggle for quite a while, unable to transform itself from within. The parent organization undergoes a metamorphosis or rebirth, shedding its inhibiting cultures, philosophies and policies. The result is the intergenerational enterprise trajectory which shows the parent organization making steady improvements and then leaping to a new level of innovation. In either case, the Entrepreneurial Button is not simply a zone where transformation just happens. The button doesnt occur at some predetermined location in the model, although there are more or less favorable times—one of the most favorable being the period of maturity, just after success. Pushing the button is a conscious decision. Much of the conceptual work will already have been done. The new idea will have passed through some looping already before the decision is made to launch it. The people making the decision are not always the executive management. An idea can be so powerful that it may “seek out” other people to launch it if no one in the parent organization is interested.

Ten Step Knowledge Work Process Model (Table M-12):

[symbol] Event: The event is some process undertaken by one or several “Knodes” (Knowledge Nodes) that produces information.

[symbol] Documentation: The information is captured, encoded in the form of a message, tagged for shipping, transduced across the Event membrane, and transferred via some signal, medium, and channel to the K-Base.

[symbol] K-base: The K-Base serves as repository, or data warehouse, and router for messages in the enterprise.

[symbol] Distribution: The documentation is repackaged, encoded, transduced, and transmitted across the Web (Enterprise) to all parties that need the information as potential Compelling input.

[symbol] Tracking: Tracking records the condition, origin and destination of each message that crosses the K-Base membrane (transduction), it creates a history of the use of the K-Base.

[symbol] Feedback: Knodes transmit information back to the K-Base concerning any State Changes they have experienced as a result of receiving and processing the original information.

[symbol] K-Base: The K-Base stores the feedback. & Design: The original information and the feedback are used to design the next iteration of work—the facilitation of the next event, or process.

[symbol] Read-Ahead: A read-ahead is advance information transmitted to the future events participants.

[symbol] Event: The cycle ends as it begins.

Meetings and events are an integral part of the creative cycle that allows organizations to solve problems and implement programs. Substantial leaps in productivity and effectiveness can be achieved by managing this process according to the 10-step model.

The model in flow: Note that the K-Base is embedded within the tracking system ring. This means that any message-bearing signal that enters or leaves the K-Base domain is logged-out—not just those from the distribution stage. Information within events, documentations, feedback, designs, and read-ahead all pass through the tracking system into the K-Base, out through the tracking system again and through distribution out to the Enterprise.

Think about the model being used not by a group or team, but by a single individual. And imagine this individual has no artifact or tool for recording incoming and outgoing information: information must be passed by work of mouth. In this case, the individuals brain is the K-base and the tracking system. Distribution happens by story-telling. Feedback is a direct communication process, design is creativity, the read-ahead is verbal or perhaps environmental preparation for the next event. Documentation and the K-Base are inseparable.

Note that some information is also passed directly from one step to another without passing through the K-Base. In fact, the vast majority of information in practice is either passed directly from one step to another or lost from the system altogether. Enterprises and other living systems survive by managing a small amount of the data that arrives at their senses, converting it into information and applying it experientially as knowledge.

The modeling language described herein is more than a shorthand. The modeling language functions the same way as any high level language in a computer. In addition to the glyphs and meanings that are set forth, there are certain transactional terms including Boolean operators such as greater than, equal to, larger than, less than, and, or and not. In addition, the language should include operators such as take, by, act on and the like.

Another important aspect of the language described herein is that the language is representational. Because the language is visual, both the color and size can have an exact and referential meaning. Thus, by assigning a referential meaning to each color, context can be added to the message conveyed by the glyphs. Likewise, size can have a exact and referential meaning, for example, size can indicate importance. The bigger the glyph, the more important the concept explained by that glyph.

Every organization, system, nation, community, agent, uses its own inherent models of work. Once agents are able to understand the current model they work within, they are able to iterate the model for higher performance, and allow colleagues to “step into” proven productive models, to facilitate Emergence of solutions.

The Four Step Recreative Process Model (Table M-13):

[symbol] Vision: Create a vision for what you want to create.

[symbol] Template: Create a template for your creation, in words, symbols, pictures, 3D, or some other physical medium. This template should represent your vision and be able to communicate its essence to others.

[symbol] Act: Make the creation real. Take the necessary steps to bring it into the world.

[symbol] Feedback: Discover how well the creation performs in the world. Does it fulfill your vision? How do others like it? Does it inspire new visions in you or in others?

[symbol] Recreate: Between each of the steps, you must recreate what it is you are trying to do given the different and unique parameters of each of these different steps.

How do you create what you want to create? How do you share your vision with others to allow them to help you create what you want to create? How do you measure the success of what you have created? These are the questions that the Four Step Recreative Process model addresses. At first glance this model seems pretty straightforward. As an example, let's examine the state of education today. After looking at the world (getting feedback) you decide that the education system is not satisfactory. You create a vision for a new kind of learning environment. Knowledge in this school is no longer divided in to the rigid categories of physics, history, math, philosophy and the like. Instead, all knowledge weaves together to form the elaborate fabric of the universe. Learning in this environment is experiential and shared.

You will not be able to create this environment alone so you must be able to share this vision. The vision, however, only exists in your head and in your heart. The vision is a collection of images, ideas and impressions that can only exist in the realm of concept. To share it with others, it must take on a physical form—it must become a template. Now, a template can take on any number of physical media: words, drawings, physical models made of clay or popsicle sticks, photos, essays, charts, graphs, or any other means of communication. To create a template, you must choose the elements of your vision that you most want to represent to others. What is the essence of the vision? What elements are essential to the creation you envision, and what elements can be flexible? Now you must decide how best to represent those elements. Your template for the new learning environment takes on a number of different forms. You draw a diagram to represent the interactions of different members of the learning community. You draw another diagram to represent the physical interactions of the people. And you write a story to capture the essence of the learning experience. These templates you share with others, who catch fire with the vision as it is recreated in their own minds. They can only understand as much of your vision as you have represented by the models. The rest of their visions are their of their own creation.

Now you must gather your group to create that learning environment. You must bring the templates into reality. This involves coordinated group effort based on the blueprints of your templates. Some people set up the environments, others decide what sorts of learning will go on, others find people to become the learners in this new environment. From the templates, a creation is brought into the world, and the creation must take into account real world factors that the template may not have considered. The reality is a different creature than the template, but the two attempt to represent the same vision in their respective media.

Now you must sit back and watch the learning environment operate. How well is it working? Are people falling back on old patterns of learning and teaching? Are learners using their knowledge in the real world and are they learning what they came to learn? Are you satisfied that your vision has been fulfilled? In what other ways could this environment be used? Who else should be a part of it? What else should be taught? Now you begin to create a new vision and the creative process cycles onward.

Best Case, Worst Case Model (Table M-14):

Best Case: Here we carefully define the conditions we would find ourselves in if everything went exactly as planned. Notice that this in NOT a utopia! This is a “best case” only in that our plans went well—we did not solve all of the world's problems here.

Worst Case: Now we get to play “Devil's Advocate” What happens if things go badly? What are the disaster scenarios? What are the grim possibilities? Again, the universe does not end in this scenario—it is only the “worst case” in that our plans go wickedly awry.

Most Probable Case: With our “practical hats”; firmly in place, we can now look at what the mostly likely results will be and at the path by which we can achieve them.

In Brief: What lies between the Best Case and Worst Case paths is the field of opportunity. Between Best Case and Most Probable Case lies the Profit Range. Between Most Probable and Worst Case is the Survival Range (albeit not necessarily a pleasant survival). Outside this envelope (either better than best or worse than worst) lies the Collapse and Death options from Stages of an Enterprise.

The Dynamic Model

If you imagine this model in motion over time, several interesting patterns emerge. First, the distance between Best Case and Worst Case—the field of possibility—is variable over time. Sometimes the future is wide open. Other times there is a very narrow band of potential outcomes. (I mention this only to touch on the limits of this static portrayal of the model.) Secondly, in its dynamic form, we are always located at the mouth of the Trunk. That moment is the present, and the field of opportunity is always opening anew before us. This means that the only time we can ever ACT on the model is at the mouth of the Trunk, for that is the only place at which we find ourselves. The corollary to that is that NOW is the only time we can act to influence the system. This is the greatest opportunity we have.

From this vantage point, it becomes clear that EVERY action must be aligned and true. Every action must bring “There” to “Here.” “Easy” actions that do not take us towards our goal (the Best Case) lead us quite clearly towards our Worst Case or even outside of the scope of the model—towards Death.

Trunk Management

The key to successful navigation of this model is “Trunk Management.” In the Trunk lies all of the resources that we bring with us to the present—experience, knowledge, relationships, finances, reputation, etc. In the Trunk also lies the past—the history that brought us to the present, the history that plays a large part in determining the nature of the field of opportunity. In the Trunk lies the context in which we make our decisions.

This model lays out for us all of our possible contingencies, all of our viable options. This should also show us all of the resources that we might need to accomplish any of the entire range of options. By thus discovering all of the resources we will need, we discover two things—those resources that we do not have which we need, and those resources the we have which we do not need. We must then be sure that our actions in the present serve to enhance those resources that we need.

Creating the Problem Model (Table M-15):

[symbol] Condition: These are the existing conditions before you begin the creative process. Notice that these conditions, in and of themselves are merely conditions. They are not the problem. These conditions are in constant flux and will change as the creative process advances.

[symbol] Vision: This is your vision for an ideal future state. In creating this vision, take into account your personal experiences, insights and views of reality.

[symbol] Problem: The problem is created when you discover a gap between reality and your vision for a new reality. The problem is neither current conditions nor the vision. Rather, it is the discrepancy between them.

[symbol] Creative Tension (Tug and Pull): The creative tension that comes into being when you decide to resolve the problem is the interplay between vision and reality. As the two tug and pull at each other, they will each change and modify in an effort to reach a synthesis.

The Dynamics of Discovery

People often say that defining the problem is the first step towards solving it. And this is true as far as it goes. The greatest trap however is the tendency to define a problem too narrowly. This may result in “solutions” that are only partially successful at best.

“Creating the Problem” outlines a more rigorous process. This approach involves taking a broad look, a scan, at both your mission and the conditions surrounding that mission, to explore more deeply the true nature of the situation, and the opportunities that can be created.

Like Scan-Focus-Act, this model seeks to steer the user away from “acting on assumptions” and toward a more complete examination of the current conditions and opportunities. In addition, the model implies that modifying your mission (without compromise) may be an important part of creating the solution.

Design Formation Model (Table M-16):

Program: A set of specifications concerning the intended use of a space including who may use it, and what they want to use it for. The program is typically a list.

Schematic Concept: The first proof of the program. Freehand blocking of the ideas at the smallest scale represented by the program, showing prominent elements that drive the design. “Bubble diagrams” and loose sketches.

Preliminary Design: The proof of the program showing the scaled relationships between elements of the program. A dimensioned, hard line drawing.

Design Development: Detail drawings of key components or specially designed items; some level of engineering of the design to see how it will work; an estimate of the budget; proofing out the major systems such as electricity and heating, ventilation and air conditioning.

Contract Documents: A set of plans that someone can build from, including performance specifications of materials and every level of detail of the project.

Production Management: The process that converts plans into a finished structure; creation and management of design modifications along the way; inspections; creation of as-built plans to show what was actually created.

Evaluation: The user or tenant takes occupancy and tests the efficacy of the design and the final building that resulted. The program is revisited to see both how well it was executed, and whether it was truly relevant to the users needs at the time of occupancy.

Beyond Architectural Applications

The word “design” means in part, to conceive, invent or contrive. But it also means to intend. To design is to bring intention to the process of invention. This doesn't mean that designers don't need a set of skills that allow them to conceive, invent and contrive, but it places those skills in a subservient role to asking the question, “what is it that asks for shape and form.”

The problem with the traditional design process is that once the final product has been created, the users will employ or inhabit it, and in that act of using their new invention, they'll see everything in a new light (unless they choose to remain blind). They'll see things that they did not know about when the project was being designed. Sometimes this new sense of vision results from seeing the tangible product before their eyes for the first time. Sometimes it results from changes in the surrounding environment. Anyone who has had to wire an older building for local area networks knows what I mean. Chances are, however, that the nature of the finished product will prohibit them from employing any of their new vision and instead, they'll find themselves trapped in a system built from and on old, outdated knowledge. We can't want what we are ignorant of. Your experience is your experience, and it's difficult to design, project, wish or envision something outside of the bounds of your own experience. What the end user wants is not irrelevant to the Design Formation process, but it is inadequate, underestimated, perhaps irrelevant to the world as it will be at the end of the project. And, what the designer wants for the user is also inadequate. Together they must explore new territory. If they don't surprise each other and themselves during the process, then they will bring into being a creation that keeps them from advancing, innovating, living.

Therefore, in the traditional application of the Design Formation, the Evaluation stage is a measure of the gap between performance and expectations. In the more expanded sense of the model, the Evaluation stage measures the degree to which the performance of the final product can adapt to new, unexpected conditions. The final product should broaden, expand, challenge, push and recreate the original program! This is what it means to ask, “what is it that asks for shape and form.”

The Design Formation process is one of education-not of one expert educating an ignorant potential user, but of co-designers pressing against the boundaries of intuition, meaning, and logic, to uncover what they truly know and what they don't know.

Formation is the process of producing. And at the same time, a formation is the thing formed (as in a geologic formation). It's a noun that refers at once to the creation and the process by which it is brought into being. The spirit in the process of being expressed is its own tangible expression unfolding. There's no separation between the two definitions that is not artificial. One cannot learn the process of formation without learning the formation itself. One cannot study the tangible aspects of the thing formed without simultaneously perceiving the process. Formation calls to mind a variation of Heisenberg's Uncertainty Principle: if you measure the process aspect of formation, you lose sight of the tangible expression; but if you measure the expression, you lose sight of the process. There is a continuous dialog between the design (the intent) and the formation (the process and the product in process).

The Learning Path: Five Points of Mastery Model (Table M-17):

[symbol] Learner: An explorer, innovator, self-developer, model-builder and action-taker who is receptive to ideas and guidance, able to reflect and act creatively, learns how to access information and create value from it for self and others. A unique set of contacts—family, peers, facilitators, sponsors, experts, and community members—comprise the Learner's constantly evolving learning network.

[symbol] Sponsor—Advocate—Advisor: The Sponsor provides the feedback and boundaries that ensure the learning path is effective and balanced, that options are clearly seen, that effort is required and rewarded, and that performance assessments—provided as feedback—are understood and interpreted correctly. The Sponsor's challenge is to optimize the performance of the individual Learner's network. The Sponsor and Learner together plan the Learner's next steps, taking into account the whole person, the individual's talents and interests, and the need to ensure breadth in the curriculum as well as depth in areas of special interest. The Sponsor provides continuity and perspective. Sponsors may change, depending upon the goals of the Learner.

[symbol] Facilitator Guide: One who helps others frame their experience, providing information, concepts and models, linking to new information and avenues of exploration, encouraging further exploration, guiding discussion among learners and removing blocks (both conceptual and material) to the creative process for an individual or team. The Facilitator crafts and delivers challenges that spark individual and team innovation and provokes Learners to break through imagined limits.

A Learner works with one or several facilitators; in each case, the learner and facilitator together create a learning contract and invent appropriate experiences and products. Learners engage in many projects simultaneously, incorporating strands from the core curriculum to weave the necessary framework of understanding and mastery. The Facilitator and the Learner, jointly responsible, manage both process and content.

[symbol] [symbol] Expert: The Expert develops specialized knowledge to a high degree in a given body of knowledge and is a resource to others. Everyone has expertise to share; everyone applies their expertise to create value for themselves and others, as participants in this learning environment.

[symbol] Steward: The Steward applies talents and knowledge in service to others—in stewardship of the community and ultimately of the world. Stewardship means holding a vision for yourself, your community, and your world, and being committed to actualizing that vision. The only way to steward anything is to engage with what we are stewarding in a cybernetic, whole systems manner. By learning anticipatory design, we steward our future as well as our present.

The Learning Path: Our human Learning Path begins at birth. From infancy, the learner embarks on a course that nourishes the innate love for exploration and discovery. A community expecting life-long learning and life-long contributions from its members acts to remove whatever blocks this natural process of growth. Just as every individual is unique, every learner's learning path is unique. We visualize these through a five-part life learning model we call the “Five Points of Mastery.” Each individual, formally and informally, moves in and out of these roles throughout their life, gaining a level of mastery of each, as appropriate to his or her life stage.

The Rate of Change Model (Table M-18):

[symbol] Complexity: A description of the complex phenomena demonstrated in systems characterized by nonlinear interactive components, emergent phenomena, continuous and discontinuous change, and unpredictable outcomes. Although there is at present no one accepted definitions of complexity, the term can be applied across a range of different yet related system behaviors such as chaos, self-organized criticality, complex, adaptive systems, neural nets, nonlinear dynamics, far-from-equilibrium conditions, and so on. Complexity characterizes complex systems as opposed to simple, linear, and equilibrium-based systems. Measures of complexity include algorithmic complexity; fractal dimensionality; Lyapunov exponents; Gellmann's “effective complexity” and Bennett's “logical depth.” (http://www.plexusinstitute.com/edgeware/archive/think/main_gloss3.html#c8)

[symbol] Rate of Change: “Speed=distance/time” is the prototype of all rate of change formulae. In general a rate of change may be the change in anything divided by the corresponding change in a related variable. In context of the Rate of Change Model, this denotes the qualitative as well as quantitative measures of change within an entity (such as an organization) and the environment in which it exists.

[symbol] Ability of Organizations to Respond: The capacity of an organization to alter its structure and behavior in order to stay requisite with the level of complexity and rate of change in which it exists.

Keeping Requisite In A Knowledge-based Economy: Existing design and decision-making processes cannot deal with the rate of change, complexity, scale and scope of modern systemic problems. This promotes unintended consequences, sub-optimization, bad decisions and harmful side effects.

Organizations largely tend to scope a problem that they are concerned with to the limits of their own immediate enterprise and the tools they have for solving the problem. They may work very diligently but if the problem is truly larger than their definition of it they will fail in their efforts. Only if organizations can embrace the true scale, scope and complexity of the work they will make far better designs and implementations.

The transformation of the global economy adds tremendous complexity to organizational work. Added to this is the fact that a network economy is intrinsically more complex and fast changing than the industrial economy. Technology, itself, is increasingly complex. A crowded world with growing aspirations adds to the mix. All this gives rise to SYSTEMIC problems—problems that cannot be solved from a narrow “parts” perspective.

Linear methods of meetings and group process are inadequate to deal with the scale, scope and complexity integral to these problems. Existing environments impose hidden restrictions that make people adapt ther work processes to the environment. The environment should seamlessly adapt to people's requirements. A system and method that effectively facilitates the interactions of large groups and communities of large groups is necessary.

Algorithm Language: Rule Statements RS; Explains our experience. Interaction among agents, neuralgic behavior, fundamental building blocks. The economic, industrial, and information age work we do today is built upon algorithmic equations and rules. Rarely is it believed that ecosystems, organizations, companies, individuals are built, at the core by algorithms. Contrary to common belief, the present inventors have found that behavior within groups, among agents, is repeatable, driven by rules, and can be demonstrated as such. Regardless of the dynamics of the individuals, the groups, the organizations and the issue they wish to “solve,” certain predictable combinations of events and patterns will occur if predictable, patterned rules are followed in the facilitation process.

Deep Language: Machine Language ML; Explains the mind of individuals, the engine of automobiles, the code of computer programs, so deep that it has not yet, been decoded by humans. This is explained in connection with the exemplary Subsystems of the present Invention as described herein. It is noted, however, that it is possible to construct other Subsystems using the System and Method of the present Invention.

Agent Code Definition: According to another aspect of the present Invention, Agents may be uniquely and precisely defined. This is useful in building electronic or virtual Agents according to the present Invention. Preferably, the Agent definition “code” will contain (at least) the following:

1) Level of Recursion.

2) Iteration number (in a sequence of facilitated activities—this could be done by InfoLog #).

3) The material composition of the Agent (by category).

4) The medium of the Agent (in terms of the System).

5) The FUNCTION of the Agent (which is the sum of all the agents that make up the Agent in the language (level) of algorithm.

This code could look something like this: rL2/wid.1223990034.00123455.sts/dig/vNW/kLOC-pITRAV-rp&n In this instance, the Agent is on Recursion 2 rL2, the InfoLog# states the place, time and person using/accessing/“owning” the Agent, that the Agent is digital in physical nature and posted on the Internet (or equivalent) and is made of three agents (functions) scripts: “Know your location,” “Purchase Integrated Travel Ticket” and “Report, Post and Notify (the results). Other forms of code can be used and additional information can be embedded. Moreover, Color, shape, texture and size (in some systems) can be used to add further description for a more user friendly interface in “AgentBuilder.” The exact language structure and form of the code-strings are system-specific and will alter given the application environment.

Definition of Memory

A definition of “memory” ToA is hereby offered that provides continuity from neuron level rL1 to Global Economic System rL7. Regardless of material, type or nature of Agent, a common view of memory (language) is established that can be described, measured, documented and recorded. State 1, state 2, state 3 state . . . n—that is, the STATE of the entire system (in focus) is the memory (of the system and its conponents and parts) and that this progresses through continuous but discrete changes.

This view of memory is congruent with the definition of “Variety” which, in Cybernetics (Asby, Beer), is identified as the number of possible states of an entity or system. Which means, for the purpose of the present Invention, memory of a system and the complexity of a system are roughly equivalent.

Therefore, when building [symbol] facilitating [symbol] augmenting Agents of all kinds, the essential focus [symbol] of this System and Method is on how Agents, experience [symbol] move, learn [symbol] [symbol] connect, incorporate [symbol] and accomplish emergent synergistic results—and are memory of this experience [symbol] This is the stuff of creativity and life. The very nature of a global complex economic system is “lifelike” in its scale, scope [symbol] complexity and behavior (De Rosnay).

There are several Design Assumptions ToA that formulate this paradigm [symbol] of memory: 1—Memory is distributed. 2—The architecture of memory is a network. 3—The architecture changes with use. 4—Memory utilizes reuse. 5—It is digital and analog. 6—It is active. 7—Proximity, signal strength and repetition are important. 8—It is context sensitive. 9—It is agent-based. 10—It employs morphic resonance. 11—The components are rule-based. 12—The state of the system is the memory. 13—Geometry has content. 14—Components vote. 15—Memory employs language. 16—Dialog within and without the system transacts instructions. 17—Memory chunks into self-organizing cascading hierarchies. 18—Memory is not storage. 19—Consciousness is not necessary. 20—Complex Memory systems parallel process.

These Design [symbol] Assumptions can be used to generate the component attributes and architecture of any complex memory system. For example rL4-Ss1, a facilitator [symbol] Agent, In this System and Method, is aware of participating in a deliberate process of memory-making [symbol] This is a far deeper level of work, with many different consequences, than group “facilitation” as it is commonly understood and practiced. The retention of the experience [symbol] is clearly one of these.

In another example, rL6-Ss4, a design [symbol] of a transportation system, in this System and Method, would employ all the component Agents of the system as units (Agents) of memory utilizing the STATE of the system, itself, as a means of governing the system itself. No more standing in lines merely to “inform” the system that you are there and intend to get on the airplane.

Today, in the design [symbol] of “complex” human systems, very little of the information [symbol] that is contained, intrinsically, in the system is used [symbol] . The “memory” is lost. This leads to all kinds of sub-optimizations and, too often, the human user has to keep putting back into the system the information that was “lost.” How often have you filled out that form?

The present Invention provides a System and Method for building “smarts” and “self-awareness” and learning into designing [symbol] , building [symbol] and using [symbol] systems that Augment Knowledge Commerce.

Subsystem 1—System and Method for Facilitating Interaction Among Agents Promoting Feedback, Learning and Emergent Group Genius in a Radically Compressed Time Period

The System, Method and process of the present Invention will now be described in connection with the attached diagrams. Again, further information regarding the present invention can be found in the Appendices hereto, which are incorporated herein by reference. An embodiment of the present invention is described in FIGS. SS1-1 to SS1-7 from U.S. Pat. No. 6,292,830 which have been included in the Appendix. FIG. SS1-1 provides a block diagram overviewing a single iteration of the method of the present Invention. The steps of the present invention are not intended to occur in a particular order; they may occur simultaneously or in an orderly fashion, but not necessarily in the order illustrated in FIG. SS1-1. Moreover, the specific steps shown are illustrative, not exhaustive. The process and system can include other steps.

The method shown in FIG. SS1-1 illustrates only a single iteration of an embodiment of the present Invention. An important aspect of the present Invention is that the process occurs on multiple levels of recursion ToA. Thus, it is contemplated that other iterations can, and preferably do, occur consecutively or in a chain-like manner, such as feeding the resultant agent or product of an iteration into a subsequent iteration; in addition, simultaneous multiple iterations can occur at different levels of interaction. For example, some Agents within a particular iteration, such as a facilitator, may also conduct additional iterations relating to any particular step in the process or mirroring part or all of the iteration.

The system and process of the present invention are most productive when there are multiple levels of recursion and feedback occurring simultaneously. The use of an interactive process that includes multiple levels of recursion, feedback and self-adjustment yields a system and process that can be used to facilitate the interaction among agents such that synergistic results occur. In solving complex problems, for example, the system and process need not address the entire problem at once, but instead evolves toward a solution. In short, problems are dissolved, not solved.

In the single iteration shown in FIG. SS1-1, in step S1, a group or pool of agents for potential use with the system are identified. This identification step can be performed by a user of the system or by persons or systems outside the system of the present Invention. These agents can include, for example, intelligent agents, persons, documents, computer software, firmware, living things, computers, and other objects. Collection by a system or person outside the system of the present Invention could include, for example, a company selecting particular intelligent agents, documents, programs, and people as potential agents to be included for a particular iteration.

In step S2, an operation is conducted upon these Agents. In an embodiment of the present invention, this operation includes selecting particular Agents fitting a predetermined cross-section of skills or other creativity elements designed to foster operation of the present invention. The predetermined cross-section is dependent on the scope of the iteration; for example, if a particular problem is attempting to be solved for a particular group of agents, the nature of the problem and group suggests an appropriate cross-section. In addition, an embodiment of the present invention contains factors that support develop of a generic cross-section, which is alterable using iteration-specific information.

The selection process of step S2 can include, for example, querying the pool of agents for responses used in determining their amenability for the particular iteration. The querying can be intended to illicit characteristics about the agent that correspond or mesh with those characteristics identified for the predetermined cross-section. In addition, the substance of the responses themselves are useful in developing the cross-section.

In step S3, the agents selected as a result of the process of step S2 are added to an environment that has been created in step S4. Adding the Agents can include connecting computers or Agents via a network or other electronic or other coupling. It can also include collecting persons or groups of persons in a particular place.

Creating the environment of step S4 also includes such things as creating a particular network, designing a particular workspace, programming a computer, or other methods of collecting agents. In addition, other elements of the environment may be created. In particular, if the environment includes persons, the environment can include particular amenities designed to foster effective operation of the present invention. For example, the environment may include sectioned areas for collecting groups, wall surface writing and drawing capabilities to allow the agents to continuously maintain information in an easily viewable area, computers for use of agents, television or other video capabilities, and toys, games, books, and other tools designed to assist agents in communicating ideas and performing other functions that comprise the function of the present invention.

In step S5, the user or Agents within the system perform work. The type of work performed by the agents can include a variety of tasks or exercises designed to encourage identification and detailed definition of problems or issues specific to the iteration using methods of approaching the problems or issues that are outside the agents usual scope of problem solving patterns. The exercises and tasks can include collecting information, role playing, game playing, research, analysis, and reporting, model building, illustration of issues using three dimensional objects and tools, and other problem-solving activities.

The results of the processes of steps S3, S4, and S5 are production of new agents, such as documents, computer programs, suggested problem approaches analogous to issues at hand, and proposed solutions.

In step S6, a sophisticated decision process occurs, which is further detailed in FIG. SS1-2, described below. The outcome of the decision process produces one of two outputs to other steps. In the first output branch, the resultant new agent is fed back to the current iteration. The first step of the feedback process is to test the new agent in step S7. In step S8, a decision is made as to whether to input the new agent as a perform work function for step S5. Alternatively, the system proceeds to step S9, in which a decision is made whether to input the new agent to the environment, step S4, thereby effectively creating a new environment, or to input the new agent as another agent in the system, step S3.

In the second output branch, the output of step S6 serves as input, step S10, to a new environment. In step S11, the agent is then altered as a result of its incorporation into the new environment. In step S12, the altered agent is evaluated in a sophisticated decision process similar to step S6, as described in more detail in relation to FIG. SS1-2 below. The results of this decision process are either to feed the resultant newly altered agent back to the current iteration, via step S7, or to exit the agent from the iteration. The exit of the agent from the current iteration can serve a variety of functions. For example, the exiting agent can provide input to another iterative process using the present invention. The exiting agent can also simply exit the process.

Two examples of the operation of an iteration of the present invention as described in FIG. SS1-1 follow. These examples are intended to be illustrative only. The examples are not intended to limit the application of the system to a particular set of Agents, a particular iteration, or a particular environment. The examples are also not intended to imply that a single iteration or a particular order of steps are necessary.

The first example illustrates a facilitated creativity workshop process. In a workshop using the present invention, some number of steps of the workshop are automated, such as computerized, using the method and system of the present invention.

In this example, referring to FIG. SS1-1, in step S1 a group of persons are identified as a pool of potential agents to assist in solving a particular problem; in this example, both the pool of people and the particular problem are identified by a company.

In step S2, persons in the pool are provided with information and queried by a user, such as a facilitator, who also serves as an agent, in a targeted manner designed to illicit information about their potential amenability to the problem identified and the set of skills selected by the user. A computerized matrix of skill needs matched to the problem at hand is used to select from the pool; the matrix is partially fulfilled using a selection process. In this example, this process of matching skill results, problem-specific issues, and a matrix are automated. In addition, other agents are identified, such as intelligent agents designed to obtain particular information from the Internet. These intelligent agents can be either commercially available or specifically designed and tailored to the particular problem at hand. Also as a part of step S2, either separately or as an element of the pool selection process, a set of documents and other informational items are provided to the agents.

In step S3, the persons and intelligent agents selected are collected in a common environment, which is created in step S4. The environment can include furniture conducive to creativity, moveable walls that participants can write on, toys, games, video displays, computers, and other tools for creatively producing examples and illustrating points.

Contemporaneously with steps S3 and S4, exercises or other tasks are selected for performance by the agents as step S5. These exercises can include collecting information, such as automatically searching the Internet, role playing, game playing, analysis, reporting, or other problem-solving activities. These exercises are designed to encourage the agents to function or think about problems in a way that facilitates identification and detailed definition of the problem at hand using methods outside the scope of the usual problem solving of the agents. For example, a subgroup agents may be assigned to study and system in nature that may be suggestive of the problem at hand. The subgroup then provides their analysis and results to the selected group as a whole, which is then used for additional analysis and problem clarification. An intelligent agent may be assigned to obtain information about elements of nature when the problem is focused on a business issue.

In step S6, a decision is made as to whether the results are fed back, step S7, to the current iteration, as additional work performance, step S8, or into the environment or as additional agents, step S9. Alternatively, the results may be passed to an outside environment, step S10.

In this example, the decision process is facilitated via input and evaluation using a computer program. Following step S10, the agent is altered by the outside environment in step S11. The altered agent is then tested in step S12, in a manner similar to that of step S6, and a decision is made as to whether to exit the agent from this iteration, or to return the agent or additional information obtained as part of the altered output agent process to the current iteration through step S7. As an example feed to an outside environment in steps S10 and S11, an initial proposal regarding the problem at hand could be sent via an agent to the management of the company. The management of the company could then provide feedback to the agent, who then returns to the environment of the current iteration to continue the iterative process.

In the second example, much more of the process is automated, such as by computer program and computerized intelligent agents. In this example, in step S1, a group of intelligent agents, each having specific functions and missions, are developed, step S2, by a user at a terminal to solve a particular problem.

The functions and missions of these intelligent agents are identified or developed based on cross-indexing of pre-selected creativity traits and the scope of the problem at hand. In this example, an automated process assists the user with developing this cross-index. The agents are then connected and communicate with the user via computer connection, which serves as the environment, step S4. As the user performs work, step S5, the agents provide a variety of inputs based on their assigned functions.

For example, an agent could be assigned to search the Internet for associative ideas based on use of particular keywords by the user. Thus, as the user word processes and creates keywords some agents would continuously search and display results associated with keywords or combinations of keywords. As the user works on the problem, the results of the keyword combinations are fed back in steps S7, S8, and S9, as additional work and to other intelligent agents performing other functions; the results of these functions are also continuously provided to the user as part of the environment.

In this way, a continuous feedback loop of information from the various agents, including the user, would serve as a growing set of information that is simultaneously displayed in the users environment. At some point the user outputs the results, step S10, alters the results outside the process, step S11, and then makes a decision, step S12, as to whether the outputted result is sufficient to solve the problem for the users needs or whether the result should return to the process, step S7, for further iteration. The decision step S6 is a complex process that may in itself incorporate an entire iteration of the process shown in FIG. SS1-1.

As shown in FIG. SS1-2, this process includes the following steps. In step S20, the original state model applicable to the iteration at hand is inputted, and in step S21 a current state model is inputted. In step S22, these two models are compared to develop a differential or delta between them. In step S23, a matrix and set of rules applicable to the issue of the iteration are developed. In step S24, the matrix and set of rules are inputted with the delta. In step S25, a first combination of the matrix and rules are applied to the delta. In step S26, subsequent combinations of the matrix and rules are iteratively applied to the delta until a provisional dissolve of the delta is reached. This process can include agents, an environment, and performance of work, as described in relation to FIG. SS1-1. In step S27, the agent produced by the combination of matrix and rules is applied to the delta to produce a provisional dissolve. In step S27, this agent is shipped either back into the current iteration, or out to a new environment, or both. A similar process occurs with regard to step S12 of FIG. SS1-1, and can occur with regard to steps S8 and S9.

FIGS. SS1-SS1-3 through 7 comprise block diagrams illustrating elements supporting the various steps shown in FIG. SS1-1.

In FIG. SS1-3, the plurality of agents and their functions 1 include people 2, machines 3, computers 4, software 5, firmware 6, living things 7, objects 8, input and output both among agents and external to agents 9, and an operating system 10.

In FIG. SS1-4, elements of the environment 20 include one or more agents 21, architectural components 22, objects 23, variable boundaries 24, information 25, location (micro and macro) 26, tools 27, energy 28, input and output 29 both among elements of the environment 30 and to external elements from the environment 31, and an operating system 32. Variable boundaries can include, for example, the porosity of the environment. This variable is matched to the environment based on the agents, the scope and nature of the work, and the influence of other environmental factors. Important influences on the agent or agents in relation to the environment include energy 33, the physical nature of the agents 34, the knowledge and intellectual properties of the individual agents 35, the agents psychological makeup 36, and the knowledge base of agent characteristics 37, both for the agents as individuals 38 and as a group 39.

FIG. SS1-5 illustrates important components of the performing work element 45 of the present invention. These components include identifying or developing a goal model 46, such as an end state model that enables the problem to be created and dissolved, acquiring experience 47, reframing 48, recognizing patterns 49, building models 50, simulating 51, selecting 52, testing 53, deciding 54, and iterating 55. In addition, input and output 56 among the components and from the components to external components and an operating system 57 make up aspects of the perform work element 45 of the present invention.

FIG. SS1-6 presents examples or elements of the altered or output agent 60 produced by iterations of the present invention. The output agent 60 consists of one or more of an altered input agent 61, altered environment elements 62, new agents 63, such as work products or non-autonomous agents, and agent mission maps 64. In addition, input and output 65 among the components and from the components to external components and an operating system 66 make up aspects of the output agent element 60 of the present invention.

FIG. SS1-7 presents examples or elements of the output agent and new environment interaction 70. These elements include the output agent medium 71, such as a document or a program, mission 72, output agent feedback and communication 73, and new environment feedback and communication 74. In addition, input and output 75 among the components and from the components to external components and an operating system 76 make up aspects of the output agent and new environment interaction element 70 of the present invention.

FIG. SS1-8 defines the conditions required for the consistent occurrence of emergence in the interaction of human Agents and other Agents. A boundary 1 is required. Any, exercise, event or system starts with “add agents”—see: S3 FIG. SS1-1. The boundary rules ToA vary according to context and purpose. For example, in a DesignShop exercise, the boundary rules would incorporate and “impose” by embedding into all 7 Domains (Table M3) the 22 habits of creative people. In a software application, the rules pertain to the operating system of the machine environment and the definition of Agents in, as an option, OOP (Object Oriented Programming) code. 2 of FIG. SS1-8 illustrates the levels of recursion “above” the “zone of emergence” 3. Typically, these levels of recursion, 2, relate to high order goals, instructions, meta-code Agents and the agency ToA of context, memory, purpose. The “zone of emergence” 3 is a heuristic ToA environment. Emergent phenomena cannot be predicted or controlled. Attempts at control—interventions ToA—generate unintended consequences ToA. Cybernetic systems ToA (complex systems governed by feedback) hunt ToA. They seek outcomes and learn, adjust, adapt as they act. Their behavior is a sine wave due to lag ToA in their feedback processes. This level of recursion, 3, while free is bound ToA. This process is iterative as shown in S4, S5, S6, S7, S8, S9, of SS1-1. The zone of emergence is constantly adjusting as a consequence of the work performed within it and from feedback (8, 9, 10, 11, 12, 13, 14, 15) between recursion levels and iterations of work ToA. 4 of SS1-8 illustrates the recursion levels in support of the zone of emergence. Typically, these are composed of tool kits that augment ToA the emergent processes.

5, 6, 7 of SS1-8 show iterations of work. The Algorithm is that three levels of recursion and three iterations ToA of work is the minimum requirement for consistent emergence. An iteration requires completing the full circuit of work per the Creative Process Model (M 8) in a contiguous moment of time/space and the other factors that effect the continuity of experience of the Agents involved. Stopping work and beginning work—later—does not meet the conditions of iteration. Maintaining work continuity is essential. If factors in the internal and external environment change faster than the work iterations can occur, then requisite variety is lost (v does not equal V) between 1, 2, 3, 4, 5, 6, 7 and the external environment. Systematic emergence is lost.

8, 9, 10, 11, 12, 13, 14, 15, of SS1-8 is the feedback ToA between work iterations and recursion levels. This feedback has to be of sufficiently high frequency and low magnitude so that the sample rate is requisite with the rate of change ToA. Internally and in the greater environment. This feed back is discrete. In Table 2, for example, feedback is shown in the Scan D/PT iteration and the Focus D/PT iteration between S7 (Test Altered Agent) in the zone of emergence and S3 (Add Agents) from a higher recursion level. The “a,b,c” example shown instructs: “the process of testing participants (Altered Agents) by results from different levels of recursion to Add Agents (from the enterprise ValueWeb) as the work progresses. The rule RS of iterative, feedback driven systems acting on multiple levels of recursion (Table 2) states the conditions (Table M 15) necessary for successful operation of emergent systems as illustrate herein.

16, 17, 18, 19, 20 of SS1-8 indicates the sine wave of work and emerging results>this involves both AM ToA and FM ToA modulation ToA. The varied width of the sine wave arrow indicates the variance of critical mass ToA of Agents required a work iterations progress. This is further illustrated in Table 2. The emerging vector ToA is held in dynamic equilibrium ToA by feedback and stays within the system limits ToA only if the wiring of the feedback loops is properly done. See SS1-5.

21 of SS1-8 is the point where/when/how the emergent system “escapes to a higher order” (Prigogine). The is end-of-game for this iteration (on the scale of the illustration). A stste change is made. Agents transform.

22, 23, 24, 25, of SS1-5 indicate iterations that occur in recursion levels above and below the zone of emergence recursion level, 3. These iteration boundaries are more permiable and may not align with 5, 6, and 7.

26 of SS1-8 is equivalent to “Exit Iteration” of FIG. SS1-1. The extreme recursive nature of this System and Method must be noted. The entire SS1-8, as illustrated herein, can exist as one element at another level of recursion (in 5 of SS1-8 as example). In a complex system, it will. Multiple recursions and iterations is how requisite variety is achieved. See table 2. 27 of SS1-1 indicates several parallel processes, events and work that can have discrete feedback to iteration in focus. This is the PatchWorks Design Architecture SS1-5 which is a key aspect of this System and Method.

The Zone of Emergence Engine and Process Architecture deals with several critical issues related to control versus non control, V=V versus v not=V, intent versus emergence, on all scales of this System and Method from rL1 through rL7.

Subsystem 2—System and Method for Optimizing Agent Pattern Language Values in Collaborative Environments

At its highest level, the currently preferred embodiment of the system for optimizing human and architectural pattern language values of the present invention is based on the recognition that a collaborative work environment is a collection of objects and that the system has rules. Thus, the system comprises a computer system that has means for storing information concerning: what objects can be used within an environment, the cost of each of the objects, the architectural rules governing the objects and the environment, the architectural values associated with the objects and the environment and knows the rules of pattern language. This data can be stored in memory tables or any other suitable means.

Since some of the values, such as architectural values, vary according to a customer's taste or preferences, the system preferably includes means for adjusting the relative values of things such as architectural values based on a customer's or client's objectives.

The system also includes means, preferably electronic display monitors, for displaying a representation of the environmental layout and means, such as icons, for graphically representing objects within the environment. In the preferred embodiment, the user can use a pointing tool, such as a mouse, to “pick up” and place the objects in desired locations within the environment. Since the system knows the cost of the objects selected, the architectural rules concerning its placement, the architectural values associated with particular objects in the rules of pattern language, the system can provide the total cost as well as architectural values score or in the pattern language score, on a real time basis.

In accordance with a further embodiment of the invention, the system of the present invention can be used to manage the environment. In particular, the system can be designed so that the individual system knows what objects are in the environment and where those objects are (how the environment is configured). This can be achieved in a variety of ways such as by placing chips in each of the objects or placing sensors within the environment. In this way, the system can monitor an environment once in place and send a warning, if, for example, an object is moved into a place that is architecturally unacceptable (e.g., an object is moved to place where it blocks the door). Thus, in summary, the system facilitates both design and placement of furniture in office, home and other environments and also monitors the environment once in place.

(FIGS. SS2-1 through SS2-93, described in the text below, from U.S. Pat. No. 6,292,830 have been included in the Appendix.) While there are various ways of operating and configuring the system of the present invention, FIG. SS2-1 and 1a show a high level system flow diagram and FIG. SS2-2 shows a high level view of one possible system configuration according to the present invention.

As shown in FIG. SS2-2, the system is adapted for use by a User 1 working at a personal computer or work station 2 that includes a display monitor, which serves as the display means. Personal computer 2 may also include a CPU for performing all system functions or, as shown, the computer may be linked, as indicated at 4 and 6, to a network 5 that includes a mainframe or server computer 7. Although a specific hardware configuration is shown, the hardware configuration is not critical to the system of the invention. Specifically, as noted before, all the system functions could be performed on a stand-alone computer. The system stores (preferable in RAM) data concerning various objects (indicated as objects 1, 2 . . . n) that are available for use within the environment. For each object, the system should store at least data concerning the object's size, shape and location within the environment. The system also stores in memory data relating to the parameters of the environment and applicable architectural rules. Again, the location of this memory within the system and environment is not critical. For example, much of the information concerning the attributes of the objects could be stored within or on the objects themselves if each object includes a microchip or even a CPU. There are, of course, various ways of identifying the location of an object within the system, including, without limitation, sensors, radio signals hardwiring and infrared signals and the like. the objects should preferably be “networked” in a broad sense so that they can communicate with or be sensed by other parts of the system. Moreover, if the object is capable of reconfiguration, the system preferably includes some means (either internal or external to the object itself) for recognizing the current configuration of each object.

The system also includes various tables containing information concerning the objects selected. Specifically, the system preferably includes at least three tables: a table concerning the cost of each available object; a table concerning the architectural value associated with each available object; and a table concerning the pattern language value associated with each available object.

The system shown in FIG. SS2-2 operates as shown in FIGS. SS2-1 and 1a. Specifically, the system initially prompts, preferably through the display monitor, the customer to input his or her name at Step S1. At step S2, the customer is asked to select an objective. This objective may be selected from a menu that includes choices such as “MAXIMUM ECONOMIC EFFICIENCY” or “MAXIMUM PATTERN LANGUAGE VALUE” or more detailed choices such as “MAXIMIZE NATURAL LIGHT” or “MAXIMIZE DENSITY.” Alternatively, this list could include, as a subroutine, a customer questionnaire from which data could be obtained concerning customer preferences.

Regardless of how the customer preferences are ascertained, the system preferably includes a means such as one of the computers 2, 7 for adjusting architectural and pattern language values stored in the tables as shown at Step S3. More specifically, the values contained in Tables 2 and 3 which identify an architectural value and a pattern language value associated with each object are updated to reflect the customer's preference. Thus, for example, if a customer has indicated that there is a premium for economic efficiency, then those architectural values that provide, for example, greater density are given a higher value. Alternatively, if the customer has indicated a preference for maximum natural light, those objects that enhance natural light will receive greater value.

At Step S4, the customer is asked to select or input environment parameters. This could be done in several different ways. The customer could be presented with several standard environmental configurations (“boxes”) and asked to select among these if the design is being done for a building with the standard box-type layout. More likely, however, the customer is asked to provide an outline of the environment parameters of the environment for which the design is intended. This would include an outline of the exterior walls, including an indication of doors, windows and utilities.

Based on the input at Step S4, the system, at Step S5, displays the environment as specified by the customer. In addition, at Step S6, the system displays representations, preferably icons, of available objects for location within the environment. Preferably, the available objects are displayed in proportion to their size or, if this is not practical, are displayed to scale once selected.

The system also, at Step S7, displays the cost, architectural values and pattern language values of the system as designed thus far. At this initial step, these values will, of course, naturally, be 0.

Each time an object is placed within the environment, a determination is made, at Step S9, whether the location selected within the environment satisfies the set of architectural rules (stored within the system) that are specified for the particular jurisdiction. If not, the system outputs an error message (at Step S10) explaining the problem and prompting the user to select another option. If, on the other hand, the location satisfies all applicable architectural rules, then the cost, architectural and pattern language score is updated at Step S11, the display of the environment is updated at Step S12 and the display of available objects is updated at Step S13.

The user is then prompted, at Step S14 to confirm the selection. If the user chooses not to confirm the selection, then the object is deleted from the display of the environment at Step S15 and the tables and display are updated (reset) at Step S16.

If, at Step S14, the user confirms the selection and placement of the object, then an inquiry is made, at Step S17, as to whether the design is complete. If not, the user is returned to Step S8 and the process is repeated until the design is complete. Once the design is complete, the user is given an opportunity, at Step S18, to print out or to otherwise record the final design in the system, and the process is complete.

As mentioned previously, the present invention also relates to various furniture components that make it possible to optimize human and architectural pattern language values in a collaborative work environment. In general, a collaborative work environment may be thought of as including various levels of components. At the highest levels (aside from cities and regions themselves), the environment includes buildings and the rooms within the buildings. The present invention, relates primarily to components below these levels which may be characterized as follows: armature level components; divider (WorkWall™) level components; work station system level components; sub-components; and, at the lowest level, pieces. The present invention provides components specifically assigned to optimize human and architectural pattern language value at each of these levels. These components are described in the figures attached hereto and in the appendices hereto.

FIG. SS2-1B shows a sketch of a collaborative work environment according to the present invention. The critical aspect of this collaborative environment is the overall integration of media into the work environment. Thus, the environment of the present invention can include a range of multi-media devices, including whiteboards that are marked using markers, pixelated writing boards for enhanced 3D-type graphics, electronic whiteboards that allow electronic input and output, whiteboards that include full color scanning and copying capabilities and interactive whiteboards. As used herein, the term “whiteboards” is intended to encompass the full range of work walls or writing walls, and is not intended to be limited to such walls that are the color white. Indeed, the standard writing walls of the present invention are preferably gray in color.

With specific reference to FIG. SS2-1B, the environment shown includes a large-scale whitewall 10 that could be either a marker-type whitewall, or an electronic whitewall. The environment also includes a large-scale video screen 20 to allow remote collaboration. Additionally, knowledge workers are shown working with a variety of components including laptop computers 30, personal digital assistants 40 and a collaborative multi-screen work station 50. This sketch shows a the total integration of media into the environment and the use of the furniture systems of the present invention within the environment. The Workwall 10 includes a series of Hypertiles™ and discloses the possibility of an intelligent assistant.

The fully integrated environment of the present invention, an example of which is shown in FIG. SS2-1B, allows rapid prototyping in a collaborative way. The environment also allows for the facilitation of interaction among intelligent agents to achieve rapid design and rapid prototyping. Preferably, the environment can include multiple generations of development in a single space.

The use of media, which is most completely illustrated in FIG. SS2-1B, is an important aspect of the present invention. In this regard, it should be understood that the environments of the present invention are scaleable and adaptable to new generations of media. The environments allow full integration of a variety of media and are responsive to the needs of all of the senses.

To provide further understanding of how these components make it possible to optimize both human and architectural pattern language values various components, sub-components and pieces will now be illustrated and described with reference to FIGS. SS2-3A-93. In addition, reference should be made to the attached appendices which are part of this specification and show various component designs and system layouts that, by themselves, form part of the present invention and are used in the system of the present invention.

To begin with, FIGS. SS2-3A-C show various components. In particular, FIGS. SS2-3A and 3B shows rolling bookcases of various heights. This type of component can be used to provide mobility and variation in scale of furniture that makes partitioning of space possible. Different ranges of partitioning of any work space can be achieved through the use of components of various heights. FIG. SS2-3B also shows how moving storage capabilities can be provided.

FIG. SS2-3C shows a perspective view of a stack of chairs that can be arranged according to users' preference. Reconfigurability is important to address human values such as economic efficiency and flexibility.

FIG. SS2-4 shows a kiosk component that includes multiple work surfaces including a work surface on which a key board is shown as supported. The work surface can be moved into one of three different slots to allow work surface height adjustments. Moreover, the slots can receiving work services with a different configuration. The top of the base supports a computer monitor. The entire structure supported on rolling casters (wheels) so that the kiosk can be easily moved by the user without technical assistance.

FIG. SS2-5 illustrates the flexibility of the basic kiosk structure that results from the use of a work surface receiving slot. In particular, FIG. SS2-5 shows a kiosk that is similar to the kiosk in FIG. SS2-4 except that the work surface with a different configuration has been inserted into the work surface receiving slot.

FIG. SS2-6 shows a work unit that is a complete portable assistant. The unit contains two compartments for letter-hanging files and eight drawers for storage. The unit also includes a double sided write-on, write-off WORK WALL™. Preferably, the surface of the WORK WALL™ is magnetic to hold magnetic tiles or other pieces. The work unit includes smooth-riding casters to allow mobility without technical assistance. Thus, this single unit provides a file for storing information, drawers, work walls, and the ability to provide a work space as desired all in a component that is mobile.

FIGS. SS2-7 and 8 shows plurality of shelf cubes arranged to provide a portion of a cube-office system. The shelf cube provides adjustability without technical assistance (note FIG. SS2-8) and can be used to divide an office space. Each cube is a modular, versatile and efficient approach to shelving needs. The cubes preferably include dimple-like indentations on the top and rounded nubs on the bottom of each unit so that the shelf cubes are stackable and extremely stable. Each unit can stand alone or can or be combined with others stacking up to four cubes tall in four directions. The system also can include a plurality of base units as shown to provide stability of the cube office system. The system of the present invention preferably includes units of different width such as, for example, six inch, twelve inch and eighteen inch wide units. The user can assemble cube system with minimal number of tools.

FIG. SS2-9 shows a portion environment that includes work walls, an enclosed space, worktable, and chairs. Among other things, this portion of the environment includes WORK WALLS™ supported on wheels to provide mobility, flexibility and efficient storage. WORK WALL™, are an entire work space on wheels and include an off-white writing surface made of porcelain steel that provides opportunity for drawing directly on the surface and also allows easy attachment magnetic display tiles to the surface. According to another aspect of the present invention, either the surface itself or the tiles attached thereto can be provides with a sticky surface such as a POST-IT (® 3M Corp.) surface. In accordance with one aspect of the present invention, the display panel surfaces are provided with a roughened texture to allow users to write on the wall with a variety of graphical tools (conventional “white boards” can only be written on with markers). Alternatively, a portion of the panel surface may be pixelated (roughened) to provide a region that can be written on with other graphical tools (chalk, crayons, pencils etc.). The inventors have found that this allows much greater graphical expression. Finally, at least some of the WORK WALLS™ or other display panels should be tall (more than six feet high) so that they can be used as room dividers to partition an environment in different rooms.

The portion of the environment shown in FIG. SS2-9 also includes a architectural armature elements including hollow beam in the upper right portion of the drawing. This beam serves both a functional purpose (covering cables) and a pattern language purpose in addition to providing a sense of place (architectural armature).

FIG. SS2-10 shows a plurality of bookshelves grouped together with WORK WALL™ display panels acting as a room divider. Display monitors are included as a part of the environment in accordance with the present invention.

FIG. SS2-11 shows a kiosk component and a wing component docked together. The ability of component to dock with one another is an important aspect of the present invention in that it provides efficient utilization and easy user configurability. The kiosk is similar to the kiosk previously described and includes surfaces for accommodating a computer and a monitor intended for single or multiple users and viewers. Computer cables are managed through a built-in cord channel. The lower cabinet space is designed to accommodate computer central processing units or supplies and is accessible in the front. The entire unit can be easily maneuvered and relocated on its smooth-rolling casters. In this view, the kiosk is combined with a MEDIUM WING™ component to build a cohesive, portable workstation.

The wing component is a flexible work surface designed to adapt to a variety of needs. The wing component is extremely portable and can be easily maneuvered on its smooth-rolling casters to fit in almost any work area. The height of the work surface is adjustable to accommodate a user that is either sitting or standing. The curved work surface design surrounds the user with an efficient work surface and the built-in tilted foot rest makes the wing as comfortable as it is versatile.

FIGS. SS2-12 and 13 show a work unit that can consolidates various traditional office elements into a single, efficient non-traditional piece. The unit combines a roll-out work surface and rolling storage for tools and hanging files. The work unit has two shelves above the surface and includes built-in grooves for pens and pencils. The folded work station section smoothly overlaps the cart section to form a compact station that will conveniently fold and unfold. As shown this unit can be constructed on a small scale to accommodate both adults and children in the work environment. FIG. SS2-13 also a portion of the environment in which the work unit is located including rolling work walls in the background.

FIGS. SS2-14-17 show various aspects of the kiosk component of the present invention. FIGS. SS2-14 and 15 show how the kiosk is adjustable in height by allowing one portion to slide within another portion. FIG. SS2-15 shows the kiosk of FIG. SS2-14 at a reduced height and docked with a wing component. FIG. SS2-16 shows a kiosk of the type described previously in connection with FIG. SS2-4 in which an oval surface is inserted into one of the slots of the kiosk. FIG. SS2-17 shows the kiosk in use where the user is standing.

FIGS. SS2-18-20 show portions of an environment according to the present invention including large scale rolling work walls, radiant room and armature components. The armature components which appear as beams along the ceiling of the environment provide a sense of place and also function to conceal cables and other utility connections. The portion of the environments shown in these figures demonstrate the ability to achieve architectural scale and pattern language values using the components within the environment, the possibility of providing of multimedia integration, and particularly in FIG. SS2-20, the use of architectural armature and provision of work surfaces.

FIGS. SS2-21-30 show various view of one embodiment of the work pod component of the present invention. As shown in these views, the WORK POD includes a plurality of modular section units. Each unit is suspended from its own external mast or support. The mast or supports are supported on smooth rolling casters and designed to allow a variety of components to be snapped on, such as overhead storage and shelf units, workstations, tool caddies and tables that rotate out into the center of the pod for use by small teams.

A unique articulating translucent vane attaches to the top of the mast. The vane incorporates the pods lighting system and also allows the pods residents to make adjustments to direct that light in also adjust ventilation.

Each section of the pod may be deployed independently or in combination with one or more other sections to form a variety of configurations. A common set-up is the circular one shown in FIGS. SS2-21-30, but other set-ups are possible and may be employed by several pod residents to help the facilitate their current work process. Thus, the pod may be moved and reconfigured by the resident without any technical assistance.

FIGS. SS2-30A-50 show alternative pod constructions and configurations according to the present invention. As shown in FIG. SS2-30A, the pod can be hinged to roll in to different configuration other than the circular configuration previously described. FIGS. SS2-30A-50 also show other aspects of the pod design including the use of sub-components such as secretaries, file cabinets, pigeon holes and shelves. Each of these sub-components can be supported (directly or indirectly) on the mast and is supported on rolling casters. The adjustability of the translucent vane is also evident in these drawings. Preferably, the light source is directed toward these vanes so that it is reflected down by the vane onto the user to allow variable lighting. The light source itself may be used as a handle for adjusting the location of the translucent vane as shown, for example, in FIGS. SS2-34, 36 and 38.

FIGS. SS2-40 and 41 show an arrangement where the pod sections are used in a somewhat straight configuration. FIG. SS2-42, on the other hand, shows an arrangement in which the pods sections are arranged in an S-curve. From all these drawings, it is readily apparent that the pod design offer a tremendous level of adjustability and possible configurations. FIG. SS2-47, for example, shows an arrangement in which pods are arranged in a rectangular fashion.

FIG. SS2-37 shows how a wire chase can be incorporated into the pod design. FIG. SS2-38 shows how lights perform as moving petals with the light itself acting as a handle.

FIGS. SS2-51 and 52 show a single unit or section from which the work pod can be constructed. As shown therein, the entire system is hung from a mast that is supporting rolling casters. The system shown includes an adjustable work surface that may be pulled out from a rolling computer support, work surfaces at a variety of heights, and shelves as well as adjustable lighting. FIG. SS2-53 shows a perspective view of a work section in which one of work surface system pulled out and used as a small conference table.

The WorkPod returns to active duty an old architectural Pattern Language value of A-Room-Within-A-Room. This pattern language value was used extensively in custom designs by Wright and is recognized by Alexander. To date, however, there has been no practical way to do it with furniture. Let alone, furniture that moves. The Work Pod also provides knowledge workers significantly larger work areas and several of them. The Pod can function as a conference room for four (swing out desks configure to a table), a work are for a Team of three and a home for a single individual. A landscape of WorkPods, distributed in an appropriate pattern and augmented with the components of the present invention can accomplish the same density of typical solutions while providing greater individual spaces and a larger number of functional-type areas—Radiant Rooms as example. The system of the present invention uses available space and makes circulation paths serve many purposes. These layouts cannot be achieved with conventional furniture approaches. Even the better known mobile pieces have failed to grasp the importance of the larger armature-level pieces and thus can not replicate the effect of the present invention.

FIGS. SS2-54 and 55 show perspective views of a cube office system according to the present invention. Specifically, FIG. SS2-54 shows an essentially top view showing two-layers of cubes arranged the space in between. The space between the cubes, typically about 3 inches, can be used for acoustics (by providing reflective or absorbing surfaces), for utilities (by allowing a post and beam wire guide arrangement) and to allow for adjustable dividers, such as shoji screens, to be concealed. In this way, the cube office system can be used to provide great flexibility in dividing an environment to work spaces and to give users adjustability (through the use of shoji screens) as to degrees of privacy and the like.

FIG. SS2-56 shows one version of a polycentric work area layout that is possible in accordance with the present invention. In this instance, the work area layout follows a city metaphor with the principal flow of people through the layout indicated as “Main Street.” As shown, this layout features maximum natural light to all work areas, omni-directional access to work areas; promotes interaction at the team, unit and company levels and allows individual and team control of access and privacy. The layout also utilizes circulation areas for storage, group tools, display and visual variety, reinforces individual team and unit identity. In addition, the layout reinforces certain building features, including an atrium, the outer wall articulation, column spacing, all which can be accomplished with one semi-custom, locally built system. This layout also allows maximum future flexibility for new layouts. It is important to note, however, that FIG. SS2-56 is just one example of a layout that can be accomplished using a flexible system of components of the type described herein. Examples of other layouts (but not all possible layouts) are shown in the appendices hereto. An important aspect of the present invention is, indeed, the flexibility that is available.

FIGS. SS2-57-62 are perspective views showing a Rapid Deployment System (RDS) version of the system of the present invention in use. The components used in the Rapid Deployment System are essentially the same as those used and described elsewhere, but these components can be moved into a generic environment such as a hotel conference facility and set up quickly to establish a suitable, although not necessarily ideal, environment for facilitating group collaboration. An important feature of the components used in the RDS is the extreme mobility and ruggedness of these components.

In FIG. SS2-57, the folding work walls are used to set up a small group work area. In FIG. SS2-58, a circular table is also used as a writing surface. FIG. SS2-59 shows a larger portion of the environment, in which the flexibility that can be achieved using the components of the present invention is evident. FIGS. SS2-60-62 similarly show how a large undistinctive space such as a hotel conference room can be turned into a series of work areas using the components of the present invention.

FIG. SS2-63 is a perspective view of several components of the present invention. The system shown includes a wing with adjustable height, a kiosk and a smaller wing, as well as a movable storage file. FIG. SS2-64 is a perspective view of a work surface according to the present invention. FIGS. SS2-65 and 66 are perspective views of a portion of an environment in which cube systems are used to divide an environment into different sections.

FIG. SS2-67 is a perspective view showing several aspects of an environment according to the present invention. As shown, the environment includes curved work walls that divide the environment, architectural armature features that are suspended from the ceiling and also provide lighting, a movable work wall in use, movable supports for television sets and the like, the use of live plants within the environment and a great deal of natural light.

FIG. SS2-68 shows curved cube system according to the present invention, as well as a portion of the environment that includes natural light from the ceiling, as well as a multi-level environment.

FIGS. SS2-69-71 show other architectural armature and pattern language features according to the present invention, including a skylight, as shown in FIG. SS2-69, a unique ceiling structure as shown in FIG. SS2-70 and suspended beams as shown in FIG. SS2-71. These figures also show other aspects of the environment of the present invention.

FIGS. SS2-72 and 73 show perspective views of a cube office system according to the present invention. The particular office shown has an outside window to allow natural light to pass in. The interior wall, however, is formed by a stack of cube components (each of which has an interior shelf). Although only one side of the divider is shown, the divider preferably consists of back-to-back shelf units separated by a gap of about three inches. The gap allows for a beam that carries electrical wiring and the like to be located between the unit as shown above the stack of cube units. Moreover, a shoji screen door or similar sliding door can be mounted for sliding between the stacked cubes to provide a door to allow privacy, if necessary, while still allowing light from more than one side of the room, which is an important pattern language value. Similarly, the Plexiglas that extends from the top of the stacked cubes to the ceiling to provide some sound insulation and a sense of privacy without blocking the light. As shown best in FIG. SS2-73, the Plexiglas that extends to the ceiling has no impact on the ceiling surface. Thus, the entire arrangement is extremely mobile and can be assembled into any generic undistinguished office space.

FIGS. SS2-74-82 show various views of cube office system components and assemblies according to the present invention. Again, while a cube office system allows tremendous flexibility, a preferred form of assembly includes cubes stacked back-to-back with a gap in between to allow a shoji screen and utility beam to be located between the stacked cubes. This gap is shown well in the end view portion of FIG. SS2-81 and in the perspective view of FIG. SS2-82. FIGS. SS2-76 and 77 show the shoji screen door quite well.

FIG. SS2-83 shows a wall-mounted folding workwall in which a portion, shown on the left, of the workwall is hinged to allow flexibility of dividing space and breakout areas.

FIG. SS2-84 shows another use of the cube components of the present invention, namely providing the individual worker work areas that are partially separated from one another. The work areas also include a wing component and a table component.

FIG. SS2-85 shows a perspective view of a pod assembly according to the present invention.

As noted above, one of the principal advantages of the system of the present invention is that the components provided allow optimization of Pattern Language values. Although certain pattern language values have been used extensively in custom designs by architects such as Wright, there has to date been no way to address most of the pattern language values catalogued by Alexander in practical way with conventional off the shelf furniture, much less furniture that also addresses human values such as economic efficiency, mobility adjustability and the like. Thus, a remarkable aspect of the system of the present invention is that components allow one to address at least 100 of the 253 pattern language values catalogued by Alexander. Further information concerning these pattern language values may be gleaned from “A Pattern Language” Christopher Alexander 1977. Specifically, and without limitation, the following values, listed with the number assigned by Alexander, may be addressed using the system of the present invention (understanding that, in some cases, the Pattern is “scaled” up or down as required by the context of the application):

1. INDEPENDENT REGIONS

2. DISTRIBUTION OF TOWNS

5. LACE OF COUNTRY STREETS

8. MOSAIC OF SUB CULTURES

9. SCATTERED WORK

14. IDENTIFIABLE NEIGHBORHOOD

15. NEIGHBORHOOD BOUNDARY

19. WEB OF SHOPPING

24. SACRED SITES

26. LIFE CYCLE

28. ECCENTRIC NUCLEUS

29. DENSITY RINGS

30. ACTIVITY NODES

31. PROMENADE

36. DEGREES OF PUBLICNESS

37. HOUSE CLUSTER

41. WORK COMMUNITY

45. NECKLACE OF COMMUNITY PROJECTS

57. CHILDREN IN THE CITY (Furniture scaled for children & tools, i.e., WorkWalls, etc.

59. QUIET BACKS (through layouts using city metaphor made possible by:

Armature Elements

Systems Pieces: WorkWalls, Pods, Cube Office making a landscape (foreground, middle, background)

Variety of shapes, textures, colors and degrees of view—solid, translucent, transparent, open

60. ACCESSIBLE GREEN

67. COMMON LAND

68. CONNECTED PLAY

Armature & Systems Components—Landscape

69. PUBLIC OUTDOOR ROOM

79. YOUR OWN HOME—Work pods, cube offices, work furniture clusters, work walls

80. SELF-GOVERNING WORK SHOPS & OFFICES

82. OFFICE CONNECTIONS

83. MASTER AND APPRENTICES

88. STREET CAFE

93. FOOD STANDS

94. SLEEPING IN PUBLIC

102. FAMILY OF ENTRANCES

107. WINGS OF LIGHT

110. MAIN ENTRANCE

111. HALF HIDDEN GARDEN

112. ENTRANCE TRANSITION

114. HIERARCHY OF OPEN SPACE

115. COURTYARDS THAT LIVE

Armature, systems layout, etc.

117. SHELTERING ROOF—Trellises

119. ARCADES—Armature

120. PATHS & GOALS—Wire Chase System, Elements In Background

121. PATH SHAPE—Wire Chase System On Floor

124. ACTIVITY POCKETS—Layout Clusters, WorkWalls, Radiant Rooms

127. INTIMACY GRADIENT—Cube Offices, Pods—Variety

128. INDOOR SUNLIGHT—Articulatum to outside Windows in Skylights—advantage building assets

129. COMMON AREA AT THE HEART

130. ENTRANCE ROOM

131. THE FLOW THROUGH ROOMS

132. SHORT PASSAGES

133. STAIRCASE AS A STAGE

134. ZEN VIEW

135. TAPESTRY OF LIGHT & DARK

146. FLEXIBLE OFFICE SPACE

Flexibility of Layout

147. COMMUNAL EATING

148. SMALL WORK GROUPS—Flexibility—Reconfiguration (teams come & go)

149. RECEPTION WELCOMES YOU

150. A PLACE TO WAIT

151. SMALL MEETING ROOMS

152. HALF-PRIVATE OFFICE—Cube Office Octopus pods can do this

Armature with furniture. flexibility

153. ROOMS TO RENT—Office Hoteling—adjustability allows it

156. SETTLED WORK

157. HOME WORKSHOP—Take It Home scale/style allows it

159. LIGHT ON TWO SIDES OF EVERY ROOM—Flexibility of layout translucent effect of Cube Office & Pods (room within a room)

161. SUNNY PLACE—Take advantage of it

164. STREET WINDOWS—Take advantage of it

165. OPENING TO THE STREET—Take advantage of it

176. GARDEN SEAT

179. ALCOVES—Armature, Pods, Cube Office, Work Walls

180. WINDOW PLACE

185. SITTING CIRCLE

190. CEILING HEIGHT VARIETY—Armature, Trellises, Pod Peddles

191. THE SHAPE OF INDOOR PLACE

192. WINDOWS OVERLOOKING LIFE—“Windows” in Cube Office Pods

193. HALF OPEN WALL—Cube Office Work Pods

194. INTERIOR WINDOWS—“Windows” in Cube Office Pods

196. CORNER DOORS

197. THICK WALLS

198. CLOSETS BETWEEN ROOMS

200. OPEN SHELVES

201. WAIST HIGH SHELF PLUS POD

Cube Office System

202. BUILT IN SEATS—Armature systems (Platforms)

204. SECRET PLACE—Flexible layout allows this

205. STRUCTURE FOLLOWS SOCIAL SPACES—on our scale: the work dictates the shape not the system

225. FRAMES AS THICKENED EDGES—WorkWall trim & other elements

235. SOFT INSIDE WALLS—Fabric on pods, screens, etc.

236. WINDOWS WHICH OPEN WIDE

237. SOLID DOORS WITH GLASS—Cube Office

239. SMALL PANES—Cube Office

241. SEAT SPOTS

243. SITTING WALL

244. CANVAS ROOFS—Cube Office Trellises

249. ORNAMENT—with sub-components—with system complexity—ornamental effect

250. WARM COLORS

252. POOLS OF LIGHT

253. THINGS FROM YOUR LIFE—the system provides space to do this.

Another important feature of the collaborative environments of the present invention are their ability to provide access to information through a totally integrated multimedia approach ranging from providing various printed materials and graphics throughout the work space to the use of “just in time” information systems. The furniture components of the present invention are well-suited for this purpose in that they include a variety of shelf space, work surfaces and display surfaces. The work space also preferably includes access to electronic databases including the Internet and data warehouses. To facilitate such access, the environments of the present invention include display monitors throughout the space and furniture components are designed to movably support such monitors. In addition, the furniture components and armature elements are designed to conceal or guide cables and wires connected to electronic components. This collection of components and their arrangement within the environments as shown in the drawings and appendices are able to provide total seamless media integration within the environment. In addition, the system is highly scaleable and adaptable to new technologies that are now widely available or likely to become widely available in the next few years, including large scale electronic work walls, electronic assistants, electronic displays, real time video conferencing, intelligent agents and data warehouses. Collectively, these components provide an environment in which information can be made available as needed, i.e., “just in time information,” and remote collaboration is seamless.

Moreover, the system and method of the present invention provide an environment that is uniquely complementary to systems, such as “query tone” technology, for providing “just in time information.” Specifically, as illustrated in FIG. SS2-1B and elsewhere, the environment includes a complete range of fully integrated media sources and displays so that, for example, a knowledge worker can turn on a computer (workstation, network computer, lap top, PDA or intelligent assistant), and ask any question from any database anywhere, in the same way that a knowledge worker today can pick up a telephone, and talk to anybody anywhere.

As noted previously, the present invention particularly relates to a system and method for optimizing a collaborative work space that is used in connection with the inventor's system and method for facilitating communication and other interaction among agents (humans, machines, groups, organizations and combinations thereof) so as to provide feedback, learning and self-adjustment among the individual agents thereby creating an environment for interaction (consisting of environment, tools and processes) that facilitates emergent group genius in a radically compressed time period.

Subsystem 3—System and Method for Integrating/Optimizing Technical Systems to Promote Agent Interaction

This Sub-System of the present invention provides a new framework, processes and algorithms for the performance of knowledge-based work. Further, this invention is based on 20 years of experimentation with Human Agents in the production of real work producing economic value. In these experiments (supported by DesignShop, management center and NavCenter processes tools and environments) a disciplined, scaleable approach has been developed for the augmentation and facilitation of agents of all kinds. Further, the basic rules for the “manufacturing” of non-human agents have been determined by demonstration and test.

A Human Agent, in a Knowledge Economy, will have an augmentation system that consists of the following components:

A basic, integrated tool kit for drawing, writing, calculating, analyzing, accessing the Internet and other networks, scenario building, planning, project managing, scheduling, full (real time) multimedia augmentation and various custom applications.

An “Agent Builder” for the manufacture and management of a variety of virtual “intelligent” agents to perform tasks, represent existing articles of value and trade, search data bases and other virtual environments, “represent”—as an agent—the Human Agent in conducting negotiations and trades.

A simulator for testing agents and communities of agents to understand their behavior and the behavior of complex environments.

A library and system of processes and process filters for analyzing, testing. designing, engineering and the performance of the majority of (codified) professional services.

A Pattern Recognizer for recognizing patterns in textual, audio or visual inputs or data together with a means for presenting similar data as a suggestion to the user and receiving input (feedback) from the user as to the desirability of the suggestion.

Data Warehouse and Knowledge Base functions.

A “Decider” (Sub-System 1).

A seamless (agent-based) interface that is context sensitive and “learns” the Human Agent's habits and desires.

The above is representational of the elements of the present invention but not exhaustive.

This Sub-System is, at a high level, a knowledge worker tool kit module of the full system. The overall system not only includes the tool kit, but agent functions, process filters, simulators and data or knowledge warehouses.

According to the present invention, a user builds the agents and then, in accordance with the overall process of the present invention tests the agent, uses the agent, sets a term for the agent and stores the experience. Using principles of iteration and recursion, together with feedback and critical mass, the system becomes self-adapting and self-improving.

Of course, testing the agent requires simulation. The process filters described are required to replicate a scan build process. In particular, when working with human agents, it is possible to engage in a very different level of consciousness that is often referred to as “brainstorming.” Although brainstorming is often referred to as just another kind of thought process, it is in fact an entirely different level of consciousness in which the mind is forming new connections without the constraint of logic. To replicate this process in a machine, it is necessary to use a randomizer that is iterative and self-adapting. At the basic level, the randomizer is able to make random connections of relevant or related pieces of data and then test those random connections to see what type of results they provide. Machines capable of this type of randomizer activity include a so-called “Zwicky box,” and other devices that can generate morphological forced connections. The Zwicky Box is named after Fritz Zwicky, a designer who invented the morphological forced connection process as a way of searching for connections that no “logical” mind would make.

Another significant module of the system and method for integrating/optimizing technical systems for promoting agent interaction is the pattern recognizer. The pattern recognizer is a system that analyzes data and looks for patterns in the data. It provides information concerning these patterns as a possible route for gaining feedback. For example, the pattern recognizer may analyze the user's input into the system (textual, audio or visual) and compare these various inputs to see if a pattern can be recognized. If a pattern is recognized, the system can suggest additional inputs that have a similar pattern. The user/system interface may be in the form of the system posing a simple question to the user, “Is this what you are looking for?” or the interface may be automatic or transparent to the user. In this way, the user's acceptance, acquiescence or rejection of the suggestion derived from pattern recognition will allow the system to learn from feedback. The pattern recognizer thus facilitates feedback into the system so that even a generic simple agent can quickly “teach itself” to be a customized agent for the particular user. The agents thus teach themselves through application of the system and method of the present invention.

In this sense, the present invention provides a unified process and system for approaching the wide variety of problems associated with the transformation to a knowledge economy. The system applies a consistent logical sequence to the variety of problems and relies to a large extent on recursion, iteration, critical mass and feedback to allow solutions to emerge even when the underlying rationale for why the solution works may not be fully understood. The basic process follows the three cat model approach of designing, building and testing through simulation and feeding back the results of the simulation to the design.

A central element of the success of this system is that the simulator gets smarter as it goes along. Thus, the simulator has a learning mode. The simulator generates results that are stored in the form of a data or knowledge warehouse, which provides input for future simulations.

It is important to note that the same process applies to all Sub-Systems of the present invention. In this sense, the present invention provides a formal system of a concurrent engineering that is applicable to a wide variety of systems.

Central to the present invention is the iterative building of agents as solutions to complex problems. According to the present invention, the agent (solution) is designed with minimum information and then built. The agent is allowed to act within its environment, and able to provide information concerning its results so that this information can be used in refining the design. Thus, agents evolve or emerge through recursion and iteration.

This is fundamentally different from the approach taken today in trying to design complex solutions using more information from data warehouses in the initial design. If too much complexity is introduced in the design of the initial agent, then the agent is so constrained that it cannot evolve or emerge through actual experience. It is in this sense that the present invention provides an IC factory, in iterative recursive engine of creation. Thus, the present invention is based on the fundamental recognition that knowledge is created only in interaction with reality and the experience gained therefrom. To create a “engine of creation”, therefore, it is necessary to create a system that allows both interaction with an environment (either actual or simulated) and learning from the experience of the interaction. With these two fundamental characteristics, the ability to improve the agent or the design is limited only by the ability to iterate successive generations of the design through the simulation and learning process. Thus, recursion, interaction and feedback are the key elements to this interactive process.

The system for integrating and optimizing technical systems according to the present invention is a powerful tool for supporting the transition to the knowledge economy. It can provide agents with new ways of working. It can aid in the redesign effectively and re-equipment of the workplace to operate effectively in the information age. The system for integrating and optimizing technical systems according to the present invention is a synthesis of elements of the present invention. The components are: 1—Body of Knowledge, 2—Process Facilitation, 3—Educational Programs, 4—Technical Systems, 5—Environments, 6—Project Management, and 7—Venture Management. The functioning of the system for integrating and optimizing technical systems according to the present invention depends on all the components working together. None can exist alone and have a full expression of the system. This is not to say that each component must function at the same level of sophistication. The components will, in fact, co-exist while each is at a different level of completion and sophistication. The system itself is subject to the same “rules” of creativity and evolution, as are the projects and processes it manages.

The system for integrating and optimizing technical systems according to the present invention is, in broader terms, an idea manager as well as a planning and project manager. The hub of the system is a knowledgebase designed to provide information to the user, information that is relevant to the task at hand, but that also provides gateways to further exploration of the implications of that task. The knowledgebase is designed to support the user's creative process in dealing with any topic. Further, it is designed to act as a “knowledge capture” mechanism through its interaction with the person using it.

Linked to the knowledgebase are a series of modules. The main function of these modules is to allow the user to explore the relationships between ideas about how the future might unfold and the creation of practical plans to guide actions into that future. These modules bring together three of the principal Taylor knowledge technologies: the Scenario; the Strategic Plan and its graphic manifestation, the AND MAP; and the Time and Task management system. The system for integrating and optimizing technical systems according to the present invention also provides a pathway to the corporate knowledgebase and to other application packages that support the creative process, such as word-processing, spreadsheet, graphics and computer aided design.

The system will function as an expert system providing the user with artificial intelligence, as well as tools with which to pursue creative endeavors. The large-scale synthesis of agent intelligence will usher in an era of creative exploration far surpassing any in humanity's experience.

The system for integrating and optimizing technical systems according to the present invention is composed of eight major modules. At the hub of the system is the knowledgebase, the main data base of information resources. The Knowledgebase Interface is the shell that protects the data base and provides the tools to access the data directly or through applications. Outside the shell are the six “principle applications” modules of the system. They are Data Management, General Applications, Tools, Scenario, Strategic Plan and Time and Task Management Modules. Together they form an integrated environment for the creative exploration of ideas about the future. They also provide the means of programming and managing courses of action to provide the transition, for the corporation or organizations between the present and the future. Finally, the system also provides an intelligent link with the corporate past, which it builds upon by documenting corporate actions as they unfold. The system is, therefore, an historian of actions, providing the chronicle as events occur.

The knowledgebase and its interface contain the information upon which the six “applications” draw. The knowledgebase also provides the means of entering and retrieving general information to and from the system. Finally, it provides a means of exploring and creating new ideas, using the creative process and the black box models. The knowledgebase interface will link the specific work modules, called the principle applications, with the knowledgebase and application programs that reside “outside” the system for integrating and optimizing technical systems according to the present invention. It will provide the means of manipulating data so that it is compatible with the needs of the work modules and the outside applications programs.

Ultimately, the knowledgebase interface will manage the expert system aspects of the system for integrating and optimizing technical systems according to the present invention. For example, in a full expert system implementation, when a particular user signs on to work with a module, the system will call up specific parts of the tool kit that the user profile indicates the user prefers to use. The system might also make suggestions on investigative strategies the user might like to pursue, basing the suggestions on the user's level of expertise.

The Scenario Module will facilitate the formulation of ideas about the future. A structured investigation into the past could also be accomplished using this module. Key features will include: 1) the support of several formal methodologies such as morphological and cross-impact analysis, with which the structure of postulated events may be developed and/or analyzed, 2) the ability to access information in the knowledgebase that pertains to an event through a keyword query 3) the ability to compare different scenarios and to analyze the implications of variations between the types of events projected, and variations in the timing of those events.

The Strategic Plan Module facilitates the formulation, testing, and maintenance of broad plans of action. The AND MAP technology will be supported in PERT/CPM or decision network form. Formulation of goals and objectives as well as specific activities within the plan will be linked to scenario events that affect them. Likewise, events within a plan are linked to specific actions within the time and task management system associated with the plan. Through this linkage, the effects of a change in any one of the modules on the other modules will be recorded. Documents that support or explain the plan, or specific actions within the plan, can be retrieved from the knowledgebase. The module will support “what if” computations on a plan or group of alternative plans. The development and alteration of AND maps will be graphically and analytically supported.

The Time and Task Management Module will translate the intent of the strategic plan into a day to day scheduling of actions implementing the plan. Specific work packages will be broken out showing team membership, the responsible manager, time lines, etc. The rate of completion of various work packages and specific actions will be fed back to the strategic plan to monitor plan progress. Possession of a variety of reporting capabilities will be a key feature of both the Strategic Plan and the Time and Task Management modules.

The Tool Kit Module will contain routines that are used in common by the other work modules. For example, statistical analysis of data will be needed in each of the main work modules. When needed, it will be called from the tool kit, 90 that it will not be necessary to have a complete set of code to do statistical work resident within all three of the planning modules. Possibly some simple procedures, such as calculation of the mean and standard deviation of a set of data, will be more efficiently placed within the planning modules themselves. This is an issue to be determined in the future, however.

The planning modules, that is, the Scenario, Strategic Plan, and the Time and Task Management modules, are designed to support a complete planning process. This process can be described in simplified fashion in the following model:

1. define problems and opportunities

2. describe the problems and opportunities in systems terms

3. define goals and objectives to deal with the problems and opportunities

4. define performance specifications to implement the goals and objectives

5. define resources and constraints to accomplish the goals and objectives

6. define the plan of action

7. create work packages to implement the plan

8. create a task management system to control and track work

9. feed back changes in organizational goals and objectives and in resource or constraints to the plan and the task management system

10. feed back changes in the plan's schedule to organizational goals and objectives

Each of the above steps in the planning process is related to one of the system for integrating and optimizing technical systems according to the present invention planning modules.

The system of the present invention provides a method of user interaction with the system that allows the user to learn the system's next level of operation while using a lower level. The system of the present invention also creates various scenarios about the future. Be able to test the assumptions within the scenarios to see how reliable they are based on present knowledge and opinion. Be able to compare the probability and the impacts of various scenarios. Be able to monitor the reliability of a given scenario as events unfold.

The system of the present invention also provides a method of exploration of the knowledgebase in a way that gives the user the information s/he is looking for and makes reference to other related information not initially requested.

The system of the present invention, in all modules, provides the ability to work with text and graphic images within the same viewing plane and provides multiple window display.

The system of the present invention also provides the user with the ability to create an outline plan for each working session with the system. It should facilitate the discovery of new information by the user.

The system of the present invention also provides a record of each working session for the user to review and learn from to increase his/her efficiency.

The system of the present invention also provides extensive on-screen help and tutorials to assist the user in operating the system in an efficient and effective manner.

The system of the present invention also provides the user with a “tool kit” of methods for the exploration of the structure of knowledge in selected subject areas aimed toward generating new insights and knowledge. That is, an expert system on the exploration of knowledge.

The system of the present invention also provides the system with the ability to acquire new information from interaction with the user, and to learn the user's methods of operation, in order to assist the user in performing those methods with maximum effectiveness and efficiency.

The system of the present invention also provides the ability for agents within the system to carry on multiple conferences with each other.

The system of the present invention also an analysis of scenario events to show how events are logically connected. Develop strings of events to be inserted into a scenario.

The system of the present invention also shows the variability in the estimates of when an event will happen within a scenario

The system of the present invention also shows the combined probability of a particular chain of events happening, that is, a risk analysis of the chain of events.

The system of the present invention also correlates the scenario events to specific articles, working papers, etc. that collaborate or dispute the probability of the event occurring.

The system of the present invention also facilitates the formulation of alternative plans of action based on key events in the scenario. Creates network diagrams of these plans. Link activities within the plans to a database of the characteristics of the activities.

The system of the present invention also links key events in the scenario to elements in the strategic plan. Links the work packages in the strategic plan to elements in the time and task management system. When one related element in any module changes, the system will inform the user and/or automatically update related elements in the other modules.

The system of the present invention also creates plans in a decision network format, utilizing the unique symbols and identifying structures of the AND map.

The system of the present invention is also able to analyze a network based on time minimization, cost minimization, and optimization (trade-off between time and cost) criteria. The system of the present invention is also able to compare various plans based on any one or all of the above criteria, i.e. a goals achievement analysis across multiple plans. The system of the present invention is also able to perform “what if analysis on a plan or plans based on:

a. minimum time with unlimited resources for a given topology.

b. minimum cost criteria

c. specific resource limitations.

d. maximum parallel tracks for network activities

The system of the present invention is also able to perform “what if” calculations on a given plan based on:

a. changes in the network topology.

b. changes in the resource allocations on the network.

The system of the present invention can provide the ability to do resource leveling.

The system of the present invention can create descriptions of the network in AND map form, Gantt Chart form, and in activity precedence tables; show the critical path activities for deterministic networks and critical path options for probabilistic networks; report slack times for each non-critical activity. Also show the reduction in slack for non-critical activities as the project progresses, so that these activities do not go critical.

The system of the present invention can create “work packages” that are given to people responsible for given major tasks and that identify the specifications of the work to be done, the time lines to be met, and the resources available to the project team. The reporting schemes for all three major modules will be hierarchical in nature. The first level will give only basic information and each succeeding level will increase the density of information about the queried activity or event.

The system of the present invention can monitor the actual time and resources required by various activities for completion, and feedback those results to an on-going activity type model. Incorporate an analysis of variance to see if the variation in performance is due to the nature of the activity or the nature of the resources: primarily people and their level of training and expertise. Create an activity by activity comparison of the time scheduled versus the actual completion time, and report any slippages in time lines.

Monitoring will be tied to the cost outlay accounting for each activity in the Plan. The time and task system will be tied to an overall project time and cost accounting system. (2)

The strategic plan module parameters are very flexible in order to respond to the variety of types of plans that will be developed using it.

The system learn the user's planning style and provide appropriate information and tools to support that style. The style should also be compared with “ideal” approaches and the user be made aware of the differences in approach, and possible performance differences, between his/her style and the “ideal”.

The time and task management system provides a break out on a sub-track basis of who will do what and when. All activities within the time and task management system will be tied to a specific activity within the strategic plan.

The system of the present invention includes time and task reporting systems that are able to call up the “work package” in which are contained the associated project activities, the name of the person responsible for the project's completion, the time frame in the total project, whether the activities in the work package are on the critical path and if not what their slack is.

The system of the present invention also preferably includes means to: record comments and suggestions about the plan from those using the plan; analyze their comments and use the results to bring refinement to the plan.

The system of the present invention also preferably includes means to: create ways of allowing the “line” managers and personnel to design the ways that the time and task management categories are developed, in order to implement the project; create ways of allowing the “line” personnel to have input into the creation as well as the modification of the plan; create a flexible report generator so that information output concerning any of the modules can be customized or called from a standard template.

The system of the present invention also preferably includes means to: provide a project documentation module that records who gets what information, so that updates and changes to the plan can be distributed efficiently to the appropriate people.

The system of the present invention also preferably includes means to: create a user interface that is graphically-oriented and has a menu-command string-icon structure.

The system of the present invention also preferably includes means to employ a “learn as you do” user operation strategy.

The system of the present invention also preferably includes means to: create “fly it” expert systems for each of the main modules.

FIG. SS3-3 Agent Builder illustrates components of the system for the “manufacturing” of virtual Agents.

FIG. SS3-11 CyberCon Augmentation Environment and System illustrates components and technical systems to augment the work of human and other Agents.

FIG. SS3-12 CyberCon Knowledge Commerce Augmentation System illustrates the components, systems and tools, serving FIG. SS3-11. These are organized into group: 2 organizing the physical and virtual environments themselves; 3 components of the CyberConn tooling system to manage work production and building artifacts; and, 4 the means to build, transport and exchange virtual Agents.

Subsystem 4—System and Method for Transporting Agents and Agent Environments as an Integrated Experience

The system and method for transporting agents and agent environments as an integrated experience of the present invention can be used to transport agents, including human agents, within separate environments that are unique to that agent in a remarkable efficient way while optimizing utilization of transportation resources. The system includes transportation modules or “eggs,” that can take many different forms. In the case of human transport, the environment can be tailored to an individual's wants, needs and desires. However, all of the “eggs” within the system should minimally be able to know where they are (in the case of human transport this can be accomplished through, for example, a GPS system or the like) and be able to report their location to a central system for coordinating transportation. The eggs should also be able to verify the identity of their occupant. In the case of human transport, this can this could be done, for example, through biometric techniques discussed herein or passwords and keys.

Use of a central system that knows the identity and location of all agents within the system affords tremendous opportunities to facilitate transportation of agents. Moreover, in accordance the system and process underlying this invention, the system is capable of receiving feedback and is thus capable of improving itself through recursion and iteration.

To fully facilitate transportation, the agents within the system must able to communicate to the overall system to indicate a desired location, i.e., where they want to go. The system has predictive capabilities that are improved over time through recursion, iteration and feedback to increasingly improve its ability to facilitate transportation. The transportation system improves the overall system in two ways. First, the transportation Sub-System provides tremendous opportunities to reduce waste in transportation. In the case of human transport, for example, consider, for example, a person going to the airport. Under current systems, the airline has no way of definitively forecasting which passengers holding reservations will actually arrive at the airport. Moreover, the current system for identifying passengers, ticketing passengers and loading passengers onto the plane only begins when the passenger arrives at the airport. Thus, passengers are told to arrive an “hour or two” before scheduled departure time. Although people have generally grown accustomed to this delay, almost all of it is a waste of time. A system that knows the identity and location of agents within the system can accurately forecast which agents will actually arrive in time for a particular flight. In addition, processing the agents is greatly exemplified using the centralized system. By producing these unnecessary delays, the utilization rate or percentage use of expensive assets such as jet aircraft, could be dramatically increased, thus increasing airline profit.

The transportation system offers similar advantages in connection with other modes of transportation. One can appreciate the lack of utilization of modes of transportation by considering the number of cars that are not in use at any one time. The same applies to trucks, boats and trains. A system that is aware of the location and desired destinations of all agents within the system, allows further optimization through multi-modal transportation. In particular, based on past experience, an agent is transported in the most efficient way possible using whatever particular modes of transportation will yield fastest transport. Again, the only systems necessary are the individual environment (agent module) or egg having the ability to know its location, its occupancy, the desired destination of its occupancy and the ability to report all of these to a central system. To make the central system a learning system, however, the system should have a predictive capability to predict the best routing of the agent as well as storage means for keeping track of predictive routing as well as actual results so that the system receives feedback and can then improve itself using principles of recursion and iteration.

Although the greatest inefficiencies in today's economy seem to be in connection with the transportation of human agents, the system described herein is readily adaptable transportation of all forms of agents.

Thus, at one level, the system of transportation serves to generate a vastly improved efficiency and utilization of existing transportation resources. It is expected that this improved efficiency will likely result in changes in the allocation of investment in transportational resources. For example, if one is ensured of having transportation available when and where needed, ownership of transportation assets (and the burdens associated with such ownership) becomes much less desirable to individuals.

As indicated above, the specific form of the transportation module, or egg, can vary. However, it should be appreciated that certain additional efficiencies are offered, especially in the ability to use a multi-modal form of transportation, when the individual transportation module is readily adaptable to different forms of transportation.

The system and method for transporting agents and agent environments as an integrated experience of the present invention is expressly not limited to the transport of human agents. To the contrary, the transportation Sub-System of the present invention is scaleable both upward and downward in size to address analogous problems in connection with other forms of agents. Specifically, the system of providing an agent builder, feedback and transportation can be used in the development of “learning systems” and other forms of intelligent agents.

For example, as noted above, there is still a need for a software robot “agent” that can intelligently search through the files of the Internet and for a mechanism for processing the located files for presentation to an end user in a meaningful manner. Known approaches, including that disclosed in the Mauldin patent attempt to gain information through brute force sifting through files. The fundamental problems with such solutions are that they are not sufficiently scaleable to accommodate exponential growth in use and data to be searched and that the “agents” used are static and do not improve through feedback. The system and method of the present invention can be applied to develop improved “agents” for searching databases. This can be understood as an application of the transportation Sub-System of the present invention (where the “agents” are software objects transported through of a plurality of interconnected computers each having a plurality of files stored thereon) and/or an application of the facilitation Sub-System of the present invention (where the software “agents” interact with one another and the user to develop better agents. This again demonstrates the tight interaction and integration of the Sub-Systems of the present invention.

In addition, the method and system of transporting agents and agent environments as an integrated experience according to the present invention demonstrates the interaction of the entire system. In particular, the system and method are developed by developing a PatchWorks Design (tm) Diagram. In this case, the exercise is aimed at the development process of the Transportation Sub-System of the Invention itself.

The system and method for transporting agents and agent environments as an integrated experience includes various transportation modes for transporting an occupant environment. The environment may be in the form of a contained environment or “egg.” The egg itself is a complete user environment that is adaptable to a variety of modes of transportation, for example, the environment may include navigation, GPS and communication systems.

The specific mode of transportation shown can include, among other things, smart adjustable shrouds, impact protection, storage areas, an adaptive tracking system that allows the vehicle or transportation component to be used in the road, rail, air, etc., a propulsion unit and an agent environment package.

In accordance with the method of the present invention, the occupant egg is adaptable to various modes of transportation, and the transportation vehicle itself is adaptable to traditional modes of transportation.

In operation, the system can be used as, among other things, a virtual facilitator. In particular, the system includes agents that can reach out and scan data bases throughout the world and bring back “new” and “interesting” information without being overly constrained. This information is chunked into different categories, but not too stringently. These creative “agents” know that part of good design is heuristic searches and unexpected finds.

Agent scanning is but the first step. Next, the agents connect, sort, merge, and find complimentary and contrary data, and offer these chunks of information to their partner, which could be a human user. The user may hunt for information without knowing the exact nature of what she or he is looking for. The user need only know some of the characteristics of what is needed. This is a significant advantage of the present invention even when compared to a “query tone” system of the type currently contemplated, but not implemented, by others.

Agents organize questions/scenarios for the user to respond to. Some agents require the user to do some back casting from the future; others focus the user on convergent ideas; agents could even ask the user to read contextual articles. Thus, the system (machine) acts as a facilitator of human agents. Moreover, the agents can work with multiple people and teams simultaneously. A user can call colleagues, interrupting their work, and ask them to join in group exercises. The system may employ a Zwicky Box or some other means of implementing a morphological forced connection process as a way of searching for connections that no “logical” mind would make.

As part of the Focus step, the agents can provide users a set of scenarios that ask them to think diligently about what they want to do. Other humans that are not deeply involved in the work can be brought into the process at the suggestion of the machine agents to offer fresh insights and perspective. The other humans are thus “agents”.

The agents are also capable of feeding information back to the user, asking further questions, clarifying and most important, eliminating options. The user need not prioritize; since, through operation of the system, ideas get stronger through the iterations of original intent and vision and the information the agents were able to bring to the users (human agents). The system can also display or flash models on the user's screens encouraging the users to “Invent the real problem” and reminding the users where they were in the creative process. Axioms such as “Creativity is the elimination of options” can be displayed as a traveling banner across my screen. The agents convey the idea that it is important to eliminate by design and not prioritize by order of yesterday's logic.

User's immersed in interaction with the system may find it difficult to quit, thus, the system should include means for warning of the user's exhaustion and need to sleep and assimilation. The agents can also suggest and print out articles for the users to read before retiring.

In the ACT stage, the user's screens can display a large ACT written across them to alert the user's that the time to begin pulling things together has arrived. The system can display an ANDMap that has, for example, a time line of three years across the top and familiar tracks down the side: financial, marketing, product development; resource utilization, etc. At some point on the ANDMap, for example eleven months down the product track, a three dimensional Landmark Circle identifies when the initial product ships. Touching this landmark causes all the relevant information that had been considered to show up on the screen, including, for example, all of the assumptions that would make this timing “right.” The user's may be prompted to add Events to the Map that needed to happen before shipping and also to name things that needed to happen after shipping. The system can also ask the user “So what” and “Now what” questions. Everything added to the map by the users causes the agents to retrieve information and attach the information it to the symbol. At any time, the user may pull up charts showing percentage of likelihood of meeting the deadline or of what would be needed financially during this phase of the work, etc. Within a short time, the user has an ANDMap completed and next steps in hand. This information is all neatly packaged in the user's computer ready and waiting for the user. The system can also provide feedback letting the user know what her or his biases were in how the user thought and worked. The system can then suggest ways to let her or his intuition reveal itself a bit more and suggest hat the user to read certain books for this purpose. The use of the system and method of the present invention to foster the creative process is based on the recognition that we are all inherently creative, that genius lies just under the surface of most organizations; and that they had a process for systematically releasing this genius, no matter what the complexity of the idea.

The agents described above need not be expensive. The can be constructed using JAVA or XML software objects and available on an as needed basis. Thus, for example, a user may plugged in a smart card at the beginning of the session to allow the Agents to purchase information. The user can see the charges adding up. Retrievals might cost between 10¢; or $25 (as examples) so that at the close of the session the user will have spent less than $250. This is certainly reasonable considering the user's savings in time and frustration.

In accordance with another aspect of the present invention, the system can accommodate results based payment. For example, the system can provide free or relatively free demonstrations to show the value of the service. The system can report to the user how much the session would cost. The system could then offer the user the choice of either walking away with her or his package or creating a value proposition under which the system agents or vendors would become ongoing partners and obtain profit participation if the project was successful.

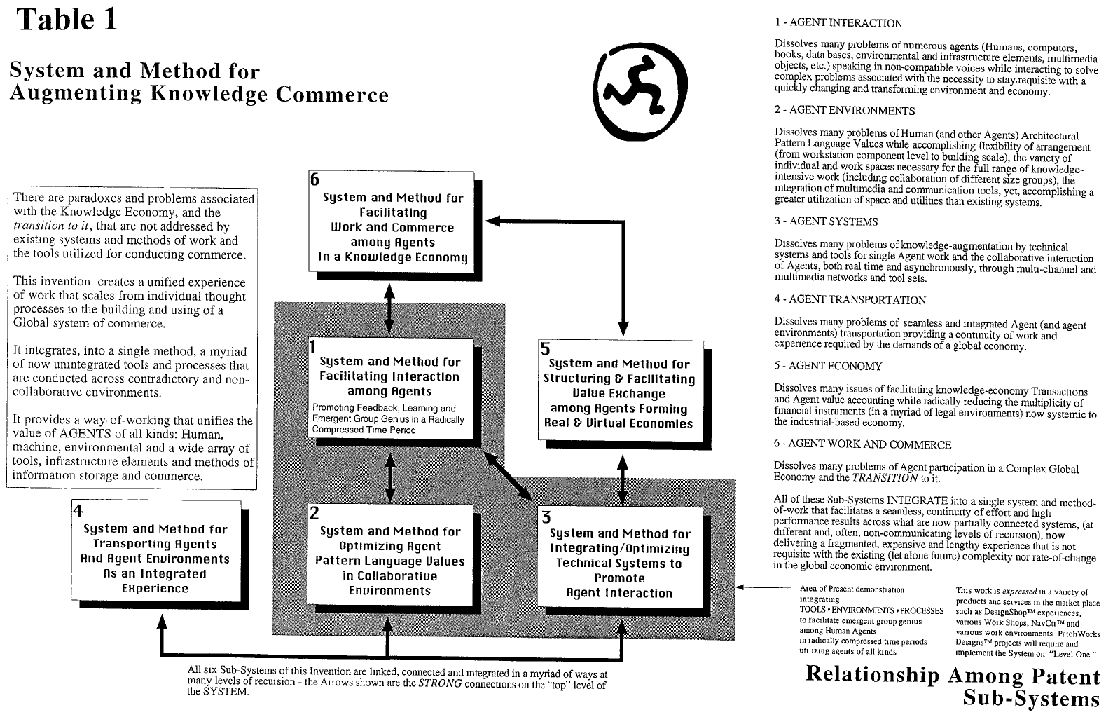

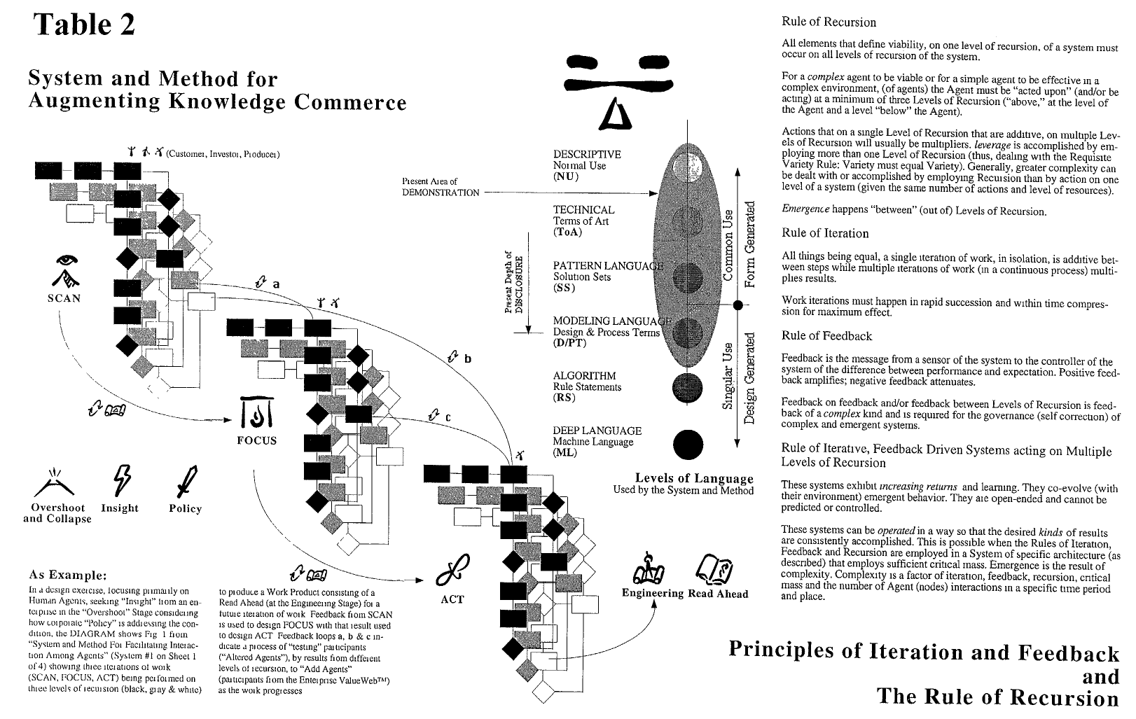

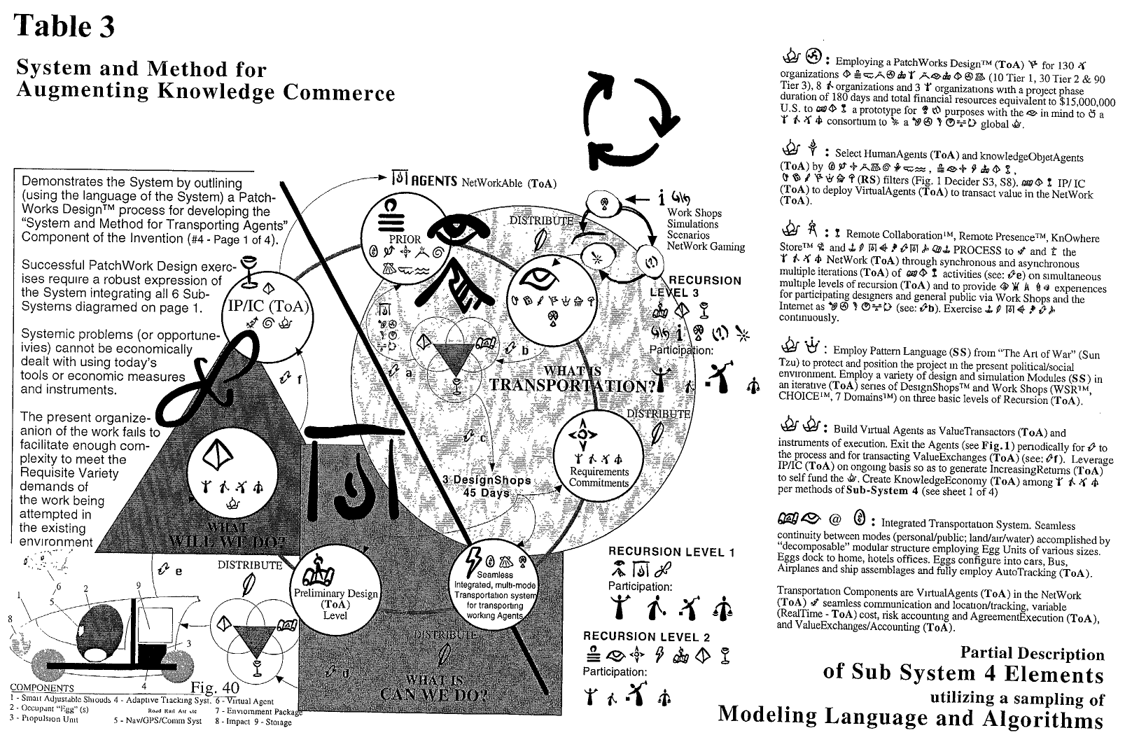

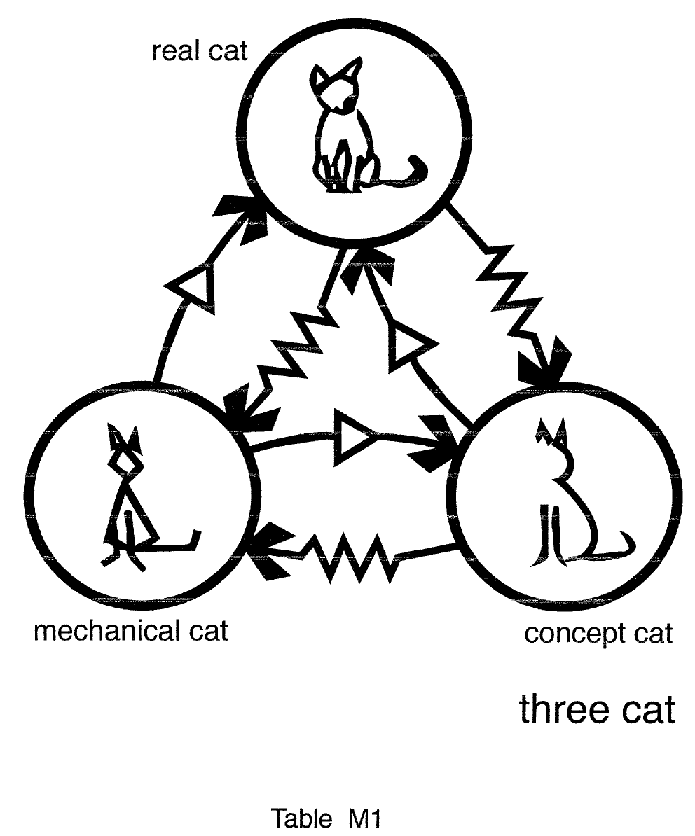

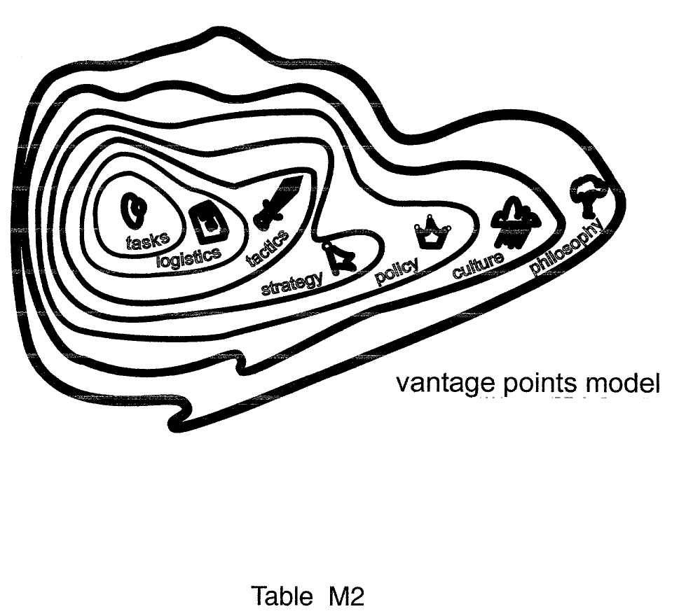

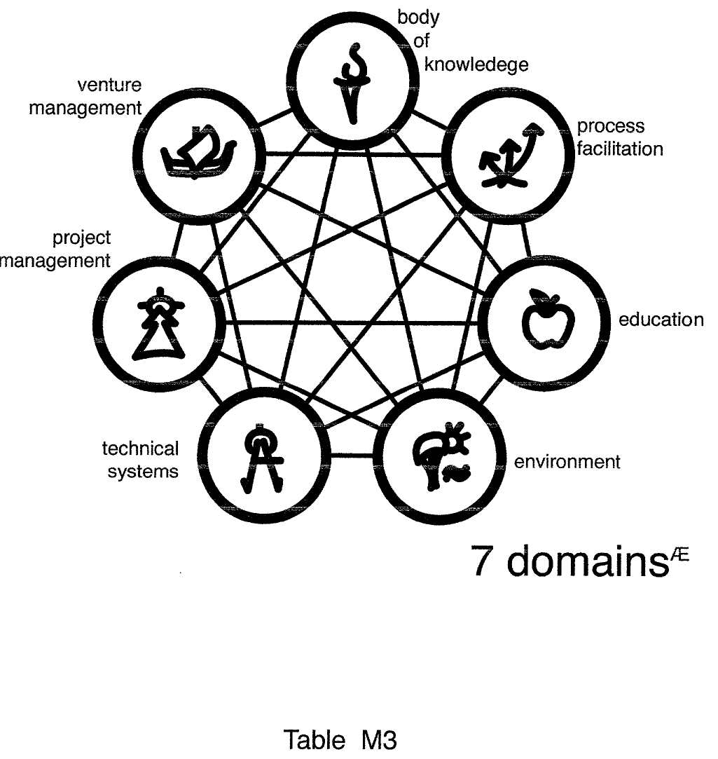

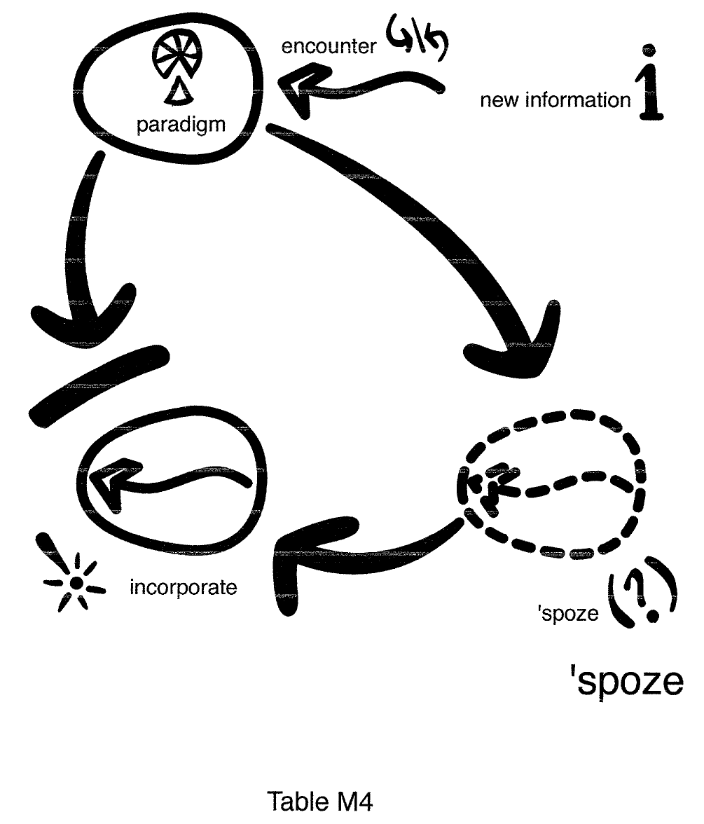

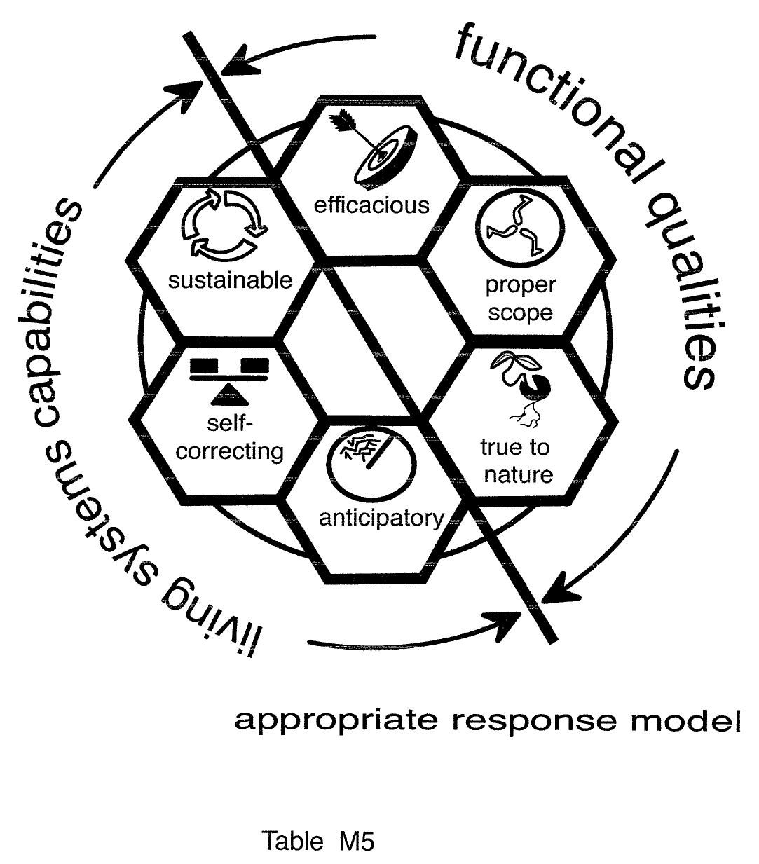

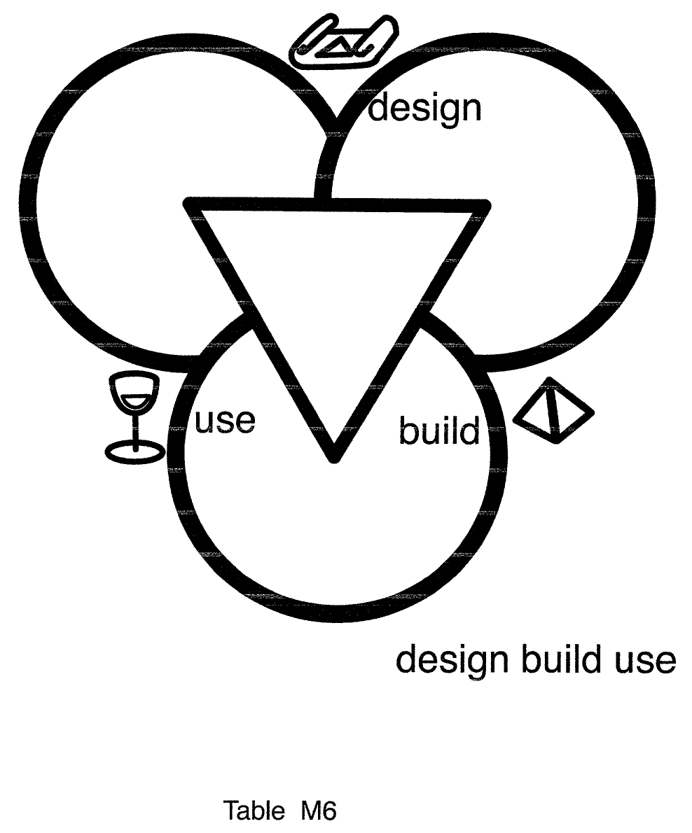

FIG. 4 demonstrates the method and system of the present invention by developing a PatchWorks Design (tm) Diagram. In this case, the exercise is aimed at the development process of the Transportation Sub-System of the Invention itself. This example serves to “demonstrate” one of the Sub-Systems of the present invention in a somewhat self-referential way and also shows why it takes the “System” to make the System. In addition, this Figure represents a high level design of a complex engagement as it would be done by a person skilled in the art and communicating to someone skilled in the art.

Though Table 3 initially appears very dense and difficult to understand, the density and complexity and the Table 3, itself, exhibits certain Pattern Language (which is a term of art defined above) conventions that are used in the present invention and require skill in the art to understand. The objective is for the user to have to rethink and recreate the process embedded in the present invention to understand it. This is intrinsic to the present invention on all Levels of Recursion (which is a term of art defined above). Also, the present invention allows an order-of-magnitude compression in the representation of knowledge not only in its use and creation. Using the Glyphs is not just to save some space—it allows a visual gestalt while conveying exact meaning to any member of a community-of-work that knows the code.

As indicated above, an important aspect of the present invention is the interaction among the various Sub-Systems. Again, it is the underlying similarities among these systems that make the overall system and process of the present invention so widely applicable. There are, naturally, differences among the various agents. One important difference is that, among the different agents discussed herein (including humans, machines, organizations and groups), human agents are the only agent that “times out.” To the extent that the human agents are the center of the overall system and process is currently contemplated, this becomes a significant issue.

The human agent or knowledge worker “times out” when he sleeps, engages in recreation or when moving from one location to another. Until very recently, most workers, including knowledge workers, worked in only one location, thus the human agent has been disconnected from the system while engaged in other lifestyle activities (sleeping, recreation) or moving from place to place. With increased use of transportation, the amount of time spent moving from place to place has increased dramatically. Thus, there have been attempts to allow human agents to connect to the system from remote locations. Portable phones, portable pagers and portable computers are examples of such efforts to keep human agents connected. Nonetheless, these systems are, without question, less than perfect in keeping human agents connected with the system.

In accordance with the system and method for transporting agents and agent environments as an integrated experience of the present invention, on the other hand, agents, including human agents, can be transported within separate environments that are unique to that agent. In the example described in Table 3, for example, the environment is referred to as an egg, but the environment could obviously take many different forms. The environment can be tailored to an individual's wants, needs and desires. However, all of the “eggs” within the system should minimally be able to know where they are (through, for example, a GPS system or the like) and be able to report their location to a central system for coordinating transportation. The eggs should also be able to verify the identity of their occupant. This could be done, for example, through biometric techniques discussed herein or passwords and keys.

It can be appreciated, therefore that if there is a central system that knows the identity and location of all agents within the system, there are tremendous opportunities to facilitate transportation of agents. Moreover, in accordance the system and process underlying this invention, the system is capable of receiving feedback and is thus capable of improving itself through recursion and iteration.

To fully facilitate transportation, the agents within the system must able to communicate to the overall system to indicate a desired location, i.e., where they want to go. The system has predictive capabilities that are improved over time through recursion, iteration and feedback to increasingly improve its ability to facilitate transportation. The transportation system improves the overall system in two ways. First, the transportation Sub-System provides tremendous opportunities to reduce waste in transportation. Consider, for example, a person going to the airport. Under current systems, the airline has no way of definitively forecasting which passengers holding reservations will actually arrive at the airport. Moreover, the current system for identifying passengers, ticketing passengers and loading passengers onto the plane only begins when the passenger arrives at the airport. Thus, passengers are told to arrive an “hour or two” before scheduled departure time. Although people have generally grown accustomed to this delay, almost all of it is a waste of time. A system that knows the identity and location of agents within the system can accurately forecast which agents will actually arrive in time for a particular flight. In addition, processing the agents is greatly exemplified using the centralized system. By producing these unnecessary delays, the utilization rate or percentage use of expensive assets such as jet aircraft, could be dramatically increased, thus increasing airline profit.

The transportation system offers similar advantages in connection with other modes of transportation. One can appreciate the lack of utilization of modes of transportation by considering the number of cars that are not in use at any one time. The same applies to trucks, boats and trains. A system that is aware of the location and desired destinations of all agents within the system, allows further optimization through multi-modal transportation. In particular, based on past experience, an agent is transported in the most efficient way possible using whatever particular modes of transportation will yield fastest transport. Again, the only systems necessary are the individual environment (agent module) or egg having the ability to know its location, its occupancy, the desired destination of its occupancy and the ability to report all of these to a central system. To make the central system a learning system, however, the system should have a predictive capability to predict the best routing of the agent as well as storage means for keeping track of predictive routing as well as actual results so that the system receives feedback and can then improve itself using principles of recursion and iteration.

Although the greatest inefficiencies in today's economy seem to be in connection with the transportation of human agents, the system described herein is readily adaptable transportation of all forms of agents.

Thus, at one level, the system of transportation serves to generate a vastly improved efficiency and utilization of existing transportation resources. It is expected that this improved efficiency will likely result in changes in the allocation of investment in transportational resources. For example, if one is ensured of having transportation available when and where needed, ownership of transportation assets (and the burdens associated with such ownership) becomes much less desirable to individuals.

As indicated above, the specific form of the transportation module, or egg, can vary. However, it should be appreciated that certain additional efficiencies are offered, especially in the ability to use a multi-modal form of transportation, when the individual transportation module is readily adaptable to different forms of transportation.

One example of the system and method for transporting agents and agent environments as an integrated experience is shown in FIG. SS4-1, from U.S. Pat. No. 6,292,830 which has been included in the Appendix. Specifically, as shown therein, the system itself includes an agent environment or transportation module 2 in the form of an occupant “egg”. The system of the present invention includes various transportation modes for transporting the occupant module or egg, one of which is shown schematically in FIG. SS4-1.

The egg itself is a complete user environment that is adaptable to a variety of modes of transportation, for example, in the illustrated embodiment, the environment includes navigation, GPS and communication systems. Most critically, the occupant module includes means for communicating with a central processor (central system); means for ascertaining its own location precisely (GPS or the like); means for identifying/confirming its occupancy, i.e., who is in the module; and means for determining its occupants' desired destination (means for receiving input).

With these characteristics, the occupant module or egg becomes a virtual agent or representation of the occupant that can be processed by the central processor.

The specific mode of transportation shown is a module that includes, among other things, smart adjustable shrouds 1, impact protection 8, storage areas 9, an adaptive tracking system 4 that allows the vehicle or transportation component to be used in the road, rail, air, etc., a propulsion unit 3 and an agent environment package 7.

In accordance with the method of the present invention, the occupant module or egg is adaptable to various modes of transportation, and the transportation vehicle itself is adaptable to traditional modes of transportation.

Table 3 also illustrates how other aspects of the present invention can be used in the development process of the transportation sub-system of the invention itself. This example serves to demonstrate one of the Sub-Systems of the present invention in a somewhat self-referential way, and also shows why it takes the “system” to make the system. Thus, Table 3 shows an example of the use of the modeling language and systems of the present invention in problem solving.

Thus, it is apparent that Agents cannot be disconnected from the ability to ACT—this is critical for HUMAN Agents in a Knowledge Economy, and, they must be able to do so in real time. Computer code “agents” are now shipped in “eggs” it is called encapsulation. The Transportation Sub-System of the present invention piece is both INTRINSIC to the overall System and Method of the present invention, AND, it has a numerous implications to existing day-to-day transportation systems.

It should be appreciated that the system and method for transporting agents and agent environments as an integrated experience of the present invention is not limited the transport of human agents. To the contrary, the transportation Sub-System of the present invention is scaleable both upward and downward in size to address analogous problems in connection with other forms of agents. Specifically, the system of providing an agent builder, feedback and transportation can be used in the development of “learning systems” and other forms of intelligent agents.

For example, as noted above, there is still a need for a software robot “agent” that can intelligently search through the files of the Internet and for a mechanism for processing the located files for presentation to an end user in a meaningful manner. Known approaches, including that disclosed in the Mauldin patent attempt to gain information through brute force sifting through files. The fundamental problems with such solutions are that they are not sufficiently scaleable to accommodate exponential growth in use and data to be searched and that the “agents” used are static and do not improve through feedback. The system and method of the present invention can be applied to develop improved “agents” for searching databases. This can be understood as an application of the transportation Sub-System of the present invention (where the “agents” are software objects transported through of a plurality of interconnected computers each having a plurality of files stored thereon) and/or an application of the facilitation Sub-System of the present invention (where the software “agents” interact with one another and the user to develop better agents. This again demonstrates the tight interaction and integration of the Sub-Systems of the present invention.

It is a central insight of the present invention that that the transportation of any agent, in reality, involves the replication, recreation or transformation of the agent being transported. In a system, as actions are taken, and/or as agents “move,” the system changes STATE (ToA). Thus, the system proceeds through state¹, state², state³ to state . . . ⁿ This can be considered the memory of the system. In the case of Human thought, for example, approximately 20 minutes after a thought, new dentrites start to form in the human brain. A physical analog of the process is, thus, created. Thinking is a physical activity. Every time a neuron fires, it become a different neuron. Every “virtual” meeting takes place somewhere, that is, the agents (of all kinds) comprising the meeting all are someplace and some-time. This time is relative. An agent “on” the Earth-ball, for example is spinning as the Earth turns, orbiting the Sun-Star, in a Galaxy that is traveling along a vector. Therefore, every object (agent) on the Earth (as example) is traveling at a different velocity and “experiencing” time at a different rate as a consequence. In fact, every agent is being transported. In fact, every agent is a unique experience. Therefore, every agent upon “arriving” is materially different than when “leaving.” Aging is the “memory” of experience. Experience is how agents learn. It is a critical aspect of the present invention to facilitate the transportation of agents (of all kinds) in a way that recognizes this aspect of change-through-experiences and that provides the best System and Method (environment, process and tools) to augment the agent's ability to learn and perform useful work and trade.

The observations stated above have profound impact on the design and utilization of the system and Method of the present invention. First, a definition of “memory” (ToA) is hereby offered that provides continuity from neuron level to Global Economic System. Regardless of material, type or nature of agent, a common view of memory (language) is established that can be described, measured, documented and recorded. State¹, state², state³ state . . . ⁿ. This view of memory is congruent with the definition of “Variety” which, in Cybernetics (Asby, Beer), is identified as the number of possible states of an entity or system. Which means, for the purpose of the present invention, memory of a system and the complexity of a system are roughly equivalent. Therefore, when building, facilitating, augmenting agents of all kinds, the essential focus of this System and Method is on how agents, experience, move, learn, connect and accomplish emergent synergistic results. This is the stuff of creativity and life. The very nature of a global complex economic system is “life-like.”

Existing “systems” (of thought, processes tool-kits and physical environments) do not recognize that a human agent departing from an airplane in San Francisco is materially different than the persona-system who left New York. This failure makes certain distinctions, and consequently, appropriate actions impossible. The experience of this “passenger” is not designed and facilitated to enhance productivity and synergy—baggage agents are actually handled better. Nearly a working day of loading and unloading bags, navigating different transportation units, standing in line, and ultimately speeding in a cramped seat across time zones and magnetic fields is “seen” as merely “tiring.”

Secondly, conventional methods cannot resolve the essential differences between, a thought, a book, a computer program, a human, a global system of commerce. Consequently, these are all described in different terms-of-art and augmented by different methods and tools. The System and Method of the present invention does not. As an example of this difference of Method and in the context of sub-system 4, all of the above can be seen as agents that transport agents within themselves, and on another level of recursion are transported, themselves, thereby changing; state1, state2, state3, state . . . n; and thereby creating a new memory in the system. It can be considered that these transformations occur in bundles, or eggs (which are themselves agents) and that all this can be described in a language system composed of desecrate levels of recursion (NU, ToA, SS, D/PT, RS, ML). Further, it can be considered that these transformations can be seen as “manufacturing” by specific process engineering methods. The transportation of a Human agent in an integrated system resulting in a unified, coherent and creative experience and the transpiration of information resulting in the manufacture of a dwelling are, therefore, essentially the same practice of “process engineering”. Additionally, success of both processes is determined by rule-based sub-systems (agents) and the proper use of complex feedback (ToA).

Subsystem 5—System and Method for Structuring and Facilitating Value Exchange Among Agents Forming Real and Virtual Economies

The present invention further includes objected oriented system and method for exchanging a value and objects that serve as a medium of exchange or a measure of value. In this system, objects, preferably computer software objects, are created to represent the value of various items within the system. Thus, for example, an object could be created to represent the value of a tangible object such as a boat, an object can be created to represent the value of one person's service and so on. Objects can also be created to represent the value of one's future earnings. Each object within the system has certain characteristics. Foremost among the characteristics of each object is an ownership characteristic, which is establishes who, within the system, has ownership with control of the value represented by the object. It is, naturally, critically important that the integrity of the ownership characteristic be maintained. In other words, it is important that one person within the system cannot misappropriate the ownership characteristic from others within the system. Thus, it is contemplated that the ownership characteristic be linked to unique characteristics of the individuals within the system. Examples of appropriate and unique characteristics can include fingerprint patterns, iris patterns, DNA patters and, encrypted code values. Thus, an object “knows” that it is linked to the person having a certain, unique, DNA pattern or fingerprint.

Like the transportation Sub-System, the system for determining the value of objects makes it possible to achieve increased utilization of objects that have value. These can include objects that are physical objects (a boat) or metaphysical objects (the future value of services that can be rendered). At its most basic level, the system includes objects that have value. The system is connected with data resources capable of evaluating or ascertaining the “value” of an object at any particular time. In addition, the object's location is always known and its status (health or condition) is always known. Reporting on location can be done with GPS technology or other similar devices that can ascertain a location precisely. Circuits and chips that measure conditions that are believed to be significant factors in the value of the object can be used to ascertain “status” or “health.” In the simple case of a boat, for example, a chip would report whether the boat is afloat or sunk. Initially, the object within the system should be very simple, but should operate through recursion and iteration to refine the predictiveness of the system. Thus, through experience, for example, it will be learned that certain factors affect the value of the objects. The system must be adjusted accordingly. The key it that feedback is used to refine as experience is gained.

Thus, using the system of the present invention, anything that has value to some people can be a commodity. Any commodity in this sense can be a tradable instrument. This allows much greater utilization of assets (for example, future value of services rendered that might otherwise not be used at all).

This system should also include a third party agent or enforcement agent, which under current systems could be courts, a legal process generally to enforce rules of exchange and ownership, for example.

This system is useful on an extremely large macroscale and for discrete, definable groups of persons that have a common interest. Thus, it is possible with this system to have multiple, distinct economies. It is contemplated that it will be necessary to include within the system some form of interface with other economies. This Sub-System of the present invention plainly opens doors to even greater utilization of assets to field the economy. Thus, the present invention offers the opportunity to create tremendous wealth since most assets of the economy are, at any given time, inactive because of the inherent limitations of the second wave economy.

It is further contemplated that the system includes means for modeling, sampling, and verifying the current value, preferably in a real time basis, of the objects within the system. Thus, for example, the physical objects that are represented by the software objects within the system could, for example, report signals indicative of their current state to a monitoring system. In the case of a boat, for example, the boat would continuously report its location and that all systems were in order. As long as these signals were received the system would recognize the value of the object representing the boat. However, once the system failed to receive an indication that the boat reported the boat's location and function, it would no longer recognize the value of the object value associated with the object representing the boat. There are, of course, other ways of verifying the values of the objects represented within the system. For example, in the case of tangible objects such as boats and automobiles, there is the conventional techniques for establishing a “blue book value” could be used. It should be appreciated, however, that because of the digital nature of the system and method of the present invention, it is possible, with sufficient input to much more accurately model real world values. The fact or/of ownership and control of the physical object could be continuously verified, but this seems to be unduly complicated using current technology. Thus, it is preferred that the system operate, to some extent, on an “honor system” that is enforced through periodic verification or spot checking as well as by a credit report type system whereby participants within the system can lose the ability to participate within the system if they fail to report or file misleading or fraudulent reports.

One form of identification is Biometric verification, in which an individual's identity is checked by examining unique physical characteristics such as fingerprints, eye retinas, palm prints and voice signatures. Because they are unique to each individual, biometrics can prevent theft or fraud. Unlike a password or PIN, a biometric trait cannot be lost, stolen, or recreated.

Among the most reliable and widely accepted methods in biometrics is fingerprint identification. The method of verifying a person's identity is popular because the fingerprint is the most convenient biological characteristic to identify. it takes little time and effort for somebody using a fingerprint identification device to have their fingerprint scanned. Studies have also found that using fingerprints as an identification source is the least intrusive of all biometric techniques.

Verification of fingerprints is the fastest and most reliable of all other biometric methods. Users will not experience as many errors in matching when they use their fingerprint and the device requires very little space on a desk or in a machine. One of the biggest fears of fingerprint technology is the theft of fingerprints. Skeptics point out that latent or residual prints left behind on the glass of a fingerprint scanner may be copied. However, there are known devices that only detect live fingers and a copy of a fingerprint will not work.

Leading companies now offer devices that can take advantage of the security and convenience of fingerprints. These devices include a completely self-contained scanner that automatically performs enrollment, comparison and verification of a user's fingerprint. With an internal CPU and non-volatile memory, the device processes and matches fingerprints internally in less than a second and requires no additional hardware to function. The known fingerprint identification unit is easy to use and requires little time to match and verify a fingerprint. To begin using a known fingerprint identification unit, you must first enroll your fingerprint (similar to setting up a password). During the enrollment process, the scanner captures a partial image of your fingerprint called the fingerprint template. The known fingerprint identification unit only captures a sampling of the fingerprint and does not store the entire image of the fingerprint. This helps reduce the stored template size, increases speed, and protects the user by avoiding potential privacy problems. When the time comes for you to access a computer or validate your fingerprint, just place your finger on the known fingerprint identification unit; it scans the fingerprint and captures an image of your print. The internal CPU then compares the image to the stored templates. In less than a second, a match or rejection is made and the result is sent back to your PC for proper access. Users can adjust the verification level on the known fingerprint identification unit to match their application needs. The device offers five settings for closeness of match, depending on the level of security required and the importance of user friendliness. Since the known fingerprint identification unit does all of its processing internally, it is also platform independent and will work with a variety of systems ranging from embedded controllers to high-end workstations.

In addition, the known fingerprint identification unit is a compact, light weight device that can fit in the palm of your hand. The known fingerprint identification unit has the capability to enroll, scan, process, or match fingerprints internally in less than a second. With an internal CPU, custom ASIC, and memory, the known fingerprint identification unit can quickly process various fingerprint related tasks. The internal CPU removes the burden of complex fingerprint calculations from the host machine. Since the known fingerprint identification unit is not dependent on an external processing unit, results are always fast, reliable, and consistent. The known fingerprint identification unit also comes with internal flash RAM for storing fingerprint templates. This internal memory eliminates the need for an external database to store templates. The known fingerprint identification unit's nonvolatile memory can store many fingerprint templates and it can verify a finger against any one of them in less than a second. It also allows you to store templates on an external host machine. The known fingerprint identification unit contains a biometric sensor that detects whether a finger has been placed on the fingerprint scanner. It will allow only a “real” finger to register. This precautionary feature prevents fraud and allows it to tell the difference between a real finger and an imitation. This biometric sensor on the known fingerprint identification unit is also used to trigger the scanning process.

Subsystem 6—System and Method for Facilitating Work and Commerce Among Agents in a Knowledge Economy

In accordance with another aspect of the present invention, it is possible to develop a model for a total service network that takes insights and ideas from the creation stage to the organizational stage—an Intellectual Capital Factory.™ In direct contrast to the conventional approach of trying to quantify that which occurs or is found to exist in “successful” organizations, makes it possible to manage and grow intellectual capital from the seed of a good idea. The contrast between these two approaches is as sharp as the contrast between foraging for food in a fertile valley and hydroponic agriculture. Thus, where a conventional view of intellectual capital management might focus on retaining employees that demonstrate creativity, the present invention provides and maintains a work environment that unleashes the creativity that most people have so that “ordinary” individuals achieve the “extraordinary” results that they are capable of.

The focus of the present invention is not “finding the hidden wealth within organizations,” but rather systematically managing and nurturing the growth of insights and ideas into successful organizations that have a wealth of intellectual capital.

The underlying process is analogous to an “Agriculture of Ideas.” Just as agriculture involves providing a suitable environment and removing obstacles to growth, our systematic approach to creating intellectual capital involves cultivate and nurturing ideas from the seed stage to the producer/company stage in an accelerated way by creating an environment that fosters creativity and removing barriers to creativity. The result of the process is hydroponic-like growth of ideas—an IC Factory™.

The IC Factory™

Vast amounts of capital are no longer needed to create value and wealth. Consider the software industry, the requirements for entry are basically a god idea and a personal computer. Hardware manufacturers, on the other hand, are saddled with costs and competitive concerns that software manufacturers can ignore. Hardware manufacturers must, for example, compete against foreign manufacturers with far lower production costs and underwrite factory facilities.

This is just one example of the implications of the shift from a resource-based economy to a knowledge-based economy. In a resource-based economy much of industry is labor intensive, in contrast, a knowledge-based economy is knowledge intensive. Moreover, in a resource-based economy it is important to be near transportation and communication nodes and the location must be near resources that are consumed in creating products. In a knowledge-based economy, on the other hand, physical location is less important, particularly with the advent of the Internet and other forms of communication that allow collaboration on individuals in remote locations.

The key to bringing structure to the process of creating intellectual capital may be summarized in the model of an intellectual capital factory or “IC factory.” The IC factory is a model for bringing structure to creation, nurturing and protection of intellectual capital.

A central premise of this model is the notion that the creative process cannot be controlled, but it can be managed. The creative process is managed by managing the conditions that create or block creativity. Thus it is necessary to manage the process of information development within a group and manage the process of information development within a group and to manage the energy field around the group. All of this is accomplished through structure that can be managed and modeled as an IC Factory.

The IC factory model provides a system and method for creating and nurturing intellectual capital.

Again, information age products are not capital intensive. Information age products are difficult to create, but easy to recreate or replicate. This is because knowledge-based products result from an insight or idea. Once the insight or idea is recognized a path to creation of the knowledge-based product may be inevitable at least once that path is made clear in the introduction of a product. Thus, for example, knowledge-based products such as computer software are often based on important insight, but once a product becomes available, the product itself can be easily replicated or the insight can be appropriated by others. There are also examples in the life sciences field. For example, the discovery of a new composition, pharmaceutical or gene sequence requires a great deal of research and in some instances an insight. However, once the existence of the composition, pharmaceutical or gene sequence is understood it is easily, in a relative sense, replicated

The IC factory model represents a structured non-linear non-incremental approach to creating, nurturing and protecting intellectual capital. In this sense, the IC factory structured approach is analogous to hydroponic growth of ideas.

The IC factory requires a knowledge-based (body of knowledge) and systems (educational and technical) for keeping the knowledge-based fresh and current. In addition, there must be systems for facilitating access to the knowledge-based within work groups. Thus, one critical function that must occur within the IC factory is growing and adapting the body of knowledge required to model the internal and external environment. This is done, as mentioned before, by creating education systems to receive inputs from external services—find out what's going on and use technical systems to leverage education systems and adapt a body of knowledge. When these systems are appropriately structured to achieve these functions, ideas are introduced into the system (the IC factory) and rapidly iterated and grown.

The IC factory also includes a structured environment that allows release of group genius. This requires careful attention to the effect of one's environment on one's creativity and productivity. The environments of the present invention are a good example of this type of structured environment, but most current work environments include numerous obstacles to creativity and group genius.

One of the critical elements of any collaborative work environment is to create an environment that allows individuals and groups to see the whole picture and, simultaneously, see details to allow effective collaboration.

In addition, to release group genius, there must be a way to facilitate the process of decision-making. We have found that an interdisciplinary approach is particularly helpful. Thus, it is very important to have all stakeholders involved. In the case of an IC factory, the stakeholders would certainly include an expert in intellectual property, an expert in capital financing, and an expert in the particular industry that our idea relates to.

The IC factory also includes a value web that is managed as a venture. The web members provide inputs into the system or venture, but also have separate identities. In this sense, the members of the value web are like software objects and that they bring value to the web and draw value from the web. Examples of web members within an IC factory would include the intellectual property expert member and the capital financing expert member or object. The members or objects can be individuals or groups of individuals or firms.

Obviously, a critical aspect of managing a web of independent agents is the integration and system facilitation function.

The value of members provides feedback loops into areas of interest so as to keep the knowledge base fresh and current.

The IC factory may be industry focused or generalist depending on the available expert objects.

As mentioned above, the IC factory requires a system integrator who brings these various elements together. This is best done using a system and method for facilitating interaction of intelligent agents. In this regard, it should be understood that the agents could be human agents, organizational agents, machine agents and electronic agents.

The present invention achieves hydroponic growth of ideas by removing environmental and structural barriers and expanding an organization's knowledge base. The IC factory approach provides a clear path to directly (not indirectly) proving every element of intellectual capital in a systematic way. Thus, all the traditional components of intellectual capital are proved in a systematic way. Consider, for example, the improvements to corporate brain-power, organizational knowledge, customer relations, the ability to innovate, employee morale, the knowledge base, the technology base and the market position. Successful high technology companies empirically know that environment profoundly effects morale. Thus, the emergence of “open work places and casual dress” has been a characteristic feature of emerging growth companies. However, these approaches are working on the edges, but not addressing the environment in a comprehensive way.

In summary, therefore, the IC factory is an open system that incorporate new technologies or individuals for performing the critical functions. Ultimately, the quality of results achieved by the IC factory model will depend on the quality of performing the requisite functions.

The critical functions may be summarized as follows:

(1) Establishing a knowledge base that is continuously refreshed with inputs from outside the organization (IC factory). In the case of an IC factory, the knowledge base must include information concerning intellectual property, a venture capital financing and the particular industry involved.

(2) The information and the knowledge base must be made available to all people that need the information in the collaborative process.

(3) Environmental barriers to collaboration and communication must be removed.

(4) The output of the IC factory must be protectable so as to establish “ownership” of the value created.

The basic team members of an IC factory are selected to achieve the following functions:

1. Intellectual Property: This cannot be addressed after the fact. It must be part o the process of creating product.

2. Incubation: Providing the tangible resources to develop a product and create a product or service.

3. Organizational Building Capacity

4. Financing

5. Operational Capabilities

6. Marketing and Distribution Systems and, perhaps the most important, a system integrative for integrating each of these six other functions.

Finally, and most importantly, there must be a system integrator or facilitator. Intellectual capital involves the interaction among agents. This includes human-human interaction; human to environment interaction; human to machine interaction; and machine to machine interaction. To date, there has been no system and method for facilitating interaction among these various agents. As a result, there is no reliable direct process for moving an idea to a sustainable organization. Communication within the organization is critical to establish dynamic, adaptable self-adjusting organic organization that operates with feedback loops to insure rapid iteration and growth to achieve the desired hydroponic growth of ideas. The IC factory model provides such a process for turning ideas into protectable intellectual capital.

FIG. SS6-1 illustrates the Mind Engine of this System and method. 1 is “mind” the totality of system and Agent experience on any level of recursion. It involves all 22 attributes of memory ToA as described elsewhere. 2, Unconsciousness, is all of Mind ToA not acting in Executive Routine ToA mode. 3 represents those elements (Agents) acting in Executive Routine mode. 4 is the multi-mode, multi-media I/O (input-output TofA) Channel ToA (see 19 FIG. SS6-2) that opens Mind (on one level of recursion) to environment (another level of recursion). 5 represents Unconsciousness, Consciousness dialog ToA. 6 illustrates Consciousness and outside (of Mind, recursion level) interactions. 7 illustrates Unconsciousness and outside (of Mind, recursion level) interactions. 8 illustrates Consciousness tracking of Consciousness and Unconsciousness I/O activities. 9 illustrates the Meta-Programming (Lilly) of Unconsciousness by Consciousness. 10 illustrates the sum of the “state-of-mind” State 1, State 2, State 3, State . . . n—see Memory ToA as described herein. 11 illustrates the upload channel to Consciousness from Unconsciousness of the memory elements (Agents) employed as “content” in the operation of the Executive Routine at any iteration of process. This is context sensitive.

The Mind Engine, as illustrated in SS6-1 operates in three modes: Mode A—Unconsciousness dominates the system. Mode B—Consciousness dominates the system. Mode C—Unconsciousness and Consciousness are co-equal. This is the default state ToA. Mind is all material (Agents) in the system. Unconsciousness and Consciousness are rule-based systems. They are self programmable.

FIG. SS6-2 ValueWeb Architecture illustrates the configuration of of sustainable complex purposeful networks. Complex ToA, true ValueWebs function as Mind Engines. The are “made” as diagrammed in SS6-3 ValueWeb Builder and SS3-12 CyberCon Knowledge Commerce Augmentation Engine. ValueWebs employ all 19 sub-systems of the Living systems Model (miller).

1 of SS6-2 illustrates the ValueWeb Boundary ToA.

2 of SS6-2 illustrates the System Integrator ToA of the ValueWeb.

3 of SS6-2 illustrates the Investor ToA Network ToA.

4 of SS6-2 illustrates the User ToA Network.

5 of SS6-2 illustrates the Producer ToA Network.

3, 4, 5 of SS6-2 are not static roles. The are modalities. Agents will often play more than one role in a ValueWeb architecture. At any iteration ToA, they are in one mode.

6 of SS6-2 illustrates a ValueWeb in incubation as part of the Producer Network (see: Miller ss1 “reproducer”).

7 of SS6-2 illustrates an existing ValueWeb (created out side of the ValueWeb in focus) in the process of making contact.

8 of SS6-2 illustrates an Existing Valueweb in the process of coming into the Valueweb in focus Miller (ss3 “Ingetor”)

9 of SS6-2 illustrates the Outer Clamshell of Network 3.

10 of SS6-2 illustrates the Middle Clamshell of Network 3.

11 of SS6-2 illustrates the Inner Clamshell of Network 3.

12 of SS6-2 illustrates the Outer Clamshell of Network 4.

13 of SS6-2 illustrates the Middle Clamshell of Network 4.

14 of SS6-2 illustrates the Inner Clamshell of Network 4.

15 of SS6-2 illustrates the Outer Clamshell of Network 5.

16 of SS6-2 illustrates the Middle Clamshell of Network 5.

17 of SS6-2 illustrates the Inner Clamshell of Network 6.

11, 14, 17 of SS6-2 make up the core of the enterprise, create it's signature, brand and identity.

10, 13, 16 of SS6-2 are the critical mass ToA of the enterprise.

9, 12, 15 of SS6-2 are the enterprise at scale ToA.

The role of the System Integrator function, 2, is to facilitate the purpose of the ValueWeb which is, in general, to create wealth and distribute it equably to it's members.

18 of SS6-2 illustrates Nodes ToA of the ValueWeb of which there are several kinds some of which are shown.

19 of SS6-2 illustrates Channels ToA between Nodes of which there are several kind some of which are shown. A Replacement Cluster is a Node that is capable of recreating the ValueWeb. This is the “Entrepreneurial Button in the Stages of an Enterprise M 1.

20 of SS6-2 illustrates Nets ToA which span across Networks often weaving through the entire ValueWeb.

21 of SS6-2 illustrates the environment of the ValueWeb itself composed of of elements, Nodes, Nets, Networks, Valueweb—all acting as Agents.

22 of SS6-2 illustrates a Note outside the valueWeb. Nodes like this act as a sensor ToA to the ValueWeb which is necessary for feedback. MEM 14.

SS6-3 ValueWeb Builder—3 Cat Engine illustrates the architecture, process and means necessary to the systematic constructing of Valuewebs. It is a specific technical adaptation of the 3 Cat model. See Table M1.

1 of SS6-3 illustrates the limits ToA i.e. boundary ToA of the tool.

2 of SS6-3 illustrates the Valueweb architecture SS6-2 as “Model Cat.”

3 of SS6-3 illustrates ValueWeb Simulator SS3-10 as “Mechanical Cat.”

4 of SS6-3 illustrates the ValueWeb in Focus ToA to be built ToA as “Real Cat.”

5 of SS6-3 illustrates the Process Engine SS1-1 U.S. Pat. No. 6,292,830 B1 Taylor et al.

6 of SS6-3 illustrates Agent Builder SS3-3.

7 of SS6-3 illustrates the CyberCon Tool Kit SS3-9.

8 of SS6-3 illustrates System Memory SS3-2.

9 of SS6-3 illustrates Virtual Media and connection of which the Internet is but one means.

There are several elements that must be in place, as a system, for the systematic, sustained creation of Intellectual capital. The are: 1) Dynamic memory (22 aspects as described herein). 2) An Executive Routine that learns, facilitates and emerges, itself as it performs it's role. 3) Memory and the Executive Routine have to co-operate in real time and be requisite with change. 4) The system has means of physical (thing) and virtual/metaphysical (no-thing) man-u-factur-ing. 5) The System is composed of physical and virtual environments that seamlessly integrate the elements of ValueWebs and their greater environments—the IC factory. 6) Provides means for Agents to create transacting media, build, customize and operate trading networks (economies) and employ “money” that has embedded the aspsects of memory.

Memory—22 Aspects and Rules of Use

Design Assumptions ToA related to the nature of mind and memory functionality and the executive routine of any intelligent Agent ToA are a core aspect of this System and Method. Mind experiments ToA, related to the nature of mind, executive functions and memory, have been conducted by Matt Taylor, since 1966—these have proven predictive in several areas of science and technology development.

Between 1980 and the present, tests have been run, by Gail and Matt Taylor, in various DesignShop ToA and PatchWorks ToA events and in Various Management Center ToA and NavCenter ToA environments, to refine the Model of Memory derived from these mind experiments and the processes that support the building of “strong” memory in intelligent Agents and complex systems.

These various experiments and observations formulate the basis of the Model herein. This Model is not offered as hard, verified, science—although many aspects of it qualify as such. It is a conceptual Model built for the purpose of building and employing certain systems. Processes, tools, environments required to do this are described elsewhere in this document and referenced herein.

It is not necessary for an idea to be totally true or verifiable to be useful. This statement, itself, is an insight of this System and Method. “The only valid test of a concept or theory is what it enables you to do” (Taylor Axiom). What is necessary is that the idea can be applied as an algorithm, process [symbol] or artifact of this System and Method and produce reasonably consistent, useful results as specified by the Appropriate Response Model. In other words, not all natural systems employ all aspects of this Model, nor does the Model cover all aspects of natural memory phenomena. The Model is, however, complete enough to do two things: build “artificial” memory processes and systems and facilitate significant memory processes of many living beings—notably humans.

While the following statements are not presented as science, they are presented as engineering design assumptions ToA useful for generating practical insights about memory-systems across a wide band width of type, scale, application and system media ToA. These assumptions, and the algorithms presented with them, make up a generalized design tool-kit that can be successfully applied to a wide variety of design challenges.

These assumptions are used in creating the architecture, processes, artifacts, tools and rule sets (algorithms) of the present Invention and every expression of it on multiple levels of recursion ToA.

In the following explanation, each of the 22 design assumptions (or memory aspects and functions) are stated with examples (in the realm of Environment, Process and Tools) for each assumption along with a brief explanation. Following each set of examples, are some general observations relevant to the assumption. The examples are specific to some aspect, on a designated level of recursion and a particular Subsystem, of the System and Method of the present invention. These examples are stated as system specifications, rules, algorithms or pseudo-code. While not exhaustive of the System and Method nor it's practice (in Trade Secret), these examples indicate the potential range and scope of the design assumption as rules for building specific expressions, artifacts and processes of the System and Method. The detail provided is sufficient for building significant “mind-like” processes, tools, environments, systems and artifacts across a broad range of application in a similar broad range of media.

Recap of Recursion Levels:

To facilitate understanding of what Level of Recursion T0A a given description or definition is applied to, the following convention is employed: rL1=neural nodes, computer code, small parts scale; rL2=machine environment scale; rL3=human scale; rL4=human team and group scale; rl5=human environments and organizations scale; rL6=social and ValueWeb ToA scale; rL7=global network and economy scale. These scales are roughly derived from and related to Miller's system and will be noted herein. This code is part of an Agent Definition Code which is an aspect the “Agent Builder” toolkit—Subsystem 3 Ss3.

In the following examples, the Principle of Minimum claim ToA is employed. That is, the science and philosophy statements are made in a way that claims the least amount of certainty and information necessary to support the design assumption in focus, and the examples and rules necessary to implement this principle, in some operating subsystem or component in some part of and level of recursion of this System and Method.

Aspects:

1—Memory is Distributed

### EXAMPLES

Of Pattern Language principles and Rules in various expressions:

[symbol] On scale of a regional networks and ValueWebs rL6 supporting:

Human design, individual and collaborative work processes distribute the documentation [symbol] per the 10 Step Model with sufficient redundancy to ensure a high probability of recall/recovery and Agent response across a broad range of probable human, systems, climatic, social and geopolitical occurrences.

Distribute, separately, a tracking system [symbol] that is not vulnerable to the same risks as the core documents.

Distribute the KnowledgeBase [symbol] in a similar manor.

For key, critical aspects of the KnowledgeBase, distribute in various media, languages and systems architecture, with geographic perspective, to avoid, time, location and culture specific obliteration. See: S12 of FIG. SS1-1—Exit iteration.

[symbol] On the scale of the human built environment as a global system rL7:

Create, and connect through networks, smart buildings and transportation units that report their status as they function informing both the system, impacted localities and immediate users of their status and options. Employ this information on all levels of the system rL1 through rL7 to augment performance of all connected Agents on all levels (of system). Store this information in a variety of connected devices distributed throughout the system. See: FIG. SS4-1 and FIG. SS6-1

[symbol] On the scale of rL1 through rL7:

Design distributed multi-model networks and to be partially overlapping, encrypted for different private and public levels of access so as to promote variety, diversity and time-delayed I/O events between the various components. This creates conscousness-like and unconscousness-like behaviors in the system. See: SS6-1

This can be observed in any system of minimal complexity and sustain-ability. A non distributed system in a dynamic environment will fail. Any single-point-of failure, in a complex environment is a weak strategy. In complex systems, different distribution strategies are governed by different rule sets.

Simple rules can be hardwired at the level of the unit of memory—as part of the memory. Complex rules act as Agents ToA.

Distributed memory is more than defensive. The pattern of distribution, itself, contains information. Distances and signal rates matter and contain information. Field effects are created and responded to—and contain and transmit information when active. Channels and Nodes are redundant for many different, “unrelated” memories. The totality of this architecture has a style and signature—it is “brand.” It can be recognized. In an animal or human it is part of what is perceived as “personality.” The same will be said of machines when they become smart ToA.

The pattern, as an architecture, is an analog of the systems genetic background and specific experience. Transactions create another layer of pattern—and fields (levels of recursion).Connection rules create “chunks” of cascading hierarchies. Channels and Nodes execute, by built in logic and learned rules, across analog Thresholds.

“Strong” memories ToA have many connections of different types. “Weak” memories ToA have few connections and/or a lower variety of connection types. A major objective of any intentional process related to “learning,” “creativity” and the creation of a complex, responsive system, is to make STRONG memory which is absolutely essential to the kinds of entities that exhibit enduring and/or intelligent characteristics.

2—The architecture of Memory is a Network

### EXAMPLES

Of Pattern Language principles and Rules in various expressions:

[symbol] On scale of work teams rL4 working is distributed networks for a global organization rL47:

Structure Teams in PatchWorks configurations of Patches, Nodes and Channels. Develop communications protocols that facilitates transparent communication between nodes while avoiding grid lock between Patches. See FIG. SS1-5

[symbol] On scale of creating an augmented work environment rL4 for human [symbol] [symbol] [symbol] [symbol] Agents ToA employing the CyberCon System rL2:

Support the work process [symbol] with documentation and feedback [symbol] in active mode: ToA (hear/watch—search—display—document [symbol] —iterate) employing the 10 Step Model in real time ToA and Distribute by the need-to-know ToA rule as established by employing ValueWeb-Builder See: FIG. SS6-3.

[symbol] On the scale of continent wide transportation corridors rL7 that create replacement-economy ToA ribbon-regions ToA employ:

Virtual-Agents ToA that act as tranaction and transport Agents, FIG. SS4-1 and FIG. SS3-3, for every real-Agent ToA brought into the system—said virtual and real Agents reporting status, S-7, to each other at an apporpriate rate and scale as established by the owner-Agent, S-8, employing Agent Builder FIG. SS3-3.

The “state” of said Agents to be readable by other Agents (real and virtual) in the system determined by the mutual-connectivity ToA rule-set ToA, S-4, of ValueWeb-Builder.

There are many organizing principles employed in memory systems, however, the major, integrating architecture of any system beyond minimal complexity ToA, in an environment [symbol] beyond minimal complexity, is a network ToA.

The architecture of this network, itself, contains information. This pattern can be “read” from another level of recursion. Activity (transactions) through the network, levels, rates, patterns, kinds (of transactions), and so on, contain and transmit information.

The architecture of memory is specific to the actual degrees of freedom of Channels, Nodes and Thresholds and their access strategies (rules) Real estate is important.

3—The Architecture Changes With Use

### EXAMPLES

Of Pattern Language principles and Rules in various expressions:

[symbol] On scale of documents and artifacts associated with the design process rL2:

Employ the Stages of an Enterprise, Solution Box Models and appropriate visual/verbal/graphical pattern language to describe “status” of and idea or artifact that change as the work moves through iterations of development. Provide means for the placement of data in storage system to adjust and reconfigure according to the status of these documents and artifacts (i.e. SolutionBox KnowledgeBase System). See 3 SS3-12

[symbol] On the scale of collaborative work environments for teams rL4:

Create flexible environments—user configurable and auto mode—that respond to evolving needs need in real time by adjusting tool carts, multimedia space shape, color, acoustic properties, temperature, light levels, and so one by protocols based on the Creative Process Model. See: 2 of SS3-12 and 61, 62, 63, 64 and 65 of SS3-11.

[symbol] On the scale of human economic and planetary ecology rL7:

Provide a Master planning process and augmentation system that reflects past, present and possible future states of the landscape and built environment on global, regional, ribbon, political/economic and local scales. Feed this system with human and virtual Agents inputs real time so that the system accurately reflects the status—and possible future status—of development.

Memory is not something in something like an immutable box, it is the thing and the architecture of its composition. Nodes ToA, Channels ToA and Thresholds ToA change with experience. The pattern of the whole changes with experience [symbol] . Change happens on levels of recursions above and below the system-in-focus and field of emergence (in activity).

Delay rates between an activity and its reflection in the architecture are significant. Delay rates can be a design feature of the system.

In complex systems, “emotions” effect Thresholds most; “thoughts” effect logic and rules most. Emotions are (more) analog. Thoughts are (more) digital. Fields are generated by activity and form part of the architecture.

4—Memory Utilizes Reuse

An existing pattern will be employed, as a first choice, where available. This is efficient and saves energy and storage media. Reuse reinforces a Channel and Net, making it a candidate for more reuse starting an increasing returns, positive feedback loop. The consequence can be “getting into a rut.”

The resulting Network acts [symbol] like an economy. It is always voting, shifting, changing.

Synergistic, unpredictable “associations” are formed between “unrelated” events when reuse is employed. This a principle means of introducing randomness—an important aspect of a complex system and what, in human terms, becomes a key element of what is called “creativity.”

5—It is Digital and Analog

Binary yes-no and sliding scale (analog) modalities, in various combinations, are necessary to achieving memory of any complexity. The architecture of how these modalities interrelate and interact is significant.

“Chunks” of these “strategies” can act as Agents of the system or a subsystem within the system.

6—It is Active

Memory is often seen as passive. This cannot account for the performance of complex systems. Memory actively seeks patterns of like kinds through multiple channels.

Memory never “sleeps.” Robust memory systems actively avoid boredom and potential bleed off. This is one factor that triggers “reuse.”

7—Proximity, Signal Strength and Repetition are Important

### EXAMPLES

Of Pattern Language principles and Rules in various expressions:

[symbol] On the scale of a creating an environment of human [symbol] [symbol] [symbol] [symbol] Agents working in Teams rL4-Ss3:

Do not isolate the teams (visually, traffic pattern, acoustically, energy-field-reach, work process experience, technical language) so that signal strength and reinforcing contacts are effectively eliminated.

Design the environment so that an appropriate level of interaction is forced and so that the levels of bleed-through between Teams can be “gated” (light, sound, view, sense-of-presence, and so on) and modulated in concert (rule-based) with a Creative Process Model (and decision process).

[symbol] On the scale of

Memory of the TEAM experience is, thus, created if supported with the appropriate technical system, documentation and feedback process.

Memory creates itself in physical media by signal strength (ToA) and repetition. It prioritizes access by use, context and proximity. This requires “voting.”

Non physical related memory phenomena, such as fields, rely heavily on signal strength and proximity and transacts by resonance and field effect.

Physical (thing) and non physical (no-thing) co-operate in complex systems.

8—It is Context Sensitive

Context is information ToA and feedback ToA, from one level of recursion to another, about the “state” of the system or a “chunk” of the system. State sensitivity can be transacted through Threshold and Channels and, thus, act on Nodes and/or effect Nodal logic. Context can raise or lower resistance to act.

A Threshold or Channel can be an Agent or act as a simple Rule and be “context”—i.e. be a modal switch—to another level of recursion of the system.

A part of the system that is context-sensitive can be triggered/switched (clustered cascading hierarchies) to execute a series of programmed and/or learned actions (an autonomous or “automated” response). How did you read this?

9—It is Agent-Based

Agents are made of various combinations of the system (Channel, Nodes, Thresholds), in self organizing clustered cascading hierarchies, and have the functional ability to act as if autonomous.

An Agent is a Cluster with certain characteristics. Among them are feedback, sensors, rules, multiple (action) choices, ownership.

Parts of one Agent can be in another Agent—or not.

Agent rules are formed on another level of recursion than the Agent. An Agent can work on more than one level of recursion; a complex Agent must do so.

Agents change through iterations of experience.

Agents act. Agents learn.

10—It Employs Morphic Resonance

Field effects are important channels in complex systems. Hardwiring cannot supply enough information (size and connection complexity). Activity through hardwired channels generate fields. The fields, themselves, contain information. They interact with other fields. Field influence and or act upon material elements to change them and sometimes trigger action. They can be a Threshold media.

Affinity for like-kind is strong and can be recognized as a pattern. Many, non physical “Channels” and fields can create a resonate effect. Resonance and entrainment (ToA) are major means of information creation and transaction in a complex system.

11—The Components are Rule-Based (Nodes, Channels, Nets and Threshold Media)

Nodes, channels and thresholds follow simple rules in their operation. A rule can be hardware or software coded. Software is volatile hardware coding on one level of recursion working on another level of recursion.

There are rules about rules usage—rule cluster to create requisite variety.

12—The State of the Entire System is the Memory (State 1, State 2, State 3 State . . . n)

### EXAMPLES

Of Pattern Language principles and Rules in various expressions:

[symbol] On the scale of a global Transportation Systems such as an Airline rL5-Ss4:

Employ the movement of the human and artifact Agents through the System as the means of governing the response and adaptation of the System. Track [symbol] each Event [symbol] (from “home to home”) as a series of descrete steps (State 1, State 2, State 3, Stare . . . n) that switch/trigger responces that:

1. facilitates [symbol] each traveling Agent through a seamless, non interrupted, user option-rich travel experience [symbol] ;

2. provides feedback (ToA) to optimize the real-time (ToA) and future performance of the System itself;

3. enhances the information (ToA) in the system, about the system (Agency ToA) and its components (Agents ToA), providing memory for all participating Agents on a Reciprocal Transparency basis;

4. automates and supports Agent transaction processes.

See: FIG. SS3-12

[symbol] On the scale of designing global communities of work

Build ValueWebs with infrastructure resources, FIG. SS6-2, and employ processes, FIG. SS1-1, in augmented environment (real and virtual), FIG. SS3-12, at critical mass ToA and scale ToA, sufficient (Appropriate Response Model) to make Mind “Engines,” FIG. SS6-1, that provide Nets, 20 FIG. SS6-2, with active, strong ToA memory that remains requisite ToA with the transaction rate and changes within said Net and it's environment.

The entire system is the memory. Every change changes the memory of the “part” and the whole. Recall, reenacts a “circuit” of the system (Channel, Nodes, Thresholds) and, itself, becomes an event.

This can be seen and treated as a progression of discreet States.

The frequency of (messaging, measurement or awareness) these states (1, 2, 3, n . . . ) is determined by the change rate of the system and it's environment. Too fast is redundant and burdens the system, too slow and the system fails. This is context sensitive.

The system does not remember—it re-acts. Doing so, it changes “the” memory.

Prior States leave physical traces for extended periods of time.

13—Awareness of the Systems Architecture Pattern is Necessary

In any complex system, some “awareness” (feedback) of the architecture pattern has to be available to some portions of the system as “content.” This does not have to occur on the threshold level necessary to provoke consciousness (as commonly defined or experienced by Humans).

14—Sensors to the Environment are Necessary

A system cannot retain memory cut off from an environment. Memory, to be retained, has to be stimulated and reinforced. It “bleeds” like a capacitor. It takes continual information and energy to keep memory intact. “Bleeding, however, does not “loose” memory—it changes it.

Different Channels, Nodes, Thresholds and Clusters can have different sensors. Different Channels, Nodes, Thresholds and Cluster can rely exclusively on other's sensors as the information is passed on. These architecture attributes are significant.

No sensor, no feedback, No feedback, no learning. No learning, no memory. A memory event requires a difference, a distinction.

The environment of any system can be can be acted upon on many levels of recursion depending on the function being studied or employed. What is an environment is functionally defined and revealed by a process action.

15—Geometry has Content

The shape, form and pattern (multidimensional in a complex system) of the geometry of memory, itself, has content. Channels, Nodes and Thresholds form Clusters. When active, Clusters “look” for a similar patterns in their own system and in other systems. When active, Channels, Nodes, Thresholds and Clusters generate fields which influence and act upon other Channels, Nodes, Thresholds and Clusters.

These clusters are embedded experience and, therefore, have “meaning”—Agents of similar composition complexity and pattern experience—not necessarily species—can understand this “meaning”—and add their own to it (given a coherent system).

16—Components Vote

When memory acts there are competing “Agents” each bringing a different shading to the “experience.” Systems employ simple voting rules to sort out these “voices.” These rules are context sensitive and adjust (by rules) from feedback (in complex systems).

Voting is continuous and never “complete.” Voting rate is a factor of ambiguity and importance (greater gap equals greater information potential equals more voting) to the system (inside a non-external-crises context). Ambiguity and importance are described by the “3 Cat Model” (the difference between “Real” [symbol] , “Concept” [symbol] and Mechanical” [symbol] cats). More than one level of recursion and iteration is necessary in complex conditions and environments.

Voting competes with other potential actions and consumes system bandwidth. This is a feature, The system becomes “aware” of high levels of conflict.

17—Memory Employs Language

### EXAMPLES

Of Pattern Language principles and Rules in various expressions:

[symbol] On scale of interaction among human Agents rL4-Ss1, when messaging to or communicating with individuals from different fields, professions, regions, age groups, philosophies:

Test your circuit before investing in massive communication. What you said is the feedback (message) that returns not the meaning you ascribed to your words as an output.

What happened to your “message” is the memory map unique to the individuals/group you engaged.

Each individual is the sum of their prior experience. They are their memory. Each human culture attaches different meaning to words according to their common experience (group memory). The description and language of this experience reinforces the experience and memory of it. The language is the codification of the experience. Each field and profession has Terms-of-Art that define their profession. This is memory of the profession. Your message creates new memory—there is no “experiment” (dialog) without consequence.

[symbol] on the scale of an environment rL5-Ss2 for human Agents of different backgrounds and cultures:

Employ a matrix of denotative and connotative elements, each speaking specific Agent idioms, in order to deliver a clear, unified architectural message to a broad population.

Different shapes, colors, sounds, forms, textures, rhythms, denote and connote different meanings. This is the language of human architecture (and culture). Different humans, as individuals, and as members of different cultural groups, are different memory sets—or patterns. There are universal and idiosyncratic meanings given to the components (shapes, colors, sounds, forms, textures, rhythms) of this architectural language. To “speak” strongly to the memory that is—to create a new memory—requires linking directly with the existing memory pattern, then, bridging to and creating the new pattern(s). This is why idiom and style are so important—they are cultural gestalts. Experience “chunks.” People who make movies understand this.

To deliver a single message requires a plurality of language elements. Each human agent will connect each element in a different way. However, the sum of all of them can provide a remarkably uniform experience (and memory). This is what art does. This is why art is not a luxury but a necessary function of human experience. Manufacturers of quality, high perforce automobiles understand this.

[symbol] On the scale of designing a computer augmentation system interfaces rL2-Ss3 facilitating human Agent work:

Employ multiple languages. Avoid the too simple interface mostly word based. Avoid arbitrary uses of color, form, sound, textures. Allow the user to build the interface from a language kit. Employ icons and glyphs that have intrinsic, deep, social and cultural meaning.

Existing systems actually work against the memory patterns of some users. Using such systems can cause memory lapse, confusion and deterioration. Systems and technologies are not neutral. They are embodied thought processes. Using them, employs those thought processes. This triggers all kinds of mental and physiological responses in Human Agents—mostly unintended.

Signals in a memory circuit are coded—they employ Language (Deep Language). Channels and Nets are not neutral—they become part of the message (Channels and Nets modify both language and the message). The power of a message is related to its fit: the number of nodal connections made, the reinforcement of existing Channels and the location of these “hooks” in the architecture (chunks of self organizing clustered cascading hierarchies) of the system.

Agents of different types employ different languages and language systems. An Agent's access to the information in a system is limited by the ability to “read” the language employed. Information potential can exist but not be readable. It is a feature of this System and Method to employ new language(s) as a means of “reading” existing information previously unreadable by human and other Agents and to make bridges between these gaps.

18—Dialog Within and Without the System Transacts Instructions

### EXAMPLES

Of Pattern Language principles and Rules in various expressions:

[symbol] On scale of interaction among human Agents rL4-Ss1, as a facilitator using the natural authority of the position (facilitator, teacher, guide):

Shape language as an instruction to the group—as a whole—and to the subconscious of each individual.

Conscious (ToA) mind programs unconscious (ToA) which will respond within the limits of the system. Giving oneself the instruction to wake up in the morning at a specific (non habitual) time is an example of this process (see Lilly).

Within the negotiated limits of the facilitation mandate, direct the process, firmly, without equivocation. This frees the participants from unnecessary overhead.

[symbol] on the scale of an environment of human Agents rL5-Ss2, arrange the environment of Agents (furniture, artifacts, knowledge-objects, natural elements, and so on):

To speak explicitly to the work to be done and the spirit of the occasion. The design use of prospect and refuge, connotation and denotation, symbol and message are the means for doing this.

[symbol] On the scale of a computer knowledge-base systems rL7-Ss3 using the 10 Step Knowledge Work Process Model:

If step 3 finds match of 65% or greater send list to step 4 recipients as priority 2; then, initiate step 5.

This is a “push” action on the part of the knowledge-base that delivers a “must read” message to a work team on a real time basis. The Tracking (Step 5) and Feedback (Step 6) protocols are automatically started.

Each transaction is an instruction to some Agent (simple or complex) part of the system to take some action [symbol] An instruction does not have to be followed by a free-Agent ToA—it does by a owned-Agent ToA.

In poorly designed and/or operated systems, instructions self-cancel—this leads to sub-optimization of the system and high overhead. The “net vector” of a group of activities is low. Natural alignment in an individual human, an organization or a system is the result of the clarity and fit of the language instructions employed.

19—Memory Chunks into Self-Organizing Clustered Cascading Hierarchies

### EXAMPLES

Of Pattern Language principles and Rules in various expressions:

[symbol] On the scale of a complex PatchWorks Design exercise,

[symbol] on the scale of an Innovation “city” rL5-Ss2, to design [symbol] the organization of functional spaces:

Structure the relationship between the functional spaces in an hierarchy that clearly expresses the purpose and program of the environment and allows for a high level of user alternatives and adaptability.

The experience of human Agents within a building lack coherence and continuity if the pattern language of the environment does not convey necessary information related to location and logistics, place and purpose, use and tool assembly—and so on. This is critical in the case of large scale structures such a cites and mega-structures. This is the same issue that in the design of computer systems is called “interface.” It is a question of language. “Readable” (by the Agents in focus) language has to be embedded into the structure of the environment. Contradictory and arbitrary messages have to be avoided—they are often built-in by default or ignorance.

Provide feedback to the Structure (as Agency) and Technical Systems (as Agents) so that they can adapt, respond and document as they learn and support user routines.

The experience of human and other agents inside a building (made up of agents) is the memory of the building. In tradition buildings, there are few means to retain that memory and make it effective. There exists a gap between the level of recursion of the building and the human and other Agents within it. A “smart” or “intelligent” building has mean to retain the Agent experience and employ it in specific ways.

[symbol] On the scale of a global Transportation System:

(Agent tracking/transacting)

These “chunks” can act [symbol] as Agents—or not. Chunks are at a higher level of recursion ToA than the parts of which they are composed. The hierarchies are clustered. Cascading is the propensity to “recall” and trigger (act [symbol] ). It is never determined.

Self-organization is a factor of memory being active and seeking patterns of like kind. This is a requirement of an evolving network architecture. Patterns of different media (numbers, text, size, shape, tone, rhythm, relationship, material, age, texture, sound, taste, smell, color, to name a few) can be “recognized” (by different systems) and chunked.

Clustered cascading hierarchies can be switched/triggered leading to complex, fast and “autonomous” responses. In human Agents, reading, speaking, reacting to perceived danger are examples. In machine Agents, an expert system landing an airplane is an example. In network systems, a load prioritization routine, in response to an overload, is an example. Feedback [symbol] is a common switch/trigger in these examples. All these switched/triggered responses are rule-based (hard or “soft” coded). Clustered cascading hierarchies are roughly equivalent to “long term” memory in systems where this concept is relevant.

20—Memory is Not Storage

### EXAMPLES

Of Pattern Language principles and Rules in various expressions:

[symbol] On the scale of

Storage is necessary to memory but is not memory. Storage, itself, cannot be considered memory. Everything is storage and contains memory.

21—Consciousness is Not Necessary

Consciousness is feedback [symbol] from one part and/or level (of recursion) of a system of sufficient scale, mass and repetitive frequency that the system becomes aware of some aspects of its own functioning and/or actions (see: Janes). Feedback of a complex kind (see: Weiner) and critical mass is required for complex memory and self-aware systems.

The same mechanisms can function in a way that does not trigger self-awareness—even in systems capable of it.

22—Complex Memory Systems Parallel Process

Information Theory and Al established the Model, long ago, that most organic systems must parallel process. This conclusion stems from the difference of their throughput compared to their cycle time. To date, most human-designed systems are linear; they are very fast—on the level of machine cycle time—but engage in one sequential operation following the one before.

Complex systems require a far greater utilization of resources.

This makes sequencing a far greater engineering problem than exists in simpler, linear systems. However, sequencing and threading do not have to be totally understood or controlled in order for the system to be viable. Certain rules of intersection, input and feedback do have to be working. Non-directed, not predictable inputs and feedback messages are a means of inducing randomization into a system that otherwise may just be a self-fulfilling process heading for stasis. This random process subsystem is essential to, what on the Human scale of recursion, is called creativity. It is an essential element in the creation of machine intelligence. Design and operation of the random element (via feedback and inputs from different iterations and levels of recursion of the system), on the scale of large, complex, multi-modal systems—made up of Agents of different kinds—is critical. It is a key aspect of how these systems actually work.

Requirements and Capacities . . .

The techniques, processes, augmentation tools, artifacts and system components that compose the memory providing, building and employing aspects of this System and Method, address the following required capacities:

The ability to make, now disparate components of a system, “act” in “mind-like” ways wherein the various components:

record and “inform” one another of their status and state and record the informing act;

Encode and translate various “experiences” so that various components and users of a subsystem (or the System) can “read” the embodied information and employ it—making a functional memory—that relates to and ties the “experience” of one system component to others—across time, activity and work iterations and levels of recursion;

Memory ToA is misunderstood. It is confused with storage. It is confused with other cognitive processes. It is rarely used as an active design element in the creation of Human artifacts and systems. Consequently, both component and system performance is compromised. This leads to ineffective systems. Beyond these consequences, however, is an even more limiting result. There are whole categories of artifacts and systems that cannot function without intact, dynamic memory. The present Invention is concerned with both these situations—one can be called “traditional” and “lifelike.” The Human species is approaching a level of complexity, in organizational, technical and socials systems, that exceeds the capacity of the kind (traditional) of systems they employ. If there is not to be breakdown and a “limits to growth” consequence, more complex (lifelike) systems have to be built.

Much of what makes inefficient, high maintenance systems can be addressed by building in, and employing, more sophisticated memory. This facilitates cybernetic performance. Complex systems require multiple levels of recursion of feedback; this requires multiple autonomous memory components. Engineering these kinds of systems will require the employment of multiple combinations of the 22 memory functions described herein as design assumptions.

1. An iterative, feedback driven system for building and sustaining ValueWebs comprising:
means for imbedding mind like characteristics and behavior in agents
means for facilitating emergence in agents.

2. The system of claim 1, used for facilitating interaction among agents promoting feedback, learning and emergent group genius in a radically compressed time period.

3. The system of claim 1, used for optimizing agent pattern language values in collaborative environments the system further comprising;
means for creating virtual agents to represent real agents in the system, each of the agents containing data corresponding to some characteristic of the real agent represented;
means for at least some of the virtual agents having an access/use characteristic that allows access or use only to agents having access privilege corresponding to the agent;
means for allowing agents to control what is revealed by those agents that they control;
means for allowing agents to modify the agents that they control; AND
means for determining the location of agents within the system.

4. The system of claim 1, used for integrating/optimizing technical systems to promote agent interaction the system further comprising:
means for creating virtual agents to represent real agents in the system, each of the agents containing data corresponding to some characteristic of the real agent represented;
means for at least some of the virtual agents having an access/use characteristic that allows access or use only to agents having access privilege corresponding to the agent;
means for allowing agents to control what is revealed by those agents that they control;
means for allowing agents to modify the agents that they control;
means for allowing agents to control what is revealed by those agents that they control; and
means for allowing agents to modify the agents that they control.

5. The system of claim 1, used for transporting agents and agent environments as an integrated experience the system further comprising:
means for creating virtual agents to represent real agents in the system, each of the agents containing data corresponding to some characteristic of the real agent represented;
means for at least some of the virtual agents having an access/use characteristic that allows access or use only to agents having access privilege corresponding to the agent;
means for allowing agents to control what is revealed by those agents that they control;
means for allowing agents to modify the agents that they control; and
means for determining the location of agents within the system.

6. The system of claim 1, used for structuring and facilitating value exchange among agents forming real and virtual economies the system further comprising:
means for creating virtual agents to represent real agents in the system, each of the agents containing data corresponding to some characteristic of the real agent represented;
means for at least some of the virtual agents having an access/use characteristic that allows access or use only to agents having access privilege corresponding to the agent;
means for allowing agents to control what is revealed by those agents that they control;
means for allowing agents to modify the agents that they control;
means for determining the location of agents within the system; and
means for determining the health, status or condition of agents within the system.

7. The system of claim 1, used for facilitating work and commerce among agents in a knowledge economy the system further comprising:
means for creating virtual agents to represent real agents in the system, each of the agents containing data corresponding to some characteristic of the real agent represented;
means for allowing agents to replicate other agents to the extent the characteristics of the other agents are revealed;
means for at least some of the virtual agents having an access/use characteristic that allows access or use only to agents having access privilege corresponding to the agent;
means for allowing agents to control what is revealed by those agents that they control;
means for allowing agents to modify the agents that they control;
means for determining the location of agents within the system; and
means for determining the health, status or condition of agents within the system.

8. An iterative, feedback driven method for building and sustaining ValueWebs comprising:
means for imbedding mind like characteristics and behavior in agents
means for facilitating emergence in agents.

9. The method of claim 8, used for facilitating interaction among agents promoting feedback, learning and emergent group genius in a radically compressed time period.

10. The method of claim 8, used for optimizing agent pattern language values in collaborative environments the system further comprising;
means for creating virtual agents to represent real agents in the system, each of the agents containing data corresponding to some characteristic of the real agent represented;
means for at least some of the virtual agents having an access/use characteristic that allows access or use only to agents having access privilege corresponding to the agent;
means for allowing agents to control what is revealed by those agents that they control;
means for allowing agents to modify the agents that they control; AND
means for determining the location of agents within the system.

11. The method of claim 8, used for integrating/optimizing technical systems to promote agent interaction the system further comprising:
means for creating virtual agents to represent real agents in the system, each of the agents containing data corresponding to some characteristic of the real agent represented;
means for at least some of the virtual agents having an access/use characteristic that allows access or use only to agents having access privilege corresponding to the agent;
means for allowing agents to control what is revealed by those agents that they control;
means for allowing agents to modify the agents that they control;
means for allowing agents to control what is revealed by those agents that they control; and
means for allowing agents to modify the agents that they control.

12. The method of claim 8, used for transporting agents and agent environments as an integrated experience the system further comprising:
means for creating virtual agents to represent real agents in the system, each of the agents containing data corresponding to some characteristic of the real agent represented;
means for at least some of the virtual agents having an access/use characteristic that allows access or use only to agents having access privilege corresponding to the agent;
means for allowing agents to control what is revealed by those agents that they control;
means for allowing agents to modify the agents that they control; and
means for determining the location of agents within the system.

13. The method of claim 8, used for structuring and facilitating value exchange among agents forming real and virtual economies the system further comprising:
means for creating virtual agents to represent real agents in the system, each of the agents containing data corresponding to some characteristic of the real agent represented;
means for at least some of the virtual agents having an access/use characteristic that allows access or use only to agents having access privilege corresponding to the agent;
means for allowing agents to control what is revealed by those agents that they control;
means for allowing agents to modify the agents that they control;
means for determining the location of agents within the system; and
means for determining the health, status or condition of agents within the system.

14. The method of claim 8, used for facilitating work and commerce among agents in a knowledge economy the system further comprising:
means for creating virtual agents to represent real agents in the system, each of the agents containing data corresponding to some characteristic of the real agent represented;
means for allowing agents to replicate other agents to the extent the characteristics of the other agents are revealed;
means for at least some of the virtual agents having an access/use characteristic that allows access or use only to agents having access privilege corresponding to the agent;
means for allowing agents to control what is revealed by those agents that they control;
means for allowing agents to modify the agents that they control;
means for determining the location of agents within the system; and
means for determining the health, status or condition of agents within the system.

15. An iterative, feedback driven system for building Agents comprising:
means for imbedding mind like characteristics and behavior in agents
means for facilitating emergence in agents.

16. The system of claim 15, used for facilitating interaction among agents promoting feedback, learning and emergent group genius in a radically compressed time period.

17. The system of claim 15, used for optimizing agent pattern language values in collaborative environments the system further comprising;
means for creating virtual agents to represent real agents in the system, each of the agents containing data corresponding to some characteristic of the real agent represented;
means for at least some of the virtual agents having an access/use characteristic that allows access or use only to agents having access privilege corresponding to the agent;
means for allowing agents to control what is revealed by those agents that they control;
means for allowing agents to modify the agents that they control; AND
means for determining the location of agents within the system.

18. The system of claim 15, used for integrating/optimizing technical systems to promote agent interaction the system further comprising:
means for creating virtual agents to represent real agents in the system, each of the agents containing data corresponding to some characteristic of the real agent represented;
means for at least some of the virtual agents having an access/use characteristic that allows access or use only to agents having access privilege corresponding to the agent;
means for allowing agents to control what is revealed by those agents that they control;
means for allowing agents to modify the agents that they control;
means for allowing agents to control what is revealed by those agents that they control; and
means for allowing agents to modify the agents that they control.

19. The system of claim 15, used for transporting agents and agent environments as an integrated experience the system further comprising:
means for creating virtual agents to represent real agents in the system, each of the agents containing data corresponding to some characteristic of the real agent represented;
means for at least some of the virtual agents having an access/use characteristic that allows access or use only to agents having access privilege corresponding to the agent;
means for allowing agents to control what is revealed by those agents that they control;
means for allowing agents to modify the agents that they control; and
means for determining the location of agents within the system.

20. The system of claim 15, used for structuring and facilitating value exchange among agents forming real and virtual economies the system further comprising:
means for creating virtual agents to represent real agents in the system, each of the agents containing data corresponding to some characteristic of the real agent represented;
means for at least some of the virtual agents having an access/use characteristic that allows access or use only to agents having access privilege corresponding to the agent;
means for allowing agents to control what is revealed by those agents that they control;
means for allowing agents to modify the agents that they control;
means for determining the location of agents within the system; and
means for determining the health, status or condition of agents within the system.

21. The system of claim 15, used for facilitating work and commerce among agents in a knowledge economy the system further comprising:
means for creating virtual agents to represent real agents in the system, each of the agents containing data corresponding to some characteristic of the real agent represented;
means for allowing agents to replicate other agents to the extent the characteristics of the other agents are revealed;
means for at least some of the virtual agents having an access/use characteristic that allows access or use only to agents having access privilege corresponding to the agent;
means for allowing agents to control what is revealed by those agents that they control;
means for allowing agents to modify the agents that they control;
means for determining the location of agents within the system; and
means for determining the health, status or condition of agents within the system.

22. An iterative, feedback driven method for building Agents comprising:
means for imbedding mind like characteristics and behavior in agents
means for facilitating emergence in agents.

23. The method of claim 22, used for facilitating interaction among agents promoting feedback, learning and emergent group genius in a radically compressed time period.

24. The method of claim 22, used for optimizing agent pattern language values in collaborative environments the system further comprising;
means for creating virtual agents to represent real agents in the system, each of the agents containing data corresponding to some characteristic of the real agent represented;
means for at least some of the virtual agents having an access/use characteristic that allows access or use only to agents having access privilege corresponding to the agent;
means for allowing agents to control what is revealed by those agents that they control;
means for allowing agents to modify the agents that they control; AND
means for determining the location of agents within the system.

25. The method of claim 22, used for integrating/optimizing technical systems to promote agent interaction the system further comprising:
means for creating virtual agents to represent real agents in the system, each of the agents containing data corresponding to some characteristic of the real agent represented;
means for at least some of the virtual agents having an access/use characteristic that allows access or use only to agents having access privilege corresponding to the agent;
means for allowing agents to control what is revealed by those agents that they control;
means for allowing agents to modify the agents that they control;
means for allowing agents to control what is revealed by those agents that they control; and
means for allowing agents to modify the agents that they control.

26. The method of claim 22, used for transporting agents and agent environments as an integrated experience the system further comprising:
means for creating virtual agents to represent real agents in the system, each of the agents containing data corresponding to some characteristic of the real agent represented;
means for at least some of the virtual agents having an access/use characteristic that allows access or use only to agents having access privilege corresponding to the agent;
means for allowing agents to control what is revealed by those agents that they control;
means for allowing agents to modify the agents that they control; and
means for determining the location of agents within the system.

27. The method of claim 22, used for structuring and facilitating value exchange among agents forming real and virtual economies the system further comprising:
means for creating virtual agents to represent real agents in the system, each of the agents containing data corresponding to some characteristic of the real agent represented;
means for at least some of the virtual agents having an access/use characteristic that allows access or use only to agents having access privilege corresponding to the agent;
means for allowing agents to control what is revealed by those agents that they control;
means for allowing agents to modify the agents that they control;
means for determining the location of agents within the system; and
means for determining the health, status or condition of agents within the system.

28. The method of claim 22, used for facilitating work and commerce among agents in a knowledge economy the system further comprising:
means for creating virtual agents to represent real agents in the system, each of the agents containing data corresponding to some characteristic of the real agent represented;
means for allowing agents to replicate other agents to the extent the characteristics of the other agents are revealed;
means for at least some of the virtual agents having an access/use characteristic that allows access or use only to agents having access privilege corresponding to the agent;
means for allowing agents to control what is revealed by those agents that they control;
means for allowing agents to modify the agents that they control;
means for determining the location of agents within the system; and
means for determining the health, status or condition of agents within the system.
